(19) United States
(12) Patent Application Publication
(10) Pub. No.: US 2026/0049376 A1
(43) Pub. Date: Feb. 19, 2026

(54) REMOVAL OF IMPURITIES FROM LITHIUM ELUATE

(71) Applicant: Lilac Solutions, Inc., Oakland, CA (US)

(72) Inventors: David Henry SNYDACKER, San Francisco, CA (US); Sophia Patricia MOCK, Berkeley, CA (US); Christopher John KOMLOS, San Francisco, CA (US); Nicolás Andrés GROSSO GIORDANO, Oakland, CA (US); Amos INDRANADA, Oakland, CA (US); Garrett LAU, Castro Valley, CA (US)

(21) Appl. No.: 18/861,149

(22) PCT Filed: May 2, 2023
(86) PCT No.: PCT/US2023/020726

§ 371 Date: Oct. 28, 2024

Related U.S. Application Data
(60) Provisional application No. 63/337,735, filed on May 3, 2022.

(51) Int. Cl. C22B 26/12; B01J 39/09; C22B 3/42; C25C 1/00

(52) U.S. Cl. CPC C22B 26/12; B01J 39/09; C22B 3/42; C25C 1/00

(57) ABSTRACT

The present disclosure relates to the extraction of lithium from liquid resources such as natural and synthetic brines, leachate solutions from clays and minerals, and recycled products. Herein are systems and processes for extracting lithium using ion exchange materials, where transition metal impurities may be removed from the synthetic lithium solution. In some embodiments, the transition metal species are reformulated to form ion exchange materials to be used in the systems and processes described herein.

### CROSS-REFERENCE

This application claims the benefit of U.S. Provisional Application Ser. No. 63/337,735 filed May 3, 2022, which is hereby incorporated by reference in its entirety.

### BACKGROUND OF THE INVENTION

Lithium is an essential element for high-energy rechargeable batteries and other technologies. Lithium can be found in a variety of liquid solutions, including natural and synthetic brines and leachate solutions from minerals and recycled products.

### SUMMARY OF THE INVENTION

In an aspect, disclosed herein are systems and processes for extracting lithium from liquid resources using ion exchange materials to produce a synthetic lithium solution. In some instances, transition metal impurities are present in the synthetic lithium solution. The transition metal impurities may originate from the liquid resource, a reagent, or may be a byproduct of the ion exchange material being partially dissolved during the ion exchange process. The system removes such transition metal species from the synthetic lithium solution. In some embodiments, the transition metal species are reformulated to form ion exchange materials to be used in the systems and processes described herein. In some embodiments, an ion exchange material (e.g., an impurities-derived ion exchange material) is manufactured from the transition metal species removed from the synthetic lithium solution.

In an aspect, disclosed herein is a system for producing a synthetic lithium solution and removing transition metal species from said synthetic lithium solution, comprising: a. a first subsystem configured to 1) first contact an ion exchange material to a liquid resource, wherein said ion exchange material absorbs lithium ions from said liquid resource while releasing protons, and subsequently 2) contact the ion the ion exchange material to an acidic solution, wherein said ion exchange material releases lithium into said acidic solution while absorbing protons, producing a synthetic lithium solution. b. a second subsystem configured to remove transition metal species from said synthetic lithium solution. In some embodiments, the second subsystem further comprises: 1) a third subsystem configured to precipitate transition metal species dissolved in the synthetic lithium solution; and 2) a fourth subsystem for separating the liquid from the precipitated transition metal species. In some embodiments, the third subsystem is configured to perform an adjustment of the pH of the synthetic lithium solution, and wherein said adjustment causes the precipitated transition metal species to form. In some embodiments, the third subsystem is configured to perform an adjustment of the oxidation-reduction potential of the synthetic lithium solution, and wherein said adjustment causes the precipitated transition metal species to form. In some embodiments, the third subsystem is configured to perform an adjustment of the pH and oxidation-reduction potential of the synthetic lithium solution, and wherein said adjustment causes the precipitated transition metal species to form. In some embodiments, the second subsystem removes dissolved transition metal species directly from solution. In some embodiments, removal of transition metals species occurs by contacting an immiscible solvent to the synthetic lithium solution, and wherein said immiscible solvent preferentially dissolves the transition metal species. In some embodiments, removal of transition metals species occurs by contacting the synthetic lithium solution to a cation exchange resin, and wherein said cation exchange resin preferentially absorbs the transition metal species. In some embodiments, removal of transition metals species occurs by treating the synthetic lithium solution through a nanofiltration system comprising a filter, and wherein said nanofiltration system preferentially retains the transition metal species while allowing lithium ions to pass through the filter. In some embodiments, removal of transition metals species occurs by a combination of the systems described herein. In some embodiments, removal of transition metals species occurs by a combination of the systems described herein. In some embodiments, the second subsystem is configured to pass an electrical current through the synthetic lithium solution. In some embodiments, said electrical current is passed between two electrodes in contact with the synthetic lithium solution. In some embodiments, a solid is formed on one of the electrodes, and wherein said solid comprises a transition metal species removed from the synthetic lithium solution. In some embodiments, transition metal species is additionally removed by the system of any of the claims 2-11. In some embodiments, the system further comprises a fifth subsystem that is configured to manufacture an ion exchange material (e.g., an impurities-derived ion exchange material) from the transition metal species removed from the synthetic lithium eluate. In some embodiments, said fifth subsystem uses precipitated transition metal species produced by the system of any of the claims 2-5 to manufacture an ion exchange material. In some embodiments, said fifth subsystem uses precipitated transition metal species produced by the system of any of the claims 12-15 to manufacture an ion exchange material. In some embodiments, the precipitated transition metal species are washed with pure water or an aqueous solution. In some embodiments, the precipitated transition metal species comprise oxides, hydroxides, metals, insoluble salts, chelates, or combinations thereof. In some embodiments, the precipitated transition metal species are dissolved with an acid, and wherein said acid comprises hydrochloric acid, sulfuric acid, nitric acid, phosphoric acid, hydrobromic acid, hydroiodic acid, perchloric acid, acetic acid, or a combination thereof. In some embodiments, the precipitated transition metal species are purified via hydrometallurgical processes. In some embodiments, the hydrometallurgical processes comprises leaching, concentration, precipitation, cementation, solvent extraction, ion exchange, gas reduction, electrowinning, electrolysis, electrorefining, and combinations thereof. In some embodiments, the precipitated transition metal species are purified via pyrometallurgical processes. In some embodiments, the precipitated transition metal species are purified via vapor metallurgy processes. In some embodiments, the precipitated transition metal species are purified via molten salt electrometallurgy processes. In some embodiments, the precipitated transition metal species are reduced in size through milling, grinding, and combinations thereof. In some embodiments, the precipitated transition metal species are calcined in a furnace or kiln to prepare as precursors for manufacture of an ion exchange material. In some embodiments, the precipitated transition metal species are mixed with a lithium salt and calcined in a furnace or kiln to produce ion exchange material. In some embodiments, the lithium salt comprises Li₂CO₃, LiOH, LiNO₃, Li₂SO₄, Li₃PO₄, or combinations thereof. In some embodiments, the synthetic lithium solution produced by the first subsystem comprises chloride, sulfate, phosphate, bromide, chlorate, perchlorate, nitrate, formate, citrate, acetate, or combinations thereof. In some embodiments, the synthetic lithium solution produced by the first subsystem comprises chloride. In some embodiments, the synthetic lithium solution produced by the first subsystem comprises sulfate. In some embodiments, the synthetic lithium solution produced by the first subsystem comprises nitrate. In some embodiments, the synthetic lithium solution is used to produce a lithium product, and wherein said lithium product comprises lithium carbonation, lithium chloride, lithium hydroxide, lithium hydroxide monohydrate, lithium nitrate, lithium sulfate, lithium phosphate, metallic lithium, or a combination thereof. In some embodiments, the transition metal species comprises titanium, zirconium, vanadium, iron, copper, manganese, molybdenum, aluminum, niobium, or combinations thereof. In some embodiments, in the synthetic lithium solution produced by the first subsystem, the molar concentration of transition metal species is lower than the molar concentration of lithium in the synthetic lithium solution. In some embodiments, the concentration of lithium in the synthetic lithium solution produced by the first subsystem is greater than about 200 milligrams per liter and less than about 8000 milligrams per liter. In some embodiments, the concentration of lithium in the synthetic lithium solution produced by the first subsystem is greater than about 200 milligrams per liter and less than about 4000 milligrams per liter. In some embodiments, the concentration of lithium in the synthetic lithium solution produced by the first subsystem is greater than about 2000 milligrams per liter and less than about 8000 milligrams per liter. In some embodiments, the concentration of lithium in the synthetic lithium solution produced by the first subsystem is greater than about 200 milligrams per liter and less than about 1000 milligrams per liter. In some embodiments, the concentration of lithium in the synthetic lithium solution produced by the first subsystem is greater than about 200 milligrams per liter and less than about 500 milligrams per liter. In some embodiments, the concentration of lithium in the synthetic lithium solution produced by the first subsystem is greater than about 1000 milligrams per liter and less than about 4000 milligrams per liter. In some embodiments, the concentration of lithium in the synthetic lithium solution produced by the first subsystem is greater than about 1000 milligrams per liter and less than about 2000 milligrams per liter. In some embodiments, the concentration of lithium in the synthetic lithium solution produced by the first subsystem is greater than about 2000 milligrams per liter and less than about 3000 milligrams per liter. In some embodiments, the concentration of lithium in the synthetic lithium solution produced by the first subsystem is greater than about 3000 milligrams per liter and less than about 4000 milligrams per liter. In some embodiments, the concentration of lithium in the synthetic lithium solution produced by the first subsystem is greater than about 4000 milligrams per liter and less than about 5000 milligrams per liter. In some embodiments, the concentration of lithium in the synthetic lithium solution produced by the first subsystem is greater than about 5000 milligrams per liter and less than about 6000 milligrams per liter. In some embodiments, the concentration of lithium in the synthetic lithium solution produced by the first subsystem is greater than about 6000 milligrams per liter and less than about 8000 milligrams per liter. In some embodiments, the synthetic lithium solution produced by the first subsystem is acidic. In some embodiments, the value of pH of the synthetic lithium solution produced by the first subsystem is greater than about 1 and less than about 4. In some embodiments, the value of pH of the synthetic lithium solution produced by the first subsystem is greater than about 0 and less than about 1. In some embodiments, the value of pH of the synthetic lithium solution produced by the first subsystem is greater than about 1 and less than about 2. In some embodiments, the value of pH of the synthetic lithium solution produced by the first subsystem is greater than about 2 and less than about 3. In some embodiments, the value of pH of the synthetic lithium solution produced by the first subsystem is greater than about 3 and less than about 4. In some embodiments, the value of pH of the synthetic lithium solution produced by the first subsystem is greater than about 4 and less than about 5. In some embodiments, the value of pH of the synthetic lithium solution produced by the first subsystem is greater than about 5 and less than about 6. In some embodiments, the value of pH of the synthetic lithium solution produced by the first subsystem is greater than about 6 and less than about 8. In some embodiments, the value of pH of the synthetic lithium solution produced by the first subsystem is greater than about 8 and less than about 10. In some embodiments, the pH of the synthetic lithium solution is adjusted by adding a base. In some embodiments, the pH is adjusted by adding hydroxide containing species to precipitate insoluble transition metal hydroxide salts. In some embodiments, the transition metal species are precipitated by adding hydroxide containing species to precipitate insoluble transition metal hydroxide salts. In some embodiments, the pH of the synthetic lithium solution is adjusted by adding NaOH, KOH, LiOH, RbOH, Ca(OH)₂, Mg(OH)₂, Sr(OH)₂, Ba(OH)₂, NH₄OH, other basic compounds, or combinations thereof. In some embodiments, the pH of the synthetic lithium solution is adjusted by distilling off the acid. In some embodiments, the pH of the synthetic lithium solution is adjusted by distilling off the acid at temperatures of from about 50 to about 150 degrees centigrade. In some embodiments, the pH of the synthetic lithium solution is adjusted by distilling off the acid at temperatures of from about 100 to about 200 degrees centigrade. In some embodiments, the pH of the synthetic lithium solution is adjusted by distilling off the acid at temperatures of from about 100 to about 300 degrees centigrade. In some embodiments, the pH of the synthetic lithium solution is adjusted by distilling off the acid at temperatures of from about 200 to about 400 degrees centigrade. In some embodiments, the pH of the synthetic lithium solution is adjusted by distilling off the acid at temperatures of from about 400 to about 600 degrees centigrade. In some embodiments, the pH of the synthetic lithium solution is adjusted by distilling off the acid a pressure of from about 0.01 to about 0.1 atmospheres. In some embodiments, the pH of the synthetic lithium solution is adjusted by distilling off the acid a pressure of from about 0.1 to about 1 atmosphere. In some embodiments, the pH of the synthetic lithium solution is adjusted by distilling off the acid a pressure of from about 1 to about 10 atmospheres. In some embodiments, in the second subsystem, the pH of the synthetic lithium solution is adjusted from a value of less than about 3 to a value greater than about 9. In some embodiments, in the second subsystem, the pH of the synthetic lithium solution is adjusted from a value of less than about 3 to a value of between 7 and 8. In some embodiments, in the second subsystem, the pH of the synthetic lithium solution is adjusted from a value of less than about 3 to a value of between 8 and 9. In some embodiments, in the second subsystem, the pH of the synthetic lithium solution is adjusted from a value of less than about 3 to a value of between 9 and 10. In some embodiments, in the second subsystem, the pH of the synthetic lithium solution is adjusted from a value of less than about 2 to a value of between 7 and 8. In some embodiments, in the second subsystem, the pH of the synthetic lithium solution is adjusted from a value of less than about 2 to a value of between 8 and 9. In some embodiments, in the second subsystem, the pH of the synthetic lithium solution is adjusted from a value of less than about 2 to a value of between 9 and 10. In some embodiments, the value of oxidation reduction potential of the synthetic lithium solution produced by the first subsystem is greater than about 50 mV and less than about 150 mV. In some embodiments, the value of oxidation reduction potential of the synthetic lithium solution produced by the first subsystem is greater than about 150 mV and less than about 300 mV. In some embodiments, the value of oxidation reduction potential of the synthetic lithium solution produced by the first subsystem is greater than about 300 mV and less than about 500 mV. In some embodiments, the value of oxidation reduction potential of the synthetic lithium solution produced by the first subsystem is greater than about 500 mV and less than about 800 mV. In some embodiments, a redox active species is added to the synthetic lithium solution to adjust its oxidation-reduction potential. In some embodiments, an electrical current through the synthetic lithium solution to adjust its oxidation-reduction potential. In some embodiments, said electrical current is passed between two electrodes in contact with the synthetic lithium solution. In some embodiments, a solid is formed on one of the electrodes, and wherein said solid comprises a transition metal species removed from the synthetic lithium solution. In some embodiments, in the second subsystem comprises an electrolysis cell. In some embodiments, in the second subsystem comprises an electrowinning cell. In some embodiments, an oxidant is added to the synthetic lithium solution to increase its oxidation-reduction potential. In some embodiments, the oxidant comprises sodium hypochlorite, perchlorate, chlorate, bleach, hydrogen peroxide, nitric acid, potassium permanganate, fluorine, chlorine, air, oxygen, ozone, or combinations thereof. In some embodiments, a reductant is added to the synthetic lithium solution to decrease its oxidation-reduction potential. In some embodiments, the reductant comprises sodium bisulfite, sodium metabisulfite, sodium borohydride, formic acid, ascorbic acid, oxalic acid, potassium iodide, or combinations thereof. In some embodiments, in the second subsystem, the oxidation-reduction potential of the synthetic lithium solution is adjusted from a value of less than about 200 mV to a value of between 300 and 400 mV. In some embodiments, in the second subsystem, the oxidation-reduction potential of the synthetic lithium solution is adjusted from a value of less than about 200 mV to a value of between 400 and 500 mV. In some embodiments, in the second subsystem, the oxidation-reduction potential of the synthetic lithium solution is adjusted from a value of less than about 200 mV to a value of between 500 and 600 mV. In some embodiments, in the second subsystem, the oxidation-reduction potential of the synthetic lithium solution is adjusted from a value of less than about 200 mV to a value of between 600 and 700 mV. In some embodiments, in the second subsystem, the oxidation-reduction potential of the synthetic lithium solution is adjusted from a value of less than about 200 mV to a value of between 700 and 800 mV. In some embodiments, in the second subsystem, the oxidation-reduction potential of the synthetic lithium solution is adjusted from a value of less than about 200 mV to a value of between 800 and 1000 mV. In some embodiments, in the second subsystem, the oxidation-reduction potential of the synthetic lithium solution is adjusted from a value of more than about 200 mV to a value of between 100 and 200 mV. In some embodiments, in the second subsystem, the oxidation-reduction potential of the synthetic lithium solution is adjusted from a value of more than about 200 mV to a value of between 0 and 100 mV. In some embodiments, in the second subsystem, the oxidation-reduction potential of the synthetic lithium solution is adjusted from a value of more than about 100 mV to a value of between 0 and 100 mV. In some embodiments, in the second subsystem, the transition metal impurities are precipitated by adding seed crystals to the synthetic lithium solution to crystallize the transition metals in the third subsystem. In some embodiments, in the second subsystem, the addition of seed crystals increases the size of crystallites of the transition metals formed to the third subsystem. In some embodiments, in the second subsystem the addition of seed crystals increases the size of crystallites of the transition metals formed, facilitating the separation of these crystals from the liquid synthetic lithium solution in the fourth subsystem. In some embodiments, in the second subsystem the transition metal impurities are precipitated by adding chelating ligands to the third subsystem. In some embodiments, in chelating ligands comprise EDTA, oxalate, or combinations thereof. In some embodiments, in the second subsystem, the transition metal impurities are precipitated by adding complimentary anions to the third subsystem, to form insoluble transition metal salts. In some embodiments, said complimentary anions comprise sulfide, phosphate, carbonate, other anions, or combinations thereof. In some embodiments, in the second subsystem, the transition metals are precipitated by adding a precipitant comprising H₂S, Na₂S, K₂S, CaS, MgS, Na₃PO₄, K₃PO₄, Rb₃PO₄, (NH₄)₃PO₄, MgCO₃, CaCO₃, SrCO₃, CO₂, Na₂CO₃, or combinations thereof to the third subsystem. In some embodiments, in the the precipitant comprises Na₃PO₄, K₃PO₄, Rb₃PO₄, (NH₄)₃PO₄, MgCO₃, CaCO₃, SrCO₃, Na₂CO₃, or combinations thereof. In some embodiments, in the fourth subsystem the precipitated transition metals are separated from the synthetic lithium solution using centrifugation. In some embodiments, in the fourth subsystem the precipitated transition metals are separated from the synthetic lithium solution using pressure filtration. In some embodiments, in the fourth subsystem the precipitated transition metals are separated from the synthetic lithium solution using gravity sedimentation. In some embodiments, in the fourth subsystem the precipitated transition metals are removed by settling the solids and removing the supernatant. In some embodiments, the settling of the solids is aided by a flocculant, a coagulant, or combinations thereof. In some embodiments, in the fourth subsystem the precipitated transition metals are removed using membrane filtration, belt filtration, cartridge filtration, nanofiltration, pressure filtration, rotary disk filtration, or combinations thereof. In some embodiments, in the fourth subsystem the precipitated transition metals are removed using magnetic fields. In some embodiments, in the fourth subsystem the precipitated transition metals are removed using particle traps. In some embodiments, in the fourth subsystem the precipitated transition metals are removed using surfactants. In some embodiments, in the fourth subsystem the precipitated transition metals are removed using floatation. In some embodiments, in second subsystem the dissolved transition metals are removed by precipitating transition metal species, separating the precipitated species by a solid-liquid separator, and removing additional transition metals using ion exchange resins, water softeners, solvent extraction, or combinations thereof. In some embodiments, the ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof. In some embodiments, said ion exchange material is a coated ion exchange material with a coating that is selected from an oxide, a polymer, or combinations thereof. In some embodiments, said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof. In some embodiments, the liquid resource is a natural brine, a pretreated brine, a dissolved salt flat brine, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments, the acidic solution is an acid comprising hydrochloric acid, sulfuric acid, nitric acid, phosphoric acid, hydrobromic acid, hydroiodic acid, perchloric acid, acetic acid, or a combination thereof. In some embodiments, the ion exchange material is washed with pure water or an aqueous solution. In some embodiments, the second subsystem comprises one or more vessels. In some embodiments, the third subsystem comprises one or more vessels. In some embodiments, the fourth subsystem comprises one or more solid-liquid separators. In some embodiments, the content of one or more vessels are agitated. In some embodiments, the content of one or more vessels are agitated using a stirrer. In some embodiments, the content of one or more vessels are agitated using an eductor. In some embodiments, the content of one or more vessels are agitated using an air sparger. In some embodiments, the pH, ORP, or a combination of pH and ORP of the synthetic lithium solution is adjusted in each tank. In some embodiments, said system is configured within a single vessel. In some embodiments, said system is configured with 2 to 3 vessels. In some embodiments, said system is configured with 3 to 5 vessels. In some embodiments, said system is configured with 5 to 10 vessels. In some embodiments, said system is configured with 1 solid-liquid separator. In some embodiments, said system is configured with 2 to 3 solid-liquid separators. In some embodiments, said system is configured withi3 to 5 solid-liquid separators. In some embodiments, said system is configured with 5 to 10 solid-liquid separators. In some embodiments, a substance that adjusts the pH, ORP, or a combination of pH and ORP is injected using a nozzle.

Disclosed herein is a process of producing a synthetic lithium solution with any of the systems disclosed herein.

Disclosed herein is a process of producing an ion exchange material with any of the systems disclosed herein.

In an aspect, disclosed herein is a process of producing an impurities-derived ion exchange material, the process comprising:
a. contacting an ion exchange material to a liquid resource, wherein said ion exchange material absorbs lithium ions from said liquid resource while releasing protons;
b. contacting the ion exchange material to an acidic solution, wherein said ion exchange material releases lithium into said acidic solution while absorbing protons, producing a synthetic lithium solution, and wherein said synthetic lithium solution comprises at least one transition metal species;
c. removing at least one of said transition metal species from said synthetic lithium solution; and
d. manufacturing the impurities-derived ion exchange material from said transition metal species.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates an interconnected system comprising a lithium extraction system, a transition metal species precipitation system, a solid-liquid separation system, and an ion exchange material production system.

FIG. 2 illustrates an interconnected system comprising a lithium extraction system, a transition metal species precipitation system, a solid-liquid separation system, and an ion exchange material production system.

FIG. 3 illustrates an interconnected system comprising a lithium extraction system, a transition metal species precipitation system, a solid-liquid separation system, and an ion exchange material production system.

FIG. 4 illustrates an interconnected system comprising a lithium extraction system, a transition metal species precipitation system, and a solid-liquid separation system.

FIG. 5 illustrates an interconnected system comprising a lithium extraction system, a transition metal species precipitation system, a solid-liquid separation system, and an ion exchange material production system.

FIG. 6 illustrates an interconnected system comprising a lithium extraction system, a transition metal species precipitation system, a solid-liquid separation system, and an ion exchange material production system.

### DETAILED DESCRIPTION OF THE INVENTION

Unless defined otherwise, all terms of art, notations, and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range of formats. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including combinations thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative, or quantitative and qualitative determinations. Assessing can be relative or absolute.

The term “about” or “approximately” as used herein when referring to a measurable value such as an amount or concentration and the like, is meant to encompass variations of 20%, 10%, 5%, 1%, 0.5%, or even 0.1% of the specified amount. For example, “about” can mean plus or minus 10%, per the practice in the art. Alternatively, “about” can mean a range of plus or minus 20%, plus or minus 10%, plus or minus 5%, or plus or minus 1% of a given value. Alternatively, particularly with respect to biological systems or processes, the term can mean within an order of magnitude, up to 5-fold, or up to 2-fold, of a value. Where particular values can be described in the application and claims, unless otherwise stated the term “about” may be assumed to encompass the acceptable error range for the particular value. Also, where ranges, subranges, or both, of values, can be provided, the ranges or subranges can include the endpoints of the ranges or subranges.

Where values are described as ranges, it may be understood that such disclosure includes the disclosure of all possible sub-ranges within such ranges, as well as specific numerical values that fall within such ranges irrespective of whether a specific numerical value or specific sub-range is expressly stated.

The terms “comprise,” “have,” and “include” are open-ended linking verbs. Any forms or tenses of one or more of these verbs, such as “comprises,” “comprising,” “has,” “having,” “includes,” and “including,” are also open-ended. For example, any method that “comprises,” “has,” or “includes” one or more steps is not limited to possessing only those one or more steps and also covers other unlisted steps.

The terms “lithium”, “lithium ion”, and “Li⁺” are used interchangeably in the present specification and these terms are synonymous unless specifically noted to the contrary. The terms “hydrogen”, “hydrogen ion”, “proton”, and “H⁺” are used interchangeably in the present specification and these terms are synonymous unless specifically noted to the contrary.

As used herein, the words “column” and “vessel” are used interchangeably. In some embodiments described herein referring to a “vessel”, the vessel is a column. In some embodiments described herein referring to a “column”, the column is a vessel.

The term “the pH of the system” or “the pH of” a component of a system, for example one or more tanks, vessels, columns, pH modulating setups, or pipes used to establish fluid communication between one or more tanks, vessels, columns, or pH modulating setups, refers to the pH of the liquid medium contained or present in the system, or contained or present in one or more components thereof. In some embodiments, the liquid medium contained in the system, or one or more components thereof, is a liquid resource. In some embodiments, the liquid medium contained in the system, or one or more components thereof, is a brine. In some embodiments, the liquid medium contained in the system, or one or more components thereof, is an acid solution, an aqueous solution, a wash solution, a salt solution, a salt solution comprising lithium ions, or a lithium-enriched solution.

The term “concentration”, as used herein, refers to the amount of a chemical species within a given amount of liquid. In some embodiments, said concentration can be specified as the mass of a species dissolved in an amount of liquid (e.g. mg/L), or the number of moles of a species dissolved in an amount of liquid (e.g. mol/L). In some embodiments, concentration can be specified by the ratio of moles or mass of the species of interest to one or more other species dissolved in the same liquid. In some embodiments, only the mass concentration of an ionic species is stated; for example, a concentration of sodium (Na) is stated to be 100 milligrams per liter (mg/L). In such cases, the stated concentration refers to the mass concentration of the ion in solution, and does not include the mass of the anion; in the example stated above, such an ion may comprise chloride (Cl⁻), nitrate (NO₃⁻), or sulfate (SO₄²⁻).

All values of “oxidation-reduction potential” and/or “oxidation reduction potential” detailed herein shall be understood to be relative to standard hydrogen electrode (SHE) unless specified otherwise.

Lithium is an essential element for batteries and other technologies. Lithium is found in a variety of liquid resources, including natural and synthetic brines and leachate solutions from minerals, clays, and recycled products. Lithium is optionally extracted from such liquid resources using an ion exchange process based on inorganic ion exchange materials. These inorganic ion exchange materials absorb lithium from a liquid resource while releasing hydrogen, and then elute lithium in acid while absorbing hydrogen. This ion exchange process is optionally repeated to extract lithium from a liquid resource and yield a concentrated lithium solution. The concentrated lithium solution is optionally further processed into chemicals for the battery industry or other industries.

In some embodiments of the systems and methods and processes disclosed herein, an ion exchange material is contacted with a liquid resource comprising lithium. The lithium in the liquid resource is absorbed by the ion exchange material to yield an enriched ion exchange material. In some embodiments, the enriched ion exchange material contains a higher lithium content then the ion exchange material. In some embodiments, the ion exchange material is a protonated ion exchange material. In some embodiments, the protonated ion exchange material is contacted with a liquid resource comprising lithium. The lithium in the liquid resource is absorbed via an ion exchange process to yield a lithiated ion exchange material. In some cases, the terms “enriched ion exchange material” and “lithiated ion exchange material” are used interchangeably.

In some embodiments, the chemical formula of the ion exchange material may vary throughout the ion exchange systems and processes described herein in terms of hydrogen and lithium stoichiometries, as the ion exchange materials readily exchange lithium and hydrogen depending on the aqueous solutions and gases that the ion exchange material is exposed to. In addition, fully lithiated or fully protonated ion exchange materials may not be the most stable form of the material, and is therefore commercially sold as another form. For example, many commercially available ion exchange materials benefit from an activation step or an initial treatment in which the material is wetted and activated with an acid wash to produce an ion exchange material that is in an ideal state for lithium absorption (termed pre-activated ion exchange materials herein). In some embodiments, the term “protonated ion exchange material” refers to material that has been activated and is capable of absorbing lithium. In some embodiments, the protonated ion exchange material is at least partially protonated. In some embodiments, the protonated ion exchange material is fully protonated. Following exposure to a liquid resource comprising lithium, the protonated ion exchange material absorbs lithium and releases hydrogen to form the lithiated ion exchange material. The stoichiometries of the ion exchange material and the lithiated ion exchange material may vary with both the lithium concentration of the liquid resource and the pH of the acidic solution. Therefore, in some embodiments, the material is in part best described by the solution or alternate phase the material has been exposed to most recently. As such, the term “ion exchange material” is meant to include the various states that the material may exist as throughout the ion exchange and preparatory process. In some embodiments, an ion exchange material comprises a protonated ion exchange material, a lithiated ion exchange material, and a pre-activated ion exchange material.

In some embodiments, the ion exchange material may benefit from an activation process. An ion exchange material that benefits from an activation process is termed “pre-activated ion exchange material.” In some embodiments, the pre-activated ion exchange material is selected from an oxide, a phosphate, an oxyfluoride, a fluorophosphate, and combinations thereof. In some embodiments, the pre-activated ion exchange material is selected Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof. In some embodiments, the pre-activated ion exchange material is selected from the following list: Li₄Mn₅O₁₂, Li₄Ti₅O₁₂, Li_{1.6}Mn_{1.6}O₄, Li₂MO₃ (M=Ti, Mn, Sn), LiFePO₄, solid solutions thereof, or combinations thereof.

An “impurities-derived ion exchange material” as detailed herein is an ion exchange material manufactured using transition metals, transition metal species, and/or precipitated transition metal species removed from a synthetic lithium solution as a precursor or as a source of transition metal ions. In some embodiments, the impurities-derived ion exchange material comprises transition metal ions (e.g., multiple transition metal ions of one elements, multiple transition metal ions of multiple elements) derived solely from transition metals, transition metal species, and/or precipitated transition metal species removed from a synthetic lithium solution. In some embodiments, the impurities-derived ion exchange material comprises transition metal ions that are partially derived from transition metals, transition metal species, and/or precipitated transition metal species removed from a synthetic lithium solution. In some embodiments, the impurities-derived ion exchange material comprises transition metal ions derived from transition metals, transition metal species, and/or precipitated transition metal species removed from a synthetic lithium solution in addition to other transition metal ions derived from other sources. In some embodiments, the impurities-derived ion exchange material is an ion exchange material selective for multivalent cations. In some embodiments, the impurities-derived ion exchange material is a lithium-selective ion exchange material. In some embodiments, the impurities-derived ion exchange material is selected from Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof. In some embodiments, the impurities-derived ion exchange material comprises ion exchange material as detailed herein. In some embodiments, the impurities-derived ion exchange material comprises ion exchange particles. In some embodiments, the impurities-derived ion exchange material is used to manufacture ion exchange beads.

In some embodiments, the processes described herein utilize ion exchange materials that are exposed to a liquid resource and an acidic solution over the course of two or more cycles. The ion exchange material may be protonated ion exchange material following exposure to an acidic solution and subsequently yield a lithiated ion exchange material following exposure to a liquid resource. Although the ion exchange materials described herein are expressed as compounds with discrete stoichiometries, it should be understood that variable amounts of lithium ions and hydrogen ions are envisioned in each ion exchange material during the cyclic ion exchange processes described herein. For example, the ion exchange material Li₄Ti₅O₁₂ may be Li₄Ti₅O₁₂, Li₃HTi₅O₁₂, Li₂H₂Ti₅O₁₂, LiH₃Ti₅O₁₂, or H₄Ti₅O₁₂. Combinations of such states are also envisioned, and may be expressed as averages, for example Li_{2.1}H_{1.9}Ti₅O₁₂, Li_{2.2}H_{1.8}Ti₅O₁₂, Li_{2.3}H_{1.7}Ti₅O₁₂, Li_{2.4}H_{1.6}Ti₅O₁₂, etc. Applicant envisions that the ion exchange materials listed below comprise the chemical entity listed, each compound that replaces one lithium ion for one hydrogen ion, and any combination of such states: Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, and Li₂CuP₂O₇.

In some embodiments, ion exchange material comprises a chemical compound capable of exchanging lithium and hydrogen ions. In some embodiments, ion exchange material comprises a chemical compound capable of ion exchange of lithium and hydrogen, wherein the ion exchange material will uptake lithium selectively as opposed to uptaking other metals or metal ions (e.g., sodium, potassium, magnesium, other metal ions present in liquid resources). In some embodiments, ion exchange material is in the form of ion exchange particles. In some embodiments, ion exchange material or ion exchange beads comprise a coating material. In some embodiments, ion exchange material or ion exchange beads do not comprise a coating material. In some embodiments, ion exchange material is in the form of ion exchange beads. In some embodiments, ion exchange beads are porous. Embodiments of the present disclosure directed to “ion exchange beads” shall be understood to also be directed to “ion exchange material” unless specified otherwise. Embodiments of the present disclosure that specify use of “ion exchange beads” may also operably use “ion exchange material” unless specified otherwise.

Ion exchange beads, including ion exchange particles, ion exchange material, ion exchange media, porous ion exchange beads, and/or coated ion exchange particles, are loaded into ion exchange vessels. Alternating flows of brine (e.g., a liquid resource), acid (e.g., acidic solution), and other solutions are optionally flowed through an ion exchange column or vessel to extract lithium from the brine and produce a lithium concentrate, which is eluted from the column or vessel using the acid. As brine flows through the ion exchange column or vessel, the ion exchange beads absorb lithium while releasing hydrogen, where both the lithium and hydrogen are cations. After the ion exchange beads have absorbed lithium, acid is used to elute the lithium from the ion exchange beads to produce an eluate or lithium-enriched solution (e.g., a synthetic lithium solution).

Ion exchange beads may have small diameters less than about one millimeter causing a high pressure difference across a packed bed of the ion exchange beads during pumping of the liquid resource and other fluids through the bed. To minimize pressure across the packed bed and to minimize associated pumping energy, vessels with optimized geometries can be used to reduce the flow distance through the packed bed of ion exchange beads. These vessels may be networked with pH modulation units to achieve adequate control of the pH of the liquid resource.

In some embodiments a network of vessels loaded with ion exchange materials may comprise two vessels, three vessels, four vessels, five vessels, six vessels, seven vessels, eight vessels, nine vessels, 10 vessels, 11 vessels, 12 vessels, 13-14 vessels, 15-20 vessels, 20-30 vessels, 30-50 vessels, 50-70 vessels, 70-100 vessels, or more than 100 vessels.

The concentrated lithium solution (e.g., the synthetic lithium solution) is an aqueous solution comprising lithium and other dissolved ions. Said concentrated lithium solution is produced by treatment of an ion exchange material that has absorbed lithium with an acidic eluent to produce an eluate. Said eluate is acidic and contains lithium in combination with other cations and anions that are present in the liquid resource from which lithium is extracted. Said eluent is contacted with ion exchange material in one or more of the aforementioned ion exchange vessels to produce an eluate. Said eluate is stored in one or more different vessels that are part of an ion exchange network.

The type and concentration of lithium and other ions in solution vary depending on the liquid resource from which lithium is extracted. The pH of the eluate can be adjusted following elution by treatment with other acidic or basic substances. The eluate can be further treated and subjected to other separation processes to result in a changed relative concentration of lithium and other ions. The eluate can further be diluted or concentrated to result in varying concentrations of lithium and other ions.

The eluate (e.g., synthetic lithium solution) can be treated to cause the formation of solid precipitates comprising transition metals that were originally dissolved in said eluate. In some embodiments, said precipitates contain transition metal contaminants in the eluate; therefore, removal of said precipitates results in a purified eluate. In some embodiments, the precipitated transition meals species are recovered and used as raw materials in the manufacture of an ion exchange material.

The performance of the ion exchange process and associated ion exchange material can be measured by the durability, service life, cycle life, or combinations thereof of the ion exchange material used for lithium extraction by ion exchange. This durability, service life, or cycle life is quantified by the total service time, total amount of lithium carbonate equivalents produced per amount of ion exchange material over said service life, total number of lithium absorption-desorption ion exchange cycles that the ion exchange material can undergo before replacements, or combinations thereof. The performance of the ion exchange process and associated ion exchange material can also be measured by the cation purity of the synthetic lithium eluate (e.g., lithium ion exchange eluate solution) produced by the ion exchange material. The performance of the ion exchange process and associated ion exchange material can also be measured by amount of lithium that is absorbed by the ion exchange material in each cycle. The performance of the ion exchange process and associated ion exchange material can also be measured by quantity of ion exchange material dissolved in the synthetic lithium eluate (e.g., lithium ion exchange eluate solution). The performance of the ion exchange process and associated ion exchange material can also be measured by quantity of ion exchange material present in the solid phase that is most active phase. In the embodiments of the disclosure provided herein, one or more of these metrics are used to assess the performance of the ion exchange system and associated process.

Exemplary embodiments of the present disclosure include devices and methods for treating said eluate for production of marketable lithium products.

### The Liquid Resource

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from sediments, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, organic molecules, iron, certain metals, or other chemical or ionic species. In some embodiments, the liquid resource is optionally fed into the ion exchange reactor without any pre-treatment following from its source. In some embodiments, the liquid resource is injected into a reservoir, salt lake, salt flat, basin, or other geologic deposit after lithium has been removed from the liquid resource. In some embodiments, other species are recovered from the liquid resource before or after lithium recovery. In some embodiments, the pH of the liquid resource is adjusted before, during, or after lithium recovery.

In one embodiment, the liquid resource is a natural brine, a dissolved salt flat, seawater, concentrated seawater, a geothermal brine, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. Accordingly, embodiments of the present disclosure directed to “brine” are also operably directed to “liquid resource.”

In one embodiment, the brine is at a temperature of −20 to 20 degrees Celsius, 20 to 50 degrees Celsius, 50 to 100 degrees Celsius, 100 to 200 degrees Celsius, or 200 to 400 degrees Celsius. In one embodiment, the brine is heated or cooled to precipitate or dissolve species in the brine, or to facilitate removal of metals from the brine.

In one embodiment, the brine contains lithium at a concentration of less than 1 mg/L, 1 to 50 mg/L, 50 to 200 mg/L, 200 to 500 mg/L, 500 to 2,000 mg/L, 2,000 to 5,000 mg/L, 5,000 to 10,000 mg/L, 10,000 to 20,000 mg/L, 20,000 to 80,000 mg/L, or greater than 80,000 mg/L.

In one embodiment, the brine contains magnesium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains calcium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains strontium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains barium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the brine contains multivalent cations at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains multivalent ions at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains non-lithium impurities at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains transition metals at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains iron at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains manganese at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the brine is treated to produce a feed brine which has certain metals removed. In one embodiment, the feed brine contains iron at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains manganese at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains lead at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains zinc at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains lithium at a concentration of 1 to 50 mg/L, 50 to 200 mg/L, 200 to 500 mg/L, 500 to 2,000 mg/L, or greater than 2,000 mg/L.

In one embodiment, the feed brine is processed to recover metals such as lithium and yield a spent brine or raffinate. In one embodiment, the raffinate contains residual quantities of the recovered metals at a concentration of less than 0.01, 0.01 to 0.1 mg/L, mg/L, 0.1 to 1.0 mg/L, 1.0 to 10 mg/L, 10 to 100 mg/L, 100 to 1,000 mg/L, or 1,000 to 10,000 mg/L.

In one embodiment, the pH of the brine is corrected to less than 0, 0 to 1, 1 to 2, 2 to 4, 4 to 6, 6 to 8, 4 to 8, 8 to 9, 9 to 10, 9 to 11, or 10 to 12. In one embodiment, the pH of the brine is corrected to 2 to 4, 4 to 6, 6 to 8, 4 to 8, 8 to 9, 9 to 10, 9 to 11, or 10 to 12. In one embodiment, the pH of the brine is corrected to precipitate or dissolve metals.

In one embodiment, metals are precipitated from the brine to form precipitates. In one embodiment, precipitates include transition metal hydroxides, oxy-hydroxides, sulfide, flocculants, aggregate, agglomerates, or combinations thereof. In one embodiment, the precipitates include Li, Na, K, Rb, Cs, Fr, Be, Mg, Ca, Sr, Ba, Ra, Sc, Y, Ti, Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, other metals, or a combination thereof. In one embodiment, the precipitates may be concentrated into a slurry, a filter cake, a wet filter cake, a dry filter cake, a dense slurry, or a dilute slurry.

In one embodiment, the precipitates contain iron at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain manganese at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain lead at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain arsenic at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain magnesium at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain Li, Na, K, Rb, Cs, Fr, Be, Mg, Ca, Sr, Ba, Ra, Sc, Y, Ti, Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, or other metals at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates are toxic and/or radioactive.

In one embodiment, precipitates are redissolved by combining the precipitates with acid. In one embodiment, precipitates are redissolved by combining the precipitates with acid in a mixing apparatus. In one embodiment, precipitates are redissolved by combining the precipitates with acid using a high-shear mixer.

Lithium is an essential element for batteries and other technologies. Lithium is found in a variety of liquid resources, including natural and synthetic brines and leachate solutions from minerals, clays, and recycled products. Lithium is optionally extracted from such liquid resources using an ion exchange process based on inorganic ion exchange materials. These inorganic ion exchange materials absorb lithium from a liquid resource while releasing hydrogen, and then elute lithium into an acidic solution while absorbing hydrogen. This ion exchange process is optionally repeated to extract lithium from a liquid resource and yield a concentrated lithium solution. The concentrated lithium solution is optionally further processed into chemicals for the battery industry or otherindustries.

Ion exchange materials are optionally formed into beads and the ion exchange beads are optionally loaded into ion exchange columns, stirred tank reactors, other reactors, or other systems for lithium extraction. Alternating flows or aliquots of brine, acidic solution, and optionally other solutions are flowed through or flowed into an ion exchange column, reactors, or reactor system to extract lithium from the brine and produce a lithium concentrate, which is eluted from the column using the acidic solution. As brine flows through the ion exchange column, reactors, or reactor system, the ion exchange material absorbs lithium while releasing hydrogen, where both the lithium and hydrogen are cations. The release of hydrogen during lithium uptake will acidify the brine and limit lithium uptake unless the pH of the brine is optionally maintained in a suitable range to facilitate thermodynamically favorable lithium uptake and concomitant hydrogen release. In one embodiment, pH of the liquid resource is maintained near a set-point through addition of base to neutralized protons released from the ion exchange material into the liquid resource.

### Treatment of the Liquid Resource

In some embodiments, the pH of the liquid resource is adjusted before, during and/or after contact with the lithium-selective ion exchange material to maintain the pH in range that is suitable for lithium uptake.

To control the pH of the brine and maintain the pH in a range that is suitable for lithium uptake in an ion exchange column (e.g., vessel, tank, compartment, filter bank), bases such as NaOH, Ca(OH)₂, CaO, KOH, or NH₃ are optionally added to the brine as solids, aqueous solutions, or in other forms. For brines that contain divalent ions such as Mg, Ca, Sr, or Ba, addition of base to the brine can cause precipitation of solids, such as Mg(OH)₂ or Ca(OH)₂, which can cause problems for the ion exchange reaction. These precipitates cause problems in at least three ways. First, precipitation can remove base from solution, leaving less base available in solution to neutralize protons and maintain pH in a suitable range for lithium uptake in the ion exchange column. Second, precipitates that form due to base addition can clog the ion exchange column, including clogging the surfaces and pores of ion exchange beads and the voids between ion exchange beads. This clogging can prevent lithium from entering the ion exchange beads and being absorbed by the ion exchange material. The clogging can also cause large pressure heads in the column. Third, precipitates in the column dissolve during acid elution and thereby contaminate the lithium concentrate produced by the ion exchange system. For ion exchange beads to absorb lithium from brine, an ideal pH range for the brine is optionally 5 to 7, a preferred pH range is optionally 4 to 8, and an acceptable pH range is optionally 1 to 9. In one embodiment, an pH range for the brine is optionally about 1 to about 14, about 2 to about 13, about 3 to about 12, about 4 to about 12, about 4.5 to about 11, about 5 to about 10, about 5 to about 9, about 2 to about 5, about 2 to about 4, about 2 to about 3, about 3 to about 8, about 3 to about 7, about 3 to about 6, about 3 to about 5, about 3 to about 4, about 4 to about 10, about 4 to about 9, about 4 to about 8, about 4 to about 7, about 4 to about 6, about 4 to about 5, about 5 to about 6, about 5 to about 7, about 5 to about 8, about 6 to about 7, about 6 to about 8, or about 7 to about 8.

In one embodiment, the liquid resource is subjected to treatment prior to ion exchange. In some embodiments, said treatment comprises filtration, gravity sedimentation, centrifugal sedimentation, magnetic fields, other methods of solid-liquid separation, or combinations thereof. In some embodiments, precipitated metals are removed from the brine using a filter. In some embodiments, the filter is a belt filter, plate-and-frame filter press, pressure vessel containing filter elements, rotary drum filter, rotary disc filter, cartridge filter, a centrifugal filter with a fixed or moving bed, a metal screen, a perforated basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon.

In some embodiments, a filter cake is prevented, limited, or removed by using gravity, centrifugal force, an electric field, vibration, brushes, liquid jets, scrapers, intermittent reverse flow, vibration, crow-flow filtration, or pumping suspensions across the surface of the filter. In some embodiments, the precipitated metals and a liquid is moved tangentially to the filter to limit cake growth. In some embodiments, gravitational, magnetic, centrifugal sedimentation, or other means of solid-liquid separation are used before, during, or after filtering to prevent cake formation.

In some embodiments, a filter comprises a screen, a metal screen, a sieve, a sieve bend, a bent sieve, a high frequency electromagnetic screen, a resonance screen, or combinations thereof. In some embodiments, one or more particle traps are a solid-liquid separation apparatus.

In some embodiments, one or more solid-liquid separation apparatuses may be used in series or parallel. In some embodiments, a dilute slurry is removed from the tank, transferred to an external solid-liquid separation apparatus, and separated into a concentrated slurry and a solution with low or no suspended solids. In some embodiments, the concentrated slurry is returned to the tank or transferred to a different tank. In some embodiments, precipitate metals are transferred from a brine tank to another brine tank, from an acid tank to another acid tank, from a washing tank to another washing tank, from a brine tank to a washing tank, from a washing tank to an acid tank, from an acid tank to a washing tank, or from an acid tank to a brine tank.

In some embodiments, solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the ion exchange particles into a zone where the particles can leave through the bottom of the thickener.

In some embodiments, solid-liquid separation apparatuses include a deep cone, a deep cone tank, a deep cone compression tank, or a tank wherein the slurry is compacted by weight. In some embodiments, solid-liquid separation apparatuses include a tray thickener with a series of thickeners oriented vertically with a center axle and raking components. In some embodiments, solid-liquid separation apparatuses include a lamella type thickener with inclined plates or tubes that may be smooth, flat, rough, or corrugated. In some embodiments, solid-liquid separation apparatuses include a gravity clarifier that may be a rectangular basin with feed at one end and overflow at the opposite end optionally with paddles and/or a chain mechanism to move particles. In some embodiments, the solid-liquid separation apparatuses may be a particle trap.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the precipitated metals. In some embodiments, the hydrocyclones may have multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried precipitated metals entering near the middle of the apparatus, and precipitated metals get trapped at the bottom and center of the apparatus due to a “teacup effect”.

### Ion Exchange Material

An aspect of the disclosure described herein is a system wherein the ion exchange material comprises a plurality of ion exchange particles. In an embodiment, the plurality of ion exchange particles in the ion exchange material is selected from uncoated ion exchange particles, coated ion exchange particles and combinations thereof. In an embodiment, the ion exchange material is a porous ion exchange material. In an embodiment, the porousion exchange material comprises a network of pores that allows liquids to move quickly from the surface of the porous ion exchange material to the plurality of ion exchange particles. In an embodiment, the ion exchange material is in the form of porous ion exchange beads. Accordingly, embodiments of the disclosure detailed herein that are directed to “ion exchange beads” are also operably directed to “ion exchange material.” In an embodiment, the liquid resource is a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

Ion exchange materials are typically small particles, which together constitute a fine powder. In some embodiments small particle size minimizes the diffusion distance that lithium must travel into the core of the ion exchange particles. In some cases, these particles are optionally coated with protective surface coatings to minimize dissolution of the ion exchange materials while allowing efficient transfer of lithium and hydrogen to and from the particles.

In an embodiment, the coated ion exchange particles are comprised of an ion exchange material and a coating material wherein the ion exchange material comprises Li₄Mn₅O₁₂, Li_{1.6}Mn_{1.6}O₄, Li₂MO₃ (M=Ti, Mn, Sn), LiFePO₄, solid solutions thereof, or combinations thereof and the coating material comprises TiO₂, ZrO₂, MoO₂, Li₂TiO₃, Li₂ZrO₃, LiNbO₃, AlF₃, SiC, Si₃N₄, graphitic carbon, amorphous carbon, diamond-like carbon, or combinations thereof. The coated ion exchange particles have an average diameter less than about 100 nm, less than about 1,000 nm, or less than about 10,000 nm, and the coating thickness is less than about 1 nm, less than about 10 nm, or less than about 100 nm. The particles are created by first synthesizing the ion exchange material using a method such as hydrothermal, solid state, or microwave. The coating material is then deposited on the surface of the ion exchange material using a method such as chemical vapor deposition, hydrothermal, solvothermal, sol-gel, precipitation, or microwave. The coated ion exchange particles are treated with an acid solution prepared with hydrochloric acid, sulfuric acid, nitric acid, or combinations thereof wherein the concentration of the acid solution is greater than about 0.1 M, greater than about 1.0 M, greater than about 5 M, greater than about 10 M, or combinations thereof. During acid treatment, the particles absorb hydrogen while releasing lithium. The ion exchange material is converted to a hydrated state with a hydrogen-rich composition (e.g., a hydrogen-rich ion exchange material, a hydrated ion exchange material). The coating material allows diffusion of hydrogen and lithium respectively to and from the ion exchange material while providing a protective barrier that limits dissolution of the ion exchange material. After treatment in acid, the hydrated coated ion exchange particles are treated with a liquid resource wherein the liquid resource is a natural brine, a dissolved salt flat, a concentrated brine, a processed brine, a synthetic brine, liquid from an ion exchange process, liquid from a solvent extraction process, leachate from minerals, leachate from clays, leachate from recycled products, leachate from recycled materials, or combinations thereof. The coated ion exchange particles absorb lithium while releasing hydrogen. The lithium salt solution is then collected. The coated ion exchange particles are capable then perform the ion exchange reaction repeatedly over a number of cycles greater than about 10 cycles, greater than about 30 cycles, greater than about 100 cycles, or greater than about 300 cycles.

In some embodiments, a cycle comprises contacting an ion exchange material (e.g., a hydrogen-rich ion exchange material, a hydrated ion exchange material) with a liquid resource (e.g., brine) to provide a lithiated ion exchange material and contacting the lithiated ion exchange material with an acidic solution (e.g., acid) to provide a lithium eluate (e.g., lithium concentrate, synthetic lithium solution, synthetic lithium eluate, lithium ion exchange eluate solution). In some embodiments, the ion exchange material is used (e.g., a process for generating a lithium ion exchange eluate solution is conducted) for at least 10 cycles, at least 50 cycles, at least 100 cycles, at least 250 cycles, at least 500 cycles, at least 1000 cycles, at least 2000 cycles, at least 3000 cycles, at least 4000 cycles, at least 5000 cycles, at least 6000 cycles, at least 7000 cycles, at least 8000 cycles, at least 9000 cycles, or at least 10000 cycles.

One major challenge for lithium extraction using inorganic ion exchange particles is the loading of the particles into an ion exchange column in such a way that brine and acid are optionally pumped efficiently through the column with minimal clogging. The materials are optionally formed into beads, and the ion exchange beads are optionally loaded into the column. This bead loading creates void spaces between the ion exchange beads, and these void spaces facilitate pumping through the column. The ion exchange beads hold the ion exchange particles in place and prevent free movement of the particles throughout the column. When the materials are formed into beads, the penetration of brine and acid solutions into the ion exchange beads become slow and challenging. A slow rate of convection and diffusion of the acid and brine solutions into the ion exchange bead slows the kinetics of lithium absorption and release. Such slow kinetics can create problems for column operation. Slow kinetics can require slow pumping rates through the column. Slow kinetics can also lead to low lithium recovery from the brine and inefficient use of acid to elute the lithium.

In some embodiments, the ion exchange beads are porous ion exchange beads with networks of pores that facilitate the transport into the ion exchange beads of solutions that are pumped through an ion exchange column. Pore networks are optionally strategically controlled to provide fast and distributed access for the brine and acid solutions to penetrate into the ion exchange bead and deliver lithium and hydrogen to the ion exchange particles.

In some embodiments, the ion exchange beads are formed by mixing ion exchange particles, a matrix material, and a filler material. These components are mixed and formed into a bead. Then, the filler material is removed from the ion exchange bead to leave behind pores. The filler material is dispersed in the ion exchange bead in such a way to leave behind a pore structure that enables transport of lithium and hydrogen with fast kinetics. This method optionally involves multiple ion exchange materials, multiple polymer materials, and multiple filler materials.

Another major challenge for lithium extraction using inorganic ion exchange materials is dissolution and degradation of the ion exchange materials, especially during lithium elution in acid but also during lithium uptake in liquid resources. To yield a concentrated lithium solution (e.g., a synthetic lithium solution, a lithium eluate) from the ion exchange process (e.g., one or more cycles), it is desirable to use a concentrated acid solution to elute the lithium. However, concentrated acid solutions dissolve and degrade inorganic ion exchange materials, which decrease the performance and lifespan of the materials. Therefore, the porousion exchange beads optionally contain coated ion exchange particles for lithium extraction that are comprised of an ion exchange material and a coating material protecting the particle surface. The coating protects the ion exchange material from dissolution and degradation during lithium elution in acid, during lithium uptake from a liquid resource, and during other aspects of an ion exchange process. This coated particle enables the use of concentrated acids in the ion exchange process to yield concentrated lithium solutions.

In this disclosure, the ion exchange material is selected for high lithium absorption capacity, high selectivity for lithium in a liquid resource relative to other ions such as sodium and magnesium, strong lithium uptake in liquid resources including those with low concentrations of lithium, facile elution of lithium with a small excess of acid, and fast ionic diffusion. A coating material is optionally selected to protect the particle from dissolution and chemical degradation during lithium recovery in acid and also during lithium uptake in various liquid resources. A coating material optionally is also selected to facilitate diffusion of lithium and hydrogen between the particles and the liquid resources, to enable adherence of the particles to a structural support, and to suppress structural and mechanical degradation of the particles.

When the porous ion exchange beads are used in an ion exchange column, the liquid resource containing lithium is pumped through the ion exchange column so that the ion exchange particles absorb lithium from the liquid resource while releasing hydrogen. After the ion exchange beads have absorbed lithium, an acid solution is pumped through the column so that the particles release lithium into the acid solution while absorbing hydrogen. The column is optionally operated in co-flow mode with the liquid resource and acid solution alternately flowing through the column in the same direction, or the column is optionally operated in counter-flow mode with a liquid resource and acid solution alternately flowing through the column in opposite directions. Between flows of the liquid resource and the acid solution, the column is optionally treated or washed with water or other solutions for purposes such as adjusting pH in the column or removing potential contaminants. The ion exchange beads optionally form a fixed or moving bed, and the moving bed optionally moves in counter-current to the brine and acid flows. The ion exchange beads are optionally moved between multiple columns with moving beds where different columns are used for brine, acid, water, or other flows. Before or after the liquid resource flows through the column, the pH of the liquid is optionally adjusted with NaOH or other chemicals to facilitate the ion exchange reaction as well as handling or disposal of the spent liquid resource. Before or after the liquid resource flows through the column, the liquid resource is optionally subjected to other processes including other ion exchange processes, solvent extraction, evaporation, chemical treatment, or precipitation to remove lithium, to remove other chemical species, or to otherwise treat the brine.

When the ion exchange particles are treated with acid, a lithium solution is produced. This lithium solution is optionally further processed to produce lithium chemicals. These lithium chemicals are optionally supplied for an industrial application. In some embodiments, an ion exchange material is selected from the following list: an oxide, a phosphate, an oxyfluoride, a fluorophosphate, or combinations thereof. In some embodiments, an ion exchange material (e.g., lithiated ion exchange material) is selected from the following list: LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, or combinations thereof. In a further aspect, an ion exchange material comprises LiFePO₄, Li₂SnO₃, Li₂MnO₃, Li₂TiO₃, Li₄Ti₅O₁₂, Li₄Mn₅O₁₂, Li_{1.6}Mn_{1.6}O₄, solid solutions thereof, or combinations thereof.

In a further aspect described herein, the coating material allows diffusion to and from the ion exchange material. In particular, the coating material facilitates diffusion of lithium and hydrogen between the particles and the liquid resources, enables adherence of the particles to a structural support, and suppresses structural and mechanical degradation of the particles. In a further aspect described herein, the coating material comprises a carbide, a nitride, an oxide, a phosphate, a fluoride, a polymer, carbon, a carbonaceous material, or combinations thereof. In a further aspect, the coating material comprises polyvinylidene difluoride, polyvinyl chloride, a fluoro-polymer, a chloro-polymer, or a fluoro-chloro-polymer. In a further aspect, a coating material comprises Nb₂O₅, Ta₂O₅, MoO₂, TiO₂, ZrO₂, SnO₂, SiO₂, Li₂O, Li₂TiO₃, Li₂ZrO₃, Li₂MoO₃, LiNbO₃, LiTaO₃, Li₂SiO₃, Li₂Si₂O₅, Li₂MnO₃, ZrSiO₄, AlPO₄, LaPO₄, ZrP₂O₇, MoP₂O₇, Mo₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, or combinations thereof. In a further aspect, a coating material comprises TiO₂, ZrO₂, SiO₂, Li₂TiO₃, Li₂ZrO₃, Li₂MnO₃, ZrSiO₄, or LiNbO₃. In a further aspect, a coating material comprises a chloro-polymer, a fluoro-polymer, a chloro-fluoro-polymer, a hydrophilic polymer, a hydrophobic polymer, co-polymers thereof, mixtures thereof, or combinations thereof. In a further aspect, a coating material comprises a co-polymer, a block co-polymer, a linear polymer, a branched polymer, a cross-linked polymer, a heat-treated polymer, a solution processed polymer, co-polymers thereof, mixtures thereof, or combinations thereof. In a further aspect, a coating material comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly(4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly(chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In a further aspect, a coating material comprises polyvinylidene fluoride (PVDF), polyvinyl chloride (PVC), ethylene chlorotrifluoro ethylene (Halar), poly(4-vinyl pyridine-co-styrene) (PVPCS), polystyrene (PS), acrylonitrile butadiene styrene (ABS), expanded polystyrene (EPS), polyphenylene sulfide, sulfonated polymer, carboxylated polymer, other polymers, co-polymers thereof, mixtures thereof, or combinations thereof. In a further aspect, a coating is deposited onto an ion exchange particle by dry mixing, mixing in solvent, emulsion, extrusion, bubbling one solvent into another, casting, heating, evaporating, vacuum evaporation, spray drying, vapor deposition, chemical vapor deposition, microwaving, hydrothermal synthesis, polymerization, co-polymerization, cross-linking, irradiation, catalysis, foaming, other deposition methods, or combinations thereof. In a further aspect, a coating is deposited using a solvent comprising N-methyl-2-pyrrolidone, dimethyl sulfoxide, tetrahydrofuran, dimethylformamide, dimethylacetamide, methyl ethyl ketone, ethanol, acetone, other solvents, or combinations thereof. In a further aspect, a coating is deposited using a solvent comprising N-methyl-2-pyrrolidone, dimethyl sulfoxide, tetrahydrofuran, dimethylformamide, dimethylacetamide, methyl ethyl ketone, ethanol, acetone, or combinations thereof.

In a further aspect described herein, the coated ion exchange particles have an average diameter less than about 10 nm, less than about 100 nm, less than about 1,000 nm, less than about 10,000 nm, or less than about 100,000 nm. In a further aspect, the coated ion exchange particles have an average size less than about 100 nm, less than about 1,000 nm, or less than about 10,000 nm. In a further aspect, the coated ion exchange particles are optionally secondary particles comprised of smaller primary particles that have an average diameter less than about 10 nm, less than about 100 nm, less than about 1,000 nm, less than about 10,000 nm, or less than about 100,000 nm. In a further aspect, the coating optionally coats the primary ion exchange particles. In a further aspect, the coating optionally coats the secondary ion exchange particles. In a further aspect, the coating optionally coats the secondary ion exchange particles. In a further aspect, the coating optionally coats both the primary ion exchange particles and the secondary ion exchange particles. In a further aspect, the primary ion exchange particles optionally have a first coating and the secondary ion exchange particles optionally have a second coating that is optionally identical, similar, or different in composition to the first coating.

It is recognized that measurements of average particle diameter can vary according to the method of determination utilized. Determination of said average particle diameter according to one method to obtain one or more values shall be understood to inherently encompass all other values that may be obtained using other methods. The average particle diameter can be determined using sieve analysis. The average particle diameter can be determined using optical microscopy. The average particle diameter can be determined using electron microscopy. The average particle diameter can be determined using laser diffraction. In some embodiments, the average particle diameter is determined using laser diffraction, wherein a Bettersizer ST instrument is used. In some embodiments, the average particle diameter is determined using a Bettersizer ST instrument. In some embodiments, the average particle diameter is determined using laser diffraction, wherein an Anton-Parr particle size analyzer (PSA) instrument is used. In some embodiments, the average particle diameter is determined using an Anton-Parr PSA instrument. The average particle diameter can be determined using dynamic light scattering. The average particle diameter can be determined using static image analysis. The average particle diameter can be determined using dynamic image analysis.

In some embodiments described herein, the coating material has a thickness less than about 1 nm, less than about 10 nm, less than about 100 nm, less than about 1,000 nm, or less than about 10,000 nm. In further embodiments, the coating material has a thickness less than about 5 nm, less than about 50 nm, or less than about 500 nm. In some embodiments, the ion exchange particles have a coating material with a thickness selected from the following list: less than 1 nm, less than 10 nm, less than 100 nm, or less than 1,000 nm. In some embodiments, the coating material has a thickness selected from the following list: less than 1 nm, less than 10 nm, or less than 100 nm. In certain embodiments, the coating material has a thickness between about 0.5 nm to about 1000 nm. In some embodiments, the coating material has a thickness between about 1 nm to about 100 nm.

In a further aspect described herein, the ion exchange material and the coating material form one or more concentration gradients where the chemical composition of the particle ranges between two or more compositions. In a further aspect, the chemical composition optionally varies between the ion exchange materials and the coating in a manner that is continuous, discontinuous, or continuous and discontinuous in different regions of the particle. In a further aspect, the ion exchange materials and the coating materials form a concentration gradient that extends over a thickness less than about 1 nm, less than about 10 nm, less than about 100 nm, less than about 1,000 nm, less than about 10,000 nm, or less than about 100,000 nm. In a further aspect, the ion exchange materials and the coating materials form a concentration gradient that extends over a thickness of about 1 nm to about 1,000 nm.

In some embodiments, coating thickness may be measured by any one or more of electron microscopy, optical microscopy, couloscopy, nanoindentation, atomic force microscopy, and X-ray fluorescence. In some embodiments, coating thickness may be inferred or extrapolated from data obtained according to an analytical method that indicates the bulk composition of the coated ion exchange particle, or the ion exchange material that further comprises the coating material. In some embodiments, coating thickness may be inferred by differential analysis of data obtained by analysis of ion exchange material that further comprises a coating material and data obtained by analysis ion exchange material that does not further comprise a coating material. In some embodiments, coating thickness may be inferred by differential analysis of data obtained by analysis of one or more coated ion exchange particles and data obtained by analysis of one or more uncoated ion exchange particles.

In a further aspect described herein, the ion exchange material is synthesized by a method such as hydrothermal, solvothermal, sol-gel, solid state, molten salt flux, ion exchange, microwave, ball milling, chemical precipitation, co-precipitation, vapor deposition, or combinations thereof. In a further aspect, the ion exchange material is synthesized by a method such as chemical precipitation, hydrothermal, solid state, or combinations thereof.

In a further aspect described herein, the coating material is deposited by a method such as chemical vapor deposition, atomic layer deposition, physical vapor deposition, hydrothermal, solvothermal, sol-gel, solid state, molten salt flux, ion exchange, microwave, chemical precipitation, co-precipitation, ball milling, pyrolysis, or combinations thereof. In a further aspect, the coating material is deposited by a method such as sol-gel, chemical precipitation, or combinations thereof. In a further aspect, the coating materials is deposited in a reactor that is optionally a batch tank reactor, a continuous tank reactor, a batch furnace, a continuous furnace, a tube furnace, a rotary tube furnace, or combinations thereof.

In some embodiments, a coating material is deposited with physical characteristics selected from the following list: crystalline, amorphous, full coverage, partial coverage, uniform, non-uniform, or combinations thereof.

In some embodiments, multiple coatings are optionally deposited on the ion exchange material in an arrangement selected from the following list: concentric, patchwork, or combinations thereof.

In some embodiments, the matrix material is selected from the following list: a polymer, an oxide, a phosphate, or combinations thereof. In some embodiments, a structural support (e.g., a structural support to which ion exchange material can be adhered, a support structure within which an ion exchange material can be embedded) is selected from the following list: polyvinyl fluoride, polyvinylidene fluoride, polyvinyl chloride, polyvinylidene chloride, polyethylene, polypropylene, polyphenylene sulfide, polytetrafluoroethylene, polytetrofluoroethylene, sulfonated polytetrofluoroethylene, polystyrene, polydivinylbenzene, polybutadiene, sulfonated polymer, carboxylated polymer, Nafion, copolymers thereof, and combinations thereof. In some embodiments, a structural support is selected from the following list: polyvinylidene difluoride, polyvinyl chloride, sulfonated polytetrofluoroethylene, polystyrene, polydivinylbenzene, copolymers thereof, or combinations thereof. In some embodiments, a structural support is selected from the following list: titanium dioxide, zirconium dioxide, silicon dioxide, solid solutions thereof, or combinations thereof. In some embodiments, the matrix material is selected for thermal resistance, acid resistance, and/or other chemical resistance.

In some embodiments, the porous ion exchange bead is formed by mixing the ion exchange particles, the matrix material, and the filler material together at once. In some embodiments, the porous ion exchange bead is formed by first mixing the ion exchange particles and the matrix material, and then mixing with the filler material. In some embodiments, the porous ion exchange bead is formed by first mixing the ion exchange particles and the filler material, and then mixing with the matrix material. In some embodiments, the porous ion exchange bead is formed by first mixing the matrix material and the filler material, and then mixing with the ion exchange particles.

In some embodiments, the porous ion exchange bead is formed by mixing the ion exchange particles, the matrix material, and/or the filler material with a solvent that dissolves once or more of the components. In some embodiments, the porous ion exchange bead is formed by mixing the ion exchange particles, the matrix material, and/or the filler material as dry powders in a mixer or ball mill. In some embodiments, the porous ion exchange bead is formed by mixing the ion exchange particles, the matrix material, and/or the filler material in a spray drier.

In some embodiments, the matrix material is a polymer that is dissolved and mixed with the ion exchange particles and/or filler material using a solvent from the following list: n-methyl-2-pyrrolidone, dimethyl sulfoxide, tetrahydrofuran, dimethylformamide, dimethylacetamide, methyl ethyl ketone, or combinations thereof. In some embodiments, the filler material is a salt that is dissolved and mixed with the ion exchange particles and/or matrix material using a solvent from the following list: water, ethanol, iso-propyl alcohol, acetone, or combinations thereof.

In some embodiments, the filler material is a salt that is dissolved out of the ion exchange bead to form pores using a solution selected from the following list: water, ethanol, iso-propyl alcohol, a surfactant mixture, an acid a base, or combinations thereof. In some embodiments, the filler material is a material that thermally decomposes to form a gas at high temperature so that the gas can leave the ion exchange bead to form pores, where the gas is selected from the following list: water vapor, oxygen, nitrogen, chlorine, carbon dioxide, nitrogen oxides, organic vapors, or combinations thereof.

In some embodiments, the porous ion exchange bead is formed from dry powder using a mechanical press, a pellet press, a tablet press, a pill press, a rotary press, or combinations thereof. In some embodiments, the porous ion exchange bead is formed from a solvent slurry by dripping the slurry into a different liquid solution. The solvent slurry is optionally formed using a solvent of n-methyl-2-pyrrolidone, dimethyl sulfoxide, tetrahydrofuran, dimethylformamide, dimethylacetamide, methyl ethyl ketone, or combinations thereof. The different liquid solution is optionally formed using water, ethanol, iso-propyl alcohol, acetone, or combinations thereof.

In some embodiments, the porous ion exchange bead is approximately spherical with an average diameter selected from the following list: less than 10 μm, less than 100 μm, less than 1 mm, less than 1 cm, or less than 10 cm. In some embodiments, the porous ion exchange bead is approximately spherical with an average diameter selected from the following list: less than 200 μm, less than 2 mm, or less than 20 mm. In certain embodiments, the porous ion exchange bead is approximately spherical with an average diameter between 10 μm and 2 mm.

In some embodiments, the porous ion exchange bead is tablet-shaped with a diameter of less than 1 mm, less than 2 mm, less than 4 mm, less than 8 mm, or less than 20 mm and with a height of less than 1 mm, less than 2 mm, less than 4 mm, less than 8 mm, or less than 20 mm. In certain embodiments, the porous ion exchange bead is tablet-shaped with a diameter between 500 μm and 10 mm.

In some embodiments, the porous ion exchange bead is embedded in a support structure, which is optionally a membrane, a spiral-wound membrane, a hollow fiber membrane, or a mesh. In some embodiments, the porous ion exchange bead is embedded on a support structure comprised of a polymer, a ceramic, or combinations thereof. In some embodiments, the porous ion exchange bead is loaded directly into an ion exchange column with no additional support structure.

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, or organic molecules. In some embodiments, the liquid resource is optionally enter the ion exchange reactor without any pre-treatment following from its source.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

System for Extracting Lithium from a Liquid Resource

In one aspect described herein, is a system for lithium extraction from a liquid resource comprising one or more vessels independently configured to simultaneously accommodate porous ion exchange beads moving in one direction and alternately acid, brine, and optionally other solutions moving in the net opposite direction. This lithium extraction system produces an eluate which is concentrated in lithium and optionally contains other ions.

In one aspect described herein, there is a device for lithium extraction from a liquid resource comprising a stirred rank reactor, an ion exchange material, and a pH modulating setup for increasing the pH of the liquid resource in the stirred tank reactor.

In one aspect described herein, is a device for lithium extraction from a liquid resource comprising a stirred rank reactor, an ion exchange material, a pH modulating setup for increasing the pH of the liquid resource in the stirred tank reactor, and a compartment for containing the ion exchange material in the stirred tank reactor while allowing for removal of liquid resource, washing fluid, and acid solutions from the stirred tank reactor.

In one embodiment, at least one of the one or more vessels are fitted with a conveyer system suitably outfitted to move porous ion exchange beads upward and simultaneously allow a net flow of acid, brine, and optionally other solutions, downward. In one embodiment, the conveyor system comprises fins with holes. In one embodiment, wherein the fins slide upward over a sliding surface that is fixed in place. In one embodiment, the fins slide upward over a sliding surface that is fixed in place. In one embodiment, all of the one or more vessels are fitted with a conveyor system suitably outfitted to move porous ion exchange beads upward and simultaneously allow a net flow of acid, brine, and optionally other solutions, downward. In one embodiment, there are an even number of vessels. In one embodiment, there are an odd number of vessels. In one embodiment, the vessels are columns.

In some embodiments, structures with holes are used to move the ion exchange material through one or more vessels. In some embodiments, the holes in the structures may be less than 10 microns, less than 100 microns, less than 1,000 microns, or less than 10,000 microns. In some embodiments, the structures may be attached to a conveyer system. In some embodiments, the structures may comprise a porous compartment, porous partition, or other porous structure. In some embodiments, the structures may contain a bed of fixed or fluidized ion exchange material. In some embodiments, the structures may contain ion exchange material while allowing brine, aqueous solution, or acid solution to pass through the structures.

In one embodiment, the porous ion exchange beads comprise ion exchange particles that reversibly exchange lithium and hydrogen and a structural matrix material and having a pore network. In one embodiment, the liquid resource comprises a natural brine, a dissolve salt flat, a concentrated brine, a processed brine, a filtered brine, a liquid from an ion exchange process, a liquid from a solvent extraction process, a synthetic brine, leachate from ores, leachate from minerals, leachate from clays, leachate from recycled products, leachate from recycled materials, or combinations thereof.

### Recirculating Batch System

In an embodiment of the system, the ion exchange material is loaded in a column. In an embodiment of the system, the pH modulating setup is connected to the column loaded with the ion exchange material. In an embodiment of the system, the pH modulating setup comprises one or more tanks.

In some embodiments of the systems described herein, the ion exchange material is loaded in a vessel. In some embodiments, the pH modulating setup is in fluid communication with the vessel loaded with the ion exchange material. In some embodiments, the pH modulating setup is in fluid communication with the column loaded with the ion exchange material.

In one embodiment of the system, one or more ion exchange columns are loaded with a fixed or fluidized bed of ion exchange beads. In one embodiment of the system, the ion exchange column is a cylindrical construct with entry and exit ports. In a further embodiment, the ion exchange column is optionally a non-cylindrical construct with entry and exit ports. In a further embodiment, the ion exchange column optionally has entry and exit ports for brine pumping, and additional doors or hatches for loading and unloading ion exchange beads to and from the column. In a further embodiment, the ion exchange column is optionally equipped with one or more security devices to decrease the risk of theft of the ion exchange beads. In one embodiment, these beads contain ion exchange material that can reversibly absorb lithium from brine and release lithium in acid. In one embodiment, the ion exchange material is comprised of particles that are optionally protected with coating material such as SiO₂, ZrO₂, or TiO₂ to limit dissolution or degradation of the ion exchange material. In one embodiment, these beads contain a structural component such as an acid-resistant polymer that binds the ion exchange materials. In one embodiment, the ion exchange beads contain pores that facilitate penetration of brine, acid, aqueous, and other solutions into the ion exchange beads to deliver lithium and hydrogen to and from the ion exchange bead or to wash the ion exchange bead. In one embodiment, the ion exchange bead pores are structured to form a connected network of pores with a distribution of pore sizes and are structured by incorporating filler materials during bead formation and later removing that filler material in a liquid or gas.

In one embodiment of the system, the system is a recirculating batch system, which comprises an ion exchange column that is connected to one or more tanks for mixing base into the brine, settling out any precipitates following base addition, and storing the brine prior to reinjection into the ion exchange column or the other tanks. In one embodiment of the recirculating batch system, the brine is loaded into one or more tanks, pumped through the ion exchange column, pumped through a series of tanks, and then returned to the ion exchange column in a loop. In one embodiment, the brine optionally traverses this loop repeatedly. In one embodiment, the brine is recirculated through the ion exchange column to enable optimal lithium uptake by the ion exchange beads. In one embodiment, base is added to the brine in such a way that pH is maintained at an adequate level for lithium uptake and in such a way that the amount of base-related precipitates in the ion exchange column is minimized.

In one embodiment, as the brine is pumped through the recirculating batch system, the brine pH drops in the ion exchange column due to hydrogen release from the ion exchange beads during lithium uptake, and the brine pH is adjusted upward by the addition of base as a solid, aqueous solution, or other form. In one embodiment, the ion exchange system drives the ion exchange reaction to near completion, and the pH of the brine leaving the ion exchange column approaches the pH of the brine entering the ion exchange column. In one embodiment, the amount of base added is optionally controlled to neutralize the hydrogen released by the ion exchange beads in such a way that no basic precipitates form. In one embodiment, an excess of base or a transient excess of base is optionally added in such a way that basic precipitates form. In one embodiment, the basic precipitates form transiently and then are redissolved partially or fully by the hydrogen that is released from the ion exchange column. In one embodiment of the system, base is optionally added to the brine flow prior to the ion exchange column, after the ion exchange column, prior to one or more tanks, or after one or more tanks.

In one embodiment of the recirculating batch system, the tanks include a mixing tank where the base is mixed with the brine. In one embodiment, the tanks include a settling tank, where precipitates such as Mg(OH)₂ optionally settle to the bottom of the settling tank to avoid injection of the precipitates into the ion exchange column. In one embodiment, the tanks include a storage tank where the brine is stored prior to reinjection into the ion exchange column, mixing tank, settling tank, or other tanks. In one embodiment, the tanks include an acid recirculation tank. In one embodiment, some tanks in the recirculating batch reactor optionally serve a combination of purposes including base mixing tank, settling tank, acid recirculation tank, or storage tank. In any embodiment, a tank optionally does not fulfil two functions at the same time. For example, a tank is not a base mixing tank and a settling tank.

In one embodiment of the recirculating batch system, base is added to a mixing tank, which is optionally a continuous stirred tank system, a confluence of acidified brine flow and base flow followed by a static mixer, a confluence of acidified brine flow and base flow followed by a paddle mixer, a confluence of acidified brine flow and base flow followed by a turbine impeller mixer, or a continuous stirred tank system in the shape of a vertical column which is well mixed at the bottom and settled near the top. In one embodiment, the base is optionally added as a solid or as an aqueous solution. In one embodiment, the base is optionally added continuously at a constant or variable rate. In one embodiment, the base is optionally added discretely in constant or variable aliquots or batches. In one embodiment, the base is optionally added according to one or more pH meters, which optionally samples brine downstream of the ion exchange column or elsewhere in the recirculating batch system. In one embodiment, filters are optionally used to prevent precipitates from leaving the mixing tank. In one embodiment, the filters are optionally plastic mesh screens, small packed columns containing granular media such as sand, silica, or alumina, small packed columns containing porous media filter, or a membrane.

In one embodiment of the recirculating batch system, the settling tank is optionally a settling tank with influent at bottom and effluent at top or a settling tank with influent on one end and effluent on another end. In one embodiment, chambered weirs are used to fully settle precipitates before brine is recirculated into reactor. In one embodiment, solid base precipitates are collected at the bottom of the settling tank and recirculated into the mixer. In one embodiment, precipitates such as Mg(OH)₂ optionally settle near the bottom of the tank. In one embodiment, brine is removed from the top of the settling tank, where the amount of suspended precipitates is minimal. In one embodiment, the precipitates optionally settle under forces such as gravity, centrifugal action, or other forces. In one embodiment, filters are optionally used to prevent precipitates from leaving the settling tank. In one embodiment, the filters are optionally plastic mesh screens, small packed columns containing granular media such as sand, silica, or alumina, small packed columns containing porous media filter, or a membrane. In one embodiment, baffles are optionally used to ensure settling of the precipitate and to prevent the precipitate from exiting the settling tank and entering the column.

In one embodiment of the recirculating batch system, basic precipitates are optionally collected from the settling tank and reinjected into the brine in a mixing tank or elsewhere to adjust the pH of the brine.

In one embodiment of the recirculating batch system, one or more ion exchange columns are optionally connected to one or more tanks or set of tanks. In one embodiment of the recirculating batch system, there are optionally multiple ion exchange columns recirculating brine through a shared set of mixing, settling, and storage tanks. In one embodiment of the recirculating batch system, there is optionally one ion exchange column recirculating brine through multiple sets of mixing, settling, and storage tanks.

### Column Interchange System

An aspect of the disclosure described herein is a system wherein the ion exchange material is loaded in a plurality of columns. In an embodiment, the pH modulating setup comprises a plurality of tanks connected to the plurality of columns, wherein each of the plurality of tanks is immediately connected to one of the plurality of columns. In an embodiment, two or more of the plurality of tanks connected to the plurality of columns forms at least one circuit. In an embodiment, three or more of the plurality of tanks connected to the plurality of columns forms at least two circuits. In an embodiment, three or more of the plurality of tanks connected to the plurality of columns forms at least three circuits. In an embodiment, at least one circuit is a liquid resource circuit. In an embodiment, at least one circuit is a water washing circuit. In an embodiment, at least one circuit is an acid solution circuit. In an embodiment, at least two circuits are water washing circuits.

In one embodiment of the ion exchange system, the system is a column interchange system where a series of ion exchange columns are connected to form a brine circuit, an acid circuit, a water washing circuit, and optionally other circuits. In one embodiment of the brine circuit, brine flows through a first column in the brine circuit, then into a next column in the brine circuit, and so on, such that lithium is removed from the brine as the brine flows through one or more columns. In one embodiment of the brine circuit, base is added to the brine before or after each ion exchange column or certain ion exchange columns in the brine circuit to maintain the pH of the brine in a suitable range for lithium uptake by the ion exchange beads. In one embodiment of the acid circuit, acid flows through a first column in the acid circuit, then into the next column in the acid circuit, and so on, such that lithium is eluted from the columns with acid to produce a lithium concentrate. In one embodiment of the acid circuit, acid flows through a first column in the acid circuit, then optionally into a next column in the acid circuit, and so on, such that lithium is eluted from the columns with acid to produce a lithium concentrate. In one embodiment of the water washing circuit, water flows through a first column in the water washing circuit, then optionally into a next column in the water washing circuit, and so on, such that brine in the void space, pore space, or head space of the columns in the water washing circuit is washed out.

In one embodiment of the column interchange system, ion exchange columns are interchanged between the brine circuit, the water washing circuit, and the acid circuit. In one embodiment, the first column in the brine circuit is loaded with lithium and then interchanged into the water washing circuit to remove brine from the void space, pore space, or head space of the column. In one embodiment, the first column in the water washing circuit is washed to remove brine, and then interchanged to the acid circuit, where lithium is eluted with acid to form a lithium concentrate. In one embodiment, the first column in the acid circuit is eluted with acid and then interchanged into the brine circuit to absorb lithium from the brine. In one embodiment of the column interchange system, two water washing circuits are used to wash the columns after both the brine circuit and the acid circuit. In one embodiment of the column interchange system, only one water washing circuit is used to wash the columns after the brine circuit, whereas excess acid is neutralized with base or washed out of the columns in the brine circuit.

In one embodiment of the column interchange system, the first column in the brine circuit is interchanged to become the last column in the water washing circuit. In one embodiment of the column interchange system, the first column in the water washing circuit is interchanged to become the last column in the acid circuit. In one embodiment of the column interchange system, the first column in the acid circuit is interchanged to become the last column in the brine circuit.

In one embodiment of the column interchange system, each column in the brine circuit contains one or more tanks or junctions for mixing base into the brine and optionally settling any basic precipitates that form following base addition. In one embodiment of the column interchange system, each column in the brine circuit has associated one or more tanks or junctions for removing basic precipitates or other particles via settling or filtration. In one embodiment of the column interchange system, each column or various clusters of columns have associated one or more settling tanks or filters that remove particles including particles that detach from ion exchange beads.

In one embodiment of the column interchange system, the number of the columns in the brine circuit is optionally less than about 3, less than about 10, less than about 30, or less than about 100. In one embodiment of the column interchange system, the number of the columns in the acid circuit is optionally less than about 3, less than about 10, less than about 30, or less than about 100. In one embodiment of the column interchange system, the number of the columns in the water washing circuit is optionally less than about 3, less than about 10, less than about 30, or less than about 100. In certain embodiments, the number of columns in the brine circuit is 1 to 10. In some embodiments, the number of columns in the acid circuit is 1 to 10. In some embodiments, the number of columns in washing circuit is 1 to 10.

In one embodiment of the column interchange system, there is optionally one or more brine circuits, one or more acid circuits, and one or more water washing circuits. In one embodiment of the column interchange system, ion exchange columns are optionally supplied with fresh ion exchange beads without interruption to operating columns. In one embodiment of the column interchange system, ion exchange columns with beads that have been depleted in capacity is optionally replaced with ion exchange columns with fresh ion exchange beads without interruption to operating columns.

In one embodiment of the column interchange system, the columns contain fluidized beds of ion exchange material. In one embodiment of the column interchange system, the columns have means of created a fluidized bed of ion exchange material such as overhead stirrers or pumps. In one embodiment of the column interchange system, the columns contain fluidized beds of ion exchange material. In one embodiment of the ion exchange system, the system is an interchange system and the vessels are stirred tank reactors. In one embodiment of the interchange system, base may be added directly to the columns or other tanks containing the ion exchange material. In one embodiment of the interchange system, base may be added to the brine or another solution in a separate mixing tank and then added to the columns or other tanks containing the ion exchange material.

In one embodiment of the ion exchange system, ion exchange beads are loaded into ion exchange columns and following lithium uptake from brine, lithium is eluted from the ion exchange columns using an acid recirculation loop. In one embodiment of the acid recirculation loop, acid is flowed through an ion exchange column, into a tank, and then recirculated through the ion exchange column to optimize lithium elution. In one embodiment of the ion exchange system, ion exchange beads are loaded into ion exchange columns and following lithium uptake from brine, lithium is eluted from each ion exchange column using a once-through flow of acid. In one embodiment of the ion exchange system, ion exchange beads are loaded into an ion exchange column and following lithium uptake from brine, lithium is eluted from the ion exchange column using a column interchange circuit.

In one embodiment of the ion exchange system, ion exchange columns are loaded with lithium by flowing brine through the columns using a recirculating batch system and then lithium is eluted from the columns using a column interchange system. In one embodiment of the ion exchange system, ion exchange columns are loaded with lithium by flowing brine through the columns using a column interchange system and then lithium is eluted from the columns using a recirculating batch system. In one embodiment of the ion exchange system, ion exchange columns are loaded with lithium by flowing brine through the columns using a recirculating batch system and then lithium is eluted from the columns using a recirculating batch system. In one embodiment of the ion exchange system, ion exchange columns are loaded with lithium by flowing brine through the columns using a column interchange system and then lithium is eluted from the columns using a column interchange system.

### Stirred Tank System

An aspect of the disclosure described herein is a system wherein the pH modulating setup is a tank comprising: a) one or more compartments; and b) a means for moving the liquid resource through the one or more compartments. In an embodiment, the ion exchange material is loaded in at least one compartment. In an embodiment, the means for moving the liquid resource through the one or more compartments is a pipe. In a further embodiment, the means for moving the liquid resource through the one or more compartments is a pipe and suitably a configured pump. In an embodiment, the tank further comprises a means for circulating the liquid resource throughout the tank. In an embodiment, the means for circulating the liquid resource throughout the tank is a mixing device. In an embodiment, the tank further comprises an injection port.

In some embodiments, the tank further comprises one or more injection ports. In some embodiments, the tank further comprises a plurality of injection ports.

An aspect described herein is a system for the extraction of lithium ions from a liquid resource, comprising a tank, wherein the tank further comprises: a) one or more compartments; b) an ion exchange material; c) a mixing device; and d) a pH modulating setup for changing the pH of the system, wherein the ion exchange material is used to extract lithium ions from the liquid resource. In one embodiment, the pH modulating setup changes the pH of the liquid resource in the system.

In some embodiments, the ion exchange material is loaded in at least one of the one or more compartments. In some embodiments, the ion exchange material is fluidized in at least one of the one or more compartments. In some embodiments, the ion exchange material is non-fluidized in at least one of the one or more compartments. In some embodiments, the ion exchange material occupies a fixed position in at least one of the one or more compartments.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the tank further comprises a porous partition. In some embodiments, the porous partition is a porous polymer partition. In some embodiments, the porous partition is a mesh or membrane. In some embodiments, the porous partition is a polymer mesh or polymer membrane. In some embodiments, the porous partition comprises one or more layers of mesh, membrane, or other porous structure. In some embodiments, the porous partition comprises one or more coarse meshes that provide structural support and one or more fine meshes and/or membranes that provide filtration. In some embodiments, the porous partition comprises a polyether ether ketone mesh, a polypropylene mesh, a polyethylene mesh, a polysulfone mesh, a polyester mesh, a polyamide mesh, a polytetrafluoroethylene mesh, an ethylene tetrafluoroethylene polymer mesh, a stainless steel mesh, a stainless steel mesh coated in polymer, a stainless steel mesh coated in ceramic, or a combination thereof, wherein the mesh is a course mesh, a fine mesh, or a combination thereof. In some embodiments, the porous polymer partition comprises a mesh comprising one or more blends of two or more of a polyether ether ketone, a polypropylene, a polyethylene, a polysulfone, a polyester, a polyamide, a polytetrafluoroethylene, or an ethylene tetrafluoroethylene polymer. In some embodiments, the porous partition comprises a polyether ether ketone membrane, a polypropylene membrane, a polyethylene membrane, a polysulfone membrane, a polyester membrane, a polyamide membrane, a polytetrafluoroethylene membrane, an ethylene tetrafluoroethylene polymer membrane, or combinations thereof.

In one embodiment of the ion exchange system, the system is a stirred tank system comprised of a tank of brine containing permeable bead compartments such as permeable pallets, cases, boxes, or other containers that are loaded with ion exchange beads, and the brine is stirred through the tank in a batch process. In one embodiment of the stirred tank system, the base is optionally added directly to the tank gradually or all at once as a solid or in an aqueous solution. In one embodiment of the stirred tank system, after a brine uptake stage is complete, the permeable bead containers are optionally moved to another tank for acid elution. In one embodiment of the stirred tank system, the permeable bead compartments are located at the bottom of the stirred tank during the brine stage and after the brine stage is completed, then brine is removed, and the bottom of the stirred tank is filled with acid to elute lithium in such a way that the permeable bead compartments are covered with an optimal volume of acid.

In one embodiment of the stirred tank system, the ion exchange beads are suspended using plastic structural supports in a tank with an internal mixing device. In one embodiment of the stirred tank system, a stream of brine is removed from the tank and passed through a column where hydrogen ions in the brine produced by ion exchange are neutralized using sacrificial base in solution or added as solid, or by an ion exchange resin. This pH-corrected stream is sent back into the system where the lithium can continue to be removed. In one embodiment of the stirred tank system, brine that has passed through the ion exchange bead compartment is returned to the opposite end of the tank through a pipe that is optionally internal or external to the tank. In one embodiment of the stirred tank system, base is optionally added to the brine inside the tank or in a base addition tank outside the tank.

In one embodiment of the stirred tank system, fresh brine is fed to the system so as to operate in continuous stirred tank system mode instead of batch mode. In one embodiment of the recirculating batch system, fresh brine is fed to the system so as to operate in continuous stirred tank system mode instead of batch mode.

In one embodiment of the ion exchange system, the ion exchange material is mixed with a liquid resource in a stirred tank reactor. In one embodiment, the ion exchange material may be comprised of coated ion exchange particles, uncoated ion exchange particles, porous ion exchange beads, or combinations thereof.

In one embodiment of the ion exchange system, a stirred tank reactor is used to fluidize the ion exchange material in a liquid resource to enable absorption of lithium from the liquid resource into the ion exchange material. In one embodiment, a stirred tank reactor is used to fluidize the ion exchange material in a washing fluid to remove residual brine, acid, or other contaminants from the ion exchange materials. In one embodiment, a stirred tank reactor is used to fluidize the ion exchange material in an acid solution to elute lithium from the ion exchange material while replacing the lithium in the ion exchange material with protons. In one embodiment, a single stirred tank reactor is used to mix ion exchange material with a liquid resource, washing fluid, and acid solution.

In some embodiments, the system for the extraction of lithium ions from a liquid resource, comprising a tank, wherein the tank further comprises: a) one or more compartments; b) an ion exchange material; c) a mixing device; and d) a pH modulating setup for changing the pH of the liquid resource in the system, wherein the ion exchange material is used to extract lithium ions from the liquid resource, further comprises another tank, wherein the other tank further comprises: a) one or more compartments; b) an ion exchange material; c) a mixing device; and d) a pH modulating setup for changing the pH of the liquid resource in the system. In some embodiments, the tank is in fluid communication with the other tank.

In some embodiments, the system for the extraction of lithium ions from a liquid resource, comprising a tank, wherein the system further comprises another tank, wherein the other tank further comprises: a) one or more compartments; b) an ion exchange material; c) a mixing device; and d) an acid inlet for adding acid to the system. In a further embodiment, the ion exchange material is moved between the tank and the other tank.

In some embodiments, the system for the extraction of lithium ions from a liquid resource, comprising a tank, wherein the tank further comprises: a) one or more compartments; b) an ion exchange material; c) a mixing device; and d) a pH modulating setup for changing the pH of the liquid resource in the system, wherein the ion exchange material is used to extract lithium ions from the liquid resource, further comprises a plurality of tanks, each tank further comprising: a) one or more compartments; b) an ion exchange material; c) a mixing device; and d) a pH modulating setup for changing the pH of the liquid resource in the system. In some embodiments, each tank of the system is in fluid communication with each other tank of the system.

In some embodiments, the system further comprises another plurality of tanks, wherein each tank further comprises: a) one or more compartments; b) an ion exchange material; and c) a mixing device.

In some embodiments, the system is configured to operate in a batch mode. In some embodiments, the system is configured to operate in a continuous mode. In some embodiments, the system is configured to operate in a batch mode and a continuous mode. In some embodiments, one or more tanks in the system are configured to operate in a batch mode and one or more tanks in the system are configured to operate in a continuous mode. In some embodiments, one or more tanks in the system are configured to operate in a batch mode and one or more tanks in the system are configured to operate in a semi-continuous mode. In some embodiments, one or more tanks in the system are configured to operate in a semi-continuous mode and one or more tanks in the system are configured to operate in a continuous mode. In some embodiments, one or more tanks in the system are configured to operate in a batch mode, one or more tanks in the system are configured to operate in a semi-continuous mode, and one or more tanks in the system are configured to operate in a continuous mode. In some embodiments, the system is configured to operate in a semi-continuous mode, a batch mode, a continuous mode, or combinations thereof.

In one embodiment of the ion exchange system, a plurality of stirred tank reactors are used to mix ion exchange material with a liquid resource, washing fluid, and acid solution. In one embodiment, the stirred tank reactors may be different sizes and may contain different volumes of a liquid resource, washing fluid, and acid solution. In one embodiment, the stirred tanks may be cylindrical, conical, rectangular, pyramidal, or a combination thereof. In one embodiment of the ion exchange system, the ion exchange material may move through the plurality of stirred tank reactors in the opposite direction of the liquid resource, the washing fluid, or the acid solution.

In one embodiment of the ion exchange system, a plurality of stirred tank reactors may be used where one or more stirred tank reactors mix the ion exchange material with a liquid resource, one or more stirred tank reactors mix the ion exchange material with a washing fluid, and one or more stirred tank reactors mix the ion exchange material with an acid solution.

In one embodiment of the ion exchange system, stirred tank reactors may be operated in a continuous, semi-continuous, or batch mode where a liquid resource flows continuously, semi-continuously, or batch-wise through the stirred tank reactor. In one embodiment of the ion exchange system, stirred tank reactors may be operated in a continuous, semi-continuous, or batch mode where the ion exchange material flows continuously, semi-continuously, or batch-wise through the stirred tank reactor. In one embodiment of the ion exchange system, stirred tank reactors may be operated in a mode where the ion exchange material remains in the tank while flows of liquid resource, washing fluid, or acid solution are flowed through the tank in continuous, semi-continuous, or batch flows.

In one embodiment, ion exchange material may be loaded into or removed from the stirred tank reactors through the top, the bottom, or the side of the tank.

In one embodiment of the ion exchange system, stirred tank reactors may comprise one or more compartments. In one embodiment, the compartments may contain ion exchange material in a bed that is fluidized, fixed, partially fluidized, partially fixed, alternatively fluidized, alternatively fixed, or combinations thereof. In one embodiment, the compartments may be comprised of a porous support at the bottom of the compartment, the sizes of the compartment, the top of the compartment, or combinations thereof. In one embodiment, the compartments may be conical, cylindrical, rectangular, pyramidal, other shapes, or combinations thereof. In one embodiment, the compartment may be located at the bottom of the tank. In one embodiment, the shape of the compartment may conform to the shape of the stirred tank reactor. In one embodiment, the compartment may be partially or fully comprised of the tank of the stirred tank reactor.

In one embodiment, the compartment may be comprised of a porous structure. In one embodiment, the compartment may be comprised of a polymer, a ceramic, a metal, or combinations thereof. In one embodiment, the compartment may be comprised be comprised partially or fully of a porous material or a mesh. In one embodiment, the compartment may be at the top of the tank. In one embodiment, the compartment may be separated from the rest of the tank with one or more porous materials. In one embodiment, the compartment may be at the top of the tank. In one embodiment, the compartment may be separated from the rest of the tank with a bilayer mesh comprising one layer of coarse mesh for strength and one layer of fine mesh to contain smaller particles in the compartment. In one embodiment, the compartment may allow liquid to flow freely through the stirred tank reactor and through the compartment. In one embodiment, the compartment may be open on the top. In one embodiment, the compartment may contain the ion exchange material in the tank but allow the ion exchange material to move throughout the tank. In one embodiment, the compartment may comprise a majority or minority of the tank volume. In one embodiment, the compartment may represent a fraction of the volume of the tank that is greater than 1 percent, greater than 10 percent, greater than 50 percent, greater than 90 percent, greater than 99 percent, or greater than 99.9 percent. In one embodiment, one or more devices for stirring, mixing, or pumping may be used to move fluid through the compartment, the stirred tank reactor, or combinations thereof.

In one embodiment of the ion exchange system, stirred tank reactors may be arranged into a network where flows of brine, washing fluid, and acid solutions are directly through different columns. In one embodiment, a network of stirred tank reactors may involve physical movement of the ion exchange material through the various stirred tank reactors. In one embodiment, a network of stirred tank reactors may involve no physical movement of the ion exchange material through the various stirred tank reactors. In one embodiment, a network of stirred tank reactors may involve switching of flows of brine, washing fluid, and acid solutions through the various stirred tank reactors. In one embodiment, brine may into stirred tank reactors in continuous or batch mode. In one embodiment, brine may be mixed with ion exchange material in one or more reactors before exiting the system. In one embodiment, a network of stirred tank reactors may involve a brine circuit with counter-current exposure of ion exchange material to flows of brine. In one embodiment, a network of stirred tank reactors may involve a washing circuit with counter-current exposure of ion exchange material to flows of washing fluid. In one embodiment, a network of stirred tank reactors may involve an acid circuit with counter-current exposure of ion exchange material to flows of acid solution. In one embodiment, the washing fluid may be water, an aqueous solution, or a solution containing an anti-scalant.

In one embodiment of the stirred tank reactor, acid is added at the beginning of elution. In one embodiment of the stirred tank reactor, acid is added at the beginning of elution and again during elution. In one embodiment of the stirred tank reactor, an acid of lower concentration is added at the start of elution and additional acid of high concentration is added to continue elution.

An aspect of the disclosure described herein is a system for the extraction of lithium ions from a liquid resource, comprising: a) an ion exchange material; b) a tank comprising one or more compartments; and c) a mixing device, wherein the ion exchange material is used to extract lithium ions from the liquid resource.

In some embodiments, the ion exchange material is loaded in at least one of the one or more compartments. In some embodiments, the ion exchange material is fluidized or partially fluidized in at least one of the one or more compartments. In some embodiments, the ion exchange material occupies a fixed position in at least one of the one or more compartments. In some embodiments, the ion exchange material is mounted in at least one of the one or more compartments.

An aspect of the disclosure described herein is a system for the extraction of lithium ions from a liquid resource, comprising: a) a column comprising an ion exchange material; and b) a pH modulating setup for changing the pH of the liquid resource in the system, wherein the pH modulating setup is in fluid communication with the column, wherein the ion exchange material is used to extract lithium ions from the liquid resource.

### Other Types of Systems

An aspect of the disclosure described herein is a system for the extraction of lithium ions from a liquid resource, comprising: a) a plurality of columns, wherein each of the plurality of columns comprises an ion exchange material; and b) a pH modulating setup for changing the pH of the liquid resource in the system, wherein the pH modulating setup is in fluid communication with each of the plurality of columns, wherein the ion exchange material is used to extract lithium ions from the liquid resource.

In some embodiments, the pH modulating setup comprises a plurality of tanks, wherein each of the plurality of tanks is immediately connected to one of the plurality of columns. In one embodiment, the pH modulating setup comprises a plurality of tanks, wherein each of the plurality of tanks is in immediate liquid communication with one of the plurality of columns. In some embodiments, two or more of the plurality of tanks connected to two or more of the plurality of columns forms at least one circuit. In some embodiments, two or more of the plurality of tanks connected to two or more of the plurality of columns forms at least two circuits. In some embodiments, three or more of the plurality of tanks connected to three or more of the plurality of columns forms at least two circuits. In some embodiments, three or more of the plurality of tanks connected to three or more of the plurality of columns forms at least three circuits.

In some embodiments, the pH modulating setup comprises a plurality of tanks, wherein each of the plurality of tanks is connected to the of the plurality of columns through a filtration system. In some embodiments, two or more of the plurality of tanks are connected to two or more of the plurality of columns through a filter system to form at least one circuit. In some embodiments, two or more of the plurality of tanks are connected to two or more of the plurality of columns through a filter system to form at least two circuits. In some embodiments, three or more of the plurality of tanks are connected to two or more of the plurality of columns through a filter system to form at least two circuits. In some embodiments, three or more of the plurality of tanks are connected to two or more of the plurality of columns through a filter system to form at least three circuits.

In some embodiments, the filtration system comprises a bag filter, a candle filter, a cartridge filter, a media filter, a depth filter, a sand filter, a membrane filter, an ultrafiltration system, a microfiltration filter, a nanofiltration filter, a cross-flow filter, a dead-end filter, a drum filter, a filter press, or a combination thereof. In some embodiments, the openings in this filter are of less than about 0.02 μm, less than about 0.1 μm, less than about 0.2 μm, less than about 1 μm, less than about 2 μm, less than about 5 μm, less than about 10 μm, less than about 25 μm, less than about 100 μm, less than about 1000 μm. In some embodiments, the perforated openings in outer-perforated walls are of dimension of more than about 0.02 μm, more than about 0.1 μm, more than about 0.2 μm, more than about 1 μm, more than about 2 μm, more than about 5 μm, more than about 10 μm, more than about 25 μm, more than about 100 μm. In some embodiments, the perforated openings in outer-perforated walls are of dimension of about 0.02 μm to about 0.1 μm, from about 0.1 μm to about 0.2 μm, from about 0.2 μm to about 0.5 μm, from about 0.5 μm to about 1 μm, from about 1 μm to about 5 μm, from about 5 μm to about 10 μm, from about 10 μm to about 25 μm, from about 25 μm to about 100 μm. In some embodiments, the filter martial comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly(4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly(chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In a further aspect, a coating material comprises polyvinylidene fluoride (PVDF), polyvinyl chloride (PVC), ethylene chlorotrifluoro ethylene (Halar), poly(4-vinyl pyridine-co-styrene) (PVPCS), polystyrene (PS), acrylonitrile butadiene styrene (ABS), expanded poly styrene (EPS), polyphenylene sulfide, sulfonated polymer, carboxylated polymer, other polymers, co-polymers thereof, mixtures thereof, or combinations thereof. In some embodiments, the filter martial comprises iron, stainless steel, nickel, carbon steel, titanium, Hastelloy, Inconel, zirconium, tantalum, alloys thereof, mixtures thereof, or combinations thereof.

In some embodiments, at least one circuit is a liquid resource circuit. In some embodiments, at least one circuit is a water washing circuit. In some embodiments, at least two circuits are water washing circuits. In some embodiments, at least one circuit is an acid solution circuit.

An aspect of the disclosure described herein is a system for the extraction of lithium ions from a liquid resource comprising an ion exchange material and a plurality of vessels, wherein each of the plurality of vessels is configured to transport the ion exchange material along the length of the vessel and the ion exchange material is used to extract lithium ions from the liquid resource. In some embodiments, at least one of the plurality of vessels comprises an acidic solution. In some embodiments, at least one of the plurality of vessels comprises the liquid resource. In some embodiments, each of the plurality of vessels is configured to transport the ion exchange material by a pipe system or an internal conveyer system.

An aspect of the disclosure described herein is a system for the extraction of lithium ions from a liquid resource comprising an ion exchange material and a plurality of columns, wherein each of the plurality of columns is configured to transport the ion exchange material along the length of the column and the ion exchange material is used to extract lithium ions from the liquid resource.

In some embodiments, at least one of the plurality of columns comprises an acidic solution. In some embodiments, at least one of the plurality of columns comprises the liquid resource. In some embodiments, each of the plurality of columns is configured to transport the ion exchange material by a pipe system or an internal conveyer system.

In some embodiments, the ion exchange material comprises ion exchange particles. In some embodiments, at least a portion of the ion exchange material is in the form of ion exchange particles. In some embodiments, the ion exchange particles are selected from uncoated ion exchange particles, coated ion exchange particles, and combinations thereof. In some embodiments, the ion exchange particles comprise uncoated ion exchange particles. In some embodiments, the ion exchange particles comprise coated ion exchange particles. In some embodiments, the ion exchange particles comprise a mixture of uncoated and coated ion exchange particles.

In some embodiments, the coated ion exchange particles comprise an ion exchange material and a coating material.

In some embodiments, the coating material of the coated ion exchange particles comprises a carbide, a nitride, an oxide, a phosphate, a fluoride, a polymer, carbon, a carbonaceous material, or combinations thereof. In some embodiments, the coating material of the coated ion exchange particles is selected from the group consisting of TiO₂, ZrO₂, MoO₂, SnO₂, Nb₂O₅, Ta₂O₅, SiO₂, Li₂TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, Mo₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, and combinations thereof.

In some embodiments, the ion exchange material of the coated ion exchange particles comprises an oxide, a phosphate, an oxyfluoride, a fluorophosphate, or combinations thereof. In some embodiments, the ion exchange material of the coated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof; wherein x is from 0.1-10; and y is from 0.1-10.

In some embodiments, the uncoated ion exchange particles comprise an ion exchange material. In some embodiments, the ion exchange material of the uncoated ion exchange particles comprises an oxide, a phosphate, an oxyfluoride, a fluorophosphate, or combinations thereof. In some embodiments, the ion exchange material of the uncoated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof; wherein x is from 0.1-10; and y is from 0.1-10.

In some embodiments, the ion exchange material is porous. In some embodiments, the porous ion exchange material comprises a network of pores that allows liquids to move quickly from the surface of the porousion exchange material to a plurality of ion exchange particles. In some embodiments, the porous ion exchange material comprises a network of pores that allows a liquid to move from the surface of the porous ion exchange material to a plurality of ion exchange particles. In some embodiments, the porous ion exchange material comprises a network of pores that allows a liquid to move quickly from the surface of the porous ion exchange material to a plurality of ion exchange particles. In some embodiments, the porous ion exchange material is porous ion exchange beads. In some embodiments, the porous ion exchange material is comprised of porous ion exchange beads.

In some embodiments of the systems described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments of the systems described herein, the liquid resource is a brine. In some embodiments of the systems described herein, the liquid resource comprises a natural brine, a synthetic brine, or a mixture of a natural and a synthetic brine. In some embodiments of the systems described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, or combinations thereof.

An aspect of the disclosure described herein is a system, wherein the column further comprises a plurality of injection ports, wherein the plurality of injection ports are used to increase the pH of the liquid resource in the system

In one embodiment of the ion exchange system, the system is a mixed base system comprising an ion exchange column and a mixing chamber where base is mixed into the brine immediately prior to injection of the brine into the column.

In one embodiment of the ion exchange system, the system is a ported ion exchange column system with multiple ports for injection of aqueous base spaced at intervals along the direction of brine flow through the column. As brine flows through the column, there is a region of the column where the ion exchange beads experience the greatest rate of lithium absorption, and this region moves through the column in the direction of brine flow. In the ported ion exchange column system, base is injected near that region to neutralize protons released by the ion exchange reaction. In regions of the columns where the ion exchange beads have been saturated with lithium and the rate of release of protons has slowed, base injected is decreased or terminated to avoid formation of basic precipitates.

In one embodiment of the ion exchange system, the system has a moving bed of beads that moves in a direction opposite to the flow of brine and base is injected at one or more fixed points in the column in a region near where the ion exchange reaction occurs at a maximum rate in the column to neutralize the protons released from the ion exchange reaction.

In one embodiment of the ion exchange system, the base added to the brine is optionally NaOH, KOH, Mg(OH)₂, Ca(OH)₂, CaO, NH₃, Na₂SO₄, K₂SO₄, NaHSO₄, KHSO₄, NaOCl, KOCl, NaClO₄, KClO₄, NaH₂BO₄, Na₂HBO₄, Na₃BO₄, KH₂BO₄, K₂HBO₄, K₃BO₄, MgHBO₄, CaHBO₄, NaHCO₃, KHCO₃, NaCO₃, KCO₃, MgCO₃, CaCO₃, Na₂O, K₂O, Na₂CO₃, K₂CO₃, Na₃PO₄, Na₂HPO₄, NaH₂PO₄, K₃PO₄, K₂HPO₄, KH₂PO₄, CaHPO₄, MgHPO₄, sodium acetate, potassium acetate, magnesium acetate, poly(vinylpyridine), poly(vinylamine), polyacrylonitrile, other bases, or combinations thereof. In one embodiment, the base is optionally added to the brine in its pure form or as an aqueous solution. In one embodiment, the base is optionally added in a gaseous state such as gaseous NH₃. In one embodiment, the base is optionally added to the brine in a steady stream, a variable stream, in steady aliquots, or in variable aliquots. In one embodiment, the base is optionally created in the brine by using an electrochemical cell to remove H₂ and Cl₂ gas, which is optionally combined in a separate system to create HCl acid to be used for eluting lithium from the system or for other purposes.

In some embodiments, a solid base is mixed with a liquid resource to create a basic solution. In some embodiments, a solid base is mixed with a liquid resource to create a basic solution, and the resulting basic solution is added to a second volume of a liquid resource to increase the pH of the second volume of the liquid resource. In some embodiments, solid base is mixed with a liquid resource to create a basic solution, wherein the resulting basic solution is used to adjust or control the pH of a second solution. In some embodiments, a solid base is mixed with a liquid resource to create a basic slurry. In some embodiments, a solid base is mixed with a liquid resource to create a basic slurry, and the resulting basic slurry is added to a second volume of a liquid resource to increase the pH of the second volume of the liquid resource. In some embodiments, solid base is mixed with a liquid resource to create a basic slurry, wherein the resulting basic slurry is used to adjust or control the pH of a second solution. In some embodiments, base may be added to a liquid resource as a mixture or slurry of base and liquid resource.

In one embodiment of the ion exchange system, the brine flows through a pH control column containing solid sacrificial base particles such as NaOH, CaO, or Ca(OH)₂, which dissolve into the brine and raise the pH of the brine. In one embodiment of the ion exchange system, the brine flows through a pH control column containing immobilized regeneratable OH-containing ion exchange resins which react with hydrogen ions, or regeneratable base species such as immobilized polypyridine, which conjugate HCl, thereby neutralizing the acidified brine. When the ion exchange resin has been depleted of its OH groups or is saturated with HCl, it is optionally regenerated with a base such as NaOH.

In one embodiment of the ion exchange system, pH meters are optionally installed in tanks, pipes, column, and other components of the system to monitor pH and control the rates and amounts of base addition at various locations throughout the system.

In one embodiment of the ion exchange system, the columns, tanks, pipes, and other components of the system are optionally constructed using plastic, metal with a plastic lining, or other materials that are resistant to corrosion by brine or acid.

In one embodiment of the ion exchange system, the ion exchange columns are optionally washed with water that is mildly acidic, optionally including a buffer, to remove any basic precipitates from the column prior to acid elution.

After the ion exchange column is saturated or nearly saturated with lithium, the lithium is flushed out of the ion exchange column using acid. The acid is optionally flowed through the column one or more times to elute the lithium. In one embodiment, the acid is optionally flowed through the ion exchange column using a recirculating batch system comprised of the ion exchange column connected to a tank. In one embodiment, the tank used for acid flows is optionally the same tank used for the brine flows. In a further embodiment, the tank used for acid flows is optionally a different tank than the one used for brine flows. In a further embodiment, the acid is distributed at the top of the ion exchange column and allowed to percolate through and immediately recirculated into the column with no extra tank. In an embodiment, acid addition optionally occurs without a tank used for acid flows.

In one embodiment of the ion exchange system, the column is optionally washed with water after the brine and/or acid steps, and the effluent water from washing is optionally treated using pH neutralization and reverse osmosis to yield process water.

In one embodiment of the ion exchange system, the ion exchange column is optionally shaped like a cylinder, a rectangle, or another shape. In one embodiment, the ion exchange column optionally has a cylinder shape with a height that is greater or less than its diameter. In one embodiment, the ion exchange column optionally has a cylinder shape with a height that is less than 10 cm, less than 1 meter, or less than 10 meters. In one embodiment, the ion exchange column optionally has a cylinder shape with a diameter that is less than 10 cm, less than 1 meter, or less than 10 meters.

In one embodiment of the ion exchange system, the system is optionally resupplied with fresh ion exchange beads by swapping out an ion exchange column with a new column loaded with fresh ion exchange beads. In one embodiment of the ion exchange system, the system is optionally resupplied with fresh ion exchange beads by removing the ion exchange beads from the column and loading new beads into the column. In one embodiment of the ion exchange system, new beads are optionally supplied to all columns in the system simultaneously. In one embodiment of the ion exchange system, new beads are optionally supplied to one or more columns at a time. In one embodiment of the ion exchange system, new beads are optionally supplied to one or more columns without interruption to other columns that optionally continue operating.

In one embodiment of the ion exchange system, brine pumping optionally continues until the ion exchange beads approach a point of lithium saturation over a period of time that is optionally less than about 1 hours, less than about 2 hours, less than about 4 hours, less than about 8 hours, less than about 24 hours, less than about 48 hours, or less than about one week. In one embodiment of the ion exchange system, brine pumping optionally continues until the ion exchange beads approach a point of lithium saturation over a period of time that is optionally greater than about one week. In certain embodiments of the ion exchange system, brine pumping optionally continues until the ion exchange beads approach a point of lithium saturation over a period of time that is optionally between 30 minutes and 24 hours. In one embodiment of the ion exchange system, acid pumping optionally continues until the ion exchange beads approach a point of hydrogen saturation over a period of time that is optionally less than about 1 hours, less than about 2 hours, less than about 4 hours, less than about 8 hours, less than about 24 hours, or less than about 48 hours. In one embodiment of the ion exchange system, brine pumping optionally continues until the ion exchange beads approach a point of hydrogen saturation over a period of time that is optionally greater than about one 48 hours. In certain embodiments of the ion exchange system, brine pumping optionally continues until the ion exchange beads approach a point of hydrogen saturation over a period of time that is optionally between 30 minutes and 24 hours.

For commercial production of lithium using ion exchange, it is desirable to construct large-scale ion exchange modules containing large quantities of ion exchange beads. However, most large vessels capable of holding about one tonne or more of ion exchange beads have large fluid flow distances of about one meter or more. These fluid flow distances cause large pressure drops. To reduce the pressure drop across the ion exchange bed, the ion exchange beads can be loaded into vessels facilitating flow across the ion exchange beads with a shorter fluid flow distance. These vessels can be designed to evenly distribute flow of the liquid resource and other fluids through the ion exchange beads.

In some embodiments, ion exchange vessels are designed to facilitate flow across the ion exchange beads with a shorter fluid flow distance. In some embodiments, the vessel can be oriented vertically, horizontally, or at any angle relative to the horizontal axis. In some embodiments, the vessel can be cylindrical, rectangular, spherical, another shape, or a combinations thereof. In some embodiments, the vessel can have a constant cross-sectional area or a varying cross-sectional area.

In some embodiments, the typical thickness of the distribution compartment within the vessel containing the ion-exchange compartments is less than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the distribution compartment within the vessel containing the ion-exchange compartments is more than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the distribution compartment within the vessel containing the ion-exchange compartments is from about 1 cm to about 2 cm, from about 2 cm to about 4 cm, from about 4 cm to about 8 cm, from about 8 cm to about 20 cm, from about 20 cm to about 40 cm, from about 40 cm to about 80 cm, from about 80 cm to about 120 cm, from about 120 cm to about 2 m, from about 2 m to about 4 m.

In some embodiments, the typical thickness of the compartment containing ion-exchange beads within the vessel containing the ion-exchange compartments is less than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the compartment containing ion-exchange beads within the vessel containing the ion-exchange compartments is more than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the compartment containing ion-exchange beads within the vessel containing the ion-exchange compartments is from about 1 cm to about 2 cm, from about 2 cm to about 4 cm, from about 4 cm to about 8 cm, from about 8 cm to about 20 cm, from about 20 cm to about 40 cm, from about 40 cm to about 80 cm, from about 80 cm to about 120 cm, from about 120 cm to about 2 m, from about 2 m to about 4 m.

In some embodiments, an alternate phase is contacted with the ion exchange material within an ion exchange device. In some embodiments, contact between the ion exchange beads and the alternate phase is maximized and made possible by the design of this ion exchange device.

In some embodiments, the alternate phase improves lithium extraction performance by reducing the time required to absorb hydrogen to generate hydrogen-enriched beads and release lithium to generate a lithium-enriched solution; reducing the time and water required for washing the hydrogen-enriched beads with water to generate hydrogen-enriched beads substantially free of residual acid; reducing the time required for treating the hydrogen-enriched beads with the liquid resource under conditions suitable to absorb lithium to generate lithium-enriched beads; reducing the time and water required for washing the lithium-enriched beads with water to generate lithium-enriched beads substantially free of liquid resource; improving the life-time and total lithium produce by the ion exchange material; improving the speed of pH adjustment using alkali; improving the solid-liquid mixing efficiency; and reducing the time required to drain liquids from the ion exchange vessel.

In some embodiments, the alternate phase is a liquid or gas. In some embodiments, said alternate phase is a non-aqueous liquid. In some embodiments, the alternate phase is non-aqueous liquid. In some embodiments, the alternate phase is a non-aqueous solution. In some embodiments, the alternate phase is an organic liquid such as an alkane, alcohol, oil, bio-organic oil, ester, ether, hydrocarbon, or a combination thereof. In some embodiments, the alternate phase is butane, pentane, hexane, acetone, diethyl ether, butanol, or combinations thereof. In some embodiments, the alternate is a gas such as air, nitrogen, argon, or a combination thereof. In some embodiments, the alternate phase comprises a compressed or pressurized gas.

In some embodiments, the ion exchange bed is a fixed bed that does move during the ion exchange process. In some embodiments, the ion exchange bed is a fluidized bed that is agitated at one or more periods during the ion exchange process.

### Methods of Modulating pH for the Extraction of Lithium

An aspect of the disclosure described herein is a method of extracting lithium ions from a liquid resource, comprising: flowing the liquid resource through the column of the system described above to produce a lithiated ion exchange material; and treating the resulting lithiated ion exchange material with an acid solution to produce a salt solution comprising lithium ions.

An aspect of the disclosure described herein is a method of extracting lithium ions from a liquid resource, comprising: flowing the liquid resource through the plurality of columns of the system described above to produce a lithiated ion exchange material; and treating the resulting lithiated ion exchange material with an acid solution (e.g., acidic solution) to produce a salt solution comprising lithium ions (e.g., a synthetic lithium solution).

An aspect of the disclosure described herein is a method of extracting lithium ions from a liquid resource, comprising: flowing the liquid resource through the tank of the system described above to produce a lithiated ion exchange material; and treating the resulting lithiated ion exchange material with an acid solution (e.g., acidic solution) to produce a salt solution comprising lithium ions (e.g., a synthetic lithium solution).

An aspect of the disclosure described herein is a method of extracting lithium ions from a liquid resource, comprising: flowing the liquid resource through the column of the system described above to produce a lithiated ion exchange material; and treating the resulting lithiated ion exchange material with an acid solution (e.g., acidic solution) to produce a salt solution comprising lithium ions (e.g., a synthetic lithium solution).

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, or organic molecules. In some embodiments, the liquid resource is optionally entered the ion exchange reactor without any pre-treatment following from its source.

In an embodiment, the liquid resource is a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

In some embodiments, the acid used for recovering lithium from the ion exchange reactor is selected from the following list: hydrochloric acid, sulfuric acid, phosphoric acid, hydrobromic acid, chloric acid, perchloric acid, nitric acid, formic acid, acetic acid, or combinations thereof. In some embodiments, the acid used for recovering lithium from the porous ion exchange beads is selected from the following list: hydrochloric acid, sulfuric acid, nitric acid, or combinations thereof.

In an embodiment, the acid solution comprises hydrochloric acid, sulfuric acid, phosphoric acid, hydrobromic acid, chloric acid, perchloric acid, nitric acid, formic acid, acetic acid, or combinations thereof.

In some embodiments, the acid used for recovering lithium from the ion exchange system has a concentration selected from the following list: less than 0.1 M, less than 1.0 M, less than 5 M, less than 10 M, or combinations thereof. In some embodiments, the acid used for recovering lithium from the porous ion exchange beads has a concentration greater than 10 M.

In an embodiment, acids with distinct concentrations are used during the elution process. In an embodiment, acid with a lower concentration is first added to elute lithium from the ion exchange material and then additional acid of a greater concentration is added to elute more lithium into the solution and increase the concentration of lithium in the eluate.

In some embodiments, the ion exchange beads perform the ion exchange reaction repeatedly while maintaining adequate lithium uptake capacity over a number of cycles selected from the following list: greater than 10 cycles, greater than 30 cycles, greater than 100 cycles, greater than 300 cycles, or greater than 1,000 cycles. In some embodiments, the porous ion exchange beads perform the ion exchange reaction repeatedly over a number of cycles selected from the following list: greater than 50 cycles, greater than 100 cycles, or greater than 200 cycles. In some embodiments, adequate lithium uptake capacity is optionally defined as a percentage of initial uptake capacity selected from the following list: greater than 95%, greater than 90%, greater than 80%, greater than 60%, or greater than 20%. In some embodiments, adequate lithium uptake capacity is optionally defined as a percentage of initial uptake capacity such as less than 20%.

In some embodiments, the concentrated lithium solution that is yielded from the ion exchange reactor is further processed into lithium raw materials using methods selected from the following list: solvent extraction, ion exchange, chemical precipitation, electrodialysis, electrowinning, electrolysis, evaporation with direct solar energy, evaporation with concentrated solar energy, evaporation with a heat transfer medium heated by concentrated solar energy, evaporation with heat from a geothermal brine, evaporation with heat from combustion, pH neutralization, or combinations thereof. In some embodiments, the concentrated lithium solution that is yielded from the ion exchange reactor is concentrated using reverse osmosis or membrane technologies.

In some embodiments, the concentrated lithium solution that is yielded from the ion exchange reactor is further processed into lithium chemicals selected from the following list: lithium chloride, lithium carbonate, lithium hydroxide, lithium metal, lithium metal oxide, lithium metal phosphate, lithium sulfide, or combinations thereof. In some embodiments, the concentrated lithium solution that is yielded from the porous ion exchange beads is further processed into lithium chemicals that are solid, liquid, hydrated, or anhydrous.

In some embodiments, the lithium chemicals produced using the ion exchange reactor are used in an industrial application selected from the following list: lithium batteries, metal alloys, glass, grease, or combinations thereof. In some embodiments, the lithium chemicals produced using the coated ion exchange particles are used in an application selected from the following list: lithium batteries, lithium-ion batteries, lithium sulfur batteries, lithium solid-state batteries, and combinations thereof.

In some embodiments, the ion exchange materials are synthesized in a lithiated state with a sublattice fully or partly occupied by lithium. In some embodiments, the ion exchange materials are synthesized in a hydrated state with a sublattice fully or partly occupied by hydrogen.

In some embodiments, the ion exchange material extracts lithium ions from a liquid resource. During the extraction of lithium ions from a liquid resource by the ion exchange material, the pH of the liquid resource optionally decreases. Increasing the pH of the liquid resource in the system by using a pH modulating setup maintains the pH in a range that is suitable for lithium ion uptake by the ion exchange material. In an embodiment, the pH modulating setup comprises measuring the pH of the system and adjusting the pH of the system to an ideal pH range for lithium extraction. In an embodiment, for ion exchange material to absorb lithium from brine, an ideal pH range for the brine is optionally 6 to 9, a preferred pH range is optionally 4 to 9, and an acceptable pH range is optionally 2 to 9. In an embodiment, the pH modulating setup comprises measuring the pH of the system and wherein the pH of the system is less than 6, less than 4, or less than 2, the pH of the system is adjusted to a pH of 2 to 9, a pH of 4 to 9, or a pH of 6 to 9.

Another aspect of the disclosure described herein is a method of extracting lithium ions from a liquid resource, comprising: a) flowing the liquid resource into a system comprising a tank to produce a lithiated ion exchange mateiral, wherein the tank further comprises (i) one or more compartments, (ii) an ion exchange material, (iii) a mixing device, and (iv) a pH modulating setup for changing the pH of the liquid resource in the system; and b) treating the lithiated ion exchange material from a) with an acid solution to produce a hydrogen-rich ion exchange material and a salt solution comprising lithium ions.

In some embodiments, the method further comprises, prior to b), washing the lithiated ion exchange material with an aqueous solution. In some embodiments, the method further comprises, subsequent to b), washing the hydrogen-rich ion exchange material with an aqueous solution. In some embodiments, the aqueous solution is water.

In some embodiments, the method further comprises, prior to b), flowing the lithiated ion exchange material into a washing system. In some embodiments, the method further comprises, prior to b), transferring a suspension comprising the lithiated ion exchange material. In some embodiments, the method further comprises, prior to b), flowing the lithiated ion exchange material into a washing system and washing the lithiated ion exchange material with a solution. In some embodiments, the method further comprises, prior to b), flowing the lithiated ion exchange material into a washing system and washing the lithiated ion exchange material with a solution comprising water. In some embodiments, the method further comprises, prior to b), flowing the lithiated ion exchange material into a washing system and washing the lithiated ion exchange material with an aqueous solution. In some embodiments, the lithiated ion exchange material is washed with an aqueous solution.

In some embodiments, the method further comprises, prior to b), flowing the lithiated ion exchange material into a stripping system. In some embodiments, the method further comprises, prior to b), flowing the lithiated ion exchange material into a stripping system and stripping the lithiated ion exchange material. In some embodiments, the method further comprises, prior to b), flowing the lithiated ion exchange material into a stripping system and stripping volatile components from the lithiated ion exchange material. In some embodiments, the method further comprises, prior to b), flowing the lithiated ion exchange material into a stripping system and stripping volatile components comprising water from the lithiated ion exchange material.

In some embodiments, the pH modulating setup comprises a pH measuring device and an inlet for adding base to the tank. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the measured change in pH triggers adding a base to maintain lithium uptake. In some embodiments, a change in pH to below a pH value of about 2 to about 9 triggers the addition of a base to maintain lithium uptake. In some embodiments, a change in pH to below a pH value of about 2, of about 3, of about 4, of about 5, of about 6, of about 7, of about 8, or of about 9 triggers the addition of a base to maintain lithium uptake. In some embodiments, a change in pH to below a pH of about 2 to about 4, of about 3 to about 5, of about 4 to about 6, of about 5 to about 7, of about 6 to about 8, or of about 7 to about 9 triggers the addition of a base to maintain lithium uptake. In some embodiments, base is added to the liquid resource to maintain the pH of the liquid resource in a range of about 2-3, 3-4, 4-5, 5-6, 6-7, 7-8, or 8-9. In some embodiments, base is added to the liquid resource to maintain the pH of the liquid resource in a range of about 4-5, 5-6, 6-7, or 7-8. In some embodiments, base is added to the liquid resource to maintain the pH of the liquid resource in a range of about 4.0-4.5, 4.5-5.0, 5.0-5.5, 5.5-6.0, 6.0-6.5, 6.5-7.0, 7.0-7.5, or 7.5-8.0. In some embodiments, the pH of a liquid resource is maintained in a target range that is high enough to facilitate lithium uptake and low enough to avoid precipitation of metal salts from the liquid resource. In some embodiments, the pH of a liquid resource is maintained below a pH of about 8 to avoid precipitation of Mg salts. In some embodiments, the pH of a liquid resource is maintained below a pH of about 2, below a pH of about 3, below a pH of about 4, below a pH of about 5, below a pH of about 6, below a pH of about 7, below a pH of about 8, or below a pH of about 9 to avoid precipitation of metal salts. In some embodiments, the pH of the liquid resource may drop out of a target pH range due to release of protons from an ion exchange material and a pH modulating setup may adjust the pH of the liquid resource back to within a target pH range. In some embodiments, the pH of the liquid resource may be adjusted above a target pH range prior to the liquid resource entering the system and then protons released from the ion exchange material may decrease the pH of the system into the target range. In some embodiments, the pH of the liquid resource may be controlled in a certain range and the range may be changed over time. In some embodiments, the pH of the liquid resource may be controlled in a certain range and then the pH of the liquid resource may be allowed to drop. In some embodiments, the pH of the liquid resource may be controlled in a certain range and then the pH of the liquid resource may be allowed to drop to solubilize colloids or solids. In some embodiments, base may be added to a liquid resource to neutralize protons without measuring pH. In some embodiments, base may be added to a liquid resource to neutralize protons with monitoring of volumes or quantities of the base. In some embodiments, the pH of the liquid resource may be measured to monitor lithium uptake by an ion exchange material. In some embodiments, the pH of the liquid resource may be monitored to determine when to separate a liquid resource from an ion exchange material. In some embodiments, the rate of change of the pH of the liquid resource may be measured to monitor the rate of lithium uptake. In some embodiments, the rate of change of the pH of the liquid resource may be measured to determine when to separate a liquid resource from an ion exchange material.

In some embodiments, the tank further comprises a porous partition. In some embodiments, the porous partition is a porous polymer partition. In some embodiments, the porous partition is a mesh or membrane. In some embodiments, the porous partition is a polymer mesh or polymer membrane. In some embodiments, the porous partition comprises one or more layers of mesh, membrane, or other porous structure. In some embodiments, the porous partition comprises one or more coarse meshes that provide structural support and one or more fine meshes and/or membranes that provide filtration. In some embodiments, the porous partition comprises a polyether ether ketone mesh, a polypropylene mesh, a polyethylene mesh, a polysulfone mesh, a polyester mesh, a polyamide mesh, a polytetrafluoroethylene mesh, an ethylene tetrafluoroethylene polymer mesh, a stainless steel mesh, a stainless steel mesh coated in polymer, a stainless steel mesh coated in ceramic, or a combination thereof, wherein the mesh is a course mesh, a fine mesh, or a combination thereof. In some embodiments, the porous polymer partition comprises a mesh comprising one or more blends of two or more of a polyether ether ketone, a polypropylene, a polyethylene, a polysulfone, a polyester, a polyamide, a polytetrafluoroethylene, or an ethylene tetrafluoroethylene polymer. In some embodiments, the porous partition comprises a polyether ether ketone membrane, a polypropylene membrane, a polyethylene membrane, a polysulfone membrane, a polyester membrane, a polyamide membrane, a polytetrafluoroethylene membrane, an ethylene tetrafluoroethylene polymer membrane, or combinations thereof.

In some embodiments, the method further comprises, after a), draining the liquid resource through the porous partition after the production of the lithiated ion exchange material.

In some embodiments, the method further comprises, after b), draining the salt solution comprising lithium ions through the porous partition after the production of the hydrogen-rich ion exchange material.

In some embodiments, the method further comprises, subsequent to a), flowing the lithiated ion exchange material into another system comprising a tank to produce the hydrogen-rich ion exchange material and the salt solution comprising lithium ions, wherein the tank of the other system further comprises (i) one or more compartments, and (ii) a mixing device.

In some embodiments, the system comprises a plurality of tanks and each of the plurality of tanks further comprises (i) one or more compartments, (ii) an ion exchange material, (iii) a mixing device, and (iv) a pH modulating setup for changing the pH of the system.

An aspect of the disclosure described herein is a method of extracting lithium ions from a liquid resource, comprising: a) flowing the liquid resource into a first system comprising a tank, wherein the tank of the first system further comprises (i) one or more compartments, (ii) an ion exchange material, (iii) a mixing device, and (iv) a pH modulating setup for changing the pH of the liquid resource in the first system, to produce a lithiated ion exchange material; b) flowing the lithiated ion exchange material of a) into a second system comprising a tank, wherein the tank of the second system further comprises (i) one or more compartments, and (ii) a mixing device; and c) treating the lithiated ion exchange from b) with an acid solution to produce a hydrogen-rich ion exchange material and a salt solution comprising lithium ions.

In some embodiments, the method further comprises, subsequent to a), washing the lithiated ion exchange material with an aqueous solution.

In some embodiments, the method further comprises, prior to b), adding an aqueous solution to the lithiated ion exchange material to form a fluidized lithiated ion exchange material.

In some embodiments, the method further comprises, subsequent to c), washing the hydrogen-rich ion exchange material with an aqueous solution. In some embodiments, the aqueous solution is water.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the change in pH triggers adding a base to maintain lithium uptake.

An aspect of the disclosure described herein is a method of extracting lithium ions from a liquid resource, comprising: a) flowing the liquid resource into a first system comprising a plurality of tanks to produce a lithiated ion exchange material, wherein each of the plurality of tanks in the first system is in fluid communication with every other one of the plurality of tanks in the first system and, each of the plurality of tanks in the first system further comprises (i) one or more compartments, (ii) an ion exchange material, (iii) a mixing device, and (iv) a pH modulating setup for changing the pH of each of the plurality of tanks in the first system; b) flowing the lithiated ion exchange material into a second system comprising a plurality of tanks, wherein each of the plurality of tanks in the second system is in fluid communication with every other one of the plurality of tanks in the second system and, each of the plurality of tanks in the second system further comprises (i) one or more compartments, and (ii) a mixing device; and c) treating the lithiated ion exchange material from b) with an acid solution in at least one of the plurality of tanks in the second system to produce a hydrogen-rich ion exchange material and a salt solution comprising lithium ions.

In some embodiments, the method further comprises, subsequent to c), washing the hydrogen-rich ion exchange material with an aqueous solution in at least one of the plurality of tanks in the second system.

In some embodiments, the method is operated in a batch mode. In some embodiments, the method is operated in a continuous mode. In some embodiments, the method is operated in continuous and batch mode. In some embodiments, the method is operated in continuous mode, a batch mode, a semi-continuous mode, or combinations thereof.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the change in pH triggers adding a base to maintain lithium uptake.

An aspect of the disclosure described herein is a method of extracting lithium ions from a liquid resource, comprising: a) flowing the liquid resource into a first system comprising a tank to produce a lithiated ion exchange material, wherein the tank further comprises (i) one or more compartments, (ii) ion exchange material, and (iii) a mixing device; b) flowing the lithiated ion exchange material from a) into a second system comprising a tank, wherein the tank further comprises (i) one or more compartments, (ii) an acid solution, and (iii) a mixing device; and c) stripping the lithiated ion exchange material to produce hydrogen-rich ion exchange material and a salt solution comprising lithium ions.

In some embodiments, prior to b), the lithiated ion exchange material is washed. In some embodiments, the lithiated ion exchange material is washed with an aqueous solution.

An aspect described herein is a method of extracting lithium ions from a liquid resource, comprising: a) providing a system comprising an ion exchange material, a tank comprising one or more compartments; and a mixing device, wherein (i) the ion exchange material is oxide-based and exchanges hydrogen ions with lithium ions, and (ii) the mixing device is capable of moving the liquid resource around the tank comprising one or more compartments; b) flowing the liquid resource into the system of a), thereby contacting the liquid resource with the ion exchange material, wherein the ion exchange material exchanges hydrogen ions with lithium ions in the liquid resource to produce lithiated ion exchange material; c) removing the liquid resource from the system of b); d) flowing an acid solution into the system of c) thereby contacting the acid solution with the lithiated ion exchange material, wherein the lithiated ion exchange material exchanges lithium ions with the hydrogen ions in the acid solution to produce the ion exchange material and a salt solution comprising lithium ions from the lithiated ion exchange material; and e) collecting the salt solution comprising the lithium ions for further processing.

In some embodiments, the salt solution comprising lithium ions (e.g., the synthetic lithium solution) undergoes crystallization (e.g., one or more chemicals are isolated from the salt solution by crystallization, and/or the salt solution is subjected to conditions that promote crystallization, and/or one or more chemicals are added to the salt solution to promote crystallization and/or modulate the composition of the one more chemicals isolated from the salt solution by crystallization).

A method of extracting lithium ions from a liquid resource, comprising: a) flowing the liquid resource through a system comprising an ion exchange material and a plurality of columns, wherein the plurality of columns is configured to transport the ion exchange material along the length of the column, to produce a lithiated ion exchange material; and b) treating the lithiated ion exchange material from a) with an acid solution to produce a salt solution comprising lithium ions (e.g., a synthetic lithium solution).

An aspect of the disclosure described herein is a method of extracting lithium ions from a liquid resource, comprising: a) providing a system comprising an ion exchange material and a plurality of columns, wherein each of the plurality of columns is configured to transport the ion exchange material along the length of the column; b) flowing the liquid resource through a first one of the plurality of columns to produce a lithiated ion exchange material; c) flowing the lithiated ion exchange material from b) into a second one of the plurality of columns; and d) treating the lithiated ion exchange material from c) with an acid solution to produce a hydrogen-rich ion exchange material and a salt solution comprising lithium ions.

In some embodiments, the method further comprises, subsequent to b), flowing the lithiated ion exchange material into another one of the plurality of columns and washing the lithiated ion exchange material with an aqueous solution. In some embodiments, the method further comprises, subsequent to d), flowing the hydrogen-rich ion exchange material into another one of the plurality of columns and washing the hydrogen-rich ion exchange material with an aqueous solution.

An aspect of the disclosure described herein is a method of extracting lithium ion from a liquid resource, comprising: a) providing a system comprising an ion exchange material and a plurality of columns, wherein each of the plurality of columns is configured to transport the ion exchange material along the length of the column; b) flowing the liquid resource through a first one of the plurality of columns to produce a lithiated ion exchange material; c) flowing the lithiated ion exchange material from b) into a second one of the plurality of columns; d) washing the lithiated ion exchange material from c) with an aqueous solution; e) flowing the lithiated ion exchange material from d) into a third one of the plurality of columns; and f) treating the lithiated ion exchange material from e) with an acid solution to produce a hydrogen-rich ion exchange material and a salt solution comprising lithium ions.

In some embodiments, the method further comprises: g) flowing the hydrogen-rich ion exchange material into a fourth one of the plurality of columns; and h) washing the hydrogen-rich ion exchange material with an aqueous solution. In some embodiments, each of the plurality of columns is configured to transport the ion exchange material by a pipe system or an internal conveyer system. In some embodiments, each of the plurality of columns is configured to transport the ion exchange material by a pipe system. In some embodiments, each of the plurality of columns is configured to transport the ion exchange material by an internal conveyer system.

In some embodiments of the methods described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments of the methods described herein, the liquid resource is a brine. In some embodiments of the methods described herein, the liquid resource comprises a natural brine, a synthetic brine, or a mixture of a natural and a synthetic brine. In some embodiments of the methods described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, or combinations thereof.

In some embodiments of the methods described herein, the acid solution comprises hydrochloric acid, sulfuric acid, phosphoric acid, hydrobromic acid, chloric acid, perchloric acid, nitric acid, formic acid, acetic acid, or combinations thereof. In some embodiments of the methods described herein, the acid solution comprises hydrochloric acid, sulfuric acid, phosphoric acid, nitric acid, or combinations thereof. In some embodiments of the methods described herein, the acid solution comprises hydrochloric acid, sulfuric acid, phosphoric acid, or combinations thereof. In some embodiments of the methods described herein the acid solution comprises hydrochloric acid. In some embodiments of the methods described herein the acid solution comprises sulfuric acid. In some embodiments of the methods described herein the acid solution comprises phosphoric acid.

### Continuous Process for Lithium Extraction

Lithium is an essential element for batteries and other technologies. Lithium is found in a variety of liquid resources, including natural and synthetic brines and leachate solutions from minerals, clays, and recycled products. Lithium can be extracted from such liquid resources using an ion exchange process based on inorganic ion exchange materials. These inorganic ion exchange materials absorb lithium from a liquid resource while releasing hydrogen, and then elute lithium in acid while absorbing hydrogen. This ion exchange process can be repeated to extract lithium from a liquid resource and yield a concentrated lithium solution. The concentrated lithium solution can be further processed into chemicals for the battery industry or other industries.

Ion exchange materials are typically small particles, which together constitute a fine powder. Small particle size is required to minimize the diffusion distance that lithium must travel into the core of the ion exchange particles. In some cases, these particles may be coated with protective surface coatings to minimize dissolution of the ion exchange materials while allowing efficient transfer of lithium and hydrogen to and from the particles, as disclosed in U.S. provisional application 62/421,934, filed on Nov. 14, 2016, entitled “Lithium Extraction with Coated Ion Exchange Particles,” which is hereby incorporated by reference in its entirety.

One major challenge for lithium extraction using inorganic ion exchange particles is the loading of the particles into an ion exchange column in such a way that brine and acid can be pumped efficiently through the column with minimal clogging. The materials can be formed into beads, and the ion exchange beads can be loaded into the column. This bead loading creates void spaces between the ion exchange beads, and these void spaces facilitate pumping through the column. The ion exchange beads hold the ion exchange particles in place and prevent free movement of the particles throughout the column. When the materials are formed into beads, the penetration of brine and acid solutions into the ion exchange beads may become slow and challenging. A slow rate of convection and diffusion of the acid and brine solutions into the ion exchange bead slows the kinetics of lithium absorption and release. Such slow kinetics can create problems for column operation. Slow kinetics can require slow pumping rates through the column. Slow kinetics can also lead to low lithium recovery from the brine and inefficient use of acid to elute the lithium.

In one embodiment, an alternate phase is contacted with the ion exchange beads during on ore more of the steps of the process step. In some embodiments, the use of alternate phase speeds up the kinetics of ion exchange, enhances the forming of the ion exchange bed, controls liquid level height in one or more process tanks, or a combination thereof. In some embodiments, contact between the ion exchange beads and the alternate phase is maximized and made possible by the design of this ion exchange device.

In some embodiments, the alternate phase is a liquid or gas. In some embodiments, said alternate phase is a non-aqueous liquid. In some embodiments, the alternate phase is non-aqueous liquid. In some embodiments, the alternate phase is a non-aqueous solution. In some embodiments, the alternate phase is an organic liquid such as an alkane, alcohol, oil, bio-organic oil, ester, ether, hydrocarbon, or a combination thereof. In some embodiments, the alternate phase is butane, pentane, hexane, acetone, diethyl ether, butanol, or combinations thereof. In some embodiments, the alternate is a gas such as air, nitrogen, argon, or a combination thereof. In some embodiments, the alternate phase comprises a compressed or pressurized gas.

In some embodiments, the ion exchange beads are porous ion exchange beads with networks of pores that facilitate the transport into the ion exchange beads of solutions that are pumped through an ion exchange column. Pore networks can be strategically controlled to provide fast and distributed access for the brine and acid solutions to penetrate into the ion exchange bead and deliver lithium and hydrogen to the ion exchange particles.

In some embodiments, the ion exchange beads are formed by mixing of ion exchange particles, a matrix material, and a filler material. These components are mixed and formed into a bead. Then, the filler material is removed from the ion exchange bead to leave behind pores. The filler material is dispersed in the ion exchange bead in such a way to leave behind a pore structure that enables transport of lithium and hydrogen with fast kinetics. This method may involve multiple ion exchange materials, multiple polymer materials, and multiple filler materials.

Another major challenge for lithium extraction using inorganic ion exchange materials is dissolution and degradation of the materials, especially during lithium elution in acid but also during lithium uptake in liquid resources. To yield a concentrated lithium solution from the ion exchange process, it is desirable to use a concentrated acid solution to elute the lithium. However, concentrated acid solutions dissolve and degrade inorganic ion exchange materials, which decreases the performance and lifespan of the materials. Therefore, the porous ion exchange beads may contain coated ion exchange particle for lithium extraction that are comprised of an ion exchange material and a coating material protecting the particle surface. The coating protects the ion exchange material from dissolution and degradation during lithium elution in acid, during lithium uptake from a liquid resource, and during other aspects of an ion exchange process. This coated particle enables the use of concentrated acids in the ion exchange process to yield concentrated lithium solutions.

In one aspect described herein, the ion exchange material is selected for high lithium absorption capacity, high selectivity for lithium in a liquid resource relative to other ions such as sodium and magnesium, strong lithium uptake in liquid resources including those with low concentrations of lithium, facile elution of lithium with a small excess of acid, and fast ionic diffusion. In one aspect described herein, a coating material is selected to protect the particle from dissolution and chemical degradation during lithium recovery in acid and also during lithium uptake in various liquid resources. In some embodiments, the coating material may also be selected to facilitate one or more of the following objectives: diffusion of lithium and hydrogen between the particles and the liquid resources, enabling adherence of the particles to a structural support, and suppressing structural and mechanical degradation of the particles.

When the porous ion exchange beads are used in an ion exchange column, the liquid resource containing lithium is pumped through the ion exchange column so that the ion exchange particles absorb lithium from the liquid resource while releasing hydrogen. After the ion exchange beads have absorbed lithium, an acid solution is pumped through the column so that the particles release lithium into the acid solution while absorbing hydrogen. The column may be operated in co-flow mode with the liquid resource and acid solution alternately flowing through the column in the same direction, or the column may be operated in counter-flow mode with a liquid resource and acid solution alternately flowing through the column in opposite directions. Between flows of the liquid resource and the acid solution, the column may be treated or washed with water or other solutions for purposes such as adjusting pH in the column or removing potential contaminants. The ion exchange beads may form a fixed or moving bed, and the moving bed may move in counter-current to the brine and acid flows. The ion exchange beads may be moved between multiple columns with moving beds where different columns are used for brine, acid, water, or other flows. Before or after the liquid resource flows through the column, the pH of the liquid may be adjusted with NaOH or other chemicals to facilitate the ion exchange reaction as well as handling or disposal of the spent liquid resource. Before or after the liquid resource flows through the column, the liquid resource may be subjected to other processes including other ion exchange processes, solvent extraction, evaporation, chemical treatment, or precipitation to remove lithium, to remove other chemical species, or to otherwise treat the brine.

When the ion exchange particles are treated with acid, a lithium solution is produced. This lithium solution may be further processed to produce lithium chemicals. These lithium chemicals may be supplied for an industrial application.

In some embodiments, an ion exchange material is selected from the following list: an oxide, a phosphate, an oxyfluoride, a fluorophosphate, or combinations thereof. In some embodiments, an ion exchange material is selected from the following list: Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, or combinations thereof. In some embodiments, an ion exchange material is selected from the following list: Li₄Mn₅O₁₂, Li₄Ti₅O₁₂, Li_{1.6}Mn_{1.6}O₄, Li₂MO₃ (M=Ti, Mn, Sn), LiFePO₄, solid solutions thereof, or combinations thereof.

In some embodiments, a coating material for protecting the surface of the ion exchange material is selected from the following list: a carbide, a nitride, an oxide, a phosphate, a fluoride, a polymer, carbon, a carbonaceous material, or combinations thereof. In some embodiments, a coating material is selected from the following list: TiO₂, ZrO₂, MoO₂, SnO₂, Nb₂O₅, Ta₂O₅, SiO₂, Li₂TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, Mo₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, or combinations thereof. In some embodiments, a coating material is selected from the following list: TiO₂, ZrO₂, MoO₂, SiO₂, Li₂TiO₃, Li₂ZrO₃, Li₂SiO₃, Li₂MnO₃, LiNbO₃, AlF₃, SiC, Si₃N₄, graphitic carbon, amorphous carbon, diamond-like carbon, or combinations thereof.

In some embodiments, the ion exchange particles may have an average diameter that is selected from the following list: less than 10 nm, less than 100 nm, less than 1,000 nm, less than 10,000 nm, or less than 100,000 nm. In some embodiments, the ion exchange particles may have an average size that is selected from the following list: less than 200 nm, less than 2,000 nm, or less than 20,000 nm.

In some embodiments, the ion exchange particles may be secondary particles comprised of smaller primary particles that may have an average diameter selected from the following list: less than 10 nm, less than 100 nm, less than 1,000 nm, or less than 10,000 nm.

In some embodiments, the ion exchange particles have a coating material with a thickness selected from the following list: less than 1 nm, less than 10 nm, less than 100 nm, or less than 1,000 nm. In some embodiments, the coating material has a thickness selected from the following list: less than 1 nm, less than 10 nm, or less than 100 nm.

In some embodiments, the ion exchange material and a coating material may form one or more concentration gradients where the chemical composition of the particle ranges between two or more compositions. In some embodiments, the ion exchange materials and the coating materials may form a concentration gradient that extends over a thickness selected from the following list: less than 1 nm, less than 10 nm, less than 100 nm, less than 1,000 nm, less than 10,000 nm, or less than 100,000 nm.

In some embodiments, the ion exchange material is synthesized by a method selected from the following list: hydrothermal, solvothermal, sol-gel, solid state, molten salt flux, ion exchange, microwave, ball milling, precipitation, or vapor deposition. In some embodiments, the ion exchange material is synthesized by a method selected from the following list: hydrothermal, solid state, or microwave.

In some embodiments, a coating material is deposited by a method selected from the following list: chemical vapor deposition, atomic layer deposition, physical vapor deposition, hydrothermal, solvothermal, sol-gel, solid state, molten salt flux, ion exchange, microwave, wet impregnation, precipitation, titration, aging, ball milling, or combinations thereof. In some embodiments, the coating material is deposited by a method selected from the following list: chemical vapor deposition, hydrothermal, titration, solvothermal, wet impregnation, sol-gel, precipitation, microwave, or combinations thereof.

In some embodiments, a coating material is deposited with physical characteristics selected from the following list: crystalline, amorphous, full coverage, partial coverage, uniform, non-uniform, or combinations thereof.

In some embodiments, multiple coatings may be deposited on the ion exchange material in an arrangement selected from the following list: concentric, patchwork, or combinations thereof.

In some embodiments, the matrix material is selected from the following list: a polymer, an oxide, a phosphate, or combinations thereof. In some embodiments, a structural support is selected from the following list: polyvinyl fluoride, polyvinylidene difluoride, polyvinyl chloride, polyvinylidene dichloride, polyethylene, polypropylene, polyphenylene sulfide, polytetrafluoroethylene, polytetrofluoroethylene, sulfonated polytetrofluoroethylene, polystyrene, polydivinylbenzene, polybutadiene, sulfonated polymer, carboxylated polymer, Nafion, copolymers thereof, and combinations thereof. In some embodiments, a structural support is selected from the following list: polyvinylidene difluoride, polyvinyl chloride, sulfonated polytetrofluoroethylene, polystyrene, polydivinylbenzene, copolymers thereof, or combinations thereof. In some embodiments, a structural support is selected from the following list: titanium dioxide, zirconium dioxide, silicon dioxide, solid solutions thereof, or combinations thereof. In some embodiments, the matrix material is selected for thermal resistance, acid resistance, and/or other chemical resistance.

In some embodiments, the porous ion exchange bead is formed by mixing the ion exchange particles, the matrix material, and the filler material together at once. In some embodiments, the porous ion exchange bead is formed by first mixing the ion exchange particles and the matrix material, and then mixing with the filler material. In some embodiments, the porous ion exchange bead is formed by first mixing the ion exchange particles and the filler material, and then mixing with the matrix material. In some embodiments, the porous ion exchange bead is formed by first mixing the matrix material and the filler material, and then mixing with the ion exchange particles.

In some embodiments, the porous ion exchange bead is formed by mixing the ion exchange particles, the matrix material, and/or the filler material with a solvent that dissolves once or more of the components. In some embodiments, the porous ion exchange bead is formed by mixing the ion exchange particles, the matrix material, and/or the filler material as dry powders in a mixer or ball mill. In some embodiments, the porous ion exchange bead is formed by mixing the ion exchange particles, the matrix material, and/or the filler material in a spray drier.

In some embodiments, the matrix material is a polymer that is dissolved and mixed with the ion exchange particles and/or filler material using a solvent from the following list: n-methyl-2-pyrrolidone, dimethyl sulfoxide, tetrahydrofuran, dimethylformamide, dimethylacetamide, methyl ethyl ketone, or combinations thereof. In some embodiments, the filler material is a salt that is dissolved and mixed with the ion exchange particles and/or matrix material using a solvent from the following list: water, ethanol, iso-propyl alcohol, acetone, or combinations thereof.

In some embodiments, the filler material is a salt that is dissolved out of the ion exchange bead to form pores using a solution selected from the following list: water, ethanol, iso-propyl alcohol, a surfactant mixture, an acid a base, or combinations thereof. In some embodiments, the filler material is a material that thermally decomposes to form a gas at high temperature so that the gas can leave the ion exchange bead to form pores, where the gas is selected from the following list: water vapor, oxygen, nitrogen, chlorine, carbon dioxide, nitrogen oxides, organic vapors, or combinations thereof.

In some embodiments, the porous ion exchange bead is formed from dry powder using a mechanical press, a pellet press, a tablet press, a pill press, a rotary press, or combinations thereof. In some embodiments, the porous ion exchange bead is formed from a solvent slurry by dripping the slurry into a different liquid solution. The solvent slurry may be formed using a solvent of n-methyl-2-pyrrolidone, dimethyl sulfoxide, tetrahydrofuran, dimethylformamide, dimethylacetamide, methyl ethyl ketone, or combinations thereof. The different liquid solution may be formed using water, ethanol, iso-propyl alcohol, acetone, or combinations thereof.

In some embodiments, the porous ion exchange bead is approximately spherical with an average diameter selected from the following list: less than 10 μm, less than 100 μm, less than 1 mm, less than 1 cm, or less than 10 cm. In some embodiments, the porous ion exchange bead is approximately spherical with an average diameter selected from the following list: less than 200 μm, less than 2 mm, or less than 20 mm.

In some embodiments, the porous ion exchange bead is tablet-shaped with a diameter of less than 1 mm, less than 2 mm, less than 4 mm, less than 8 mm, or less than 20 mm and with a height of less than 1 mm, less than 2 mm, less than 4 mm, less than 8 mm, or less than 20 mm.

In some embodiments, the porous ion exchange bead is embedded in a support structure, which may be a membrane, a spiral-wound membrane, a hollow fiber membrane, or a mesh. In some embodiments, the porous ion exchange bead is embedded on a support structure comprised of a polymer, a ceramic, or combinations thereof. In some embodiments, the porous ion exchange bead is loaded directly into an ion exchange column with no additional support structure.

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

In some embodiments, the acid used for recovering lithium from the porous ion exchange beads is selected from the following list: hydrochloric acid, sulfuric acid, phosphoric acid, hydrobromic acid, chloric acid, perchloric acid, nitric acid, formic acid, acetic acid, or combinations thereof. In some embodiments, the acid used for recovering lithium from the porous ion exchange beads is selected from the following list: hydrochloric acid, sulfuric acid, nitric acid, or combinations thereof.

In some embodiments, the acid used for recovering lithium from the porous ion exchange beads has a concentration selected from the following list: less than 0.1 M, less than 1.0 M, less than 5 M, less than 10 M, or combinations thereof.

In some embodiments, the porous ion exchange beads perform the ion exchange reaction repeatedly over a number of cycles selected from the following list: greater than 10 cycles, greater than 30 cycles, greater than 100 cycles, greater than 300 cycles, or greater than 1,000 cycles. In some embodiments, the porousion exchange beads perform the ion exchange reaction repeatedly over a number of cycles selected from the following list: greater than 50 cycles, greater than 100 cycles, or greater than 200 cycles.

In some embodiments, the concentrated lithium solution that is yielded from the porous ion exchange beads is further processed into lithium raw materials using methods selected from the following list: solvent extraction, ion exchange, chemical precipitation, electrodialysis, electrowinning, evaporation with direct solar energy, evaporation with concentrated solar energy, evaporation with a heat transfer medium heated by concentrated solar energy, evaporation with heat from a geothermal brine, evaporation with heat from combustion, or combinations thereof.

In some embodiments, the concentrated lithium solution that is yielded from the porous ion exchange beads is further processed into lithium chemicals selected from the following list: lithium chloride, lithium carbonate, lithium hydroxide, lithium metal, lithium metal oxide, lithium metal phosphate, lithium sulfide, or combinations thereof. In some embodiments, the concentrated lithium solution that is yielded from the porous ion exchange beads is further processed into lithium chemicals that are solid, liquid, hydrated, or anhydrous.

In some embodiments, the lithium chemicals produced using the porous ion exchange beads are used in an industrial application selected from the following list: lithium batteries, metal alloys, glass, grease, or combinations thereof. In some embodiments, the lithium chemicals produced using the coated ion exchange particles are used in an application selected from the following list: lithium batteries, lithium-ion batteries, lithium sulfur batteries, lithium solid-state batteries, and combinations thereof.

In some embodiments, the ion exchange materials are synthesized in a lithiated state with a sublattice fully or partly occupied by lithium. In some embodiments, the ion exchange materials are synthesized in a hydrated state with a sublattice fully or partly occupied by hydrogen.

### Base and Acid Generation

In one embodiment of this disclosure, acid and base are generated using an electrochemical cell. In one embodiment, acid and base are generated using electrodes. In one embodiment, acid and base are generated using a membrane. In some embodiments, the acid and base generated using an electrochemical cell are used in a process or system for lithium extraction from a liquid resource. In some embodiments, a lithium ion exchange eluate solution comprises acid and/or base generated using an electrochemical cell. In some embodiments, a synthetic lithium solution (e.g., before one or more transition metal species are removed therefrom, after one or more transition metal species are removed therefrom) is fed into an electrochemical cell wherein acid and base are generated therefrom.

In one embodiment, said ion-conducting membrane is a cation-conducting membrane, an anion-conducting membrane or combinations thereof. In one embodiment, said ion-conducting membrane comprises sulfonated tetrafluoroethylene-based fluoropolymer-copolymer, sulfonated tetrafluoroethylene, sulfonated fluoropolymer, MK-40, co-polymers, or combinations thereof. In one embodiment, said anion-conducting membrane comprises a functionalized polymer structure.

In one embodiment, said functionalized polymer structure comprises polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment, said cation-conducting membrane allows for transfer of lithium ions but prevents transfer of anion groups. In one embodiment, said ion-conducting membrane has a thickness from about 1 μm to about 1000 μm. In one embodiment, said ion-conducting membrane has a thickness from about 1 mm to about 10 mm.

In one embodiment, said electrodes are comprised of titanium, niobium, zirconium, tantalum, magnesium, titanium dioxide, oxides thereof, or combinations thereof. In one embodiment, said electrodes further comprise a coating of platinum, TiO₂, ZrO₂, Nb₂O₅, Ta₂O₅, SnO₂, IrO₂, RuO₂, mixed metal oxides, graphene, derivatives thereof, or combinations thereof.

In one embodiment of an integrated system, a chlor-alkali setup is used to generate HCl and NaOH from an aqueous NaCl solution. In one embodiment, the HCl is used to elute lithium from an ion exchange system for selective lithium uptake to produce a lithium eluate solution. In one embodiment, the NaOH from the chlor-alkali setup is used to control the pH of the brine in the ion exchange system for selective lithium uptake. In one embodiment, the NaOH is used to precipitate impurities from a lithium eluate solution.

In one embodiment, the system includes one or more electrochemical or electrolysis systems. The terms “electrochemical” and “electrolysis” are used interchangeably in the present specification and these terms are synonymous unless specifically noted to the contrary. In one embodiment, an electrolysis system is comprised of one or more electrochemical cells. In one embodiment, an electrochemical system is used to produce HCl and NaOH. In one embodiment, an electrochemical system converts a salt solution into acid in base. In one embodiment, an electrochemical system converts a salt solution containing NaCl, KCl, and/or other chlorides into a base and an acid. In one embodiment, a salt solution precipitated or recovered from the brine is fed into an electrochemical system to produce acid and base. In one embodiment, an electrolysis system converts a lithium salt solution to form a lithium hydroxide solution, an acidified solution, and optionally a dilute lithium salt solution. In one embodiment, the lithium salt solution is or is derived from a lithium eluate solution, produced by an ion exchange system that has optionally been concentrated and/or purified. In one embodiment, acidified solution from an electrolysis system is returned to an ion exchange system to elute more lithium eluate solution.

In one embodiment of the integrated system, the integrated system includes one or more electrolysis systems. In one embodiment, an electrolysis system is comprised of one or more electrodialysis cells. In one embodiment, an electrolysis system converts a lithium salt solution to form a lithium hydroxide solution, an acidified solution, and optionally a dilute lithium salt solution. In one embodiment, the lithium salt solution is or is derived from a lithium eluate solution, produced by an ion exchange system that has optionally been concentrated and/or purified. In one embodiment, acidified solution from an electrolysis system is returned to an ion exchange system to elute more lithium eluate solution.

In one embodiment, a lithium salt solution contains unreacted acid from the ion exchange system. In one embodiment, unreacted acid in the lithium salt solution from an ion exchange system passes through an electrolysis system and is further acidified to form an acidified solution. In one embodiment, a lithium salt solution derived from an ion exchange system is purified to remove impurities without neutralizing the unreacted acid in the lithium salt solution and is then fed into an electrolysis system.

In one embodiment, an acidified solution produced by an electrolysis system contains lithium ions from the lithium salt solution fed into the electrolysis system. In one embodiment, an acidified solution containing lithium ions leaves the electrolysis system and is fed back to an ion exchange system to elute lithium and produce more lithium salt solution.

In one embodiment of an electrolysis system, the electrolysis cells are electrochemical cells. In one embodiment of a electrochemical cell, the membranes may be cation-conducting and/or anion-conducting membranes. In one embodiment, the electrochemical cell is a two-compartment cell with a cation-conducting membrane that allows for transfer of lithium ions between the chambers but prevents transfer of anion groups such as chloride, sulfate, and hydroxide groups.

In one embodiment of an electrolysis system, the electrolysis cells are electrodialysis cells. In one embodiment of a electrodialysis cell, the membranes may be cation-conducting and/or anion-conducting membranes. In one embodiment, the electrodialysis cell is a two-compartment cell with a cation-conducting membrane that allows for transfer of lithium ions between the chambers but prevents transfer of anion groups such as chloride, sulfate, and hydroxide groups.

In one embodiment of an electrolysis system, the electrolysis cells are membrane electrolysis cells. In one embodiment of a membrane electrolysis cell, the membranes may be cation-conducting and/or anion-conducting membranes. In one embodiment, the membrane electrolysis cell is a two-compartment cell with a cation-conducting membrane that allows for transfer of lithium ions between the chambers but prevents transfer of anion groups such as chloride, sulfate, and hydroxide groups.

In one embodiment, the membrane electrolysis cell is a three-compartment cell with a cation-conducting membrane that allows for transfer of lithium ions separating a compartment with an electrochemically reducing electrode from a central compartment and with an anion-conducting membrane that allows for transfer of anions ions separating a compartment with an electrochemically oxidizing electrode from the central compartment. In one embodiment, the cation-conducting membrane prevents transfer of anions such as chloride, sulfate, or hydroxide. In one embodiment, the anion-conducting membrane prevents transfer of cations such as lithium, sodium, or protons.

In one embodiment of the membrane electrolysis cell, the membranes may be comprised of Nafion®, sulfonated tetrafluoroethylene, sulfonated fluoropolymer, MK-40, co-polymers, other membrane materials, composites, or combinations thereof. In one embodiment of the membrane electrolysis cell, the cation exchange membranes are comprised of a functionalized polymer structure which may be Nafion®, sulfonated tetrafluoroethylene, sulfonated fluoropolymer, co-polymers, different polymers, composites of polymers, or combinations thereof. In one embodiment of the membrane electrolysis cell, the polymer structures of the cation exchange membrane are functionalized with sulfone groups, carboxylic acid groups, phosphate groups, other negatively charged functional groups, or combinations thereof.

In one embodiment of the electrochemical cell, the membranes may be comprised of Nafion®, sulfonated tetrafluoroethylene, sulfonated fluoropolymer, MK-40, co-polymers, other membrane materials, composites, or combinations thereof. In one embodiment of the electrochemical cell, the cation exchange membranes are comprised of a functionalized polymer structure which may be Nafion®, sulfonated tetrafluoroethylene, sulfonated fluoropolymer, co-polymers, different polymers, composites of polymers, or combinations thereof. In one embodiment of the electrochemical cell, the polymer structures of the cation exchange membrane are functionalized with sulfone groups, carboxylic acid groups, phosphate groups, other negatively charged functional groups, or combinations thereof.

In one embodiment of the electrodialysis cell, the membranes may be comprised of Nafion®, sulfonated tetrafluoroethylene, sulfonated fluoropolymer, MK-40, co-polymers, other membrane materials, composites, or combinations thereof. In one embodiment of the electrodialysis cell, the cation exchange membranes are comprised of a functionalized polymer structure which may be Nafion®, sulfonated tetrafluoroethylene, sulfonated fluoropolymer, co-polymers, different polymers, composites of polymers, or combinations thereof. In one embodiment of the electrodialysis cell, the polymer structures of the cation exchange membrane are functionalized with sulfone groups, carboxylic acid groups, phosphate groups, other negatively charged functional groups, or combinations thereof.

In one embodiment of the membrane electrolysis cell, an anion exchange membrane is comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the electrochemical cell, an anion exchange membrane is comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the electrodialysis cell, an anion exchange membrane is comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the membrane electrolysis cell, the membrane may have a thickness of less than 10 μm, less than 50 μm, less than 200 μm, less than 400 μm, or less than 1,000 μm. In one embodiment of the membrane electrolysis cell, the membranes may have a thickness of greater than 1,000 μm. In one embodiment of the membrane electrolysis cell, the membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment of the electrochemical cell, the membrane may have a thickness of less than 10 μm, less than 50 μm, less than 200 μm, less than 400 μm, or less than 1,000 μm. In one embodiment of the electrochemical cell, the membranes may have a thickness of greater than 1,000 μm. In one embodiment of the electrochemical cell, the membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment of the electrodialysis cell, the membrane may have a thickness of less than 10 μm, less than 50 μm, less than 200 μm, less than 400 μm, or less than 1,000 μm. In one embodiment of the electrodialysis cell, the membranes may have a thickness of greater than 1,000 μm. In one embodiment of the electrodialysis cell, the membrane may have a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment, an electrolysis system contains electrolysis cells that may be two-compartment electrolysis cells or three-compartment electrolysis cells.

In one embodiment of a two-compartment electrolysis cell, the cell contains a first compartment that contains an electrochemically oxidizing electrode. A lithium salt solution enters the first compartment and is converted into an acidified solution. In one embodiment of a two-compartment electrolysis cell, the cell contains a second compartment containing an electrochemically reducing electrode. This second compartment takes as an input a water or dilute LiOH solution, and produces as an output a more concentrated LiOH solution. In one embodiment, the compartments are separated by a cation-conducting membrane that limits transport of anions.

In one embodiment of a three-compartment electrolysis cell, the cell contains a first compartment containing an electrochemically oxidizing electrode. The first compartment takes as an input water or a dilute salt solution, and produces as an output an acidified solution. In one embodiment of a three-compartment electrolysis cell, the cell contains a second compartment containing an electrochemically reducing electrode. This second compartment takes as an input a water or dilute hydroxide solution, and produces as an output a more concentrated hydroxide solution. In one embodiment of a three-compartment electrolysis cell, the cell contains a third compartment containing no electrode, which is located between the first and second compartment, and takes as an input a concentrated lithium salt solution, and produces as an output a dilute lithium salt solution. In one embodiment, the first and the third compartments are separated by an anion-conducting membrane that limits transport of cations. In one embodiment, the second and the third compartments are separated by a cation-conducting membrane that limits transport of anions.

In one embodiment of the electrolysis cell, the electrodes may be comprised of titanium, niobium, zirconium, tantalum, magnesium, titanium dioxide, oxides thereof, or combinations thereof. In one embodiment of the electrolysis cell, the electrodes may be coated with platinum, TiO₂, ZrO₂, Nb₂O₅, Ta₂O₅, SnO₂, IrO₂, RuO₂, PtOₓ, mixed metal oxides, graphene, derivatives thereof, or combinations thereof. In one embodiment of the electrolysis cell, the electrodes may be comprised of steel, stainless steel, nickel, nickel alloys, steel alloys, or graphite.

In one embodiment of the electrolysis system, the lithium salt solution is a LiCl solution optionally containing HCl. In one embodiment of the electrolysis system, the electrochemically oxidizing electrode oxides chloride ions to produce chlorine gas.

In one embodiment of the electrolysis system, the lithium salt solution is a Li₂SO₄ solution optionally containing H₂SO₄. In one embodiment of the electrolysis system, the electrochemically oxidizing electrode oxidizes water, hydroxide, or other species to produce oxygen gas.

In one embodiment of the electrolysis system, the electrochemically reducing electrode reduces hydrogen ions to produce hydrogen gas. In one embodiment of the electrolysis system, the chamber containing the electrochemically reducing electrode produces a hydroxide solution or increases the hydroxide concentration of a solution.

In one embodiment of the electrolysis system, chlorine and hydrogen gas are burned to produce HCl in an HCl burner. In one embodiment, the HCl burner is a column maintained at approximately 100-300 or 300-2,000 degrees Celsius. In one embodiment, HCl produced in the HCl burner is cooled through a heat exchange and absorbed into water in an absorption tower to produce aqueous HCl solution. In one embodiment, the HCl solution produced from the HCl burner is used to elute lithium from an ion exchange system.

In one embodiment, the pH of the acidified solution leaving the electrolysis cell may be 0 to 1, −2 to 0, 1 to 2, less than 2, less than 1, or less than 0. In some embodiments, the membrane electrolysis cell is an electrodialysis cell with multiple compartments. In some embodiments, the electrodialysis cell may have more than about two, more than about five, more than about 10, or more than about twenty compartments.

In one embodiment, the base added to precipitate metals from the liquid resource may be calcium hydroxide or sodium hydroxide. In one embodiment, the base may be added to the liquid resource as an aqueous solution with a base concentration that may be less than 1 N, 1-2 N, 2-4 N, 4-10 N, 10-20 N, or 20-40 N. In one embodiment, the base may be added to the liquid resource as a solid.

In one embodiment, the acid may be added to the precipitated metals to dissolve the precipitated metals before mixing the redissolved metals with the liquid resource. In one embodiment, the acid may be added to the liquid resource to acidify the liquid resource, and the precipitated metals may be combined with the acidified liquid resource to redissolve the precipitated metals.

In some embodiments, acid from the electrochemical cell may be used to elute lithium from the selective ion exchange material. In some embodiments, base from the electrochemical cell may be used to neutralize protons released from the selective ion exchange material.

Lithium Production with Volatile Acid

An aspect of the disclosure described herein is lithium production plant. This lithium production plant functions to contact a liquid resource with ion exchange particles so that the ion exchange particles can uptake lithium from the liquid resource, separate the ion exchange particles from the liquid resource, wash the particles with aqueous solution, separate the ion exchange particles from the aqueous solution, elute lithium out of the particles using an acid solution, and yield a lithium salt. The plant uses heat to decompose the lithium salt to regenerate the acid a yield a lithium base such as lithium oxide, lithium hydroxide, or lithium carbonate. In some cases, the ion exchange particles are ion exchange beads, ion exchange material, coated ion exchange particles, porous ion exchange material, or other material capable of absorbing lithium from a liquid resource.

An aspect of the disclosure described herein is lithium production plant. This lithium production plant functions to contact a liquid resource with ion exchange particles so that the ion exchange particles can uptake lithium from the liquid resource, separate the ion exchange particles from the liquid resource, wash the particles with aqueous solution, separate the ion exchange particles from the aqueous solution, elute lithium out of the particles using a nitric acid solution, and yield lithium nitrate. The plant uses heat to decompose the lithium nitrate into lithium oxide and nitrogen oxide gas which can be recaptured to reform the nitric acid solution. The lithium oxide can optionally be processed into lithium hydroxide by addition of water, or into lithium carbonate by addition of water and carbonate dioxide or sodium carbonate. In some cases, the ion exchange particles are ion exchange beads, ion exchange material, coated ion exchange particles, porous ion exchange material, or other material capable of absorbing lithium from a liquid resource.

An aspect of the disclosure described herein is lithium production plant. This lithium production plant functions to contact a liquid resource with ion exchange particles so that the ion exchange particles can uptake lithium from the liquid resource, separate the ion exchange particles from the liquid resource, wash the particles with aqueous solution, separate the ion exchange particles from the aqueous solution, elute lithium out of the particles using a sulfuric acid solution, and yield lithium sulfate. The plant uses heat to decompose the lithium sulfate into lithium oxide and sulfur oxide gas which can be recaptured to reform the sulfuric acid solution. In some embodiments, the sulfur oxide gas comprises sulfur trioxide, sulfur dioxide, sulfur monoxide, oxygen, or combinations thereof. The lithium oxide can optionally be processed into lithium hydroxide by addition of water, or into lithium carbonate by addition of water and carbonate dioxide or sodium carbonate. In some cases, the ion exchange particles are ion exchange beads, ion exchange material, coated ion exchange particles, porous ion exchange material, or other material capable of absorbing lithium from a liquid resource.

An aspect of the disclosure described herein is lithium production plant. This lithium production plant functions to contact a liquid resource with ion exchange particles so that the ion exchange particles can uptake lithium from the liquid resource, separate the ion exchange particles from the liquid resource, wash the particles with aqueous solution, separate the ion exchange particles from the aqueous solution, elute lithium out of the particles using a nitric acid solution, and yield lithium nitrate solution. The plant combines the lithium nitrate solution with sulfuric acid and then heats the mixture to distill off nitric acid which can be recaptured to reform the nitric acid solution while yielding lithium sulfate. The lithium sulfate can optionally be in an aqueous, solid, or molten salt form. The lithium sulfate is optionally processed into lithium hydroxide by addition of sodium hydroxide followed by crystallization of lithium hydroxide. The lithium sulfate is optionally processed into lithium carbonate by addition of sodium carbonate to precipitate lithium carbonate. In some cases, the ion exchange particles are ion exchange beads, ion exchange material, coated ion exchange particles, porous ion exchange material, or other material capable of absorbing lithium from a liquid resource.

An aspect of the disclosure described herein is lithium production plant. This lithium production plant functions to contact a liquid resource with ion exchange particles so that the ion exchange particles can uptake lithium from the liquid resource, separate the ion exchange particles from the liquid resource, wash the particles with aqueous solution, separate the ion exchange particles from the aqueous solution, elute lithium out of the particles using a hydrochloric acid solution, and yield lithium chloride solution. The plant combines the lithium chloride solution with sulfuric acid and then heats the mixture to distill off hydrochloric acid which can be recaptured to reform the hydrochloric acid solution while yielding lithium sulfate. The lithium sulfate can optionally be in an aqueous, solid, or molten salt form. The lithium sulfate is optionally processed into lithium hydroxide by addition of sodium hydroxide followed by crystallization of lithium hydroxide. The lithium sulfate is optionally processed into lithium carbonate by addition of sodium carbonate to precipitate lithium carbonate. In some cases, the ion exchange particles are ion exchange beads, ion exchange material, coated ion exchange particles, porous ion exchange material, or other material capable of absorbing lithium from a liquid resource.

In some embodiments, the lithium sulfate is processed with an electrochemical cell to produce lithium hydroxide and sulfuric acid. In some embodiments, the lithium sulfate is processed with a membrane cell to produce lithium hydroxide and sulfuric acid. In some embodiments, the lithium sulfate is processed via electrochemical cell to produce lithium hydroxide and sulfuric acid which is reused to mix with a lithium salt and distill off a volatile acid. In some embodiments, the lithium sulfate is processed via electrochemical cell to produce lithium hydroxide and sulfuric acid which is returned to the ion exchange unit for elution of lithium.

In some embodiments, a mixture of a lithium salt and sulfuric acid is spray dried to produce a lithium sulfate solid while evaporating off a volatile acid or a mixture of volatile acids. In some embodiments, a mixture of a lithium salt and sulfuric acid is spray dried to produce a mixture of lithium sulfate and sulfuric acid while evaporating off a volatile acid or a mixture of volatile acids. In some embodiments, a mixture of a lithium salt and sulfuric acid is spray dried to produce a slurry of lithium sulfate and sulfuric acid while evaporating off a volatile acid or a mixture of volatile acids. In some embodiments, a mixture of a lithium salt and sulfuric acid is spray dried to produce a slurry of lithium sulfate while evaporating off a volatile acid or a mixture of volatile acids. In some embodiments, the volatile acids are condensed and used to elute lithium from an ion exchange material. In some embodiments, a mixture of lithium chloride and sulfuric acid is spray dried to produce a lithium sulfate solid while evaporating off hydrochloric acid. In some embodiments, a mixture of lithium nitrate and sulfuric acid is spray dried to produce a lithium sulfate solid while evaporating off nitric acid. In some embodiments, a mixture of lithium salt and acid is spray dried using a spray dryer. In some embodiments, a mixture of lithium salt and acid is heated using a spray, dryer, rotary kiln, or other heating device.

In some embodiments, a mixture of lithium salt and acid is heated under pressure or under vacuum. In some embodiments, a mixture of lithium salt and acid is heated under pressure or under vacuum to produce a volatile gas that is condensed under pressure or under vacuum. In some embodiments, a mixture of lithium salt and acid is heated under under vacuum to produce a volatile gas that is condensed under pressure. In some embodiments, a mixture of lithium salt and acid is heated to remove a volatile acid at a pressure of about 0.001 to about 0.01 atm, about 0.01 to about 0.1 atm, about 0.1 to about 1.0 atm, about 1.0 to about 10 atm, about 10 to about 100 atm, or combinations thereof. In some embodiments, a mixture of lithium salt and acid is heated to evaporate or distill off a volatile acid that is condensed at a pressure of about 0.001 to about 0.01 atm, about 0.01 to about 0.1 atm, about 0.1 to about 1.0 atm, about 1.0 to about 10 atm, about 10 to about 100 atm, about 100 atm to about 1,000 atm, or combinations thereof. In some embodiments, a mixture of lithium salt and acid is heated to remove a volatile acid at a temperature of about 0 degrees Celsius to about 50 degrees Celsius, about 50 degrees Celsius to about 100 degrees Celsius, about 100 degrees Celsius to about 150 degrees Celsius, about 150 degrees Celsius to about 200 degrees Celsius, about 200 degrees Celsius to about 300 degrees Celsius, about 300 degrees Celsius to about 500 degrees Celsius, or about 500 degrees Celsius to about 1,000 degrees Celsius. In some embodiments, a mixture of lithium salt and acid is heated to evaporate or distill off a volatile acid that is condensed at a temperature of about −100 degrees Celsius to about −50 degrees Celsius, −50 degrees Celsius to about 0 degrees Celsius, 0 degrees Celsius to about 50 degrees Celsius, about 50 degrees Celsius to about 100 degrees Celsius, about 100 degrees Celsius to about 150 degrees Celsius, about 150 degrees Celsius to about 200 degrees Celsius, about 200 degrees Celsius to about 300 degrees Celsius, about 300 degrees Celsius to about 500 degrees Celsius.

An aspect of the disclosure described herein is lithium production plant. This lithium production plant functions to contact a liquid resource with ion exchange particles so that the ion exchange particles can uptake lithium from the liquid resource, separate the ion exchange particles from the liquid resource, wash the particles with aqueous solution, separate the ion exchange particles from the aqueous solution, elute lithium out of the particles using a nitric acid solution, and yield lithium nitrate. The plant optionally combines the lithium nitrate with sodium hydroxide to crystallize lithium hydroxide. The plant optionally combines the lithium nitrate with sodium carbonate to crystallize lithium carbonate. The plant optionally produces a sodium nitrate byproduct for use in agricultural fertilizer or other applications. In some cases, the ion exchange particles are ion exchange beads, ion exchange material, coated ion exchange particles, porousion exchange material, or other material capable of absorbing lithium from a liquid resource.

An aspect of the disclosure described herein is lithium production plant. This lithium production plant functions to contact a liquid resource with ion exchange particles so that the ion exchange particles can uptake lithium from the liquid resource, separate the ion exchange particles from the liquid resource, wash the particles with aqueous solution, separate the ion exchange particles from the aqueous solution, elute lithium out of the particles using a nitric acid solution, and yield lithium nitrate. The plant optionally combines the lithium nitrate with calcium hydroxide to crystallize lithium hydroxide. The plant optionally produces a calcium nitrate byproduct for use in agricultural fertilizer or other applications. In some cases, the ion exchange particles are ion exchange beads, ion exchange material, coated ion exchange particles, porous ion exchange material, or other material capable of absorbing lithium from a liquid resource.

An aspect of the disclosure described herein is a method for lithium production using the lithium production plants described above.

In some embodiments, nitric acid is used to elute lithium from ion exchange particles to produce a lithium nitrate eluate. In some embodiments, the lithium nitrate eluate is concentrated and then heated to produce a lithium nitrate molten salt. In some embodiments, the lithium nitrate molten salt is heated above its decomposition temperature to convert the lithium nitrate into lithium oxide and nitrogen oxide gas. In some embodiments, the nitrogen oxide gas is a mixture of nitrogen monoxide, nitrogen dioxide, oxygen, and/or other nitrogen oxide gases. In some embodiments, the lithium nitrate is heated in the presence of a catalyst to aid nitrate decomposition. In some embodiments, the nitrogen oxide gas is absorbed into an aqueous solution to form nitric acid which can be reused to elute the ion exchange particles. In some embodiments, the lithium oxide is reacted with water to form lithium hydroxide. In some embodiments, the lithium is purified to remove sodium, magnesium, calcium, boron, transition metals, or other impurities before or after the nitrate is decomposed into nitrogen oxide gas.

In some embodiments, nitric acid is used to elute lithium from ion exchange particles to produce a lithium nitrate eluate. In some embodiments, the lithium nitrate eluate is mixed with sulfuric acid. In some embodiments, the mixture of lithium nitrate and sulfuric acid is heated to distill off nitric acid, which can be condensed and reused to elute lithium from the ion exchange particles. In some embodiments, the mixture of lithium nitrate and sulfuric acid is heated to distill off nitric acid leaving behind a lithium sulfate. In some embodiments, the lithium sulfate is in a solid form. In some embodiments, the lithium sulfate is combined with water to form an aqueous lithium sulfate solution. In some embodiments, the lithium sulfate is combined with sodium hydroxide to crystallize a lithium hydroxide product. In some embodiments, the lithium sulfate is combined with sodium hydroxide to crystallize a lithium hydroxide product. In some embodiments, this process yields a sodium sulfate byproduct.

In some embodiments, an acid selected from the list of HF, HCl, HBr, or HI is used to elute lithium from ion exchange particles to produce a lithium halide eluate. In some embodiments, the lithium halide eluate is mixed with sulfuric acid. In some embodiments, the mixture of lithium halide and sulfuric acid is heated to distill off HF, HCl, HBr, or HI acid, which can be condensed and reused to elute lithium from the ion exchange particles. In some embodiments, the mixture of lithium halide and sulfuric acid is heated to distill off acid leaving behind a lithium sulfate. In some embodiments, the lithium sulfate is in a solid form. In some embodiments, the lithium sulfate is combined with water to form an aqueous lithium sulfate solution. In some embodiments, the lithium sulfate is combined with sodium hydroxide to crystallize a lithium hydroxide product. In some embodiments, the lithium sulfate is combined with sodium hydroxide to crystallize a lithium hydroxide product. In some embodiments, this process yields a sodium sulfate byproduct.

In some embodiments, nitric acid is used to elute lithium from ion exchange particles to produce a lithium nitrate eluate. In some embodiments, the lithium nitrate eluate is mixed with sodium hydroxide to crystallize a lithium hydroxide product. In some embodiments, the lithium nitrate eluate is mixed with sodium carbonate to precipitate a lithium carbonate product. In some embodiments, the lithium nitrate eluate is mixed with calcium hydroxide to precipitate a lithium hydroxide product. In some embodiments, these processes yield a sodium nitrate or calcium nitrate byproduct that can be used in agricultural fertilizer or other applications.

In some embodiments, the lithium oxide is precipitated along with other oxides such as magnesium oxide, calcium oxide, or sodium oxide. In some embodiments, the lithium oxide contains impurities and is mixed with other to form lithium hydroxide with impurities. In some embodiments, the lithium oxide contains impurities and is mixed with other to form aqueous lithium hydroxide with impurities. In some embodiments, magnesium hydroxide and calcium hydroxide impurities can be removed from a lithium hydroxide solution through filtration.

In some embodiments, the lithium salts may be aqueous, solid, or molten. In some embodiments, the lithium salts may be hydrated. In some embodiments, the lithium hydroxide may be a lithium hydroxide monohydrate powder.

In some embodiments, a lithium salt is heated in a spray dryer to form lithium solids and a volatile acidic gas. In some embodiments, lithium nitrate is decomposed in a spray dryer to form lithium oxide solids and nitrogen oxide gases. In some embodiments, a mixture of lithium nitrate and sulfuric acid is heated in a spray dryer to form lithium sulfate solids and nitric acid gas. In some embodiments, a mixture of lithium chloride and sulfuric acid is heated in a spray dryer to form lithium sulfate solids and hydrochloric acid gas.

In some embodiments, a lithium salt is decomposed in a rotary kiln to form lithium solids and a volatile acidic gas. In some embodiments, lithium nitrate is decomposed in a rotary kiln to form lithium oxide solids and nitrogen oxide gases. In some embodiments, a mixture of lithium nitrate and sulfuric acid is heated in a rotary kiln to form lithium sulfate solids and nitric acid gas. In some embodiments, a mixture of lithium chloride and sulfuric acid is heated in a rotary kiln to form lithium sulfate solids and hydrochloric acid gas.

In some embodiments, lithium hydroxide is crystallized using a series of crystallizers to remove nitrate, sodium, calcium, or other impurities from the lithium hydroxide product.

In some embodiments, nitrate byproduct is converted into a calcium nitrate substance for use in agricultural fertilizer. In some embodiments, sodium nitrate byproduct is converted into a calcium nitrate substance for use in agricultural fertilizer. In some embodiments, nitrate byproduct is converted into an ammonium calcium nitrate substance for use in agricultural fertilizer.

In some cases, a lithium salt solution is produced from an ion exchange unit and impurities are removed from the lithium salt solution before or after distillation of acidic gases. In some cases, a lithium salt solution is produced from an ion exchange unit and impurities are removed from the lithium salt solution before or after concentration of the lithium salt solution. In some cases, impurities are removed from a lithium salt solution using precipitation of hydroxides, precipitation of carbonates, ion exchange resins, or solvent extraction.

In some embodiments, a lithium salt such as lithium nitrate or lithium sulfate is dried using a continuous forced circulation crystallizer, a continuous draft tube crystallizer, a continuous cooling crystallizer, a vacuum crystallizer, a batch scraped surface evaporator, a mechanical vapor recompression system, or combinations thereof.

In some embodiments, a lithium salt such as lithium nitrate or lithium sulfate is decomposed using a batch rotary kiln, a continuous rotary kiln, a knocking system, a kiln with internal agitation, a kiln with internal milling media, a kiln with an internal impeller, an electric kiln, a gas kiln, a continuous pusher furnace, a box furnace with ceramic saggars, a continuous pusher furnace firing through box furnace on ceramic saggars, a continuous conveyer furnace, an Inconel conveyer, an air dehumidification system, a nitrogen blanket system, a catalyst, or combinations thereof. In some embodiments, a lithium salt such as lithium nitrate or lithium sulfate is decomposed using a catalyst selected from the list of platinum, platinum on activated carbon, platinum on silica, transition metal oxide, iron oxide, nickel oxide, cobalt oxide, manganese oxide, iridium, iridium on silica, platinum-copper-aluminum on silica, platinum-zinc-aluminum on silica, or combinations thereof. In some embodiments, nitrates, sulfates, or combinations thereof are decomposed through combustion of hydrogen or a hydrocarbon. In some embodiments, nitrates, sulfates, or combinations thereof are decomposed using microwave energy.

In some embodiments, nitrogen oxide gas is absorbed into a liquid scrubbing solution in a packed bed scrubber, a venturi scrubber, an ejection venturi scrubber, a spray tower, cyclone scrubbers, with addition of hydrogen peroxide into the scrubbing solution, tray columns, or combinations thereof. In some embodiments, the scrubbing solution is water, nitric acid, hydrogen peroxide, oxygen, other oxidants, or combinations thereof.

In some embodiments, sulfur oxide gas is absorbed into a liquid scrubbing solution in a packed bed scrubber, a venturi scrubber, an ejection venturi scrubber, a spray tower, cyclone scrubbers, with addition of hydrogen peroxide into the scrubbing solution, tray columns, or combinations thereof. In some embodiments, the scrubbing solution is water, sulfuric acid, hydrogen peroxide, oxygen, other oxidants, or combinations thereof.

In some embodiments, lithium oxide is converted to lithium hydroxide by addition of water using a continuous stirred tank reactor, a batch stirred tank reactor, or a plug flow reactor.

In some embodiments, sulfuric acid is added to a lithium salt solution to a concentration of over 25 wt % sulfuric acid. In some embodiments, sulfuric acid is added to a lithium salt solution using a batch agitated tank, a continuous agitated mixing tank, an injection quill direct to piping, or combinations thereof.

In some embodiments, volatile acid is removed from a salt solution using fractional distillation, air gap membrane distillation, sulfate descaling chemicals, or combinations thereof.

In some embodiments, water is removed from a salt solution using geothermal energy. In some embodiments, acid is distilled from a salt solution using geothermal energy. In some embodiments, lithium nitrate is melted using geothermal energy. In some embodiments, acid is separated from an aqueous solution using membrane distillation. In some embodiments, acid is separated from an aqueous solution using membrane distillation at temperature of around 40-90 degrees Celsius. In some embodiments, acid is separated from an aqueous solution using flat sheet membranes, capillary membranes, or combinations thereof. In some embodiments, acid is separated from an aqueous solution using membranes comprised of PTFE, polypropylene, PVTMS, or combinations thereof.

In some embodiments, nitric acid is distilled at a temperature of around 100 degrees Celsius to 140 degrees Celsius.

In some embodiments, trace nitrate from the nitric acid elution remains entrained in the ion exchange media and contaminates the brine. In some embodiments, nitrate is removed from the brine using ion exchange, biological remediation, or other methods of nitrate removal. In some embodiments, nitrate is removed from aqueous solution using strong base anion exchange resins, quarternary amine, triethyl amine resin, tributyl amine resin, or combinations thereof. In some embodiments, a nitrate absorbing ion exchange resin is regenerated with hydroxide, chloride, or combinations thereof.

In some embodiments, the redox potential of the ion exchange particles is controlled to minimize degradation of the ion exchange particles. In some embodiments, the redox potential of the brine is controlled to minimize degradation of the ion exchange particles. In some embodiments, the redox potential of the wash water is controlled to minimize degradation of the ion exchange particles. In some embodiments, the redox potential of the acidic solution used for elution is controlled to minimize degradation of the ion exchange particles. In some embodiments, the ion exchange particles are treated with sodium hypochlorite, sodium bisulfate, hydrogen peroxide, reductant, oxidant, or combinations thereof to control the oxidation state of metals in the ion exchange particles. In some embodiments, the ion exchange particles are treated with sodium hypochlorite, sodium bisulfate, hydrogen peroxide, reductant, oxidant, or combinations thereof to limit dissolution of metals from the ion exchange particles.

In some embodiments, the oxidation reduction potential of the brine, acidic solution, and/or wash water are controlled to minimize degradation of the ion exchange particles using additives selected from the following list: ascorbic acid, sodium ascorbate, citric acid, sodium citrate, acetic acid, sodium acetate, ethylenediaminetetraacetic acid, tetrasodium ethylenediaminetetraacetate, hydrogen peroxide, hypochlorous acid, sodium hypochlorite, chlorous acid, sodium chlorite, chloric acid, sodium chlorate, perchloric acid, sodium perchlorate, sodium bisulfate, sodium persulfate, sodium percarbonate, peracetic acid, sodium peracetate, reductants, oxidants, or combinations thereof. In some embodiments, the oxidation reduction potential of the brine, acidic solution, and/or wash water are controlled to minimize degradation of the ion exchange particles via sparging with gases selected from the following list: nitrogen, argon, hydrogen, carbon monoxide, carbon dioxide, air, Cl₂, chlorine dioxide, O₂, O₃, oxidizing gases, reducing gases, or combinations thereof. In some embodiments, the ion exchange particles are treated with ascorbic acid, sodium ascorbate, citric acid, sodium citrate, acetic acid, sodium acetate, ethylenediaminetetraacetic acid, tetrasodium ethylenediaminetetraacetate, hydrogen peroxide, hypochlorous acid, sodium hypochlorite, chlorous acid, sodium chlorite, chloric acid, sodium chlorate, perchloric acid, sodium perchlorate, sodium bisulfate, sodium persulfate, sodium percarbonate, peracetic acid, sodium peracetate, reductants, oxidants, or combinations thereof to control the oxidation state of metals in the ion exchange particles. In some embodiments, the ion exchange particles are treated with ascorbic acid, sodium ascorbate, citric acid, sodium citrate, acetic acid, sodium acetate, ethylenediaminetetraacetic acid, tetrasodium ethylenediaminetetraacetate, hydrogen peroxide, hypochlorous acid, sodium hypochlorite, chlorous acid, sodium chlorite, chloric acid, sodium chlorate, perchloric acid, sodium perchlorate, sodium bisulfate, sodium persulfate, sodium percarbonate, peracetic acid, sodium peracetate, reductants, oxidants, or combinations thereof to limit dissolution of metals from the ion exchange particles.

In some embodiments, nitric acid is used to elute lithium from ion exchange particles to produce a lithium nitrate eluate. In some embodiments, the lithium nitrate eluate is combined with sodium carbonate to crystallize lithium carbonate. In some embodiments, the sodium nitrate byproduct is mixed with sulfuric acid. In some embodiments, the mixture of sodium nitrate and sulfuric acid is heated to distill off nitric acid, which can be condensed and reused to elute lithium from the ion exchange particles. In some embodiments, the mixture of sodium nitrate and sulfuric acid is heated to distill off nitric acid leaving behind a sodium bisulfate which can be used for pH adjustments. In some embodiments, the distillation happens at around 83 degrees Celsius, at around 80-90 degrees Celsius, at around 70-100 degrees Celsius, at around 75-80 degrees Celsius, or combinations thereof. In some embodiments, distillation produces a red fuming nitric acid. In some embodiments, the red fuming nitric acid is converted to the white nitric acid at around 20 to 30 kPa. In some embodiments, the red fuming nitric acid is converted to the white nitric acid at (1) 27 kPa and (2) room temperature subsequently, or concurrently to produce less NOx.

In some embodiments, a metal carbonate form selected from the list of Na, Mg, Ca is combined with sodium carbonate to crystallize lithium carbonate. In some embodiments, the metal nitrate byproduct is mixed with sulfuric acid. In some embodiments, the mixture of metal nitrate and sulfuric acid is heated to distill off nitric acid, which can be condensed and reused to elute lithium from the ion exchange particles. In some embodiments, the mixture of metal nitrate and sulfuric acid is heated to distill off nitric acid leaving behind a metal sulfate compound.

In some embodiments the distillation columns can be composed of seven to fifteen trays. In some embodiments the reboiler uses 30-150 psig saturated steam. In some embodiments, the condenser uses 300-305 K cooling water. In some embodiments the reboiler uses 10-400 psig saturated steam. In some embodiments, the condenser uses 280-330 K cooling water. In some embodiments the reboiler will operate at 200-280 K. In some embodiments, the trays will vary from 190-250 K or 150-350 K in operating temperature. In some embodiments the reflux ratio (L/D) will vary from 0.15 up to 0.85. In some embodiments the reflux ratio (L/D) will vary from 0.05 up to 3.0.

In some embodiments, the nitrate from the nitric acid elution remains entrained in the ion exchange media and contaminates the lithium depleted brine. To avoid environmental impacts, nitrates are removed from the lithium depleted brine to a concentration below about 50 mg/L prior to its release or disposal. In some embodiments, nitrate is removed from the brine via nitrate reduction or physical removal. In some embodiments, nitrate reduction methods include biological remediation or chemical denitrification. Both methods of nitrate reduction involve an electron donor reducing nitrate into nitrogen gas or ammonium via a series of redox intermediates. In some embodiments, bioremediation involves adding microorganisms capable of digesting nitrates to the lithium depleted brine. The microorganism uses enzymes to reduce nitrate into nitrogen gas or ammonium via a series of redox intermediates. In some embodiments, bioremediation is accomplished by the heterotrophic anaerobic bacterium Paracoccus denitrificans or the autotrophic aerobic Gram-negative bacterium Thiobacillus denitrificans. In some embodiments, bioremediation can occur in the form of woodchip bioreactors, electro-biochemical reactors, membrane bioreactors, or moving bed bioreactors.

Chemical remediation involves using an electron donor to reduce nitrate to nitrogen gas or ammonium via a series of redox intermediates. In some embodiments, the possible electron donors include aluminum, zinc, and iron metals, iron (ii), ammonia, hydrazine, glucose, and hydrogen in the presence of a catalyst. In some embodiments, acid is added to the lithium depleted brine to increase the reaction rate, as protons are consumed by nitrate reduction. In some embodiments, chemical nitrate reduction utilizes nanoremediation technology or permeable reactive barrier technology. In nanoremediation, nanoparticles of zerovalent metals are used reduce or adsorb nitrate from the brine. In permeable reactive barrier, the brine flows through a permeable container filled with electron donor material.

In some embodiments, the physical removal of nitrates includes ion exchange, reverse osmosis, electrodialysis, and distillation. Reverse osmosis removes salts indiscriminately using pressure through a membrane. Electrodialysis removes salts relatively indiscriminately using an applied electrical potential through an ion exchange membrane. Distillation removes salts indiscriminately by boiling the solution and collecting the water vapor. Ion exchange selectively removes nitrates from the lithium depleted brine by using anion resins to adsorb nitrates. Selective anion resins have size-selective functional groups that selectively adsorb nitrate. In some embodiments, these functional groups are tributylamine or triethylamine. Ion exchange resins must be replaced, as defined by their cycle life. Physical nitrate removal methods produce a concentrated waste solution that must be disposed of. In some embodiments, the waste solution is treated with the nitrate reduction methods outlined above.

### Methods of Generating a Lithium Eluate

An aspect of the disclosure described herein is a method of generating a lithium eluate solution (e.g., a synthetic lithium solution) from a liquid resource, comprising: providing an ion exchange reactor comprising a tank, ion exchange particles that selectively absorb lithium from a liquid resource and elute a lithium eluate solution when treated with an acid solution after absorbing lithium ions from said liquid resource, one or more particle traps, and provision to modulate pH of said liquid resource; flowing a liquid resource into said ion exchange reactor thereby allowing said ion exchange particles to selectively absorb lithium from said liquid resource; treating said ion exchange particles with an acid solution to yield said lithium eluate solution; and passing said lithium eluate solution through said one or more particle traps to collect said lithium eluate solution.

In some embodiments, the tank has a conical shape. In some embodiments, the tank has a partial conical shape. In some embodiments, the conical shape allows the ion exchange particles to settle into a settled bed so that liquid can be removed from above the settled bed. In some embodiments, the partial conical shape allows the ion exchange particles to settle into a settled bed so that liquid can be removed from above the settled bed.

In some embodiments, modulation of the pH of the liquid resource occurs in the tank. In some embodiments, modulation of the pH of the liquid resource occurs prior to injection into the tank. In some embodiments, one or more particle traps comprise one or more filters inside the tank. In some embodiments, one or more particle traps comprise one filter. In some embodiments, one or more particle traps comprise one filter. In some embodiments, one or more particle traps comprise two filters. In some embodiments, one or more particle traps comprise three filters. In some embodiments, one or more particle traps comprise four filters. In some embodiments, one or more particle traps comprise five filters.

In some embodiments, one or more particle traps is located at the bottom of the tank. In some embodiments, one or more particle traps is located close to the bottom of the tank. In some embodiments, one or more particle traps is located above the bottom of the tank.

In some embodiments, one or more particle traps comprise one or more meshes. In some embodiments, one or more particle traps comprises one mesh. In some embodiments, one or more particle traps comprises two meshes. In some embodiments, one or more particle traps comprises three meshes. In some embodiments, one or more particle traps comprises four meshes. In some embodiments, one or more particle traps comprises five meshes. In some embodiments, all the meshes of the one or more particle traps are identical. In some embodiments, at least one of the meshes of the one or more particle traps is not identical to the rest of the meshes of the one or more particle traps.

In some embodiments, one or more meshes comprise a pore space of less than about 200 microns, less than about 175 microns, less than about 150 microns, less than about 100 microns, less than about 75 microns, less than about 50 microns, less than about 25 microns, less than about 10 microns, more than about 1 micron, more than about 5 micron, more than about 10 microns, more than about 20 microns, more than about 30 microns, more than about 40 microns, more than about 50 microns, more than about 60 microns, more than about 70 microns, more than about 80 microns, more than about 90 microns, more than about 100 microns, more than about 125 microns, more than about 150 microns, more than about 175 microns from about 1 micron to about 200 microns, from about 5 microns to about 175 microns, from about 10 microns to about 150 microns, from about 10 microns to about 100 microns, from about 10 microns to about 90 microns, from about 10 microns to about 80 microns, from about 10 microns to about 70 microns, from about 10 microns to about 60 microns, or from about 10 microns to about 50 microns.

In some embodiments, one or more particle traps comprise multi-layered meshes. In some embodiments, the multi-layered meshes comprise at least one finer mesh for filtration and at least one coarser mesh for structural support. In some embodiments, one or more particle traps comprise one or more meshes supported by a structural support. In some embodiments, one or more particle traps comprise one or more polymer meshes. In some embodiments, the one or more polymer meshes are selected from the group consisting of polyetheretherketone, ethylene tetrafluorethylene, polyethylene terephthalate, polypropylene, and combinations thereof.

In some embodiments, one or more particle traps comprise one or more meshes comprising a metal wire mesh. In some embodiments, the metal wire mesh is coated with a polymer. In some embodiments, the ion exchange reactor is configured to move said ion exchange particles into one or more columns for washing. In some embodiments, the ion exchange reactor is configured to allow the ion exchange particles to settle into one or more columns for washing. In some embodiments, the columns are affixed to the bottom of said tank. In some embodiments, the one or more particle traps comprise one or more filters mounted in one or more ports through the wall of said tank.

In some embodiments, the one or more particle traps comprise one or more filters external to said tank, and with provision for fluid communication between said one or more filters and said tank. In some embodiments, the one or more particle traps comprise one or more gravity sedimentation devices external to said tank, and with provision for fluid communication between said one or more gravity sedimentation devices and said tank.

In some embodiments, one or more particle traps comprise one or more gravity sedimentation devices internal to said tank. In some embodiments, one or more particle traps comprise one or more centrifugal sedimentation devices external to said tank, and with provision for fluid communication between said one or more centrifugal sedimentation devices and said tank In some embodiments, one or more particle traps comprise one or more centrifugal sedimentation devices internal to said tank. In some embodiments, one or more particle traps comprise one or more settling tanks, one or more centrifugal devices, or combinations thereof external to said tank, and with provision for fluid communication between said one or more settling tanks, centrifugal devices, or combinations thereof, and said tank. In some embodiments, one or more particle traps comprise one or more meshes, one or more centrifugal devices, or combinations thereof external to said tank, and with provision for fluid communication between said one or more meshes, centrifugal devices, or combinations thereof, and said tank. In some embodiments, one or more particle traps comprise one or more settling tanks, one or more meshes, or combinations thereof external to said tank, and with provision for fluid communication between said one or more settling tanks, meshes, or combinations thereof, and said tank. In some embodiments, one or more particle traps comprise one or more meshes, one or more settling tanks, one or more centrifugal devices, or combinations thereof external to said tank, and with provision for fluid communication between said one or more meshes, one or more settling tanks, centrifugal devices, or combinations thereof, and said tank.

In some embodiments, the ion exchange particles are stirred. In some embodiments, the ion exchange particles are stirred by a mixer. In some embodiments, the ion exchange particles are stirred by a propeller. In some embodiments, the ion exchange particles are fluidized by pumping solution into the tank near the bottom of the tank. In some embodiments, the ion exchange particles are fluidized by pumping solution from the tank back into the tank near the bottom of the tank. In some embodiments, the ion exchange particles are fluidized by pumping a slurry of the ion exchange particles from near the bottom of the tank to a higher level in the tank.

In some embodiments, the method further comprises one or more staged elution tanks, wherein intermediate eluate solutions comprising mixtures of protons and lithium ions are stored and used further to elute lithium from said ion exchange particles that are freshly lithiated. In some embodiments, the method further comprises one or more staged elution tanks, wherein intermediate eluate solutions comprising mixtures of protons and lithium ions are mixed with additional acid and used further to elute lithium from said ion exchange particles.

In some embodiments, the ion exchange particles further comprise a coating material. In some embodiments, the coating material is a polymer. In some embodiments, the coating of the coating material comprises a chloro-polymer, a fluoro-polymer, a chloro-fluoro-polymer, a hydrophilic polymer, a hydrophobic polymer, co-polymers thereof, mixtures thereof, or combinations thereof.

As disclosed herein, in some embodiments, and for any process of lithium extraction disclosed herein, the pH of the lithium-enriched acidic eluent solution is regulated to control elution of lithium and/or non-lithium impurities. In some embodiments, pH of the lithium-enriched acidic solution is regulated by adding protons, such as an acid and/or an acidic solution, to the lithium-enriched acidic solution. In some embodiments, pH of the lithium-enriched acidic solution is regulated by adding protons, such as an acid and/or an acidic solution, to the impurities-enriched lithiated acidic solution prior to removing impurities.

In some embodiments, the acid (e.g., the acidic solution) comprises sulfuric acid, phosphoric acid, hydrochloric acid, hydrobromic acid, carbonic acid, nitric acid, or combinations thereof. In some embodiments, the acidic solution is the same as the acidic solution originally contacted with the first lithium-enriched ion exchange material. In some embodiments, the acidic solution is the different from the acidic solution originally contacted with the first lithium-enriched ion exchange material.

In some embodiments, more protons are added to the lithium-enriched acidic solution, forming a protonated lithium-enriched acidic solution that is again contacted with a lithium-enriched ion exchange material to elute more lithium into the protonated lithium-enriched acidic solution. In some embodiments, more protons are added to the lithium-enriched acidic solution by adding an acid or acidic solution thereto to form the protonated lithium-enriched acidic solution. In some embodiments, protons are added to a lithium-enriched acidic solution before passing through each vessel in a network of lithium-selective ion exchange vessels, as described herein.

### Embodiments for Limiting or Eliminating Precipitation of Impurities in the Eluate Solution

In one embodiment, lithium and non-lithium impurities are absorbed from a lithium resource into an ion exchange material. In one embodiment, lithium and non-lithium impurities are eluted from an ion exchange material into an acidic solution. In one embodiment, lithium and non-lithium impurities are eluted from an ion exchange material into an acidic solution containing dissolved species that may precipitate at certain concentrations. In one embodiment, lithium and non-lithium impurities are eluted from an ion exchange material into an acidic solution containing dissolved species that may be reduced in concentration to avoid precipitation. In one embodiment, lithium and non-lithium impurities are eluted from an ion exchange material into an acidic solution where said non-lithium impurities may precipitate at certain concentrations.

In one embodiment, lithium and multivalent impurities are absorbed from a lithium resource into an ion exchange material. In one embodiment, lithium and multivalent impurities are eluted from an ion exchange material into an acidic solution. In one embodiment, lithium and multivalent impurities are eluted from an ion exchange material into an acidic solution containing sulfate anions. In one embodiment, lithium and multivalent impurities are eluted from an ion exchange material into an acidic solution containing sulfate anions such that the multivalent impurities and sulfate anions may react to form insoluble salts that can precipitate. In one embodiment, lithium and multivalent impurities are eluted from an ion exchange material into a solution containing sulfate anions such that the multivalent impurities and sulfate anions that may react to form insoluble salts that can precipitate. In one embodiment, lithium and multivalent cations are eluted from an ion exchange material into a solution containing sulfate anions wherein the concentrations of sulfate anions and multivalent cations are limited to avoid precipitation of insoluble sulfate compounds.

In one embodiment, lithium and multivalent cations are eluted from an ion exchange material into a solution containing sulfate anions wherein the concentrations of multivalent cations are limited to avoid precipitation of insoluble sulfate compounds. In one embodiment, lithium and multivalent cations are eluted from an ion exchange material into a solution containing sulfate anions wherein the concentrations of multivalent cations are limited using nanofiltration to avoid precipitation of insoluble sulfate compounds. In one embodiment, lithium and multivalent cations are eluted from a first ion exchange material into a solution containing sulfate anions wherein the concentrations of multivalent cations are decreased using a second ion exchange material to avoid precipitation of insoluble sulfate compounds. In one embodiment, lithium and multivalent cations are eluted from a first ion exchange material into a solution containing sulfate anions wherein the concentrations of multivalent cations are limited using a second ion exchange material that is selective for multivalent cations to avoid precipitation of insoluble sulfate compounds.

In one embodiment, lithium and multivalent cations are eluted from an ion exchange material into a solution containing sulfate anions wherein the concentrations of multivalent cations are decreased to avoid precipitation of insoluble sulfate compounds. In one embodiment, lithium and multivalent cations are eluted from an ion exchange material into a solution containing sulfate anions and the concentration of multivalent cations in the sulfate solution is decreased to avoid precipitation of insoluble sulfate compounds.

In one embodiment, a sulfate solution is contacted with an ion exchange material to elute lithium along with impurities, the sulfate solution is processed to reduce the concentration of impurities, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, the sulfate solution is again contacted with an ion exchange material to elute more lithium along with impurities, and the concentration of multivalent cations is maintained at a sufficiently low level to avoid precipitation of insoluble salts.

In one embodiment, a sulfate solution is contacted with an ion exchange material to elute a target metal along with impurities, the sulfate solution is processed to reduce the concentration of impurities, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, the sulfate solution is again contacted with an ion exchange material to elute more of the target metal along with impurities, and the concentration of multivalent cations is maintained at a sufficiently low level to avoid precipitation of insoluble salts.

In one embodiment, an acidic sulfate solution is contacted with an ion exchange material to elute lithium along with impurities, the acidic sulfate solution is processed to reduce the concentration of impurities, and the acidic sulfate solution is again contacted with an ion exchange material to elute more lithium along with more impurities. In one embodiment, the pH of the acidic sulfate solution is regulated to control elution of lithium and/or impurities. In one embodiment, pH of the acidic sulfate solution is regulated by measuring pH with a pH probe and adding sulfuric acid and/or a solution containing sulfuric acid to the acidic sulfate solution. In one embodiment, pH of the acidic sulfate solution is regulated adding sulfuric acid and/or a solution containing sulfuric acid to the acidic sulfate solution.

In one embodiment, the sulfate solution used to elute lithium from the ion exchange material is replaced with a different solution. In one embodiment, the sulfate solution used to elute lithium from the ion exchange material is replaced with a solution comprising sulfate, nitrate, phosphate, chloride, bromide, fluoride, borate, iodide, carbonate, or combinations thereof. In one embodiment, a solution comprising anions is contacted with an ion exchange material to elute lithium along with impurities, the solution is processed to reduce the concentration of impurities, and the solution is again contacted with an ion exchange material to elute more lithium along with impurities, where the anions are selected from a list including sulfate, nitrate, phosphate, chloride, bromide, fluoride, borate, iodide, carbonate, or combinations thereof.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution to avoid the formation of precipitates. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic sulfate solution to elute lithium into the acidic solution, and multivalent impurities are removed from the acidic solution to avoid the formation of sulfate precipitates.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is returned to the fluidized bed.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is passed to a second fluidized bed of ion exchange material for elution of more lithium into the acidic solution. In one embodiment, the acidic solution flows through multiple fluidized beds of ion exchange material for elution of lithium and impurities, and impurities are removed from the acidic solution between the multiple fluidized beds. In one embodiment, the acidic solution flows through multiple fluidized beds of ion exchange material for elution of lithium and impurities, and impurities are removed from the acidic solution between the multiple fluidized beds using nanofiltration. In one embodiment, the acidic solution flows through multiple fluidized beds of a first ion exchange material which is lithium-selective for elution of lithium and impurities, and impurities are removed from the acidic solution between the multiple fluidized beds using a second ion exchange material that is selective for multivalent ions.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution to avoid the formation of precipitates. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic sulfate solution to elute lithium into the acidic solution, and multivalent impurities are removed from the acidic solution to avoid the formation of sulfate precipitates.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is returned to the packed bed. In one embodiment, a packed bed ofion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is returned to the packed bed. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is returned to the packed bed.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is passed to a second packed bed of ion exchange material for elution of more lithium into the acidic solution. In one embodiment, the acidic solution flows through multiple pack ed beds of ion exchange material for elution of lithium and impurities, and impurities are removed from the acidic solution between the multiple packed beds. In one embodiment, the acidic solution flows through multiple packed beds of ion exchange material for elution of lithium and impurities, and impurities are removed from the acidic solution between the multiple packed beds using nanofiltration. In one embodiment, the acidic solution flows through multiple packed beds of a first ion exchange material which is lithium-selective for elution of lithium and impurities, and impurities are removed from the acidic solution between the multiple packed beds using a second ion exchange material that is selective for multivalent ions.

In some embodiments, the packed beds may be partially or occasionally fluidized. In some embodiments, the fluidized beds may be partially or occasionally packed. In some embodiments, the packed or fluidized beds may be washed before and/or after contracting with brine and/or acid using water or washing solutions containing water, salt, chelating compounds, ethylenediaminetetraacetic acid, salt of ethylenediaminetetraacetate, compounds of ethylenediaminetetraacetate, and/or anti-scalants. In some embodiments, the acidic solution used to elute lithium from the lithium-selective ion exchange material may contain water, salt, chelating compounds, ethylenediaminetetraacetic acid, salt of ethylenediaminetetraacetate, compounds of ethylenediaminetetraacetate, and/or anti-scalants. In some embodiments, dilution water is used to limit and/or prevent formation of insoluble precipitates.

In some embodiments, multivalent impurities may be removed from a lithium salt solution using precipitation. In some embodiments, multivalent impurities may be removed from a lithium salt solution using precipitation through addition of base. In some embodiments, multivalent impurities may be removed from a lithium salt solution using precipitation through addition of sodium hydroxide, sodium carbonate, and/or other compounds.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, and the lithium selective ion exchange material is contacted with an acidic solution to elute lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more protons are added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more acid is added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a first vessel, more protons are added to the acidic solution, and the acidic solution is again contacted with lithium selective ion exchange material to elute more lithium into the acidic solution in a second vessel. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a vessel, more protons are added to the acidic solution, and the acidic solution is again contacted with lithium selective ion exchange material to elute more lithium into the acidic solution in the vessel.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution, and the acidic solution is again contacted with lithium selective ion exchange material to elute more lithium into the acidic solution.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution using nanofiltration or multivalent-selective ion exchange materials, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution using nanofiltration or multivalent-selective ion exchange materials, and the acidic solution is again contacted with lithium selective ion exchange material to elute more lithium into the acidic solution.

In some embodiments, an acidic solution is contacted with a lithium selective ion exchange material that has previously been loaded with lithium by contacting the lithium selective ion exchange material with a liquid resource, the acidic solution is treated to remove multivalent impurities, and the acidic solutions is again contacted with a lithium selective ion exchange material that has previously been loaded with lithium by contacting the lithium selective ion exchange material with a liquid resource. In some embodiments, an acidic solution is contacted with a lithium selective ion exchange material to elute lithium, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium, the acidic solution is treated to remove multivalent impurities, more protons are added to the acidic solution, and the acidic solutions is again contacted with a lithium selective ion exchange material to elute lithium. In some embodiments, an acidic solution is contacted with a lithium selective ion exchange material to elute lithium, more protons are added to the acidic solution, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium in a vessel, the acidic solution is treated to remove multivalent impurities, and the acidic solutions is contacted with a lithium selective ion exchange material to elute lithium in said vessel. In some embodiments, an acidic solution is contacted with a lithium selective ion exchange material to elute lithium in a first vessel, the acidic solution is treated to remove multivalent impurities, and the acidic solutions is contacted with a lithium selective ion exchange material to elute lithium in a second vessel. In some embodiments, multivalent impurities are removed with a multivalent cation selective ion exchange material. In some embodiments, multivalent impurities are removed using nanofiltration membranes. In some embodiments, the lithium selective ion exchange materials is in a tank, a column, or a stirred tank reactor. In some embodiments, the lithium selective ion exchange material is in a fixed or fluidized bed.

In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium and multivalent cation impurities are removed between the vessels. In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium, multivalent cation impurities are removed between the multiple vessels, and more protons are added to the acid solution between the multiple vessels. In some embodiments, an acidic solution is recirculated through a vessel loaded a lithium selective ion exchange material to elute lithium. In some embodiments, an acidic solution is recirculated through a vessel loaded a lithium selective ion exchange material to elute lithium and multivalent cation impurities are removed between each recirculation. In some embodiments, an acidic solution is recirculated through a vessel loaded a lithium selective ion exchange material to elute lithium, multivalent cation impurities are removed between each recirculation, and more protons are added to the acid solution between each recirculation.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, and the acidic solution is prepared in an acidic solution mixing unit. In one embodiment, the acidic solution mixing unit is a tank, an in-line mixing device, a stirred tank reactor, another mixing unit, or combinations thereof. In one embodiment, the acid solution mixing tank is used to service one vessel containing lithium selective ion exchange material. In one embodiment, the acid solution mixing tank is used to service multiple vessels containing lithium selective ion exchange material in parallel or series. In one embodiment, the acid solution mixing tank is used to service multiple vessels containing lithium selective ion exchange material in sequence.

In one embodiment, the acidic solution is comprised of sulfuric acid, phosphoric acid, hydrochloric acid, hydrobromic acid, carbonic acid, nitric acid, or combinations thereof. In one embodiment, lithium is eluted from a lithium selective ion exchange material using sulfuric acid, phosphoric acid, hydrochloric acid, nitric acid, or combinations thereof. In one embodiment, lithium is eluted from a lithium selective ion exchange material using an acid solution comprising sulfate, phosphate, nitrate, borate, or combinations thereof.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed using a combination of nanofiltration, multivalent cation selective ion exchange material, other methods of removing multivalent impurities, or combinations thereof. In one embodiment, impurities are removed from an acidic lithium solution (e.g., a synthetic lithium solution) using combinations of nanofiltration, multivalent cation selective ion exchange material, other methods of removing multivalent impurities in parallel, series, or combinations thereof.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using nanofiltration membrane units arranged in series and/or parallel, more protons are added to the acidic solution, and the acid solutions is contacted with lithium selective ion exchange material to elute more lithium into the acidic solution. In one embodiment, anti-scalants, chelants (e.g., chelators, chelating agents), or other means of anti-scaling are used to avoid scaling in the nanofiltration membrane units.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange materials, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material in a packed bed, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns with a first absorption column position for absorbing impurities and a last absorption column position for absorbing trace amounts of impurities, more protons are added to the acidic solution, and the acid solutions is contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a lead-lag configuration, and the acid solutions is contacted with lithium selective ion exchange material to elute more lithium into the acidic solution. In one embodiment, a multivalent cation selective ion exchange material is arranged in a variation of a lead-lag setup. In one embodiment, a multivalent cation selective ion exchange material is eluted using a second acidic solution. In one embodiment, a multivalent cation selective ion exchange material is eluted using hydrochloric acid. In one embodiment, a multivalent cation selective ion exchange material is regenerated using sodium hydroxide. In one embodiment, a multivalent cation selective ion exchange material is operated in stirred tank reactors, fluidized beds, or packed beds arranged in series and/or parallel. In one embodiment, a lithium selective ion exchange material is operated in stirred tank reactors, fluidized beds, or packed beds arranged in series and/or parallel.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphate to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphoric acid to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, Ca, Mg, Sr, and/or Ba are removed from the acidic solution by adding phosphoric acid to precipitate Ca, Mg, Sr, and/or Ba phosphate compounds, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding oxalate, oxalic acid, citrate, citric acid, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding a precipitant comprising oxalate, oxalic acid, citrate, citric acid, or combinations thereof, the precipitant concentration is decreased by adding cations to the acidic solution, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding oxalate, oxalate anions are precipitated and removed from the acidic solution by adding zinc, iron, manganese, other transition metals, other cations, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding citrate, citrate anions are precipitated and removed from the acidic solution by adding cations, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated from the acidic solution by adding anion precipitants, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated and removed from the acidic solution by adding anion precipitants, the anions precipitants are precipitated and removed from the acidic solution by adding cation precipitants, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by temporarily reducing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by changing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by decreasing the temperature of the acidic solution, protons are added to the acidic solution and the acidic solution is heated or allowed to warm, and the acid solutions is contacted with lithium selective ion exchange material to elute more lithium into the acidic solution.

In one embodiment, a chelating agent or anti-scalant is used to form a soluble complex to avoid precipitation in an acidic lithium solution. In one embodiment, a chelating agent or anti-scalant is used to form a soluble complex to avoid or redissolve precipitates. In one embodiment, a chelating agent or anti-scalants is used to limit or reduce precipitation of multivalent cations and the chelating agent or antiscalant is selected from the list of ethylenediaminetetraacetic acid (EDTA), disodium EDTA, calcium disodium EDTA, tetrasodium EDTA, citric acid, maleic acid, silicate compounds, amorphous silicate compounds, crystalline layered silicate compounds, phosphonic acid compounds, aminotris(methylenephosphonic acid) (ATMP), nitrilotrimethylphosphonic acid (NTMP), ethylenediamine tetra(methylene phosphonic acid) (EDTMP), diethylenetriamine penta(methylene phosphonic acid) (DTPMP), polyphosphonate, polyacrylate, polyacrylic acid, nitrilotriacetic acid (NTA), sodium hexametaphosphate (SHMP), or combinations thereof. In one embodiment, a threshold inhibitor is used to block development of nuclei in an acidic lithium solution. In one embodiment, a retarded is used to block the growth of precipitates in an acidic lithium solution. In one embodiment, compounds are used to limit, control, eliminate, or redissolve precipitates including phosphinopolycarboxylic acid, sulfonated polymer, polyacrylic acid, p-tagged sulfonated polymer, diethylenetriamine penta, bis-hexamethylene triamine, compounds thereof, modifications thereof, or combinations thereof.

In one embodiment, the acidic solution comprises lithium sulfate, lithium hydrogen sulfate, sulfuric acid, or combinations thereof. In one embodiment, the acidic solution comprises lithium sulfate, lithium hydrogen sulfate, sulfuric acid, lithium chloride, hydrochloric acid, lithium nitrate, nitric acid, lithium phosphate, lithium hydrogen phosphate, lithium dihydrogen phosphate, phosphoric acid, lithium bromide, bromic acid, or combinations thereof.

In some embodiments, lithium and other metals are recovered from the liquid resource. In some embodiments, the methods described for lithium recovery are applied to recover other metals.

Compositions of Eluates Produced by Lithium Extraction from a Liquid Resource Using Ion Exchange

Lithium extraction via any of the aforementioned methods produces an eluate enriched in lithium (e.g., a synthetic lithium solution), whereby the majority of impurities in the liquid resource are rejected and a purified lithium stream is produced. The concentrated lithium solution is an aqueous solution comprising lithium and other dissolved ions, and is donated as an eluate. Said eluate (e.g., said synthetic lithium solution) is produced by treatment of an ion exchange material that has absorbed lithium with an acidic eluent (e.g., an acidic solution) to produce an eluate. Said eluate is acidic and contains lithium in combination with other cations and anions that are present in the liquid resource from which lithium is extracted.

Said eluent can be contacted with ion exchange material in one or more of the aforementioned ion exchange vessels to produce an eluate. Said eluate is stored in one or more different vessels that are part of an ion exchange network.

The concentration of lithium and other ions in solution vary depending on the liquid resource from which lithium is extracted. In some embodiments, the eluate (e.g., the synthetic lithium solution) is produced by contacting the lithiated ion exchange materials with an acidic solution which comprises sulfuric acid, phosphoric acid, hydrochloric acid, hydrobromic acid, carbonic acid, nitric acid, or combinations thereof. In one embodiment, lithium is eluted from a lithium selective ion exchange material using sulfuric acid, phosphoric acid, hydrochloric acid, nitric acid, or combinations thereof. In one embodiment, lithium is eluted from a lithium selective ion exchange material using an acid solution comprising sulfate, phosphate, nitrate, borate, or combinations thereof.

In some embodiments, the concentration of acid (e.g., the concentration of acid in the acidic solution) used to produce the eluate (e.g., the synthetic lithium solution) is from about 0.01 moles per liter to 0.1 moles per liter. In some embodiments, the concentration of acid used to produce the eluate is from about 0.1 moles per liter to 0.2 moles per liter. In some embodiments, the concentration of acid used to produce the eluate is from about 0.2 moles per liter to 0.5 moles per liter. In some embodiments, the concentration of acid used to produce the eluate is from about 0.5 moles per liter to 1.0 moles per liter. In some embodiments, the concentration of acid used to produce the eluate is from about 1.0 moles per liter to 2.0 moles per liter. In some embodiments, the concentration of acid used to produce the eluate is from about 2.0 moles per liter to 5.0 moles per liter. In some embodiments, the concentration of acid used to produce the eluate is from about 5.0 moles per liter to 10 moles per liter. In some embodiments, the concentration of acid used to produce the eluate is from about 10 moles per liter to 50 moles per liter

Exemplary embodiments of the present disclosure include compositions of the concentrated lithium eluate produced by contacting an acid with an ion exchange material lithiated by lithium from a liquid resource. In some embodiments, the concentrated lithium solution contains other ions, comprising but not limited to one or more ions of lithium, sodium, calcium, magnesium, potassium, boron, strontium, barium, zirconium, titanium, vanadium, iron, copper, manganese, molybdenum, aluminum, niobium, sulfate, chloride, fluoride, bromide, nitrate, carbonate, bicarbonate, hydrogencarbonate, phosphate, borate, mixtures thereof or combinations thereof.

In some embodiments, the concentration of lithium (e.g., the concentration of lithium in the synthetic lithium solution) is greater than about 200.0 milligrams per liter and less than about 8000 milligrams per liter. In some embodiments, the concentration of lithium is greater than about 200 milligrams per liter and less than about 4000 milligrams per liter. In some embodiments, the concentration of lithium is greater than about 2000 milligrams per liter and less than about 8000 milligrams per liter. In some embodiments, the concentration of lithium is greater than about 200 milligrams per liter and less than about 1000 milligrams per liter. In some embodiments, the concentration of lithium is greater than about 200 milligrams per liter and less than about 500 milligrams per liter. In some embodiments, the concentration of lithium is greater than about 1000 milligrams per liter and less than about 4000 milligrams per liter. In some embodiments, the concentration of lithium is greater than about 1000.0 milligrams per liter and less than about 2000.0 milligrams per liter. In some embodiments, the concentration of lithium is greater than about 2000.0 milligrams per liter and less than about 3000.0 milligrams per liter. In some embodiments, the concentration of lithium is greater than about 3000.0 milligrams per liter and less than about 4000.0 milligrams per liter. In some embodiments, the concentration of lithium is greater than about 4000.0 milligrams per liter and less than about 5000.0 milligrams per liter. In some embodiments, the concentration of lithium is greater than about 5000.0 milligrams per liter and less than about 6000.0 milligrams per liter. In some embodiments, the concentration of lithium is greater than about 6000.0 milligrams per liter and less than about 8000.0 milligrams per liter. In some embodiments, the concentration of lithium is greater than about 8000.0 milligrams per liter and less than about 10000.0 milligrams per liter. In some embodiments, the concentration of lithium is greater than about 10000.0 milligrams per liter and less than about 12000.0 milligrams per liter. In some embodiments, the concentration of lithium is greater than about 12000.0 milligrams per liter and less than about 20000.0 milligrams per liter. In some embodiments, the concentration of lithium is greater than about 15000.0 milligrams per liter and less than about 25000.0 milligrams per liter. In some embodiments, the concentration of lithium is greater than about 20000.0 milligrams per liter and less than about 25000.0 milligrams per liter.

In some embodiments, the concentration of barium (e.g., the concentration of barium in the synthetic lithium solution) is greater than about 0.1 milligrams per liter and less than about 750 milligrams per liter. In some embodiments, the concentration of barium is greater than about 1 milligrams per liter and less than about 50 milligrams per liter. In some embodiments, the concentration of barium is greater than about 50 milligrams per liter and less than about 100 milligrams per liter. In some embodiments, the concentration of barium is greater than about 100 milligrams per liter and less than about 200 milligrams per liter. In some embodiments, the concentration of barium is greater than about 200 milligrams per liter and less than about 300 milligrams per liter. In some embodiments, the concentration of barium is greater than about 300 milligrams per liter and less than about 400 milligrams per liter. In some embodiments, the concentration of barium is greater than about 400.0 milligrams per liter and less than about 500.0 milligrams per liter. In some embodiments, the concentration of barium is greater than about 500.0 milligrams per liter and less than about 600.0 milligrams per liter. In some embodiments, the concentration of barium is greater than about 600.0 milligrams per liter and less than about 700.0 milligrams per liter. In some embodiments, the concentration of barium is greater than about 700.0 milligrams per liter and less than about 800.0 milligrams per liter.

In some embodiments, the concentration of boron (e.g., the concentration of boron in the synthetic lithium solution) is greater than about 10.0 milligrams per liter and less than about 5000 milligrams per liter. In some embodiments, the concentration of boron is greater than about 20 milligrams per liter and less than about 1000 milligrams per liter. In some embodiments, the concentration of boron is greater than about 1000 milligrams per liter and less than about 2000 milligrams per liter. In some embodiments, the concentration of boron is greater than about 2000 milligrams per liter and less than about 3000 milligrams per liter. In some embodiments, the concentration of boron is greater than about 3000 milligrams per liter and less than about 4000 milligrams per liter. In some embodiments, the concentration of boron is greater than about 4000 milligrams per liter and less than about 6000 milligrams per liter. In some embodiments, the concentration of boron is greater than about 10.0 milligrams per liter and less than about 500.0 milligrams per liter. In some embodiments, the concentration of boron is greater than about 500.0 milligrams per liter and less than about 1000.0 milligrams per liter. In some embodiments, the concentration of boron is greater than about 6000.0 milligrams per liter and less than about 10000.0 milligrams per liter.

In some embodiments, the concentration of calcium (e.g., the concentration of calcium in the synthetic lithium solution) is greater than about 10.0 milligrams per liter and less than about 5000 milligrams per liter. In some embodiments, the concentration of calcium is greater than about 20 milligrams per liter and less than about 1000 milligrams per liter. In some embodiments, the concentration of calcium is greater than about 1000 milligrams per liter and less than about 2000 milligrams per liter. In some embodiments, the concentration of calcium is greater than about 2000 milligrams per liter and less than about 3000 milligrams per liter. In some embodiments, the concentration of calcium is greater than about 3000 milligrams per liter and less than about 4000 milligrams per liter. In some embodiments, the concentration of calcium is greater than about 4000 milligrams per liter and less than about 6000 milligrams per liter. In some embodiments, the concentration of calcium is greater than about 10.0 milligrams per liter and less than about 500.0 milligrams per liter. In some embodiments, the concentration of calcium is greater than about 500.0 milligrams per liter and less than about 1000.0 milligrams per liter. In some embodiments, the concentration of calcium is greater than about 6000.0 milligrams per liter and less than about 10000.0 milligrams per liter. In some embodiments, the concentration of calcium is greater than about 4000 milligrams per liter and less than about 5000 milligrams per liter. In some embodiments, the concentration of calcium is greater than about 5000 milligrams per liter and less than about 6000 milligrams per liter.

In some embodiments, the concentration of magnesium (e.g., the concentration of magnesium in the synthetic lithium solution) is greater than about 10.0 milligrams per liter and less than about 5000 milligrams per liter. In some embodiments, the concentration of magnesium is greater than about 20 milligrams per liter and less than about 1000 milligrams per liter. In some embodiments, the concentration of magnesium is greater than about 1000 milligrams per liter and less than about 2000 milligrams per liter. In some embodiments, the concentration of magnesium is greater than about 2000 milligrams per liter and less than about 3000 milligrams per liter. In some embodiments, the concentration of magnesium is greater than about 3000 milligrams per liter and less than about 4000 milligrams per liter. In some embodiments, the concentration of magnesium is greater than about 4000 milligrams per liter and less than about 6000 milligrams per liter. In some embodiments, the concentration of magnesium is greater than about 10.0 milligrams per liter and less than about 500.0 milligrams per liter. In some embodiments, the concentration of magnesium is greater than about 500.0 milligrams per liter and less than about 1000.0 milligrams per liter. In some embodiments, the concentration of magnesium is greater than about 6000.0 milligrams per liter and less than about 10000.0 milligrams per liter.

In some embodiments, the concentration of potassium (e.g., the concentration of potassium in the synthetic lithium solution) is greater than about 10.0 milligrams per liter and less than about 5000 milligrams per liter. In some embodiments, the concentration of potassium is greater than about 20 milligrams per liter and less than about 1000 milligrams per liter. In some embodiments, the concentration of potassium is greater than about 1000 milligrams per liter and less than about 2000 milligrams per liter. In some embodiments, the concentration of potassium is greater than about 2000 milligrams per liter and less than about 3000 milligrams per liter. In some embodiments, the concentration of potassium is greater than about 3000 milligrams per liter and less than about 4000 milligrams per liter. In some embodiments, the concentration of potassium is greater than about 4000 milligrams per liter and less than about 6000 milligrams per liter. In some embodiments, the concentration of potassium is greater than about 10.0 milligrams per liter and less than about 500.0 milligrams per liter. In some embodiments, the concentration of potassium is greater than about 500.0 milligrams per liter and less than about 1000.0 milligrams per liter. In some embodiments, the concentration of potassium is greater than about 6000.0 milligrams per liter and less than about 10000.0 milligrams per liter.

In some embodiments, the concentration of sodium (e.g., the concentration of sodium in the synthetic lithium solution) is greater than about 10.0 milligrams per liter and less than about 5000 milligrams per liter. In some embodiments, the concentration of sodium is greater than about 20 milligrams per liter and less than about 1000 milligrams per liter. In some embodiments, the concentration of sodium is greater than about 1000 milligrams per liter and less than about 2000 milligrams per liter. In some embodiments, the concentration of sodium is greater than about 2000 milligrams per liter and less than about 3000 milligrams per liter. In some embodiments, the concentration of sodium is greater than about 3000 milligrams per liter and less than about 4000 milligrams per liter. In some embodiments, the concentration of sodium is greater than about 4000 milligrams per liter and less than about 6000 milligrams per liter. In some embodiments, the concentration of sodium is greater than about 10.0 milligrams per liter and less than about 500.0 milligrams per liter. In some embodiments, the concentration of sodium is greater than about 500.0 milligrams per liter and less than about 1000.0 milligrams per liter. In some embodiments, the concentration of sodium is greater than about 6000.0 milligrams per liter and less than about 10000.0 milligrams per liter. In some embodiments, the concentration of sodium is greater than about 10000.0 milligrams per liter and less than about 15000.0 milligrams per liter. In some embodiments, the concentration of sodium is greater than about 15000.0 milligrams per liter and less than about 20000.0 milligrams per liter. In some embodiments, the concentration of sodium is greater than about 20000.0 milligrams per liter and less than about 25000.0 milligrams per liter. In some embodiments, the concentration of sodium is greater than about 10000.0 milligrams per liter and less than about 25000.0 milligrams per liter.

In some embodiments, the concentration of strontium (e.g., the concentration of strontium in the synthetic lithium solution) is greater than about 10.0 milligrams per liter and less than about 5000 milligrams per liter. In some embodiments, the concentration of strontium is greater than about 20 milligrams per liter and less than about 1000 milligrams per liter. In some embodiments, the concentration of strontium is greater than about 1000 milligrams per liter and less than about 2000 milligrams per liter. In some embodiments, the concentration of strontium is greater than about 2000 milligrams per liter and less than about 3000 milligrams per liter. In some embodiments, the concentration of strontium is greater than about 3000 milligrams per liter and less than about 4000 milligrams per liter. In some embodiments, the concentration of strontium is greater than about 4000 milligrams per liter and less than about 6000 milligrams per liter. In some embodiments, the concentration of strontium is greater than about 10.0 milligrams per liter and less than about 500.0 milligrams per liter. In some embodiments, the concentration of strontium is greater than about 500.0 milligrams per liter and less than about 1000.0 milligrams per liter. In some embodiments, the concentration of strontium is greater than about 6000.0 milligrams per liter and less than about 10000.0 milligrams per liter.

In some embodiments, the concentration of aluminum (e.g., the concentration of aluminum in the synthetic lithium solution) is greater than about 0.1 milligrams per liter and less than about 750 milligrams per liter. In some embodiments, the concentration of aluminum is greater than about 1 milligrams per liter and less than about 50 milligrams per liter. In some embodiments, the concentration of aluminum is greater than about 50 milligrams per liter and less than about 100 milligrams per liter. In some embodiments, the concentration of aluminum is greater than about 100 milligrams per liter and less than about 200 milligrams per liter. In some embodiments, the concentration of aluminum is greater than about 200 milligrams per liter and less than about 300 milligrams per liter. In some embodiments, the concentration of aluminum is greater than about 300 milligrams per liter and less than about 400 milligrams per liter. In some embodiments, the concentration of aluminum is greater than about 400.0 milligrams per liter and less than about 500.0 milligrams per liter. In some embodiments, the concentration of aluminum is greater than about 500.0 milligrams per liter and less than about 600.0 milligrams per liter. In some embodiments, the concentration of aluminum is greater than about 600.0 milligrams per liter and less than about 700.0 milligrams per liter. In some embodiments, the concentration of aluminum is greater than about 700.0 milligrams per liter and less than about 800.0 milligrams per liter.

In some embodiments, the concentration of copper (e.g., the concentration of copper in the synthetic lithium solution) is greater than about 0.1 milligrams per liter and less than about 750 milligrams per liter. In some embodiments, the concentration of copper is greater than about 1 milligrams per liter and less than about 50 milligrams per liter. In some embodiments, the concentration of copper is greater than about 50 milligrams per liter and less than about 100 milligrams per liter. In some embodiments, the concentration of copper is greater than about 100 milligrams per liter and less than about 200 milligrams per liter. In some embodiments, the concentration of copper is greater than about 200 milligrams per liter and less than about 300 milligrams per liter. In some embodiments, the concentration of copper is greater than about 300 milligrams per liter and less than about 400 milligrams per liter. In some embodiments, the concentration of copper is greater than about 400.0 milligrams per liter and less than about 500.0 milligrams per liter. In some embodiments, the concentration of copper is greater than about 500.0 milligrams per liter and less than about 600.0 milligrams per liter. In some embodiments, the concentration of copper is greater than about 600.0 milligrams per liter and less than about 700.0 milligrams per liter. In some embodiments, the concentration of copper is greater than about 700.0 milligrams per liter and less than about 800.0 milligrams per liter.

In some embodiments, the concentration of iron (e.g., the concentration of iron in the synthetic lithium solution) is greater than about 0.1 milligrams per liter and less than about 750 milligrams per liter. In some embodiments, the concentration of iron is greater than about 1 milligrams per liter and less than about 50 milligrams per liter. In some embodiments, the concentration of iron is greater than about 50 milligrams per liter and less than about 100 milligrams per liter. In some embodiments, the concentration of iron is greater than about 100 milligrams per liter and less than about 200 milligrams per liter. In some embodiments, the concentration of iron is greater than about 200 milligrams per liter and less than about 300 milligrams per liter. In some embodiments, the concentration of iron is greater than about 300 milligrams per liter and less than about 400 milligrams per liter. In some embodiments, the concentration of iron is greater than about 400.0 milligrams per liter and less than about 500.0 milligrams per liter. In some embodiments, the concentration of iron is greater than about 500.0 milligrams per liter and less than about 600.0 milligrams per liter. In some embodiments, the concentration of iron is greater than about 600.0 milligrams per liter and less than about 700.0 milligrams per liter. In some embodiments, the concentration of iron is greater than about 700.0 milligrams per liter and less than about 800.0 milligrams per liter.

In some embodiments, the concentration of manganese (e.g., the concentration of manganese in the synthetic lithium solution) is greater than about 0.1 milligrams per liter and less than about 750 milligrams per liter. In some embodiments, the concentration of manganese is greater than about 1 milligrams per liter and less than about 50 milligrams per liter. In some embodiments, the concentration of manganese is greater than about 50 milligrams per liter and less than about 100 milligrams per liter. In some embodiments, the concentration of manganese is greater than about 100 milligrams per liter and less than about 200 milligrams per liter. In some embodiments, the concentration of manganese is greater than about 200 milligrams per liter and less than about 300 milligrams per liter. In some embodiments, the concentration of manganese is greater than about 300 milligrams per liter and less than about 400 milligrams per liter. In some embodiments, the concentration of manganese is greater than about 400.0 milligrams per liter and less than about 500.0 milligrams per liter. In some embodiments, the concentration of manganese is greater than about 500.0 milligrams per liter and less than about 600.0 milligrams per liter. In some embodiments, the concentration of manganese is greater than about 600.0 milligrams per liter and less than about 700.0 milligrams per liter. In some embodiments, the concentration of manganese is greater than about 700.0 milligrams per liter and less than about 800.0 milligrams per liter.

In some embodiments, the concentration of molybdenum (e.g., the concentration of molybdenum in the synthetic lithium solution) is greater than about 0.1 milligrams per liter and less than about 750 milligrams per liter. In some embodiments, the concentration of molybdenum is greater than about 1 milligrams per liter and less than about 50 milligrams per liter. In some embodiments, the concentration of molybdenum is greater than about 50 milligrams per liter and less than about 100 milligrams per liter. In some embodiments, the concentration of molybdenum is greater than about 100 milligrams per liter and less than about 200 milligrams per liter. In some embodiments, the concentration of molybdenum is greater than about 200 milligrams per liter and less than about 300 milligrams per liter. In some embodiments, the concentration of molybdenum is greater than about 300 milligrams per liter and less than about 400 milligrams per liter. In some embodiments, the concentration of molybdenum is greater than about 400.0 milligrams per liter and less than about 500.0 milligrams per liter. In some embodiments, the concentration of molybdenum is greater than about 500.0 milligrams per liter and less than about 600.0 milligrams per liter. In some embodiments, the concentration of molybdenum is greater than about 600.0 milligrams per liter and less than about 700.0 milligrams per liter. In some embodiments, the concentration of molybdenum is greater than about 700.0 milligrams per liter and less than about 800.0 milligrams per liter.

In some embodiments, the concentration of niobium (e.g., the concentration of niobium in the synthetic lithium solution) is greater than about 0.1 milligrams per liter and less than about 750 milligrams per liter. In some embodiments, the concentration of niobium is greater than about 1 milligrams per liter and less than about 50 milligrams per liter. In some embodiments, the concentration of niobium is greater than about 50 milligrams per liter and less than about 100 milligrams per liter. In some embodiments, the concentration of niobium is greater than about 100 milligrams per liter and less than about 200 milligrams per liter. In some embodiments, the concentration of niobium is greater than about 200 milligrams per liter and less than about 300 milligrams per liter. In some embodiments, the concentration of niobium is greater than about 300 milligrams per liter and less than about 400 milligrams per liter. In some embodiments, the concentration of niobium is greater than about 400.0 milligrams per liter and less than about 500.0 milligrams per liter. In some embodiments, the concentration of niobium is greater than about 500.0 milligrams per liter and less than about 600.0 milligrams per liter. In some embodiments, the concentration of niobium is greater than about 600.0 milligrams per liter and less than about 700.0 milligrams per liter. In some embodiments, the concentration of niobium is greater than about 700.0 milligrams per liter and less than about 800.0 milligrams per liter.

In some embodiments, the concentration of titanium (e.g., the concentration of titanium in the synthetic lithium solution) is greater than about 0.1 milligrams per liter and less than about 750 milligrams per liter. In some embodiments, the concentration of titanium is greater than about 1 milligrams per liter and less than about 50 milligrams per liter. In some embodiments, the concentration of titanium is greater than about 50 milligrams per liter and less than about 100 milligrams per liter. In some embodiments, the concentration of titanium is greater than about 100 milligrams per liter and less than about 200 milligrams per liter. In some embodiments, the concentration of titanium is greater than about 200 milligrams per liter and less than about 300 milligrams per liter. In some embodiments, the concentration of titanium is greater than about 300 milligrams per liter and less than about 400 milligrams per liter. In some embodiments, the concentration of titanium is greater than about 400.0 milligrams per liter and less than about 500.0 milligrams per liter. In some embodiments, the concentration of titanium is greater than about 500.0 milligrams per liter and less than about 600.0 milligrams per liter. In some embodiments, the concentration of titanium is greater than about 600.0 milligrams per liter and less than about 700.0 milligrams per liter. In some embodiments, the concentration of titanium is greater than about 700.0 milligrams per liter and less than about 800.0 milligrams per liter.

In some embodiments, the concentration of vanadium (e.g., the concentration of vanadium in the synthetic lithium solution) is greater than about 0.1 milligrams per liter and less than about 750 milligrams per liter. In some embodiments, the concentration of vanadium is greater than about 1 milligrams per liter and less than about 50 milligrams per liter. In some embodiments, the concentration of vanadium is greater than about 50 milligrams per liter and less than about 100 milligrams per liter. In some embodiments, the concentration of vanadium is greater than about 100 milligrams per liter and less than about 200 milligrams per liter. In some embodiments, the concentration of vanadium is greater than about 200 milligrams per liter and less than about 300 milligrams per liter. In some embodiments, the concentration of vanadium is greater than about 300 milligrams per liter and less than about 400 milligrams per liter. In some embodiments, the concentration of vanadium is greater than about 400.0 milligrams per liter and less than about 500.0 milligrams per liter. In some embodiments, the concentration of vanadium is greater than about 500.0 milligrams per liter and less than about 600.0 milligrams per liter. In some embodiments, the concentration of vanadium is greater than about 600.0 milligrams per liter and less than about 700.0 milligrams per liter. In some embodiments, the concentration of vanadium is greater than about 700.0 milligrams per liter and less than about 800.0 milligrams per liter.

In some embodiments, the concentration of zirconium (e.g., the concentration of zirconium in the synthetic lithium solution) is greater than about 0.1 milligrams per liter and less than about 750 milligrams per liter. In some embodiments, the concentration of zirconium is greater than about 1 milligrams per liter and less than about 50 milligrams per liter. In some embodiments, the concentration of zirconium is greater than about 50 milligrams per liter and less than about 100 milligrams per liter. In some embodiments, the concentration of zirconium is greater than about 100 milligrams per liter and less than about 200 milligrams per liter. In some embodiments, the concentration of zirconium is greater than about 200 milligrams per liter and less than about 300 milligrams per liter. In some embodiments, the concentration of zirconium is greater than about 300 milligrams per liter and less than about 400 milligrams per liter. In some embodiments, the concentration of zirconium is greater than about 400.0 milligrams per liter and less than about 500.0 milligrams per liter. In some embodiments, the concentration of zirconium is greater than about 500.0 milligrams per liter and less than about 600.0 milligrams per liter. In some embodiments, the concentration of zirconium is greater than about 600.0 milligrams per liter and less than about 700.0 milligrams per liter. In some embodiments, the concentration of zirconium is greater than about 700.0 milligrams per liter and less than about 800.0 milligrams per liter.

In some embodiments, a synthetic lithium solution comprises one or more transition metals (e.g., transition metal species). In some embodiments, the concentration of said one or more transition metals is greater than 0.01 milligrams per liter and less than about 1000 milligrams per liter. In some embodiments, the concentration of one or more transition metals is greater than about 0.1 milligrams per liter and less than about 750 milligrams per liter. In some embodiments, the concentration of said one or more transition metals is greater than about 1 milligram per liter and less than about 50 milligrams per liter. In some embodiments, the concentration of said one or more transition metals is greater than about 50 milligrams per liter and less than about 100 milligrams per liter. In some embodiments, the concentration of said one or more transition metals is greater than about 100 milligrams per liter and less than about 200 milligrams per liter. In some embodiments, the concentration of said one or more transition metals is greater than about 200 milligrams per liter and less than about 300 milligrams per liter. In some embodiments, the concentration of said one or more transition metals is greater than about 300 milligrams per liter and less than about 400 milligrams per liter. In some embodiments, the concentration of said one or more transition metals is greater than about 400 milligrams per liter and less than about 500 milligrams per liter. In some embodiments, the concentration of said one or more transition metals is greater than about 500 milligrams per liter and less than about 600 milligrams per liter. In some embodiments, the concentration of said one or more transition metals is greater than about 600 milligrams per liter and less than about 700 milligrams per liter. In some embodiments, the concentration of said one or more transition metals is greater than about 700 milligrams per liter and less than about 800 milligrams per liter. In some embodiments, the one or more transition metals comprises zirconium. In some embodiments, the one or more transition metals comprises titanium. In some embodiments, the one or more transition metals comprises vanadium. In some embodiments, the one or more transition metals comprises iron. In some embodiments, the one or more transition metals comprises copper. In some embodiments, the one or more transition metals comprises manganese. In some embodiments, the one or more transition metals comprises molybdenum. In some embodiments, the one or more transition metals comprises niobium. In some embodiments, the one or more transition metals comprises zirconium, titanium, vanadium, iron, copper, manganese, molybdenum, aluminum, or niobium, or combinations thereof.

In some embodiments, the concentration of bicarbonate (e.g., the concentration of bicarbonate in the synthetic lithium solution) is greater than about 1000.0 milligrams per liter and less than about 30000 milligrams per liter. In some embodiments, the concentration of bicarbonate is greater than about 10 milligrams per liter and less than about 100 milligrams per liter. In some embodiments, the concentration of bicarbonate is greater than about 100 milligrams per liter and less than about 500 milligrams per liter. In some embodiments, the concentration of bicarbonate is greater than about 500 milligrams per liter and less than about 1000 milligrams per liter. In some embodiments, the concentration of bicarbonate is greater than about 1000 milligrams per liter and less than about 5000 milligrams per liter. In some embodiments, the concentration of bicarbonate is greater than about 5000 milligrams per liter and less than about 10000 milligrams per liter. In some embodiments, the concentration of bicarbonate is greater than about 10000.0 milligrams per liter and less than about 50000.0 milligrams per liter. In some embodiments, the concentration of bicarbonate is greater than about 50000.0 milligrams per liter and less than about 100000.0 milligrams per liter. In some embodiments, the concentration of bicarbonate is greater than about 100000.0 milligrams per liter and less than about 200000.0 milligrams per liter. In some embodiments, the concentration of bicarbonate is greater than about 200000.0 milligrams per liter and less than about 300000.0 milligrams per liter. In some embodiments, the concentration of bicarbonate is greater than about 300000.0 milligrams per liter and less than about 500000.0 milligrams per liter.

In some embodiments, the concentration of borate (e.g., the concentration of borate in the synthetic lithium solution) is greater than about 1000.0 milligrams per liter and less than about 30000 milligrams per liter. In some embodiments, the concentration of borate is greater than about 10 milligrams per liter and less than about 100 milligrams per liter. In some embodiments, the concentration of borate is greater than about 100 milligrams per liter and less than about 500 milligrams per liter. In some embodiments, the concentration of borate is greater than about 500 milligrams per liter and less than about 1000 milligrams per liter. In some embodiments, the concentration of borate is greater than about 1000 milligrams per liter and less than about 5000 milligrams per liter. In some embodiments, the concentration of borate is greater than about 5000 milligrams per liter and less than about 10000 milligrams per liter. In some embodiments, the concentration of borate is greater than about 10000.0 milligrams per liter and less than about 50000.0 milligrams per liter. In some embodiments, the concentration of borate is greater than about 50000.0 milligrams per liter and less than about 100000.0 milligrams per liter. In some embodiments, the concentration of borate is greater than about 100000.0 milligrams per liter and less than about 200000.0 milligrams per liter. In some embodiments, the concentration of borate is greater than about 200000.0 milligrams per liter and less than about 300000.0 milligrams per liter. In some embodiments, the concentration of borate is greater than about 300000.0 milligrams per liter and less than about 500000.0 milligrams per liter.

In some embodiments, the concentration of bromide (e.g., the concentration of bromide in the synthetic lithium solution) is greater than about 1000.0 milligrams per liter and less than about 30000 milligrams per liter. In some embodiments, the concentration of bromide is greater than about 10 milligrams per liter and less than about 100 milligrams per liter. In some embodiments, the concentration of bromide is greater than about 100 milligrams per liter and less than about 500 milligrams per liter. In some embodiments, the concentration of bromide is greater than about 500 milligrams per liter and less than about 1000 milligrams per liter. In some embodiments, the concentration of bromide is greater than about 1000 milligrams per liter and less than about 5000 milligrams per liter. In some embodiments, the concentration of bromide is greater than about 5000 milligrams per liter and less than about 10000 milligrams per liter. In some embodiments, the concentration of bromide is greater than about 10000.0 milligrams per liter and less than about 50000.0 milligrams per liter. In some embodiments, the concentration of bromide is greater than about 50000.0 milligrams per liter and less than about 100000.0 milligrams per liter. In some embodiments, the concentration of bromide is greater than about 100000.0 milligrams per liter and less than about 200000.0 milligrams per liter. In some embodiments, the concentration of bromide is greater than about 200000.0 milligrams per liter and less than about 300000.0 milligrams per liter. In some embodiments, the concentration of bromide is greater than about 300000.0 milligrams per liter and less than about 500000.0 milligrams per liter.

In some embodiments, the concentration of carbonate (e.g., the concentration of carbonate in the synthetic lithium solution) is greater than about 1000.0 milligrams per liter and less than about 30000 milligrams per liter. In some embodiments, the concentration of carbonate is greater than about 10 milligrams per liter and less than about 100 milligrams per liter. In some embodiments, the concentration of carbonate is greater than about 100 milligrams per liter and less than about 500 milligrams per liter. In some embodiments, the concentration of carbonate is greater than about 500 milligrams per liter and less than about 1000 milligrams per liter. In some embodiments, the concentration of carbonate is greater than about 1000 milligrams per liter and less than about 5000 milligrams per liter. In some embodiments, the concentration of carbonate is greater than about 5000 milligrams per liter and less than about 10000 milligrams per liter. In some embodiments, the concentration of carbonate is greater than about 10000.0 milligrams per liter and less than about 50000.0 milligrams per liter. In some embodiments, the concentration of carbonate is greater than about 50000.0 milligrams per liter and less than about 100000.0 milligrams per liter. In some embodiments, the concentration of carbonate is greater than about 100000.0 milligrams per liter and less than about 200000.0 milligrams per liter. In some embodiments, the concentration of carbonate is greater than about 200000.0 milligrams per liter and less than about 300000.0 milligrams per liter. In some embodiments, the concentration of carbonate is greater than about 300000.0 milligrams per liter and less than about 500000.0 milligrams per liter.

In some embodiments, the concentration of chloride (e.g., the concentration of chloride in the synthetic lithium solution) is greater than about 1000.0 milligrams per liter and less than about 30000 milligrams per liter. In some embodiments, the concentration of chloride is greater than about 10 milligrams per liter and less than about 100 milligrams per liter. In some embodiments, the concentration of chloride is greater than about 100 milligrams per liter and less than about 500 milligrams per liter. In some embodiments, the concentration of chloride is greater than about 500 milligrams per liter and less than about 1000 milligrams per liter. In some embodiments, the concentration of chloride is greater than about 1000 milligrams per liter and less than about 5000 milligrams per liter. In some embodiments, the concentration of chloride is greater than about 5000 milligrams per liter and less than about 10000 milligrams per liter. In some embodiments, the concentration of chloride is greater than about 10000.0 milligrams per liter and less than about 50000.0 milligrams per liter. In some embodiments, the concentration of chloride is greater than about 50000.0 milligrams per liter and less than about 100000.0 milligrams per liter. In some embodiments, the concentration of chloride is greater than about 100000.0 milligrams per liter and less than about 200000.0 milligrams per liter. In some embodiments, the concentration of chloride is greater than about 200000.0 milligrams per liter and less than about 300000.0 milligrams per liter. In some embodiments, the concentration of chloride is greater than about 300000.0 milligrams per liter and less than about 500000.0 milligrams per liter.

In some embodiments, the concentration of fluoride (e.g., the concentration of fluoride in the synthetic lithium solution) is greater than about 1000.0 milligrams per liter and less than about 30000 milligrams per liter. In some embodiments, the concentration of fluoride is greater than about 10 milligrams per liter and less than about 100 milligrams per liter. In some embodiments, the concentration of fluoride is greater than about 100 milligrams per liter and less than about 500 milligrams per liter. In some embodiments, the concentration of fluoride is greater than about 500 milligrams per liter and less than about 1000 milligrams per liter. In some embodiments, the concentration of fluoride is greater than about 1000 milligrams per liter and less than about 5000 milligrams per liter. In some embodiments, the concentration of fluoride is greater than about 5000 milligrams per liter and less than about 10000 milligrams per liter. In some embodiments, the concentration of fluoride is greater than about 10000.0 milligrams per liter and less than about 50000.0 milligrams per liter. In some embodiments, the concentration of fluoride is greater than about 50000.0 milligrams per liter and less than about 100000.0 milligrams per liter. In some embodiments, the concentration of fluoride is greater than about 100000.0 milligrams per liter and less than about 200000.0 milligrams per liter. In some embodiments, the concentration of fluoride is greater than about 200000.0 milligrams per liter and less than about 300000.0 milligrams per liter. In some embodiments, the concentration of fluoride is greater than about 300000.0 milligrams per liter and less than about 500000.0 milligrams per liter.

In some embodiments, the concentration of hydrogencarbonate (e.g., the concentration of hydrogencarbonate in the synthetic lithium solution) is greater than about 1000.0 milligrams per liter and less than about 30000 milligrams per liter. In some embodiments, the concentration of hydrogencarbonate is greater than about 10 milligrams per liter and less than about 100 milligrams per liter. In some embodiments, the concentration of hydrogencarbonate is greater than about 100 milligrams per liter and less than about 500 milligrams per liter. In some embodiments, the concentration of hydrogencarbonate is greater than about 500 milligrams per liter and less than about 1000 milligrams per liter. In some embodiments, the concentration of hydrogencarbonate is greater than about 1000 milligrams per liter and less than about 5000 milligrams per liter. In some embodiments, the concentration of hydrogencarbonate is greater than about 5000 milligrams per liter and less than about 10000 milligrams per liter. In some embodiments, the concentration of hydrogencarbonate is greater than about 10000.0 milligrams per liter and less than about 50000.0 milligrams per liter. In some embodiments, the concentration of hydrogencarbonate is greater than about 50000.0 milligrams per liter and less than about 100000.0 milligrams per liter. In some embodiments, the concentration of hydrogencarbonate is greater than about 100000.0 milligrams per liter and less than about 200000.0 milligrams per liter. In some embodiments, the concentration of hydrogencarbonate is greater than about 200000.0 milligrams per liter and less than about 300000.0 milligrams per liter. In some embodiments, the concentration of hydrogencarbonate is greater than about 300000.0 milligrams per liter and less than about 500000.0 milligrams per liter.

In some embodiments, the concentration of nitrate (e.g., the concentration of nitrate in the synthetic lithium solution) is greater than about 1000.0 milligrams per liter and less than about 30000 milligrams per liter. In some embodiments, the concentration of nitrate is greater than about 10 milligrams per liter and less than about 100 milligrams per liter. In some embodiments, the concentration of nitrate is greater than about 100 milligrams per liter and less than about 500 milligrams per liter. In some embodiments, the concentration of nitrate is greater than about 500 milligrams per liter and less than about 1000 milligrams per liter. In some embodiments, the concentration of nitrate is greater than about 1000 milligrams per liter and less than about 5000 milligrams per liter. In some embodiments, the concentration of nitrate is greater than about 5000 milligrams per liter and less than about 10000 milligrams per liter. In some embodiments, the concentration of nitrate is greater than about 10000.0 milligrams per liter and less than about 50000.0 milligrams per liter. In some embodiments, the concentration of nitrate is greater than about 50000.0 milligrams per liter and less than about 100000.0 milligrams per liter. In some embodiments, the concentration of nitrate is greater than about 100000.0 milligrams per liter and less than about 200000.0 milligrams per liter. In some embodiments, the concentration of nitrate is greater than about 200000.0 milligrams per liter and less than about 300000.0 milligrams per liter. In some embodiments, the concentration of nitrate is greater than about 300000.0 milligrams per liter and less than about 500000.0 milligrams per liter.

In some embodiments, the concentration of phosphate (e.g., the concentration of phosphate in the synthetic lithium solution) is greater than about 1000.0 milligrams per liter and less than about 30000 milligrams per liter. In some embodiments, the concentration of phosphate is greater than about 10 milligrams per liter and less than about 100 milligrams per liter. In some embodiments, the concentration of phosphate is greater than about 100 milligrams per liter and less than about 500 milligrams per liter. In some embodiments, the concentration of phosphate is greater than about 500 milligrams per liter and less than about 1000 milligrams per liter. In some embodiments, the concentration of phosphate is greater than about 1000 milligrams per liter and less than about 5000 milligrams per liter. In some embodiments, the concentration of phosphate is greater than about 5000 milligrams per liter and less than about 10000 milligrams per liter. In some embodiments, the concentration of phosphate is greater than about 10000.0 milligrams per liter and less than about 50000.0 milligrams per liter. In some embodiments, the concentration of phosphate is greater than about 50000.0 milligrams per liter and less than about 100000.0 milligrams per liter. In some embodiments, the concentration of phosphate is greater than about 100000.0 milligrams per liter and less than about 200000.0 milligrams per liter. In some embodiments, the concentration of phosphate is greater than about 200000.0 milligrams per liter and less than about 300000.0 milligrams per liter. In some embodiments, the concentration of phosphate is greater than about 300000.0 milligrams per liter and less than about 500000.0 milligrams per liter.

In some embodiments, the concentration of sulfate (e.g., the concentration of sulfate in the synthetic lithium solution) is greater than about 1000.0 milligrams per liter and less than about 30000 milligrams per liter. In some embodiments, the concentration of sulfate is greater than about 10 milligrams per liter and less than about 100 milligrams per liter. In some embodiments, the concentration of sulfate is greater than about 100 milligrams per liter and less than about 500 milligrams per liter. In some embodiments, the concentration of sulfate is greater than about 500 milligrams per liter and less than about 1000 milligrams per liter. In some embodiments, the concentration of sulfate is greater than about 1000 milligrams per liter and less than about 5000 milligrams per liter. In some embodiments, the concentration of sulfate is greater than about 5000 milligrams per liter and less than about 10000 milligrams per liter. In some embodiments, the concentration of sulfate is greater than about 10000.0 milligrams per liter and less than about 50000.0 milligrams per liter. In some embodiments, the concentration of sulfate is greater than about 50000.0 milligrams per liter and less than about 100000.0 milligrams per liter. In some embodiments, the concentration of sulfate is greater than about 100000.0 milligrams per liter and less than about 200000.0 milligrams per liter. In some embodiments, the concentration of sulfate is greater than about 200000.0 milligrams per liter and less than about 300000.0 milligrams per liter. In some embodiments, the concentration of sulfate is greater than about 300000.0 milligrams per liter and less than about 500000.0 milligrams per liter.

In some embodiments, the value of pH (e.g., the pH of the synthetic lithium solution) is greater than about 1.0 and less than about 4.0. In some embodiments, the value of pH is greater than about 0.0 and less than about 1.0. In some embodiments, the value of pHis greater than about 1.0 and less than about 2.0. In some embodiments, the value of pH is greater than about 2.0 and less than about 3.0. In some embodiments, the value of pH is greater than about 3.0 and less than about 4.0. In some embodiments, the value of pH is greater than about 4.0 and less than about 5.0. In some embodiments, the value of pH is greater than about 5.0 and less than about 6.0. In some embodiments, the value of pH is greater than about 6.0 and less than about 7.0. In some embodiments, the value of pH is greater than about 7.0 and less than about 8.0. In some embodiments, the value of pH is greater than about 8.0 and less than about 9.0. In some embodiments, the value of pH is greater than about 9.0 and less than about 10.0. In some embodiments, the value of pH is greater than about 10.0 and less than about 11.0. In some embodiments, the value of pH is greater than about 11.0 and less than about 12.0.

In some embodiments, the value of oxidation-reduction potential (e.g., the oxidation-reduction potential of the synthetic lithium solution versus standard hydrogen electrode) is greater than about 50.0 mV and less than about 800.0 mV. In some embodiments, the value of oxidation-reduction potential is greater than about 100.0 mV and less than about 500.0 mV. In some embodiments, the value of oxidation-reduction potential is greater than about 200.0 mV and less than about 400.0 mV. In some embodiments, the value of oxidation-reduction potential is greater than about −450.0 mV and less than about 0.0 mV. In some embodiments, the value of oxidation-reduction potential is greater than about −200.0 mV and less than about 50.0 mV. In some embodiments, the value of oxidation-reduction potential is greater than about −50.0 mV and less than about 100.0 mV. In some embodiments, the value of oxidation-reduction potential is greater than about 50.0 mV and less than about 300.0 mV. In some embodiments, the value of oxidation-reduction potential is greater than about 100.0 mV and less than about 400.0 mV. In some embodiments, the value of oxidation-reduction potential is greater than about 200.0 mV and less than about 600.0 mV. In some embodiments, the value of oxidation-reduction potential is greater than about 300.0 mV and less than about 800.0 mV. In some embodiments, the value of oxidation-reduction potential is greater than about 500.0 mV and less than about 1000.0 mV. In some embodiments, the value of oxidation-reduction potential is greater than about 750.0 mV and less than about 1100.0 mV.

Treatment of the Eluate Produced from Lithium Extraction to Produce Lithium Products

In some embodiments, the lithium eluate solution (e.g., the synthetic lithium solution) that is yielded from the ion exchange reactor (e.g., vessel, column, tank, compartment, filter bank) is further processed into lithium chemicals selected from the following list: lithium sulfate, lithium chloride, lithium carbonate, lithium phosphate, lithium hydroxide, lithium metal, lithium metal oxide, lithium metal phosphate, lithium sulfide, or combinations thereof. In some embodiments, the lithium eluate solution that is yielded from the ion exchange reactor is further processed into lithium chemicals that are solid, aqueous, liquid, slurry form, hydrated, or anhydrous.

In some embodiments, the lithium eluate solution (e.g., the synthetic lithium solution) that is yielded from the ion exchange reactor is further processed using acid recovery, acid recycling, acid regeneration, distillation, reverse osmosis, evaporation, purification, chemical precipitation, membrane electrolysis, or combinations thereof.

In some embodiments, the lithium eluate (e.g., the synthetic lithium solution) is purified using hydroxide precipitation, carbonate precipitation, other precipitate, ion exchange, solvent extraction, and/or other extraction methods to remove divalent ions, multivalent ions, boron, or other chemical species. In some embodiments, the lithium eluate is concentrated using reverse osmosis, mechanical evaporation, mechanical vapor recompression, solar thermal heating, concentrated solar thermal heating, and/or solar evaporation.

In some embodiments, a lithium eluate (e.g., a synthetic lithium solution) is processed into a lithium stream that is treated with sodium carbonate to precipitate lithium carbonate. In some embodiments, a lithium chloride stream (e.g., a synthetic lithium solution) is treated with sodium carbonate to precipitate lithium carbonate. In some embodiments, a lithium sulfate stream (e.g., a synthetic lithium solution) is treated with sodium carbonate to precipitate lithium carbonate. In some embodiments, a lithium nitrate stream (e.g., a synthetic lithium solution) is treated with sodium carbonate to precipitate lithium carbonate.

In some embodiments, a lithium eluate (e.g., a synthetic lithium solution) is processed into a lithium stream that is treated with sodium hydroxide to crystallize a lithium hydroxide product. In some embodiments, a lithium sulfate stream is treated with sodium hydroxide to crystallize a lithium hydroxide product. In some embodiments, a lithium chloride stream is treated with sodium hydroxide to crystallize a lithium hydroxide product. In some embodiments, a lithium nitrate stream is treated with sodium hydroxide to crystallize a lithium hydroxide product.

### Removal of Impurities

In some embodiments, impurities (e.g., transition metal species) are removed from an IEL eluate (e.g., a synthetic lithium solution) and/or new IEL eluate using an impurities selective ion exchange material, nanofiltration, chemical precipitation, electrochemical separation, temperature reduction precipitation, other methods of removing impurities, or combinations thereof. In some embodiments, impurities are removed using combinations of impurities selective ion exchange material, nanofiltration, chemical precipitation, electrochemical separation, temperature reduction precipitation, other methods of removing multivalent impurities, or combinations thereof, in parallel, in series, or combinations thereof.

In some embodiments, impurities are removed by absorption of said impurities into an absorbent material. In some embodiments, said absorbent material comprises activated carbon. In some embodiments, said absorbent material comprises an oxide. In some embodiments, said oxide comprises alumina, silica, or a combination thereof. In some embodiments, said absorbent is a zeolite or a functionalized zeolite.

### Impurities Selective Ion Exchange Material

In some embodiments, for any lithium extraction process or system described herein, impurities (e.g., transition metal species) are at least removed by contacting an impurities-enriched lithiated (IEL) acidic solution (e.g., a synthetic lithium solution) with an impurities selective ion exchange material. In some embodiments, impurities selective ion exchange material comprises multivalent impurities selective ion exchange material. In some embodiments, the multivalent impurities selective ion exchange material comprises multivalent cation selective (MCS) ion exchange material. In some embodiments, MCS ion exchange material is provided in a packed bed. In some embodiments, MCS ion exchange material is provided in a fluidized bed. In some embodiments, MCS ion exchange material is located in a MCS vessel. In some embodiments, MCS ion exchange material is arranged in a network of MCS vessels. In some embodiments, MCS ion exchange material is arranged in a network of MCS vessels, wherein IEL acidic solution (e.g., a synthetic lithium solution) is sequentially passed through the network of MCS vessels, such that multivalent cations are absorbed from the IEL acidic solution as it passes through each MCS vessel. In some embodiments, the amount of multivalent cations absorbed from a IEL acidic solution (e.g., a synthetic lithium solution) passing through a network of MCS vessels decreases from a first MCS vessel in the sequence of IEL acidic solution flow to a last MCS vessel in said sequence. In some embodiments, the last MCS vessel in said sequence absorbs trace amounts of multivalent cations. In some embodiments, the sequence of the plurality of MCS vessels is rearranged based on the saturation of the MCS ion exchange material in each MCS vessel. In some embodiments, MCS ion exchange material is arranged in a lead-lag configuration. In some embodiments, the MCS ion exchange material is arranged in a variation of a lead-lag setup. In some embodiments, the MCS ion exchange material is eluted using a second acidic solution. In some embodiments, the MCS ion exchange material is eluted using hydrochloric acid. In some embodiments, the MCS ion exchange material is regenerated using sodium hydroxide, potassium hydroxide, or a combination thereof. In some embodiments, the MCS ion exchange material is provided in one or more stirred tank reactors, tanks, columns, fluidized beds, packed beds, or combinations thereof, and arranged in series and/or parallel.

In one embodiment, a multivalent cation selective (MCS) ion exchange material is selective for cations with a charge of 2+, 3+, 4+, 5+, 6+, or combinations thereof.

In one embodiment, the multivalent selective cation exchange material is comprised of polystyrene, polybutadiene, mixtures thereof, modifications thereof, or combinations thereof. In one embodiment, the multivalent selective cation exchange material is comprised of polystyrene, polystyrene functionalized with sulfonate, polystyrene-polybutadiene copolymer functionalized with sulfonate group and/or phosphonate group, poly(2-acrylamido-2-methyl-1-propanesulfonic acid) (Poly AMPS), poly(styrene-co-divinylbenzene) copolymer functionalized with sulfonate group, phosphonate group, iminodiacetic group, carboxylic acid group, mixtures thereof, modifications thereof, or combinations thereof. In one embodiment, the ion exchange material for impurity removal is comprised of polystyrene, polybutadiene, mixtures thereof, modifications thereof, or combinations thereof. In one embodiment, the ion exchange material for impurity removal is comprised of polystyrene, polybutadiene, poly divinyl benzene, divinyl benzene, polystyrene functionalized with sulfonate, polystyrene-polybutadiene copolymer functionalized with sulfonate group and/or phosphonate group, poly(2-acrylamido-2-methyl-1-propanesulfonic acid) (Poly AMPS), poly(styrene-co-divinylbenzene) copolymer functionalized with sulfonate group, phosphonate group, iminodiacetic group, carboxylic acid group, mixtures thereof, modifications thereof, or combinations thereof. In one embodiment, the multivalent selective cation exchange material is comprised of a zeolite, clinoptilolite, bentonite, glauconite, mixtures thereof, modifications thereof, or combinations thereof. In one embodiment, the ion exchange material for impurity removal is comprised a strong acidic cation exchange resin. In one embodiment, a strong acidic cation exchange resin is used to remove multivalent cations from an acidic solution containing lithium. In one embodiment, the ion exchange material for impurity removal is comprised a gel-type strong acidic cation exchange resin. In one embodiment, a gel-type strong acidic cation exchange resin is used to remove multivalent cations from an acidic solution containing lithium. In one embodiment, the ion exchange material for impurity removal is comprised a gel-type strong acidic cation exchange resin with a gaussian, narrow, or other particle size distribution. In one embodiment, the ion exchange material for impurity removal is operated in co-flow or counter-flow. In one embodiment, the ion exchange material for impurity removal is contacted with alternating flows of acidic eluate solution containing lithium and impurities (e.g., synthetic lithium solution), and flows of hydrochloric acid solution. In one embodiment, the ion exchange material for impurity removal is contacted with alternating flows of acidic eluate solution containing lithium and impurities (e.g., synthetic lithium solution), and flows of hydrochloric acid solution in the same or opposite directions.

In one embodiment, the ion exchange material for impurity (e.g., transition metal species) removal from the acidic lithium solution (e.g., impurities-enriched lithiated (IEL) acidic solution as described herein, synthetic lithium solution) is a styrene divinylbenzene copolymer. In one embodiment, the ion exchange material for impurity removal from the acidic lithium solution is a styrene divinylbenzene copolymer with sulfonic acid functional groups. In one embodiment, the ion exchange material for impurity removal from the acidic lithium solution is a styrene copolymer with sulfonic acid functional groups. In one embodiment, the ion exchange material for impurity removal from the acidic lithium solution is a styrene butadiene copolymer with sulfonic acid functional groups. In one embodiment, the ion exchange material for impurity removal comprises beads with a mean diameter of about 10-50 microns, 50-100 microns, 100-200 microns, 200-400 microns, 300-500 microns, 400-600 microns, 600-800 microns, 200-500 microns, 400-800 microns, 500-1000 microns, 800-1600 microns, or 1000-2000 microns. In one embodiment, the ion exchange material for selective lithium extraction from the liquid resources comprises beads with a mean diameter of about 10-50 microns, 50-100 microns, 100-200 microns, 200-400 microns, 300-500 microns, 400-600 microns, 600-800 microns, 200-500 microns, 400-800 microns, 500-1000 microns, 800-1600 microns, or 1000-2000 microns.

In one embodiment, the ion exchange material for impurity removal from the acidic lithium solution (e.g., the synthetic lithium solution) is a copolymer of styrene, divinylbenzene, butadiene, or combinations thereof. In one embodiment, the ion exchange material for impurity removal from the acidic lithium solution is a mixture of styrene, divinylbenzene, butadiene, or combinations thereof.

In one embodiment, the ion exchange material for impurity removal from the acidic lithium solution (e.g., the synthetic lithium solution) is a copolymer of styrene, divinylbenzene, butadiene, or combinations thereof functionalized with sulfonic-acid groups. In one embodiment, the ion exchange material for impurity removal from the acidic lithium solution is a mixture of styrene, divinylbenzene, butadiene, or combinations thereof functionalized with sulfonic-acid groups.

In one embodiment, the ion exchange material for impurity removal from the acidic lithium solution (e.g., the synthetic lithium solution) is a copolymer of styrene, divinylbenzene, butadiene, or combinations thereof functionalized with phosphonic-acid groups. In one embodiment, the ion exchange material for impurity removal from the acidic lithium solution is a mixture of styrene, divinylbenzene, butadiene, or combinations thereof functionalized with phosphonic-acid groups.

In one embodiment, the ion exchange material for impurity removal from the acidic lithium solution (e.g., the synthetic lithium solution) is a copolymer functionalized with sulfonic-acid groups. In one embodiment, the ion exchange material for impurity removal from the acidic lithium solution is a polymer functionalized with sulfonic-acid groups.

In one embodiment, the ion exchange material for impurity removal from the acidic lithium solution (e.g., the synthetic lithium solution) is a copolymer functionalized with phosphonic-acid groups. In one embodiment, the ion exchange material for impurity removal from the acidic lithium solution is a polymer functionalized with phosphonic-acid groups.

In one embodiment, the ion exchange material for impurity removal from the acidic lithium solution (e.g., the synthetic lithium solution) is a styrene-divinylbenzene copolymer functionalized with sulfonic acid groups. In one embodiment, the ion exchange material for impurity removal from the acidic lithium solution is a styrene-butadiene copolymer functionalized with sulfonic acid groups. In one embodiment, the ion exchange material for impurity removal from the acidic lithium solution is a divinylbenzene-butadiene copolymer functionalized with sulfonic acid groups. In one embodiment, the ion exchange material for impurity removal from the acidic lithium solution is a styrene-butadiene-divinylbenzene copolymer functionalized with sulfonic acid groups.

In one embodiment, the ion exchange material for impurity removal from the acidic lithium solution (e.g., the synthetic lithium solution) is a styrene-divinylbenzene copolymer functionalized with phosphonic acid groups. In one embodiment, the ion exchange material for impurity removal from the acidic lithium solution is a styrene-butadiene copolymer functionalized with phosphonic acid groups. In one embodiment, the ion exchange material for impurity removal from the acidic lithium solution is a divinylbenzene-butadiene copolymer functionalized with phosphonic acid groups. In one embodiment, the ion exchange material for impurity removal from the acidic lithium solution is a styrene-butadiene-divinylbenzene copolymer functionalized with phosphonic acid groups.

In one embodiment, the ion exchange material for impurity removal from the acidic lithium solution (e.g., the synthetic lithium solution) is a vinylbenzene copolymer functionalized with sulfonic acid or phosphonic acid groups. In one embodiment, the ion exchange material for impurity removal from the acidic lithium solution is a vinylbenzene chloride copolymer functionalized with sulfonic acid or phosphonic acid groups. In one embodiment, the ion exchange material for impurity removal from the acidic lithium solution is a vinylidene copolymer functionalized with sulfonic acid or phosphonic acid groups. In one embodiment, the ion exchange material for impurity removal from the acidic lithium solution is an acrylonitrile copolymer functionalized with sulfonic acid or phosphonic acid groups.

In some embodiments, the ion exchange material for impurity removal from the acidic lithium solution is a polymer functionalized with phosphoric or phosphinic acid groups.

### Nanofiltration

In some embodiments, for any lithium extraction process or system described herein, impurities (e.g., transition metal species) are at least removed by passing an impurities-enriched lithiated (IEL) acidic solution (e.g., a synthetic lithium solution) through one or more nanofiltration membrane units arranged in series and/or parallel. In some embodiments, the one or more nanofiltration membrane units comprises nanofiltration membrane material. In some embodiments, a nanofiltration membrane unit or a nanofiltration unit comprises a filter. The filter can comprise a nanofiltration membrane material.

In one embodiment, impurities (e.g., transition metal species) are removed from an IEL acidic solution (e.g., a synthetic lithium solution) using a nanofiltration membrane material. In one embodiment, impurities are removed from an acidic solution using a nanofiltration membrane material. In one embodiment, the nanofiltration membrane material is comprised of cellulose, cellulose acetate, cellulose diacetate, cellulose triacetate, polyamide, poly(piperazine-amide), mixtures thereof, modifications thereof, or combinations thereof. In one embodiment, the nanofiltration membrane material is comprised of a thin-film composite. In one embodiment, the nanofiltration membrane material is comprised of polyamide with a support comprised of polyacrylonitrile (PAN), polyethersulfone, polysulfone, polyphenylene sulfone, cellulose acetate, polyimide, polypropylene, polyketone, polyethylene terephthalate, mixtures thereof, modifications thereof, or combinations thereof. In one embodiment, the nanofiltration membrane material is comprised of polyethylene terephthalate. In one embodiment, the nanofiltration membrane material is comprised of ceramic material. In one embodiment, the nanofiltration membrane material is comprised of alumina, zirconia, yttria stabilized zirconia, titania, silica, mixtures thereof, modifications thereof, or combinations thereof. In one embodiment, the nanofiltration membrane material is comprised of carbon, carbon nanotubes, graphene oxide, mixtures thereof, modifications thereof, or combinations thereof. In one embodiment, the nanofiltration membrane material is comprised of zeolite mixed matrix membrane with polyamide and/or polysulfone support, alumina filled polyvinyl alcohol mixed matrix membrane materials, mixtures thereof, modifications thereof, or combinations thereof.

In some embodiments, anti-scalants, chelants (e.g., chelators, chelating agents), and/or other means of anti-scaling are used to avoid scaling in the nanofiltration membrane units. In some embodiments, anti-scalants are flowed through nanofiltration membrane units or ion exchange vessels to avoid formation of scalants.

### Precipitation

In one embodiment, impurities (e.g., transition metal species) are removed from the acidic solution using precipitation. In one embodiment, impurities are removed from the acidic solution using electrochemical precipitation. In one embodiment, impurities (e.g., transition metal species) are removed from the acidic solution using chemical, carbonate precipitation, hydroxide precipitation, phosphate precipitation, or combinations thereof. In one embodiment, impurities are removed from the acidic solution by adding phosphate to precipitate calcium phosphate, magnesium phosphate, barium phosphate, and/or other phosphate compounds. In one embodiment, impurities are removed from the acidic solution by adding sodium phosphate, potassium phosphate, phosphoric acid, or other phosphate compounds to precipitate calcium phosphate, magnesium phosphate, barium phosphate, and/or other phosphate compounds. In one embodiment, residual phosphate is removed from the acidic solution. In one embodiment, residual phosphate is removed from the acidic solution using ion exchange or precipitation. In one embodiment, residual phosphate is removed from the acidic solution using precipitation with aluminum or iron.

In some embodiments, for any lithium extraction process or system described herein, impurities (e.g., transition metal species) are at least removed from an impurities-enriched lithiated (IEL) acidic solution (e.g., a synthetic lithium solution) using chemically induced precipitation. In some embodiments, multivalent impurities are removed from the IEL acidic solution (e.g., the synthetic lithium solution) through carbonate precipitation, hydroxide precipitation, phosphate precipitation, or combinations thereof. In some embodiments, multivalent impurities are removed from the IEL acidic solution by adding phosphate to precipitate calcium phosphate, magnesium phosphate, barium phosphate, and/or other phosphate compounds. In some embodiments, multivalent impurities are removed from the IEL acidic solution by adding sodium phosphate, potassium phosphate, phosphoric acid, and/or other phosphate compounds to precipitate calcium phosphate, magnesium phosphate, barium phosphate, and/or other phosphate compounds. In some embodiments, residual phosphate is removed from the IEL acidic solution. In some embodiments, residual phosphate is removed from the IEL acidic solution using ion exchange or precipitation. In some embodiments, residual phosphate is removed from the IEL acidic solution using precipitation with aluminum or iron.

In some embodiments, multivalent impurities are removed from the IEL acidic solution (e.g., the synthetic lithium solution) by adding phosphoric acid to precipitate phosphate compounds. In some embodiments, adding phosphoric acid removes Ca, Mg, Sr, and/or Ba from the IEL acidic solution through precipitation of Ca, Mg, Sr, and/or Ba phosphate compounds.

In some embodiments, multivalent impurities (e.g., transition metal species) are removed from the IEL acidic solution (e.g., the synthetic lithium solution) by adding an oxalate, oxalic acid, citrate, citric acid, or combinations thereof. In some embodiments, the oxalate, oxalic acid, citrate, citric acid, or combinations thereof are added as a precipitant, such that multivalent impurities are precipitated. In some embodiments, the precipitant concentration in the IEL acidic solution is subsequently decreased through precipitation by adding cation precipitants to the IEL acidic solution. In some embodiments, multivalent impurities are removed from the IEL acidic solution by adding oxalate to the IEL acidic solution to precipitate the multivalent impurities. In some embodiments, residual oxalate anions are precipitated and removed from the resulting lithium enriched acidic solution by adding cation precipitants. In some embodiments, cation precipitants comprise zinc, iron, manganese, other transition metals, other cations, or combinations thereof. In some embodiments, multivalent impurities are removed from the IEL acidic solution by adding citrate to the IEL acidic solution to precipitate the multivalent impurities. In some embodiments, residual citrate anions are precipitated and removed from the resulting lithium enriched acidic solution by adding cation precipitants. In some embodiments, cation precipitants comprise zinc, iron, manganese, other transition metals, other cations, or combinations thereof. In some embodiments, multivalent impurities are removed from the IEL acidic solution by adding anion precipitants to the IEL acidic solution to precipitate the multivalent impurities. In some embodiments, residual anions are precipitated and removed from the resulting lithium enriched acidic solution by adding cation precipitants. In some embodiments, cation precipitants comprise zinc, iron, manganese, other transition metals, other cations, or combinations thereof.

In some embodiments, multivalent impurities (e.g., transition metal species) are removed from the eluate solution (e.g., the synthetic lithium solution). In some embodiments, multivalent impurities (e.g., transition metal species) are removed from the eluate (e.g., the synthetic lithium solution) after the pH of said eluate has been adjusted to a pH higher than the pH in which it exits the ion exchange system. In some embodiments, said pH adjustment results in precipitation of one or more species comprising a multivalent ion species (e.g., a transition metal species). In some embodiments, said pH-adjusted eluate is further treated to remove impurities by precipitation driven by addition of further reagents.

In some embodiments, the pH of the synthetic lithium solution (e.g., eluate) is adjusted before impurities (e.g., transition metal species) are removed. In some embodiments, the pH of the synthetic lithium solution is adjusted after impurities (e.g., transition metal species) are removed. In some embodiments, the pH of the synthetic lithium solution is adjusted by removing impurities (e.g., transition metal species). In some embodiments, the pH of the synthetic lithium solution is adjusted by the addition of an acid. In some embodiments, the pH of the synthetic lithium solution is adjusted by the addition of a base. Said adjustment can raise the pH of the synthetic lithium solution. Said adjustment can lower the pH of the synthetic lithium solution. In some embodiments, the pH of the synthetic lithium solution following said adjustment is between about 0 and about 14. In some embodiments, the pH of the synthetic lithium solution following said adjustment is about 0. In some embodiments, the pH of the synthetic lithium solution following said adjustment is about 1. In some embodiments, the pH of the synthetic lithium solution following said adjustment is about 2. In some embodiments, the pH of the synthetic lithium solution following said adjustment is about 3. In some embodiments, the pH of the synthetic lithium solution following said adjustment is about 4. In some embodiments, the pH of the synthetic lithium solution following said adjustment is about 5. In some embodiments, the pH of the synthetic lithium solution following said adjustment is about 6. In some embodiments, the pH of the synthetic lithium solution following said adjustment is about 7. In some embodiments, the pH of the synthetic lithium solution following said adjustment is about 8. In some embodiments, the pH of the synthetic lithium solution following said adjustment is about 9. In some embodiments, the pH of the synthetic lithium solution following said adjustment is about 10. In some embodiments, the pH of the synthetic lithium solution following said adjustment is about 11. In some embodiments, the pH of the synthetic lithium solution following said adjustment is about 12. In some embodiments, the pH of the synthetic lithium solution following said adjustment is about 13. In some embodiments, the pH of the synthetic lithium solution following said adjustment is about 14. In some embodiments, the pH of the synthetic lithium solution following said adjustment is between about 1 and about 3. In some embodiments, the pH of the synthetic lithium solution following said adjustment is between about 1 and about 4. In some embodiments, the pH of the synthetic lithium solution following said adjustment is between about 1 and about 7. In some embodiments, the pH of the synthetic lithium solution following said adjustment is between about 2 and about 4. In some embodiments, the pH of the synthetic lithium solution following said adjustment is between about 2 and about 7. In some embodiments, the pH of the synthetic lithium solution following said adjustment is between about 3 and about 7. In some embodiments, the pH of the synthetic lithium solution following said adjustment is between about 4 and about 7. In some embodiments, the pH of the synthetic lithium solution following said adjustment is between about 7 and about 9. In some embodiments, the pH of the synthetic lithium solution following said adjustment is between about 7 and about 11. In some embodiments, the pH of the synthetic lithium solution following said adjustment is between about 7 and about 13. In some embodiments, the pH of the synthetic lithium solution following said adjustment is between about 9 and about 11. In some embodiments, the pH of the synthetic lithium solution following said adjustment is between about 9 and about 13. In some embodiments, the pH of the synthetic lithium solution following said adjustment is between about 11 and about 13.

In some embodiments, a carbonate is added to the eluate solution (e.g., the synthetic lithium solution). In some embodiments, said carbonate is sodium carbonate. In some embodiments, addition of said carbonate results in precipitation of an insoluble carbonate. In some embodiments, said insoluble carbonate is calcium carbonate. In some embodiments, said insoluble carbonate is magnesium carbonate. In some embodiments, said insoluble carbonate is strontium carbonate. In some embodiments, said insoluble carbonate is manganese carbonate. In some embodiments, said carbonate is a mixture of carbonates.

In some embodiments, a hydroxide is added to the eluate solution (e.g., the synthetic lithium solution). In some embodiments, said hydroxide is calcium hydroxide. In some embodiments, said calcium hydroxide is produced by hydrolysis of calcium oxide. In some embodiments, addition of said hydroxide results in precipitation of an insoluble hydroxide. In some embodiments, said insoluble hydroxide is magnesium hydroxide. In some embodiments, said insoluble hydroxide is a mixture of hydroxides.

In some embodiments, one or more anions are precipitated from the eluate (e.g., the synthetic lithium solution) as an insoluble species. In some embodiments, said anions comprise sulfates, phosphates, chlorides, nitrates, carbonates, mixtures or combinations thereof. In some embodiments, said anions comprise sulfates. In some embodiments, said sulfate anions are precipitated by the addition of a chloride leading to the precipitation of an insoluble sulfate. In some embodiments, sulfate anions are precipitated by the addition of barium chloride leading to the precipitation of an insoluble barium sulfate. In some embodiments, said phosphate anions are precipitated by the addition of a chloride leading to the precipitation of an insoluble phosphate. In some embodiments, phosphate anions are precipitated by the addition of calcium chloride leading to the precipitation of an insoluble calcium phosphate species.

In some embodiments, the precipitated solids (e.g., the precipitated transition metal species) comprise a multivalent cation (e.g., a transition metal) and a hydroxide, a carbonate, or a mixture thereof. In some embodiments, said solids are removed from the lithium eluate to yield a purified lithium eluate. In some embodiments, the precipitated solids are removed by a liquid-solid separation method. In some embodiments, said methods comprises filtration, gravity sedimentation, centrifugal sedimentation, magnetic fields, other methods of solid-liquid separation, or combinations thereof. In some embodiments, said method comprises filtration. In some embodiments, the filter is a belt filter, plate-and-frame filter press, recessed-chamber filter press, pressure vessel containing filter elements, candle filter, pressure filter, pressure-leaf filter, Nutsche filter, rotary drum filter, rotary disc filter, cartridge filter, bag filter, a centrifugal filter with a fixed or moving bed, a metal screen, a perforated basket centrifuge, a three-point centrifuge, a peeler type centrifuge, a decanter centrifuge, or a pusher centrifuge. In some embodiments, the filter may use a scroll or a vibrating device. In some embodiments, the filter is horizontal, vertical, or may use a siphon.

In some embodiments, the precipitated solids (e.g., the precipitated transition metal species) are reused to adjust the pH of a solution. In some embodiments, the precipitated solids (e.g., the precipitated transition metal species) are reused to adjust the pH of a liquid resource, before it undergoes ion exchange. In some embodiments, said reuse results in a lithium production process that uses less reagents.

In some embodiments, one or more anions are precipitated from the eluate (e.g., the synthetic lithium solution) as an insoluble species.

### Electrodialysis Separation

In some embodiments, for any lithium extraction process or system described herein, impurities (e.g., transition metal species) are at least removed from an impurities-enriched lithiated (IEL) acidic solution (e.g., a synthetic lithium solution) by passing through one or more electrodialysis membranes to separate multivalent impurities.

In some embodiments, electrodialysis is used to remove impurities (e.g., transition metal species) from an acidic lithium solution (e.g., a synthetic lithium solution). In some embodiments, electrodialysis is a membrane separation technology in which certain charged species are allowed to pass through a membrane with assistance from an applied electric field. In some embodiments, electrodialysis is used to remove impurities from an acidic lithium solution where water is retained in the feed phase while charged ions pass through selective ion exchange membranes. In some embodiments, electrodialysis is used to remove impurities from an acidic lithium solution where selective cation exchange membranes are used to obtain separation of monovalent and multivalent ions by means of different transport kinetics through the membrane. In some embodiments, electrodialysis is used to remove impurities from an acidic lithium solution using a polymer-based membrane with functional groups. In some embodiments, electrodialysis is used to remove impurities from an acidic lithium solution using cation exchange membranes that are functionalized with negatively charged functional groups such as sulfonic, carboxyl, other functional groups, or combinations thereof which allows cations to pass through while preventing anions from passing. In some embodiments, electrodialysis is used to remove impurities from an acidic lithium solution with a rinse solution or additional membranes near the electrodes to wash out ions near the electrodes to prevent the generation of chlorine or hydrogen gas on the electrodes. In some embodiments, electrodialysis is used to remove impurities from an acidic lithium solution where divalent or multivalent cations would move through a membrane slower than monovalent ions.

In some embodiments, the electrodialysis system comprises a proton selective membrane. In some embodiments, the electrodialysis system comprises a cation selective membrane. In some embodiments, the electrodialysis system comprises negatively charged membrane. In some embodiments, the electrodialysis system comprises a anion selective membrane. In some embodiments, the electrodialysis system comprises positively charged membrane. In some embodiments, the electrodialysis system comprises a cation selective membrane. In some embodiments, the electrodialysis system comprises a bipolar membrane. In some embodiments, said bipolar membrane splits water into protons and hydroxide ions. In some embodiments, the electrodialysis system comprises an electrodialysis system. In some embodiments, the electrodialysis system comprises a two-compartment bipolar electrodialysis system. In some embodiments, the electrodialysis system comprises a three-compartment bipolar electrodialysis system. In some embodiments, the electrodialysis system has one or more salts as an inlet, wherein said salts comprise one or more cations and one or more anions, and the outlet of the electrodialysis comprises a base formed from said one or more cations and hydroxide ions, and an acid from said one or more anions and protons. In some embodiments, the electrodialysis system has one or more salts as an inlet, wherein said salts comprise NaCl, and the outlet of the electrodialysis comprises NaOH and HCl. In some embodiments, the electrodialysis system has one or more salts as an inlet, wherein said salts comprise LiCl, and the outlet of the electrodialysis comprises LiOH and HCl. In some embodiments, the electrodialysis system has one or more salts as an inlet, wherein said salts comprise Li₂SO₄, and the outlet of the electrodialysis comprises LiOH and H₂SO₄. In some embodiments, the electrodialysis system has one or more salts as an inlet, wherein said salts comprise Na₂SO₄, and the outlet of the electrodialysis comprises NaOH and H₂SO₄. In some embodiments, the electrodialysis system has one or more salts as an inlet, wherein said salts comprise Li₃PO₄, and the outlet of the electrodialysis comprises LiOH and H₃PO₄. In some embodiments, the electrodialysis system has one or more salts as an inlet, wherein said salts comprise Na₃PO₄, and the outlet of the electrodialysis comprises NaOH and H₃PO₄.

### Temperature Reduction Precipitation

In some embodiments, for any lithium extraction process or system described herein, impurities (e.g., transition metal species) are at least removed from an impurities-enriched lithiated (IEL) acidic solution (e.g., a synthetic lithium solution) by reducing the temperature of the IEL acidic solution to precipitate multivalent impurities. In some embodiments, the temperature of the IEL acidic solution is reduced using a heat exchanger. In some embodiments, the temperature is reduced by passing the IEL acidic solution through a heat exchanger. In some embodiments, the temperature of the lithium-enriched eluate, following reduction of the temperature to precipitate multivalent impurities, is heated or allowed to warm.

### Precipitation of Metal Ions by Adjustment of pH and Oxidation Reduction Potential

In some embodiments, the pH of the eluate (e.g., the synthetic lithium solution) is adjusted following elution by treatment with other acidic or basic substances. The eluate can be further treated and subjected to other separation processes to result in a changed relative concentration of lithium and other ions. The eluate can further be diluted or concentrated to result in varying concentrations of lithium and other ions. In some embodiments, the acidic solution comprises dissolved species (e.g., transition metal species) that may precipitate at certain concentrations. In some embodiments, the acidic solution comprises dissolved species that may precipitate at certain values of pH. In some embodiments, the acidic solution comprises dissolved species that may precipitate at certain values of oxidation-reduction potential.

In some embodiments, the acidic solution comprises dissolved species that may precipitate at certain concentrations. In some embodiments, the acidic solution comprises dissolved species that may be reduced in concentration to avoid precipitation. In some embodiments, the dissolved species in an acidic solution comprises sulfate anions, nitrate anions, phosphate anions, chloride anions, bromide anions, fluoride anions, borate anions, iodide anions, carbonate anions, or combinations thereof. In some embodiments, lithium and non-lithium impurities (e.g., transition metal species) are eluted into the acidic solution from the first lithium-enriched ion exchange material, forming a impurities-enriched lithiated (“IEL”) acidic solution (e.g., a synthetic lithium solution), wherein the eluted impurities react with one or more said anions in the acidic solution to form insoluble salts, which may precipitate. In some embodiments, the concentrations of said anions and non-lithium impurities in the IEL acidic solution are independently limited so as to reduce or inhibit precipitation of insoluble salts. In one embodiment, the acidic solution comprises sulfate anions.

In some embodiments, the acidic solution further comprises water, salt, chelating compounds, ethylenediaminetetraacetic acid, salt of ethylenediaminetetraacetate, compounds of ethylenediaminetetraacetate, anti-scalants, or combinations thereof. In some embodiments, dilution water is added to the acidic solution to limit and/or prevent formation of insoluble precipitates.

In some embodiments, the acidic solution comprises dissolved species that may precipitate at certain concentrations. In some embodiments, the acidic solution comprises dissolved species that may be reduced in concentration to avoid precipitation. In some embodiments, the dissolved species in an acidic solution comprises sulfate anions, nitrate anions, phosphate anions, chloride anions, bromide anions, fluoride anions, borate anions, iodide anions, carbonate anions, or combinations thereof. In some embodiments, lithium and non-lithium impurities are eluted into the acidic solution from the first lithium-enriched ion exchange material, forming a impurities-enriched lithiated (“IEL”) acidic solution, wherein the eluted impurities react with one or more said anions in the acidic solution to form insoluble salts, which may precipitate. In some embodiments, the concentrations of said anions and non-lithium impurities in the IEL acidic solution are independently limited so as to reduce or inhibit precipitation of insoluble salts. In one embodiment, the acidic solution comprises sulfate anion.

In some embodiments, the acidic solution further comprises water, salt, chelating compounds, ethylenediaminetetraacetic acid, salt of ethylenediaminetetraacetate, compounds of ethylenediaminetetraacetate, anti-scalants, or combinations thereof. In some embodiments, dilution water is added to the acidic solution to limit and/or prevent formation of insoluble precipitates.

In some embodiments, the pH (e.g., the pH of the synthetic lithium solution) is increased until precipitation of non-lithium impurities (e.g., transition metal species) is observed. In some embodiments, the pH is increased by using a base comprising sodium hydroxide, calcium hydroxide, lithium hydroxide, magnesium hydroxide, potassium hydroxide, strontium hydroxide, barium hydroxide, as pure solids or in aqueous, mixtures thereof, or combination thereof.

In some embodiments, the value of oxidation-reduction potential (e.g., the oxidation-reduction potential of the synthetic lithium solution) is adjusted until precipitation of non-lithium impurities (e.g., transition metal species) is observed. In some embodiments, oxidation-reduction potential using hydrogen peroxide, sodium hypochlorite, hypochlorous acid, ozone, potassium monopersulphate, chloramines, cyanuric acid, urea, sodium metabisulphite, mixtures thereof or combinations thereof.

In some embodiments, a precipitate (e.g., one or more precipitated transition metal species) is formed when the pH and/or oxidation-reduction potential of the eluate (e.g., the synthetic lithium solution) is adjusted. In some embodiments said precipitates comprise solids comprising lithium, sodium, calcium, magnesium, potassium, boron, strontium, barium, zirconium, titanium, vanadium, iron, copper, manganese, molybdenum, aluminum, niobium, sulfate, chloride, fluoride, bromide, nitrate, carbonate, bicarbonate, hydrogencarbonate, phosphate, borate, mixtures thereof or combinations thereof. In some embodiments, said precipitates comprise an oxide of titanium. In some embodiments, said precipitates comprise titanium dioxide. In some embodiments, said precipitates comprise an oxide of manganese. In some embodiments, said precipitates comprise manganese dioxide. In some embodiments, said precipitates comprise an oxide of niobium. In some embodiments, said precipitates comprise niobium dioxide.

### Methods for Adjusting the pH of the Lithium Eluate

In one embodiment, the acidic lithium eluate (e.g., the synthetic lithium solution) is neutralized by adjusting the pH of the eluate (e.g., the synthetic lithium solution). In some embodiments, the pH is raised to between 7 and 8, 8 and 9, 9 and 10, 10 and 11. In some embodiments, the pH is raised by adding NaOH, KOH, LiOH, RbOH, Mg(OH)₂, Ca(OH)₂, Sr(OH)₂, Ba(OH)₂, NH₄OH, Sr(OH)₂ or other basic compounds, or combinations thereof.

In some embodiments, the adjustment of the pH (e.g., the pH of the synthetic lithium solution) is performed in an agitated vessel. In some embodiments, the adjustment of the pH is performed in one or more vessels. In some embodiments, the adjustment of the pH is performed in one or more vessels connected in parallel, such that the inlet and outlet compositions of all vessels are similar, and such that a common inlet is distributed amongst all vessels, and the outlet of all vessels is connected to a common outlet. In some embodiments, the adjustment of the pH is performed in one or more vessels connected in series, wherein the outlet of one vessel is connected to the inlet of the subsequent vessel. In some embodiments, the adjustment of the pH is performed in one vessel. In some embodiments, the adjustment of the pH is performed in two vessels. In some embodiments, the adjustment of the pH is performed in three vessels. In some embodiments, the adjustment of the pH is performed in four vessels. In some embodiments, the adjustment of the pH is performed in five vessels. In some embodiments, the adjustment of the pH is performed in more than five vessels but less than ten vessels. In some embodiments, the adjustment of the pH is performed in more than ten vessels but less than twenty vessels. In some embodiments, the adjustment of the pH is performed in more than twenty vessels but less than fifty vessels.

In some embodiments, said vessel is a jacked vessel. In some embodiments, said jacket is used to add heat to or remove heat from said vessel. In some embodiments, said vessel contains two or more baffles. In some embodiments, said vessel contains nozzles for injecting liquid, air, gas, or a combination thereof. In some embodiments, said nozzles are used for recirculating the contents of said vessel. In some embodiments, said nozzles are used for mixing said vessel. In some embodiments, air is used to recirculate the contents of said vessel. In some embodiments, the adjustment of the pH is performed using an inline mixer that mixes the lithium eluate with a liquid base.

In some embodiments, said vessel is a jacketed vessel. In some embodiments, said jacket is used to add heat to or remove heat from said vessel. In some embodiments, said vessel contains two or more baffles. In some embodiments, said vessel contains nozzles for injecting liquid, air, gas, or a combination thereof. In some embodiments, said nozzles are used for recirculating the contents of said vessel. In some embodiments, said nozzles are used for mixing said vessel. In some embodiments, air is used to recirculate the contents of said vessel. In some embodiments, the vessel comprises agitators. In some embodiments, said agitators comprise one or more impellers. In some embodiments, said one or more impellers comprise propellers, anchor impellers, hydrofoils, pitched blade turbines, curved blade turbines, spiral turbine, flat blade turbines, radial blades, or a combination thereof. In some embodiments, said impellers contain one or more blades. In some embodiments, the shaft and impellers are comprised of carbon steel, stainless steel, titanium, Hastelloy, or a combination thereof. In some embodiments, the shaft and impellers are coated with glass, epoxy, rubber, a polymer coating, or combinations thereof. In some embodiments, fluidization by means of said agitator is aided by baffles mounted inside of said tank (e.g., vessel). In some embodiments, said baffles comprise flat rectangular structures mounted onto the side of the tank. In some embodiments, said baffles are oriented perpendicular to the plane of agitator of the impeller. In some embodiments, the presence of one or more baffles aid with the fluidization of the ion exchange beads inside the vessel. In some embodiments, the presence of one or more baffles reduce the swirling and vortexing associated with fluidization by an impeller. In some embodiments, the presence of said baffles results in more uniform suspension of particles in the aqueous medium. In some embodiments, the presence of said baffles results in reduce attrition of particles being fluidized. In some embodiments, said baffles are constructed to span the entire vertical length of the vessel. In some embodiments, the baffles are constructed to span from about the height of the settled bed of ion exchange beads to the top of the vessel. In some embodiments, the baffles are constructed to span from about 6″ from the bottom of the vessel to the top of the vessel. In some embodiments, there is a gap between the wall of the vessel and the baffle. In some embodiments, said gap measures less than ⅛″, less than ¼″, less than ½″, or less than 1″. In some embodiments, said baffles measure a width that is equivalent to approximately one twelfth of the width of the vessel. In some embodiments, said baffles measure a width that is equivalent to approximately less than one tenth of the width of the vessel. In some embodiments, said baffles measure a width that is equivalent to more than approximately one fifteenth of the width of the vessel. In some embodiments, all baffles are of equivalent dimensions. In some embodiments, baffles are not of the same dimensions. In some embodiments, the tank contains two baffles. In some embodiments, the tank contains three baffles. In some embodiments, the tank contains four baffles. In some embodiments, the tank contains more than four baffles. In one embodiment, the acidic lithium eluate (e.g., the synthetic lithium solution) is neutralized by performing acid distillation (e.g., distilling acid away from the synthetic lithium solution). In some embodiments, the acid distillation removes at least one volatile acid from the acidic lithium eluate (e.g., the synthetic lithium solution). In some embodiments, said volatile acid is i) fresh or virgin volatile acid, ii) the recycled volatile acid, or iii) both. In some embodiments, said volatile acid is a volatile mineral acid comprising nitric acid, hydrochloric acid, hydrofluoric acid, hydrobromic acid, hydroiodic acid, or carbonic acid. In some embodiments, said volatile acid is nitric acid. In some embodiments, said volatile acid is hydrochloric acid. In some embodiments, the acid distillation uses a distillation unit. In some embodiments, the distillation unit operates at temperatures of about 50 to about 150 degrees Celsius. In some embodiments, the distillation unit operates at temperatures of about 100 to about 200 degrees Celsius. In some embodiments, the distillation unit operates at temperatures of about 100 to about 300 degrees Celsius. In some embodiments, the distillation unit operates at temperatures of about 200 to about 400 degrees Celsius. In some embodiments, the distillation unit operates at temperatures of about 400 to about 600 degrees Celsius. In some embodiments, the distillation unit operates at temperatures of above 600 degrees Celsius. In some embodiments, the distillation unit yields said lithium sulfate in aqueous form. In some embodiments, the distillation unit yields said lithium sulfate in solid form. In some embodiments, the distillation unit comprises a spray dryer to produce said lithium sulfate in solid form. In some embodiments, the distillation unit operates at pressures from about 0.01 atm to about 0.1 atm. In some embodiments, the distillation unit operates at pressures from about 0.1 atm to about 1.0 atm. In some embodiments, the distillation unit operates at pressures from about 1.0 atm to about 10 atm. In some embodiments, the distillation unit operates at pressures above 10 atm. In some embodiments, the condensation unit operates at pressures from about 1 atm to about 10 atm. In some embodiments, the condensation unit operates at pressures from about 10 atm to about 100 atm. In some embodiments, the condensation unit operates at pressures from about 100 atm to about 1,000 atm. In some embodiments, the condensation unit operates at temperatures from about −200 degrees Celsius to about −100 degrees Celsius. In some embodiments, the condensation unit operates at temperatures from about −100 degrees Celsius to about −50 degrees Celsius. In some embodiments, the condensation unit operates at temperatures from about −50 degrees Celsius to about 0 degrees Celsius. In some embodiments, the condensation unit operates at temperatures from about −30 degrees Celsius to about 20 degrees Celsius. In some embodiments, the condensation unit operates at temperatures from about 0 degrees Celsius to about 50 degrees Celsius. In some embodiments, the condensation unit operates at temperatures above 50 degrees Celsius.

### Methods for Precipitating Dissolved Transition Metals

Transition metals may optionally be found in solution in the synthetic lithium eluate (e.g., the synthetic lithium solution). For final purification of the synthetic lithium eluate (e.g., the synthetic lithium solution) to produce lithium products, said dissolved transition metals (e.g., transition metal species) must be removed. In one embodiment, said transition metal impurities are removed from solution by precipitating them from the eluate in order to form a solid, and said solid is removed from the eluate through a solid-liquid separation method. In some embodiments, precipitation comprises the formation of a slurry comprising a) a solid comprising a transition metal species, and b) a liquid that used to contain said transition metal in solution prior to precipitation.

In one embodiment, said transition metal impurities (e.g., said transition metal species) are precipitated by raising the pH of the eluate (e.g., the synthetic lithium solution), resulting in the precipitation of the transition metal such that the liquid eluate is devoid of such transition metal and is thereby concentrated in lithium. In some embodiments, the pH is raised to between about 3 and about 4, about 4 and about 5, about 5 and about 6, about 6 and about 7, about 7 and about 8, about 8 and about 9, about 9 and about 10, about 10 and about 11, about 11 and about 12. In some embodiments, the pH is raised by adding NaOH, KOH, LiOH, RbOH, Mg(OH)₂, Ca(OH)₂, Sr(OH)₂, Ba(OH)₂, NH₄OH, or other basic compounds, mixtures thereof, or combinations thereof.

In some embodiments, titanium is the transition metal (e.g., the transition metal species comprise titanium), and the pH (e.g., the pH of the synthetic lithium solution) is raised to above 6. In some embodiments, zirconium is the transition metal (e.g., the transition metal species comprise zirconium), and the pH (e.g., the pH of the synthetic lithium solution) is raised to above 7. In some embodiments, vanadium is the transition metal (e.g., the transition metal species comprise vanadium), and the pH is raised to above 6. In some embodiments, iron is the transition metal (e.g., the transition metal species comprise iron), and the pH (e.g., the pH of the synthetic lithium solution) is raised to above 9. In some embodiments, copper is the transition metal (e.g., the transition metal species comprise copper), and the pH (e.g., the pH of the synthetic lithium solution) is raised to above 5. In some embodiments, manganese is the transition metal (e.g., the transition metal species comprise manganese), and the pH (e.g., the pH of the synthetic lithium solution) is raised to above 7. In some embodiments, molybdenum is the transition metal (e.g., the transition metal species comprise molybdenum), and the pH (e.g., the pH of the synthetic lithium solution) is raised to above 4. In some embodiments, aluminum is the transition metal (e.g., the transition metal species comprise aluminum), and the pH (e.g., the pH of the synthetic lithium solution) is raised to above 5. In some embodiments, niobium is the transition metal, and the pH (e.g., the pH of the synthetic lithium solution) is raised to above 2. In some embodiments, the transition metal species comprise a combination of transition metals, and the pH of the synthetic lithium solution is raised in a step wise manner such that different transition metal species are precipitated at different stages and optionally separated from the synthetic lithium solution prior to the subsequent stage of raising the pH. In some embodiments, the transition metal species comprise a combination of transition metals, and the pH of the synthetic lithium solution is raised in a single step to precipitate substantially all transition metal species following said single step.

In one embodiment, said transition metals (e.g., transition metal species) are precipitated (e.g., from the synthetic lithium solution) by changing the oxidation state of the transition metals to an insoluble state (e.g., wherein the transition metal species that forms following changing the oxidation state is insoluble). In one embodiment, the oxidation state of said transition metal is changed by altering the oxidation-reduction potential (also known as ORP) of the eluate (e.g., the synthetic lithium solution). In some embodiments, the ORP is changed to between about −200 mV and about −100 mV, between about −100 mV and about 100 mV, between about 100 mV and about 200 mV, between about 200 mV and about 500 mV, between about 500 mV and about 1000 mV, or combinations thereof. In one embodiment, the oxidation state of said transition metal is changed by adding a redox agent to the eluate (e.g., the synthetic lithium solution). In one embodiment, said redox agent is an oxidant. In some embodiments, said oxidant is air, oxygen, ozone, bleach, sodium hypochlorite, fluorine, chlorine, chlorate, perchlorate, hydrogen peroxide, potassium permanganate, nitric acid, or other oxidation agents, or combinations thereof. In some embodiments, said redox agent is a reductant. In some embodiments, said reductant is sodium bisulfite, sodium metabisulfite, sodium borohydride, formic acid, ascorbic acid, oxalic acid, potassium iodide, or other reducing agents, or combinations thereof. In one embodiment, the oxidation state of said transition metal (e.g., transition metal species) is changed via electrolysis or electrowinning.

In some embodiments, Ti is the transition metal (e.g., the transition metal species comprise titanium), and the ORP (e.g., the oxidation-reduction potential of the synthetic lithium solution) is raised to above about −100 mV. In some embodiments, Zr is the transition metal (e.g., the transition metal species comprise zirconium), and the ORP (e.g., the oxidation-reduction potential of the synthetic lithium solution) is raised to above about −1.5 V and below about 1.5 V. In some embodiments, V is the transition metal (e.g., the transition metal species comprise vanadium), and the ORP (e.g., the oxidation-reduction potential of the synthetic lithium solution) is raised to above about −600 mV. In some embodiments, Fe is the transition metal (e.g., the transition metal species comprise iron), and the ORP (e.g., the oxidation-reduction potential of the synthetic lithium solution) is raised to above about 1200 mV. In some embodiments, Cu is the transition metal (e.g., the transition metal species comprise copper), and the ORP (e.g., the oxidation-reduction potential of the synthetic lithium solution) is raised to above about −400 mV. In some embodiments, Mn is the transition metal (e.g., the transition metal species comprise manganese), and the ORP (e.g., the oxidation-reduction potential of the synthetic lithium solution) is raised to above about 200 mV. In some embodiments, Mo is the transition metal (e.g., the transition metal species comprise molybdenum), and the ORP (e.g., the oxidation-reduction potential of the synthetic lithium solution) is raised to above about −200 mV. In some embodiments, Al is the transition metal (e.g., the transition metal species comprise aluminum), and the ORP (e.g., the oxidation-reduction potential of the synthetic lithium solution) is raised to above about −1.75 V and below about 2 V. In some embodiments, Nb is the transition metal (e.g., the transition metal species comprise niobium), and the ORP (e.g., the oxidation-reduction potential of the synthetic lithium solution) is raised to above about −250 mV.

In some embodiments, only the pH of the synthetic eluate (e.g., the pH of the synthetic lithium solution) is modified. In some embodiments, only the ORP of the synthetic eluate (e.g., the oxidation-reduction potential of the synthetic lithium solution) is modified. In some embodiments, a combination of both the pH and ORP of the eluate (e.g., the pH and the oxidation-reduction potential of the synthetic lithium solution) are modified.

In one embodiment, said transition metal impurities are precipitated by adding transition metal seed crystals to the eluate. In one embodiment, transition metal seed crystals are recirculated. In some embodiments, transition metal seed crystals are mixed with a solution comprising the same transition metal as the seed crystals. In some embodiments, transition metal seed crystals are mixed with a solution comprising a different transition metal as the seed crystals. In some embodiments, the addition of transition metal seed crystals to a tank where transition metals precipitate results in the formation of larger precipitates. In some embodiments, the formation of larger precipitates facilities solid-liquid separation of said precipitates.

In some embodiments, the precipitated solids (e.g., the transition metal species, the precipitated transition metal species) comprise zirconium, titanium, vanadium, iron, copper, manganese, molybdenum, aluminum, niobium, mixtures or combinations thereof. In some embodiments, the precipitated solids comprise zirconium, titanium, vanadium, iron, copper, manganese, molybdenum, aluminum, niobium, lithium, sodium, calcium, magnesium, potassium, boron, strontium, barium, mixtures or combinations thereof. In some embodiments, the precipitated solids (e.g., the transition metal species, the precipitated transition metal species) comprise sulfate, chloride, fluoride, bromide, nitrate, carbonate, bicarbonate, hydrogencarbonate, phosphate, borate, mixtures or combinations thereof. In some embodiments, the precipitated solids (e.g., the transition metal species, the precipitated transition metal species) comprise a transition metal hydroxide, oxide, carbonate, sulfate, chloride, phosphate, bicarbonate, nitrate, bormide, borate, mixtures or combinations thereof.

In some embodiments, the molar ratio of lithium to the sum of all precipitated cations (e.g., in the transition metal species) is about 1000:1. In some embodiments, said molar ratio is about 500:1. In some embodiments, said molar ratio is about 100:1. In some embodiments, said molar ratio is about 50:1. In some embodiments, said molar ratio is about 10:1. In some embodiments, said molar ratio is about 5:1. In some embodiments, said molar ratio is about 2:1. In some embodiments, said molar ratio is about 1:1.

In some embodiments, said transition metal impurities (e.g., transition metal species) are precipitated from the eluate (e.g., the synthetic lithium solution) in order to form a solid, and said solid is removed from the eluate through a solid-liquid separation method.

In some embodiments, said filter retains particles smaller than about 0.01 microns, smaller than about 0.1 microns, smaller than about 0.5 microns, smaller than about 1 micron, smaller than about 5 microns, smaller than about 10 microns, smaller than about 100 microns, smaller than about 1 millimeter, smaller than about 1 centimeter.

In one embodiment, coordinating ligands are added to the eluate (e.g., the synthetic lithium solution) during precipitation of the transition metals. In one embodiment, said ligands are chelating agents. In one embodiment, said chelating agent is EDTA, oxalate, or other chelators, mixtures, or combinations thereof.

In one embodiment, said transition metal impurities (e.g., transition metal species) are precipitated by adding complementary anions to the eluate (e.g., the synthetic lithium solution) that form insoluble salts with dissolved transition metals. In one embodiment, said complimentary anion comprises sulfide, phosphate, carbonate, or combinations thereof. In one embodiment, said sulfide is H₂S, Na₂S, K₂S, CaS, MgS, other sulfide compounds, or combinations thereof. In one embodiment, said phosphate is Na₃PO₄, K₃PO₄, Rb₃PO₄, (NH₄)₃PO₄, other phosphate salts, or combinations thereof. In one embodiment, said carbonate is MgCO₃, CaCO₃, SrCO₃, CO₂, or other carbonate salts, or combinations thereof.

In one embodiment, base is added to lithium eluate solution (e.g., the synthetic lithium solution), to precipitate undesirable metals (e.g., transition metal species) followed by separation from the lithium eluate solution through solid-liquid separations. In one embodiment, base is added to lithium eluate solution to precipitated undesirable metals followed by the addition of an oxidizing agent to further precipitate undesirable metals followed by separation from lithium eluate solution using solid-liquid separations. In one embodiment, base is added to lithium eluate solution followed by the addition of an oxidizing agent to precipitate the undesirable solids, followed by separation from the lithium eluate solution through solid-liquid separations, followed by the addition of base for precipitation of undesirable metals followed by the separation from lithium eluate solution through solid-liquid separations.

### Methods for Removal of Dissolved Impurities in the Eluate

In some embodiments, some amount of dissolved transition metal impurities (e.g., transition metal species) are removed directly from solution by treatment of the synthetic eluate solution (e.g., the synthetic lithium solution).

In one embodiment, the dissolved transition metal impurities are removed from the lithium eluate (e.g., the synthetic lithium solution) using solvent extraction with an organic liquid phase that preferentially binds transition metal ions. In one embodiment, a lithium eluate solution (e.g., a synthetic lithium solution) is purified using solvent extraction with an organic liquid phase (e.g., an immiscible solvent) to preferentially bind monovalent ions or to preferentially bind divalent ions or to preferentially bind multivalent ions. In some embodiments, said multivalent ions comprise calcium, magnesium, strontium, boron, manganese, zirconium, barium, titanium, tin, iron, cobalt, nickel, zinc, aluminum, other cations, combinations or mixture thereof. In one embodiment, the solvent extraction is performed using neodecanoic acid, di-(2-ethylhexyl)phosphoric acid, mixtures or combinations thereof. In one embodiment, a flow of lithium salt solution or lithium acid eluate solution is pumped through a series of one or more columns/tanks counter-current to a flow of other liquid phase, which may be kerosene or other solvent containing neodecanoic acid, di-(2-ethylhexyl)phosphoric acid, other extractants, mixture or combinations thereof.

In one embodiment, the dissolved transition metal impurities (e.g., transition metal species) are removed using cation-exchange resins to preferentially absorb impurities (e.g., transition metals). In one embodiment, a lithium eluate solution (e.g., a synthetic lithium solution) is purified using cation-exchange resins to preferentially absorb multivalent ions while releasing sodium. In one embodiment, a lithium eluate solution is purified using cation-exchange resins to preferentially absorb multivalent ions while releasing hydrogen. In one embodiment, a lithium eluate solution is purified using cation-exchange resins to preferentially absorb multivalent ions while releasing lithium. In one embodiment, the cation-exchange resin may be a sulfonated polymer or a carboxylated polymer. In one embodiment, the cation-exchange resin may be a sulfonated polystyrene polymer, a sulfonated polystyrene-butadiene polymer, or a carboxylated polyacrylic polymer. In one embodiment, the cation-exchange resin may be loaded with Na so that Na is released as multi-valent ions are absorbed. In one embodiment, the cation-exchange resin may be loaded with Li so that Li is released as multi-valentions are absorbed.

In one embodiment, the dissolved transition metal impurities (e.g., transition metal species) are removed using anion-exchange resins to preferentially absorb anionic impurities.

Methods for Separating Precipitated Solids from Liquid Eluate

In some embodiments, solids precipitated from the synthetic eluate solution (e.g., transition metal species precipitated from the synthetic lithium solution) are removed from said eluate by solid-liquid separation, resulting in a liquid eluate stream (e.g., a synthetic lithium solution) that is purified in its lithium content.

In one embodiment, the precipitated metals (e.g., transition metal species) are separated from the lithium eluate solution (e.g., the synthetic lithium solution) utilizing filtration, gravity sedimentation, centrifugal sedimentation, centrifugation, magnetic fields, other methods of solid-liquid separation, or combinations thereof. In some embodiments, said separating of the undesirable metal precipitate (e.g., transition metal species) comprises using a filter, a settling tank, a clarifier, a hydrocyclone, a centrifuge, or combinations thereof. In some embodiments, precipitated metals are removed from the eluate using a filter. In some embodiments, the filter is a belt filter, plate-and-frame filter press, pressure vessel containing filter elements, rotary drum filter, rotary disc filter, a candle filter, a bag filter, cartridge filter, a centrifugal filter with a fixed or moving bed, a metal screen, a perforated basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon. In some embodiments, the eluate is recirculated through the solid-liquid separator.

In some embodiments, said filter retains particles smaller than about 0.01 microns, smaller than about 0.1 microns, smaller than about 0.5 microns, smaller than about 1 micron, smaller than about 5 microns, smaller than about 10 microns, smaller than about 100 microns, smaller than about 1 millimeter, smaller than about 1 centimeter.

In one embodiment, a filter cake is prevented, limited, or removed by using gravity, centrifugal force, an electric field, vibration, brushes, liquid jets, scrapers, intermittent reverse flow, vibration, crow-flow filtration, or pumping suspensions across the surface of the filter. In some embodiments, the precipitated metals and a liquid is moved tangentially to the filter to limit cake growth. In one embodiment, gravitational, magnetic, centrifugal sedimentation, or other means of solid-liquid separation are used before, during, or after filtering to prevent cake formation. In one embodiment, a filter comprises a screen, a metal screen, a sieve, a sieve bend, a bent sieve, a high frequency electromagnetic screen, a resonance screen, or combinations thereof. In one embodiment, one or more particle traps are a solid-liquid separation apparatus. In some embodiments, one or more solid-liquid separation apparatuses may be used in series or parallel. In one embodiment, a dilute slurry is removed from the tank, transferred to an external solid-liquid separation apparatus, and separated into a concentrated slurry and a solution with low or no suspended solids. In one embodiment, the concentrated slurry is returned to the tank or transferred to a different tank. In one embodiment, precipitate metals are transferred from a brine tank to another brine tank, from an acid tank to another acid tank, from a washing tank to another washing tank, from a brine tank to a washing tank, from a washing tank to an acid tank, from an acid tank to a washing tank, or from an acid tank to a brine tank.

In one embodiment, solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the solid particles into a zone where the particles can leave through the bottom of the thickener.

In one embodiment, solid-liquid separation apparatuses include a deep cone, a deep cone tank, a deep cone compression tank, or a tank wherein the slurry is compacted by weight. In some embodiments, solid-liquid separation apparatuses include a tray thickener with a series of thickeners oriented vertically with a center axle and raking components. In some embodiments, solid-liquid separation apparatuses include a lamellar-type thickener with inclined plates or tubes that may be smooth, flat, rough, or corrugated. In some embodiments, solid-liquid separation apparatuses include a gravity clarifier that may be a rectangular basin with feed at one end and overflow at the opposite end optionally with paddles and/or a chain mechanism to move particles. In some embodiments, the solid-liquid separation apparatuses may be a particle trap.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the precipitated metals. In some embodiments, the hydrocyclones may have multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried precipitated metals (e.g., transition metal species) entering near the middle of the apparatus, and precipitated metals get trapped at the bottom and center of the apparatus due to a “teacup effect”.

In one embodiment, the solid-liquid separation apparatuses may use a membrane filter. In one embodiment, solid-liquid separations membrane filters are operated in batch mode, semi-batch mode, semi-continuous mode or continuous mode. In one embodiment, solid-liquid separation membrane filters are operated in cross-flow with concentrate routed to solid-liquid feed. In one embodiment, solid-liquid separation membrane filters are operated in cross-flow with concentrate fed back into the lithium eluate solution along with the base. In one embodiment, solid-liquid separation membrane filters are operated in cross-flow with concentrate fed back into the lithium eluate solution along with the oxidizing agent. In one embodiment, solid-liquid separation membrane filters are operated without cross-flow (dead end mode), and back-washed at intervals with back-wash stream fed back into the lithium eluate solution along with the base. In one embodiment, solid-liquid separation membrane filters are operated without cross-flow (dead end mode), and back-washed at intervals with back-wash stream fed back into the lithium eluate solution (e.g., the synthetic lithium solution)_along with the oxidizing agent.

In one embodiment, the precipitated metal solids (e.g., transition metal species) separated by one or more of the above embodiments are split into two or more streams and fed back into the lithium eluate solution (e.g., the synthetic lithium solution) along with base. In some embodiments, the solids in said stream act as nucleation sites on which other metals precipitate. In some embodiments, this method serves to grow larger precipitate crystals faster. In one embodiment, the precipitated metal solids separated by one or more of the above embodiments are split into two or more streams and fed back into the lithium eluate solution along with the oxidizing agent as nucleation sites on which the metals precipitate.

In one embodiment of the metal precipitation system, the tanks include a mixing tank where the base or acid is mixed with the lithium eluate solution (e.g., the synthetic lithium solution) to adjust its pH. In one embodiment, this mixing tank is mixed using one or more submerged stirrers, pumped circulation, injection of compressed gas, such as air or ozone. In one embodiment, the tanks include a settling tank, where precipitates optionally settle to the bottom of the settling tank to concentrate the solid precipitates. In one embodiment, the tanks include a storage tank where the eluate is stored prior to mixing tank, settling tank, or other tanks. In one embodiment, some tanks in the recirculating reactor optionally serve a combination of purposes including pH adjustment, ORP adjustment, base mixing tank, settling tank, or storage tank. In any embodiment, a tank optionally does not fulfil two functions at the same time. For example, a tank is not a base mixing tank and a settling tank.

### Device for Removal of Precipitation of Impurities in the Eluate

Disclosed herein are systems and processes for extracting transition metal impurities (e.g., transition metal species) from a lithium eluate (e.g., a synthetic lithium solution) using one or more agitated vessels where transition metals are precipitated form said eluate.

In one embodiment, transitions metals (e.g., transition metal species) are 1) precipitated from a liquid resource, and 2) removed from the liquid resource. In one embodiment, transitions metals are removed from a liquid resource through precipitation by addition of base, oxidant, or combinations thereof, followed by removal of the resulting solids (via said precipitation of the undesirable metals, which can include transition metals) from the liquid resource, followed by removal of said solid undesirable metals. In one embodiment, transitions metals are removed from a liquid resource through precipitation by addition of base, oxidant, or combinations thereof, followed by removal of the resulting solids from the liquid resource, followed by reprocessing of resulting solids into ion exchange materials. In one embodiment, removed transitions metals (e.g., transition metal species, precipitated transition metal species) may be redissolved using acid and reductant, followed by mixing with raffinate, waste water, liquid resource, water, or other liquids. In one embodiment, redissolved transitions metals may be mixed with raffinate, waste water, liquid resource, water, or other liquids for removal. In one embodiment, solids of transitions metals (e.g., transition metal species, precipitated transition metal species) may be dissolved in raffinate, waste water, liquid resource, water, or other liquids for removal. In one embodiment, transitions metals may be mixed with raffinate, waste water, liquid resource, water, or other liquids for removal.

In one embodiment of the metal precipitation system, the tanks include a mixing tank where the base is mixed with the lithium eluate solution (e.g., the synthetic lithium solution). In one embodiment, this mixing tank is mixed using one or more submerged stirrers, pumped circulation, injection of compressed gas, such as air or ozone. In one embodiment, the tanks include a settling tank, where precipitates (e.g., transition metal species, precipitated transition metal species) optionally settle to the bottom of the settling tank to concentrate the solid precipitates. In one embodiment, the tanks include a storage tank where the eluate is stored prior to mixing tank, settling tank, or other tanks. In one embodiment, some tanks in the recirculating reactor optionally serve a combination of purposes including base mixing tank, settling tank, or storage tank. In any embodiment, a tank optionally does not fulfil two functions at the same time. For example, a tank is not a base mixing tank or a settling tank.

In one embodiment of the metal precipitation system, base is added to a mixing tank, which is optionally a continuous stirred tank system, a confluence of lithium eluate solution (e.g., synthetic lithium solution) flow and base flow followed by a static mixer, a confluence of lithium eluate solution flow and base flow followed by a paddle mixer, a confluence of lithium eluate flow and base flow followed by a turbine impeller mixer, or a continuous stirred tank system in the shape of a vertical column which is well mixed at the bottom and settled near the top. In one embodiment, the base is optionally added as a solid or as an aqueous solution. In one embodiment, the base is optionally added continuously at a constant or variable rate. In one embodiment, the base is optionally added discretely in constant or variable aliquots or batches. In one embodiment, the base is optionally added according to one or more pH meters, which optionally samples lithium eluate solution downstream of the mixing tank or elsewhere in the recirculating system.

In one embodiment of the metal precipitation system, oxidant is added to a mixing tank, which is optionally a continuous stirred tank system, a confluence of lithium eluate solution (e.g., synthetic lithium solution) flow and oxidant flow followed by a static mixer, a confluence of lithium eluate solution flow and oxidant flow followed by a paddle mixer, a confluence of lithium eluate flow and oxidant flow followed by a turbine impeller mixer, or a continuous stirred tank system in the shape of a vertical column which is well mixed at the bottom and settled near the top. In one embodiment, the oxidant is optionally added as a solid or as an aqueous solution. In one embodiment, the oxidant is optionally added continuously at a constant or variable rate. In one embodiment, the oxidant is optionally added discretely in constant or variable aliquots or batches. In one embodiment, the base is optionally added according to one or more oxidation-reduction potential meters, which optionally samples lithium eluate solution downstream of the mixing tank or elsewhere in the recirculating system.

In some embodiments, the oxidant is chosen from one of more of oxygen, air, ozone, hydrogen peroxide, fluorine, chlorine, bromine, iodine, nitric acid, a nitrate compound, sodium hypochlorite, bleach, a chlorite, a chlorate, a perchlorate, potassium permanganate, a permanganate, sodium perborate, a perborate, mixtures thereof or combinations thereof.

In one embodiment of the metal precipitation system, base, oxidant, or a combination there of is added to a mixing tank, which is optionally a continuous stirred tank system, which is a conical bottom tank. In one embodiment, the mixing tank is a false bottom tank.

In some embodiments of the metal precipitation system, the system comprises one or more tanks. In some embodiments of the metal precipitation system, the system comprises one tanks. In some embodiments of the metal precipitation system, the system comprises three tanks. In some embodiments of the metal precipitation system, the system comprises four tanks. In some embodiments of the metal precipitation system, the system comprises two tanks. In some embodiments of the metal precipitation system, the system comprises five tanks. In some embodiments of the metal precipitation system, the system comprises five or more tanks. In some embodiments of the metal precipitation system, the system comprises a tube fitted with mixing devices, such that the reaction occurs along the length of said tube while fluid flows in the system.

### Methods for Processing Precipitated Solids to Manufacture Ion Exchange Material

In some embodiments, the transition metals removed from a synthetic lithium solution (e.g., an eluate, a lithium eluate) are used to manufacture an ion exchange material (e.g, an impurities-derived ion exchange material). In some embodiments, the transition metal species removed from a synthetic lithium solution (e.g., an eluate, a lithium eluate) are used to manufacture an ion exchange material (e.g., an impurities-derived ion exchange material). In some embodiments, the precipitated transition metal species removed from a synthetic lithium solution (e.g., an eluate, a lithium eluate) are used to manufacture an ion exchange material (e.g, an impurities-derived ion exchange material). In some embodiments, the precipitated solids (e.g., the transition metal species, the precipitated transition metal species) removed from a synthetic lithium solution (e.g., an eluate, a lithium eluate) are used to manufacture an ion exchange material (e.g., an impurities-derived ion exchange material). In some embodiments, said manufacture of an ion exchange material (e.g., an impurities-derived ion exchange material) comprises purification of the transition metals, the transition metal species, and/or the precipitated transition metal species removed from a synthetic lithium solution. In some embodiments, only some of the transition metals within the transition metals, the transition metal species, and/or the precipitated transition metal species removed from a synthetic lithium solution are desired for use in said manufacture of an ion exchange material (e.g., an impurities-derived ion exchange material).

In some embodiments, the manufactured ion exchange material (e.g., the impurities-derived ion exchange material) is selected from Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl (OH)₃·yH₂O, SnO₂·xSb₂O₅·yH₂O, TiO₂·xSb₂O₅·yH₂O, solid solutions thereof, and combinations thereof. In some embodiments, the manufactured ion exchange material (e.g., the impurities-derived ion exchange material) comprises Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl (OH)₃·yH₂O, SnO₂·xSb₂O₅·yH₂O, TiO₂·xSb₂O₅·yH₂O, solid solutions thereof, or a combination thereof.

In some embodiments, the manufactured ion exchange material (e.g., the impurities-derived ion exchange material) comprises transition metal ions. In some embodiments, the manufactured ion exchange material (e.g., the impurities-derived ion exchange material) comprises transition metal ions corresponding to a single transition metal. In some embodiments, the manufactured ion exchange material (e.g., the impurities-derived ion exchange material) comprises transition metal ions corresponding to multiple transition metals. In some embodiments, the manufactured ion exchange material (e.g., the impurities-derived ion exchange material) comprises transition metal ions derived solely from the transition metals, the transition metal species, and/or the precipitated transition metal species removed from a synthetic lithium solution. In some embodiments, the manufactured ion exchange material (e.g., the impurities-derived ion exchange material) comprises transition metal ions derived partially from the transition metals, the transition metal species, and/or the precipitated transition metal species removed from a synthetic lithium solution. In some embodiments, the manufactured ion exchange material (e.g., the impurities-derived ion exchange material) comprises transition metal ions derived from the transition metals, the transition metal species, and/or the precipitated transition metal species removed from a synthetic lithium solution in addition to other sources of transition metal ions.

In some embodiments, about 1%, about 5%, about 10%, about 15%, about 20%, about 30%, about 40%, about 50%, about 60%, about 70%, about 80%, about 90%, or about 100% of the transition metal ions in the manufactured ion exchange material (e.g., the impurities-derived ion exchange material) are derived from the transition metals, the transition metal species, and/or the precipitated transition metal species removed from a synthetic lithium solution. In some embodiments, about 1% to about 10%, about 5% to about 10%, about 10% to about 20%, about 20% to about 30%, about 30% to about 40%, about 40% to about 50%, about 50% to about 60%, about 60% to about 70%, about 70% to about 80%, about 80% to about 90%, or about 90% to about 100% of the transition metal ions in the manufactured ion exchange material (e.g., the impurities-derived ion exchange material) are derived from the transition metals, the transition metal species, and/or the precipitated transition metal species removed from a synthetic lithium solution.

In some embodiments, the impurities-derived ion exchange material is a lithium-selective ion exchange material. In some embodiments, the impurities-derived ion exchange material is an ion exchange material selective for one or more multivalent cations. In some embodiments, the impurities-derived ion exchange material is used as an ion exchange material according to the systems, processes, and methods disclosed herein.

In some embodiments, the precipitated solids (e.g., the transition metal species, the precipitated transition metal species) are transferred from the solid-liquid separation apparatuses into another tank or vessel for further processing. In some embodiments, the precipitated solids are further processed in-place within the same solid-liquid separation apparatuses. In some embodiments, the precipitated solids are washed with water to remove soluble impurities. In some embodiments, the precipitated solids are separated from the wash water using solid-liquid separation apparatuses.

In some embodiments, the solid-liquid separation apparatuses comprise filters. In some embodiments, the filter is a belt filter, plate-and-frame filter press, pressure vessel containing filter elements, rotary drum filter, rotary disc filter, a candle filter, a bag filter, cartridge filter, a centrifugal filter with a fixed or moving bed, a metal screen, a perforated basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon. In some embodiments, the wash water is recirculated through the solid-liquid separator.

In some embodiments, the solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the precipitated solids into a zone where the solids can leave through the bottom of the thickener.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the precipitated metals. In some embodiments, the hydrocyclones may have multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried precipitated solids entering near the middle of the apparatus, and precipitated metals get trapped at the bottom and center of the apparatus due to a “teacup effect”.

In one embodiment, the solid-liquid separation apparatuses may use a membrane filter. In one embodiment, solid-liquid separations membrane filters are operated in batch mode, semi-batch mode, semi-continuous mode or continuous mode.

In some embodiments, the precipitated solids (e.g., the transition metal species, the precipitated transition metal species) are purified via hydrometallurgical processes. In some embodiments, the hydrometallurgical processes comprise leaching, concentration, precipitation, cementation, solvent extraction, ion exchange, gas reduction, electrowinning, electrolysis, electrorefining, and combinations thereof. In some embodiments, the precipitated solids (e.g., the transition metal species, the precipitated transition metal species) are purified via pyrometallurgical processes. In some embodiments, the precipitated solids (e.g., the transition metal species, the precipitated transition metal species) are purified via vapor metallurgy processes. In some embodiments, the precipitated solids (e.g., the transition metal species, the precipitated transition metal species) are purified via molten salt processes.

In some embodiments, the precipitated solids (e.g., the transition metal species, the precipitated transition metal species) are fully dissolved and further processed. In some embodiments, the precipitated solids are fully dissolved by addition of an acid. In some embodiments, the precipitated solids are fully dissolved by addition of a base. In some embodiments, the precipitated solids are fully dissolved by treatment at high temperature, high pressure, or a combination thereof. In some embodiments, the precipitated solids are fully dissolved by treatment in a mechanical, chemical, or mechanochemical system that reduces the size of the solid. In some embodiments, the precipitated solids are partially dissolved and further processed.

In some embodiments, the solution used to partially dissolve the precipitated solids (e.g., transition metal species, precipitated transition metal species) is separated from said solids, and the solids and the partially dissolved solution are processed separately. In some embodiments, the partially dissolved solution is further processed to purify and obtain species that are preferentially leached from the solids (e.g., transition metal species, precipitated transition metal species).

In some embodiments, the partially dissolved solution is processed in an evaporator. In some embodiments, said evaporator is an evaporative crystallizer. In some embodiments, the crystallization tanks are heated. In some embodiments, the crystallization tanks are not heated. In some embodiments, the crystallization tanks are insulated. In some embodiments, the crystallization tanks are agitated tanks. In some embodiments, the crystallization tanks are mechanical vapor recompression units. In some embodiments, the crystallization tanks comprise one or more draft tube baffle crystallizers, which comprise an agitator, a center tube, and a cylindrical baffle to allowed clarified liquor to be withdrawn and thicken the operating slurry magma density. In some embodiments, only one crystallizer is present in the system. In some embodiments, two crystallizers in series are present in the system. In some embodiments, three crystallizers in series are present in the system. In some embodiments, four crystallizers in series are present in the system. In some embodiments, five or more crystallizers are present in the system. In some embodiments, soda ash is added only to the first crystallizer in a series of crystallization tanks. In some embodiments, soda ash is added to the first two crystallizers in the series of crystallization tanks. In some embodiments, soda ash is added to the first three crystallizers in the series of crystallization tanks. In some embodiments, soda ash is added to all crystallizers in the series of crystallization tanks.

In some embodiments, methods and systems used for purification of the precipitated solids (e.g., the transition metal species, the precipitated transition metal species) are the same as those used for purification of the eluate (e.g., the synthetic lithium solution); such methods are described elsewhere in this disclosure, including in the section Removal of Impurities, Impurities Selective Ion Exchange Material, Treatments of the Eluate produced from Lithium Extraction to Produce Lithium Products, Nanofiltration, Precipitation, Electrodialysis Separation, Temperature Reduction Precipitation, Precipitation of metal ions by adjustment of pH and oxidation reduction potential, and associated methods.

In some embodiments, the precipitated solids (e.g., the transition metal species, the precipitated transition metal species) are fully or partially dissolved with an acidic solution. In some embodiments, the acidic solution comprises hydrochloric acid, sulfuric acid, nitric acid, phosphoric acid, hydrobromic acid, hydroiodic acid, perchloric acid, acetic acid, or a combination thereof. In some embodiments, the acid solution is raised to temperatures ranging about 25-45° C., 45-65° C., 65-85° C., or 85-100° C. In some embodiments, the ORP of the acid solution is changed to between about −200 mV and about −100 mV, between about −100 mV and about 100 mV, between about 100 mV and about 200 mV, between about 200 mV and about 500 mV, between about 500 mV and about 1000 mV, or combinations thereof. In one embodiment, the oxidation state of said precipitated solids is changed by adding a redox agent to the acid solution. In one embodiment, said redox agent is an oxidant. In some embodiments, said oxidant is air, oxygen, ozone, bleach, sodium hypochlorite, fluorine, chlorine, chlorate, perchlorate, hydrogen peroxide, potassium permanganate, nitric acid, or other oxidation agents, or combinations thereof. In some embodiments, said redox agent is a reductant. In some embodiments, said reductant is sodium bisulfite, sodium metabisulfite, sodium borohydride, formic acid, ascorbic acid, oxalic acid, potassium iodide, or other reducing agents, or combinations thereof.

In some embodiments, the solubility of undesired species in the acidic solution is decreased through the addition of base to induce precipitation. In some embodiments, the solubility of undesired species is decreased through adjustment of the ORP of the acid solution. In some embodiments, the ORP of the acid solution is changed to between about −200 mV and about −100 mV, between about −100 mV and about 100 mV, between about 100 mV and about 200 mV, between about 200 mV and about 500 mV, between about 500 mV and about 1000 mV, or combinations thereof. In one embodiment, the oxidation state of said precipitated solids (e.g, said transition metal species, said precipitated transition metal species) is changed by adding a redox agent to the acid solution. In one embodiment, said redox agent is an oxidant. In some embodiments, said oxidant is air, oxygen, ozone, bleach, sodium hypochlorite, fluorine, chlorine, chlorate, perchlorate, hydrogen peroxide, potassium permanganate, nitric acid, or other oxidation agents, or combinations thereof. In some embodiments, said redox agent is a reductant. In some embodiments, said reductant is sodium bisulfite, sodium metabisulfite, sodium borohydride, formic acid, ascorbic acid, oxalic acid, potassium iodide, or other reducing agents, or combinations thereof. In some embodiments, the resulting precipitated undesired species are removed using solid-liquid separation apparatuses.

In some embodiments, the solid-liquid separation apparatuses comprise filters. In some embodiments, the filter is a belt filter, plate-and-frame filter press, pressure vessel containing filter elements, rotary drum filter, rotary disc filter, a candle filter, a bag filter, cartridge filter, a centrifugal filter with a fixed or moving bed, a metal screen, a perforated basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon. In some embodiments, the acidic solution is recirculated through the solid-liquid separator.

In some embodiments, the solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the precipitated solids into a zone where the solids can leave through the bottom of the thickener.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the undesired insoluble species. In some embodiments, the hydrocyclones may have multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried insoluble species entering near the middle of the apparatus, and precipitated metals get trapped at the bottom and center of the apparatus due to a “teacup effect”.

In some embodiments, the solid-liquid separation apparatuses use a rare-earth magnetic trap to remove magnetic solids. In some embodiments, the solid-liquid separation apparatuses use an electromagnetic trap to remove magnetic solids. In some embodiments, the solid-liquid separation apparatuses use a permanent magnet to remove magnetic solids.

In one embodiment, the solid-liquid separation apparatuses may use a membrane filter. In one embodiment, solid-liquid separations membrane filters are operated in batch mode, semi-batch mode, semi-continuous mode or continuous mode.

In some embodiments, the desired transition metal species within the purified acidic solution (e.g., the solution comprising the transition metal species, the solution comprising the precipitated transition metal species) are extracted using electrolysis or electrowinning. In some embodiments, the purified acidic solution is neutralized prior to electrolysis or electrowinning via addition of sodium hydroxide, calcium hydroxide, lithium hydroxide, or combinations thereof. In some embodiments, the electrolyte bath is heated to 50-60° C., 60-70° C., 70-80° C., 80-90° C., 90-100° C., 50-75° C. or 75-100° C. In some embodiments, electrodes used for electrolysis or electrowinning comprise titanium, graphite, stainless steel, steel, lead, aluminum, copper, brass, zinc, manganese, nickel, gold, silver, platinum, molybdenum, or combinations thereof. In some embodiments, the electrolytically purified transition metal solid is removed from the electrode via mechanical shock or scraping. In some embodiments, the electrolytically purified transition metal does not deposit on an electrode and is removed from the electrolyte and further purified by pyrometallurgical processes.

In some embodiments, the desired transition metal species within the purified acidic solution (e.g., the solution comprising the transition metal species, the solution comprising the precipitated transition metal species) are extracted using electrolysis or electrowinning.

In some embodiments, the desired transition metal species within the purified acidic solution (e.g., the solution comprising the transition metal species, the solution comprising the precipitated transition metal species) are precipitated through addition of base, adjustment of ORP, carbonation, addition of a sulfate solution, addition of a phosphate solution, addition of a carbonate solution, addition of a sulfate salt, addition of a phosphate salt, addition of a carbonate salt or combinations thereof. In some embodiments, the pH of the acidic solution is raised to about 4-4.2, 4.2-4.4, 4.4-4.6, 4.6-4.8, 4.8-5, 5-5.2, 5.2-5.4, 5.4-5.6, 5.6-5.8, 5.8-6, 6-6.2, 6.2-6.4, 6.4-6.6, 6.6-6.8, 6.8-7, 7-7.2, 7.2-7.4, 7.4-7.6, 7.6-7.8, 7.8-8, 8-8.2, 8.2-8.4, 8.4-8.6, 8.6-8.8, 8.8-9, 9-9.2, 9.2-9.4, 9.4-9.6, 9.6-9.8, 9.8-10, 10-10.2, 10.2-10.4, 10.4-10.6, 10.6-10.8, 10.8-11, 11-11.2, 11.2-11.4, 11.4-11.6, 11.6-11.8, 11.8-12, 12-12.2, 12.2-12.4, 12.4-12.6, 12.6-12.8 or 12.8-13. In some embodiments, the base added to the acidic solution (e.g., the solution comprising the transition metal species, the solution comprising the precipitated transition metal species) comprises calcium hydroxide, sodium hydroxide, lithium hydroxide, or combinations thereof. In some embodiments, the ORP of the acid solution (e.g., the solution comprising the transition metal species, the solution comprising the precipitated transition metal species) is changed to between about −200 mV and about −100 mV, between about −100 mV and about 100 mV, between about 100 mV and about 200 mV, between about 200 mV and about 500 mV, between about 500 mV and about 1000 mV, or combinations thereof. In one embodiment, the oxidation state of the desired transition metal species is changed by adding a redox agent to the acid solution (e.g., the solution comprising the transition metal species, the solution comprising the precipitated transition metal species). In one embodiment, said redox agent is an oxidant. In some embodiments, said oxidant is air, oxygen, ozone, bleach, sodium hypochlorite, fluorine, chlorine, chlorate, perchlorate, hydrogen peroxide, potassium permanganate, nitric acid, or other oxidation agents, or combinations thereof. In some embodiments, said redox agent is a reductant. In some embodiments, said reductant is sodium bisulfite, sodium metabisulfite, sodium borohydride, formic acid, ascorbic acid, oxalic acid, potassium iodide, or other reducing agents, or combinations thereof. In some embodiments, the acidic solution is degassed, blanketed with inert gas, or combinations thereof. In some embodiments, the resulting precipitated desired species are removed using solid-liquid separation apparatuses.

In some embodiments, the solid-liquid separation apparatuses comprise filters. In some embodiments, the filter is a belt filter, plate-and-frame filter press, pressure vessel containing filter elements, rotary drum filter, rotary disc filter, a candle filter, a bag filter, cartridge filter, a centrifugal filter with a fixed or moving bed, a metal screen, a perforated basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon. In some embodiments, the acidic solution is recirculated through the solid-liquid separator.

In some embodiments, the solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the precipitated solids into a zone where the solids can leave through the bottom of the thickener.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the desired precipitated species. In some embodiments, the hydrocyclones may have multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried insoluble species entering near the middle of the apparatus, and precipitated metals get trapped at the bottom and center of the apparatus due to a “teacup effect”.

In one embodiment, the solid-liquid separation apparatuses may use a membrane filter. In one embodiment, solid-liquid separations membrane filters are operated in batch mode, semi-batch mode, semi-continuous mode or continuous mode.

In some embodiments, the purified transition metal solids (e.g., the transition metal species, the precipitated transition metal species) are dried using a fluid bed dryer, a tumble dryer, a continuous tray dryer, a conveyor belt dryer, a rotary dryer, a vacuum dryer, a tunnel dryer, or combinations thereof. In some embodiments, the purified transition metal solids (e.g., the transition metal species, the precipitated transition metal species) are reduced in size using a ball mill, an attrition mill, a hammer mill, a pin mill, a jet mill, an air-classifying mill a gyratory crusher, a jaw crusher, a horizontal shaft impact crusher, a roll crusher, a cone crusher, feeder-breakers, or combinations thereof. In some embodiments, the purified transition metal solids are sized using a vibratory screener, a rotary screener, a cyclone, an elutriator, an air classifier, or combinations thereof.

In some embodiments, the weight-average particle diameter of the sized purified transition metal solids (e.g., the transition metal species, the precipitated transition metal species) range from 0.5-100 μm, 0.5-5 μm, 5-10 μm, 10-20 μm, 20-30 μm, 30-40 μm, 40-50 μm, 50-60 μm, 60-70 μm, 70-80 μm, 80-90 μm or 90-100 μm. In some embodiments, the purified transition metal solids are secondary particles comprised of smaller primary particles, wherein the secondary particles have an average diameter of less than about 10 nm, less than about 20 nm, less than about 30 nm, less than about 40 nm, less than about 50 nm, less than about 60 nm, less than about 70 nm, less than about 80 nm, less than about 90 nm, less than about 100 nm, less than about 1,000 nm, less than about 10,000 nm, less than about 100,000 nm, more than about 10 nm, more than about 20 nm, more than about 30 nm, more than about 40 nm, more than about 50 nm, more than about 60 nm, more than about 70 nm, more than about 80 nm, more than about 90 nm, more than about 100 nm, more than about 1,000 nm, more than about 10,000 nm, from about 1 nm to about 10,000 nm, from about 1 nm to about 1,000 nm, from about 1 nm to about 100 nm, from about 1 nm to about 80 nm, from about 1 nm to about 60 nm, from about 1 nm to about 40 nm, or from about 1 nm to about 20 nm. In some embodiments, the purified transition metal solids have an average diameter of less than about 10 μm, less than about 20 μm, less than about 30 μm, less than about 40 μm, less than about 50 μm, less than about 60 μm, less than about 70 μm, less than about 80 μm, less than about 90 μm, less than about 100 μm, less than about 1,000 μm, less than about 10,000 μm, less than about 100,000 μm, more than about 10 μm, more than about 20 μm, more than about 30 μm, more than about 40 μm, more than about 50 μm, more than about 60 μm, more than about 70 μm, more than about 80 μm, more than about 90 μm, more than about 100 μm, more than about 1,000 μm, more than about 10,000 μm, from about 1 μm to about 10,000 μm, from about 1 μm to about 1,000 μm, from about 1 μm to about 100 μm, from about 1 μm to about 80 μm, from about 1 μm to about 60 μm, from about 1 μm to about 40 μm, or from about 1 μm to about 20 μm. In some embodiments, the purified transition metal solids have an average size of less than about 100 μm, less than about 1,000 μm, or less than about 10,000 μm. In some embodiments, the purified transition metal solids are secondary particles comprised of smaller primary particles, wherein the secondary particles have an average diameter of less than about 10 μm, less than about 20 μm, less than about 30 μm, less than about 40 μm, less than about 50 μm, less than about 60 μm, less than about 70 μm, less than about 80 μm, less than about 90 μm, less than about 100 μm, less than about 1,000 μm, less than about 10,000 μm, less than about 100,000 μm, more than about 10 μm, more than about 20 μm, more than about 30 μm, more than about 40 μm, more than about 50 μm, more than about 60 μm, more than about 70 μm, more than about 80 μm, more than about 90 μm, more than about 100 μm, more than about 1,000 μm, more than about 10,000 μm, from about 1 μm to about 10,000 μm, from about 1 μm to about 1,000 μm, from about 1 μm to about 100 μm, from about 1 μm to about 80 μm, from about 1 μm to about 60 μm, from about 1 μm to about 40 μm, or from about 1 μm to about 20 μm.

In an embodiment, the average diameter of the purified transition metal solids which are secondary particles comprised of smaller primary particles, is determined by measuring the particle size distribution of the purified transition metal solids and determining the mean particle size.

In some embodiments, the purified transition metal solids (e.g., the transition metal species, the precipitated transition metal species) are mixed with a lithium salt in a solid-solid mixing system. In some embodiments, the lithium salt comprises lithium carbonate, lithium hydroxide, lithium hydroxide monohydrate, lithium sulfate, lithium nitrate, lithium phosphate, and combinations thereof. In some embodiments, the molar ratio of lithium atoms to transition metal atoms in this mixture is controlled to about 0.1, 0.2, 0.3, 0.4, 0.5, 0.6, 0.66, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, or 4. In some embodiments, the solid-solid mixing system may use a ball mill, an attrition mill, a v-blender, a tumbler blender, a double-cone blender, a ribbon blender, a paddle mixer, a planetary mixer, a conical screw mixer, a fluid-bed mixer, or combinations thereof. In some embodiments, the resulting mixture is transferred to a furnace and calcined. In some embodiments, the furnace is a continuous pusher furnace or a continuous rotary furnace. In some embodiments, the resulting mixture is transferred to a kiln and calcined. In some embodiments, the kiln is a batch box kiln, a batch tunnel kiln, or a batch rotary kiln. In some embodiments, the temperature of calcination ranges from 250-600° C., 600-1000° C., 400-600° C., 600-800° C., 800-° C., 250-300° C., 300-350° C., 350-400° C., 400-450° C., 450-500° C., 500-550° C., 550-600° C., 600-650° C., 650-700° C., 700-750° C., 750-800° C., 800-850° C., 850-900° C., 900-950° C., or 950-1000° C. In some embodiments, the atmosphere of the calcination is controlled via continuous flow of oxygen, ozone, nitrogen, argon, carbon monoxide, carbon dioxide, hydrogen or combinations thereof.

### Some Embodiments of the Disclosure

Provided below are some non-limiting Embodiments of the present disclosure.

Embodiment 1. A system for producing a synthetic lithium solution and removing transition metal species from said synthetic lithium solution, comprising:
a. a first subsystem configured to 1) first contact an ion exchange material to a liquid resource, wherein said ion exchange material absorbs lithium ions from said liquid resource while releasing protons, and subsequently 2) contact the ion exchange material to an acidic solution, wherein said ion exchange material releases lithium into said acidic solution while absorbing protons, producing a synthetic lithium solution.
b. a second subsystem configured to remove transition metal species from said synthetic lithium solution.
   Embodiment 2. The system of Embodiment 1, wherein the second subsystem further comprises:
1) a third subsystem configured to precipitate transition metal species dissolved in the synthetic lithium solution; and
2) a fourth subsystem for separating the liquid from the precipitated transition metal species.
   Embodiment 3. The system of Embodiment 2, wherein the third subsystem is configured to adjust the pH of the synthetic lithium solution, and wherein said adjustment causes the precipitation of transition metal species.
   Embodiment 4. The system of Embodiment 2, wherein the third subsystem is configured to adjust the oxidation-reduction potential of the synthetic lithium solution, and wherein said adjustment causes the precipitation of transition metal species.
   Embodiment 5. The system of Embodiment 2, wherein the third subsystem is configured to adjust the pH and oxidation-reduction potential of the synthetic lithium solution, and wherein said adjustment causes the precipitation of transition metal species.
   Embodiment 6. The system of any one of Embodiments 1-5, wherein the second subsystem removes dissolved transition metal species directly from solution.
   Embodiment 7. The system of Embodiment 6, wherein removal of transition metals species occurs by contacting an immiscible solvent to the synthetic lithium solution, and wherein said immiscible solvent preferentially dissolves the transition metal species.
   Embodiment 8. The system of Embodiment 6, wherein removal of transition metals species occurs by contacting the synthetic lithium solution to a cation exchange resin, and wherein said cation exchange resin preferentially absorbs the transition metal species.
   Embodiment 9. The system of Embodiment 6, wherein removal of transition metals species occurs by treating the synthetic lithium solution through a nanofiltration system, and wherein said nanofiltration system preferentially retains the transition metal species while allowing lithium ions to pass through the filter.
   Embodiment 10. The system of Embodiment 6, wherein removal of transition metals species occurs by a combination of the systems in Embodiments 7 to 9.
   Embodiment 11. The system of any of the Embodiments 1-6, wherein removal of transition metals species occurs by a combination of the system of Embodiments 2-5 and that of Embodiments 6-10.
   Embodiment 12. The system of Embodiment 1, wherein the second subsystem is configured to pass an electrical current through the synthetic lithium solution.
   Embodiment 13. The system of Embodiment 12, wherein said electrical current is passed between two electrodes in contact with the synthetic lithium solution.
   Embodiment 14. The system of any of the Embodiments 12 to 13, wherein a solid is formed on one of the electrodes, and wherein said solid comprises a transition metal species removed from the synthetic lithium solution.
   Embodiment 15. The system of Embodiment 14, wherein transition metal species is additionally removed by the system of any of the Embodiments 2-11.
   Embodiment 16. The system of any of the Embodiments 1-15, wherein a fifth subsystem is configured to manufacture an ion exchange material from the transition metal species removed from the synthetic lithium eluate.
   Embodiment 17. The system of Embodiment 16, wherein said fifth subsystem uses precipitated transition metal species produced by the system of any of the Embodiments 2-5 to manufacture an ion exchange material.
   Embodiment 18. The system of Embodiment 16, wherein said fifth subsystem uses precipitated transition metal species produced by the system of any of the Embodiments 12-15 to manufacture an ion exchange material.
   Embodiment 19. The system of any of the Embodiments 16-18, wherein in the fifth subsystem the precipitated transition metal species are washed with pure water or an aqueous solution.
   Embodiment 20. The system of any of the Embodiments 16-19, wherein in the fifth subsystem the precipitated transition metal species comprise oxides, hydroxides, metals, insoluble salts, chelates, or combinations thereof.
   Embodiment 21. The system of any of the Embodiments 16-20, wherein in the fifth subsystem the precipitated transition metal species are dissolved with an acid, and wherein said acid comprises hydrochloric acid, sulfuric acid, nitric acid, phosphoric acid, hydrobromic acid, hydroiodic acid, perchloric acid, acetic acid, or a combination thereof.
   Embodiment 22. The system of any of the Embodiments 16-21, wherein in the fifth subsystem the precipitated transition metal species are purified via hydrometallurgical processes.
   Embodiment 23. The system of the Embodiment 22, wherein the hydrometallurgical processes comprises leaching, concentration, precipitation, cementation, solvent extraction, ion exchange, gas reduction, electrowinning, electrolysis, electrorefining, and combinations thereof.
   Embodiment 24. The system of any of the Embodiments 16-23, wherein in the fifth subsystem the precipitated transition metal species are purified via pyrometallurgical processes.
   Embodiment 25. The system of any of the Embodiments 16-24, wherein in the fifth subsystem the precipitated transition metal species are purified via vapor metallurgy processes.
   Embodiment 26. The system of any of the Embodiments 16-25, wherein in the fifth subsystem the precipitated transition metal species are purified via molten salt electrometallurgy processes.
   Embodiment 27. The system of any of the Embodiments 16-26, wherein in the fifth subsystem the precipitated transition metal species are reduced in size through milling, grinding, and combinations thereof.
   Embodiment 28. The system of any of the Embodiments 16-27, wherein in the fifth subsystem the precipitated transition metal species are calcined in a furnace or kiln to prepare as precursors for manufacture of an ion exchange material.
   Embodiment 29. The system of any of the Embodiments 16-28, wherein in the fifth subsystem the precipitated transition metal species are mixed with other metals and calcined in a furnace or kiln to produce ion exchange material.
   Embodiment 30. The system of any of the Embodiments 16-28, wherein in the fifth subsystem the precipitated transition metal species are mixed with a lithium salt and calcined in a furnace or kiln to produce ion exchange material.
   Embodiment 31. The system of any of the Embodiments 16-28, wherein in the fifth subsystem the precipitated transition metal species are mixed with other metals and a lithium salt and calcined in a furnace or kiln to produce ion exchange material.
   Embodiment 32. The system of any of the Embodiments 16-29, wherein in the fifth subsystem the lithium salt comprises Li₂CO₃, LiOH, LiOH·H₂O, LiNO₃, Li₂SO₄, Li₃PO₄, or combinations thereof.
   Embodiment 33. The system of any of the Embodiments 1-32, wherein the synthetic lithium solution produced by the first subsystem comprises chloride, sulfate, phosphate, bromide, chlorate, perchlorate, nitrate, formate, citrate, acetate, or combinations thereof.
   Embodiment 34. The system of any of the Embodiments 1-33, wherein the synthetic lithium solution produced by the first subsystem comprises chloride, sulfate, nitrate, or any combinations thereof.
   Embodiment 35. The system of any of the Embodiments 1-34, wherein the synthetic lithium solution is used to produce a lithium product, and wherein said lithium product comprises lithium carbonate, lithium chloride, lithium hydroxide, lithium nitrate, lithium sulfate, lithium phosphate, metallic lithium, or a combination thereof.
   Embodiment 36. The system of any of the Embodiments 1-35, wherein the transition metal species comprises titanium, zirconium, vanadium, iron, copper, manganese, molybdenum, aluminum, niobium, or combinations thereof.
   Embodiment 37. The system of any of the Embodiments 1-36, wherein in the synthetic lithium solution produced by the first subsystem, the molar concentration of transition metal species is lower than the molar concentration of lithium in the synthetic lithium solution.
   Embodiment 38. The system of any of the Embodiments 1-37, wherein the concentration of lithium in the synthetic lithium solution produced by the first subsystem is greater than about 200 milligrams per liter and less than about 8000 milligrams per liter.
   Embodiment 39. The system of any of the Embodiments 1-37, wherein the concentration of lithium in the synthetic lithium solution produced by the first subsystem is greater than about 200 milligrams per liter and less than about 4000 milligrams per liter.
   Embodiment 40. The system of any of the Embodiments 1-37, wherein the concentration of lithium in the synthetic lithium solution produced by the first subsystem is greater than about 2000 milligrams per liter and less than about 8000 milligrams per liter.
   Embodiment 41. The system of any of the Embodiments 1-37, wherein the concentration of lithium in the synthetic lithium solution produced by the first subsystem is greater than about 200 milligrams per liter and less than about 1000 milligrams per liter.
   Embodiment 42. The system of any of the Embodiments 1-37, wherein the concentration of lithium in the synthetic lithium solution produced by the first subsystem is greater than about 200 milligrams per liter and less than about 500 milligrams per liter.
   Embodiment 43. The system of any of the Embodiments 1-37, wherein the concentration of lithium in the synthetic lithium solution produced by the first subsystem is greater than about 1000 milligrams per liter and less than about 4000 milligrams per liter.
   Embodiment 44. The system of any of the Embodiments 1-37, wherein the concentration of lithium in the synthetic lithium solution produced by the first subsystem is greater than about 1000 milligrams per liter and less than about 2000 milligrams per liter.
   Embodiment 45. The system of any of the Embodiments 1-37, wherein the concentration of lithium in the synthetic lithium solution produced by the first subsystem is greater than about 2000 milligrams per liter and less than about 3000 milligrams per liter.
   Embodiment 46. The system of any of the Embodiments 1-37, wherein the concentration of lithium in the synthetic lithium solution produced by the first subsystem is greater than about 3000 milligrams per liter and less than about 4000 milligrams per liter.
   Embodiment 47. The system of any of the Embodiments 1-37, wherein the concentration of lithium in the synthetic lithium solution produced by the first subsystem is greater than about 4000 milligrams per liter and less than about 5000 milligrams per liter.
   Embodiment 48. The system of any of the Embodiments 1-37, wherein the concentration of lithium in the synthetic lithium solution produced by the first subsystem is greater than about 5000 milligrams per liter and less than about 6000 milligrams per liter.
   Embodiment 49. The system of any of the Embodiments 1-37, wherein the concentration of lithium in the synthetic lithium solution produced by the first subsystem is greater than about 6000 milligrams per liter and less than about 8000 milligrams per liter.
   Embodiment 50. The system of any of the Embodiments 1-49, wherein the synthetic lithium solution produced by the first subsystem is acidic.
   Embodiment 51. The system of any of the Embodiments 1-49, wherein the value of pH of the synthetic lithium solution produced by the first subsystem is greater than about 1 and less than about 4.
   Embodiment 52. The system of any of the Embodiments 1-49, wherein the value of pH of the synthetic lithium solution produced by the first subsystem is greater than about 0 and less than about 1.
   Embodiment 53. The system of any of the Embodiments 1-49, wherein the value of pH of the synthetic lithium solution produced by the first subsystem is greater than about 1 and less than about 2.
   Embodiment 54. The system of any of the Embodiments 1-49, wherein the value of pH of the synthetic lithium solution produced by the first subsystem is greater than about 2 and less than about 3.
   Embodiment 55. The system of any of the Embodiments 1-49, wherein the value of pH of the synthetic lithium solution produced by the first subsystem is greater than about 3 and less than about 4.
   Embodiment 56. The system of any of the Embodiments 1-49, wherein the value of pH of the synthetic lithium solution produced by the first subsystem is greater than about 4 and less than about 5.
   Embodiment 57. The system of any of the Embodiments 1-49, wherein the value of pH of the synthetic lithium solution produced by the first subsystem is greater than about 5 and less than about 6.
   Embodiment 58. The system of any of the Embodiments 1-49, wherein the value of pH of the synthetic lithium solution produced by the first subsystem is greater than about 6 and less than about 8.
   Embodiment 59. The system of any of the Embodiments 1-49, wherein the value of pH of the synthetic lithium solution produced by the first subsystem is greater than about 8 and less than about 10.
   Embodiment 60. The system of any of the Embodiments 1-59, wherein the pH of the synthetic lithium solution is adjusted by adding a base.
   Embodiment 61. The system of any of the Embodiments 1-59, wherein the pH is adjusted by adding hydroxide containing species to precipitate insoluble transition metal hydroxide salts.
   Embodiment 62. The system of any of the Embodiments 1-59, wherein the transition metal species are precipitated by adding hydroxide containing species to precipitate insoluble transition metal hydroxide salts.
   Embodiment 63. The system of any of the Embodiments 1-62, wherein the pH of the synthetic lithium solution is adjusted by adding NaOH, KOH, LiOH, RbOH, Ca(OH)₂, Mg(OH)₂, Sr(OH)₂, Ba(OH)₂, NH₄OH, Li₂CO₃, Na₂CO₃, other basic compounds, or combinations thereof.
   Embodiment 64. The system of any of the Embodiments 1-63, wherein the pH of the synthetic lithium solution is adjusted by distilling off the acid.
   Embodiment 65. The system of any of the Embodiments 1-64, wherein the pH of the synthetic lithium solution is adjusted by distilling off the acid at temperatures of from about 50 to about 150 degrees centigrade.
   Embodiment 66. The system of any of the Embodiments 1-64, wherein the pH of the synthetic lithium solution is adjusted by distilling off the acid at temperatures of from about 100 to about 200 degrees centigrade.
   Embodiment 67. The system of any of the Embodiments 1-64, wherein the pH of the synthetic lithium solution is adjusted by distilling off the acid at temperatures of from about 100 to about 300 degrees centigrade.
   Embodiment 68. The system of any of the Embodiments 1-64, wherein the pH of the synthetic lithium solution is adjusted by distilling off the acid at temperatures of from about 200 to about 400 degrees centigrade.
   Embodiment 69. The system of any of the Embodiments 1-64, wherein the pH of the synthetic lithium solution is adjusted by distilling off the acid at temperatures of from about 400 to about 600 degrees centigrade.
   Embodiment 70. The system of any of the Embodiments 1-65, wherein the pH of the synthetic lithium solution is adjusted by distilling off the acid a pressure of from about 0.01 to about 0.1 atmospheres.
   Embodiment 71. The system of any of the Embodiments 1-65, wherein the pH of the synthetic lithium solution is adjusted by distilling off the acid a pressure of from about 0.1 to about 1 atmosphere.
   Embodiment 72. The system of any of the Embodiments 65-69, wherein the pH of the synthetic lithium solution is adjusted by distilling off the acid a pressure of from about 1 to about 10 atmospheres.
   Embodiment 73. The system of any of the Embodiments 1-72, wherein in the second subsystem, the pH of the synthetic lithium solution is adjusted from a value of less than about 3 to a value greater than about 9.
   Embodiment 74. The system of any of the Embodiments 1-73, wherein in the second subsystem, the pH of the synthetic lithium solution is adjusted from a value of less than about 3 to a value of between 7 and 8.
   Embodiment 75. The system of any of the Embodiments 1-73, wherein in the second subsystem, the pH of the synthetic lithium solution is adjusted from a value of less than about 3 to a value of between 8 and 9.
   Embodiment 76. The system of any of the Embodiments 1-73, wherein in the second subsystem, the pH of the synthetic lithium solution is adjusted from a value of less than about 3 to a value of between 9 and 10.
   Embodiment 77. The system of any of the Embodiments 1-73, wherein in the second subsystem, the pH of the synthetic lithium solution is adjusted from a value of less than about 2 to a value of between 7 and 8.
   Embodiment 78. The system of any of the Embodiments 1-73, wherein in the second subsystem, the pH of the synthetic lithium solution is adjusted from a value of less than about 2 to a value of between 8 and 9.
   Embodiment 79. The system of any of the Embodiments 1-73, wherein in the second subsystem, the pH of the synthetic lithium solution is adjusted from a value of less than about 2 to a value of between 9 and 10.
   Embodiment 80. The system of any of the Embodiments 1-79, wherein the value of oxidation reduction potential of the synthetic lithium solution produced by the first subsystem is greater than about 50 mV and less than about 150 mV.
   Embodiment 81. The system of any of the Embodiments 1-79, wherein the value of oxidation reduction potential of the synthetic lithium solution produced by the first subsystem is greater than about 150 mV and less than about 300 mV.
   Embodiment 82. The system of any of the Embodiments 1-79, wherein the value of oxidation reduction potential of the synthetic lithium solution produced by the first subsystem is greater than about 300 mV and less than about 500 mV.
   Embodiment 83. The system of any of the Embodiments 1-79, wherein the value of oxidation reduction potential of the synthetic lithium solution produced by the first subsystem is greater than about 500 mV and less than about 800 mV.
   Embodiment 84. The system of any of the Embodiments 1-83, wherein a redox active species is added to the synthetic lithium solution to adjust its oxidation-reduction potential.
   Embodiment 85. The system of any of the Embodiments 1-83, wherein an electrical current through the synthetic lithium solution to adjust its oxidation-reduction potential.
   Embodiment 86. The system of Embodiment 85, wherein said electrical current is passed between two electrodes in contact with the synthetic lithium solution.
   Embodiment 87. The system of any of the Embodiments 85 to 86, wherein a solid is formed on one of the electrodes, and wherein said solid comprises a transition metal species removed from the synthetic lithium solution.
   Embodiment 88. The system of any of the Embodiments 1-87, wherein in the second subsystem comprises an electrolysis cell.
   Embodiment 89. The system of any of the Embodiments 1-87, wherein in the second subsystem comprises an electrowinning cell.
   Embodiment 90. The system of any of the Embodiments 1-89, wherein an oxidant is added to the synthetic lithium solution to increase its oxidation-reduction potential.
   Embodiment 91. The system of Embodiment 90, wherein the oxidant comprises sodium hypochlorite, perchlorate, chlorate, bleach, hydrogen peroxide, nitric acid, potassium permanganate, fluorine, chlorine, air, oxygen, ozone, or combinations thereof.
   Embodiment 92. The system of any of the Embodiments 1-91, wherein a reductant is added to the synthetic lithium solution to decrease its oxidation-reduction potential.
   Embodiment 93. The system of Embodiment 92, wherein the reductant comprises sodium bisulfite, sodium metabisulfite, sodium borohydride, formic acid, ascorbic acid, oxalic acid, potassium iodide, or combinations thereof.
   Embodiment 94. The system of any of the Embodiments 1-93, wherein in the second subsystem, the oxidation-reduction potential of the synthetic lithium solution is adjusted from a value of less than about 200 mV to a value of between 300 and 400 mV.
   Embodiment 95. The system of any of the Embodiments 1-93, wherein in the second subsystem, the oxidation-reduction potential of the synthetic lithium solution is adjusted from a value of less than about 200 mV to a value of between 400 and 500 mV.
   Embodiment 96. The system of any of the Embodiments 1-93, wherein in the second subsystem, the oxidation-reduction potential of the synthetic lithium solution is adjusted from a value of less than about 200 mV to a value of between 500 and 600 mV.
   Embodiment 97. The system of any of the Embodiments 1-93, wherein in the second subsystem, the oxidation-reduction potential of the synthetic lithium solution is adjusted from a value of less than about 200 mV to a value of between 600 and 700 mV.
   Embodiment 98. The system of any of the Embodiments 1-93, wherein in the second subsystem, the oxidation-reduction potential of the synthetic lithium solution is adjusted from a value of less than about 200 mV to a value of between 700 and 800 mV.
   Embodiment 99. The system of any of the Embodiments 1-93, wherein in the second subsystem, the oxidation-reduction potential of the synthetic lithium solution is adjusted from a value of less than about 200 mV to a value of between 800 and 1000 mV.
   Embodiment 100. The system of any of the Embodiments 1-93, wherein in the second subsystem, the oxidation-reduction potential of the synthetic lithium solution is adjusted from a value of more than about 200 mV to a value of between 100 and 200 mV.
   Embodiment 101. The system of any of the Embodiments 1-93, wherein in the second subsystem, the oxidation-reduction potential of the synthetic lithium solution is adjusted from a value of more than about 200 mV to a value of between 0 and 100 mV.
   Embodiment 102. The system of any of the Embodiments 1-93, wherein in the second subsystem, the oxidation-reduction potential of the synthetic lithium solution is adjusted from a value of more than about 100 mV to a value of between 0 and 100 mV.
   Embodiment 103. The system of any of the Embodiments 2-102, wherein in the second subsystem, the transition metal impurities are precipitated by adding seed crystals to the synthetic lithium solution to crystallize the transition metals in the third subsystem.
   Embodiment 104. The system of Embodiment 103, wherein in the second subsystem, the addition of seed crystals increases the size of crystallites of the transition metals formed to the third subsystem.
   Embodiment 105. The system of Embodiment 103, wherein in the second subsystem the addition of seed crystals increases the size of crystallites of the transition metals formed, facilitating the separation of these crystals from the liquid synthetic lithium solution in the fourth subsystem.
   Embodiment 106. The system of Embodiment 103, wherein in the second subsystem the transition metal impurities are precipitated by adding chelating ligands to the third subsystem.
   Embodiment 107. The system Embodiment 106, wherein in chelating ligands comprise EDTA, oxalate, or combinations thereof.
   Embodiment 108. The system of any of the Embodiments 2-107, wherein in the second subsystem, the transition metal impurities are precipitated by adding complimentary anions to the third subsystem, to form insoluble transition metal salts.
   Embodiment 109. The system Embodiment 108, wherein said complimentary anions comprise sulfide, phosphate, carbonate, other anions, or combinations thereof.
   Embodiment 110. The system of any of the Embodiments 2-109, wherein in the second subsystem, the transition metals are precipitated by adding a precipitant comprising H₂S, Na₂S, K₂S, CaS, MgS, Na₃PO₄, K₃PO₄, Rb₃PO₄, (NH₄)₃PO₄, MgCO₃, CaCO₃, SrCO₃, CO₂, Na₂CO₃, or combinations thereof to the third subsystem.
   Embodiment 111. The system of Embodiment 110, wherein in the precipitant comprises Na₃PO₄, K₃PO₄, Rb₃PO₄, (NH₄)₃PO₄, MgCO₃, CaCO₃, SrCO₃, Na₂CO₃, or combinations thereof.
   Embodiment 112. The system of any of the Embodiments 2-111, wherein in the fourth subsystem the precipitated transition metals are separated from the synthetic lithium solution using centrifugation.
   Embodiment 113. The system of any of the Embodiments 2-111, wherein in the fourth subsystem the precipitated transition metals are separated from the synthetic lithium solution using pressure filtration.
   Embodiment 114. The system of any of the Embodiments 2-111, wherein in the fourth subsystem the precipitated transition metals are separated from the synthetic lithium solution using gravity sedimentation.
   Embodiment 115. The system of any of the Embodiments 2-111, wherein in the fourth subsystem the precipitated transition metals are removed by settling the solids and removing the supernatant.
   Embodiment 116. The system of Embodiment 115, wherein the settling of the solids is aided by a flocculant, a coagulant, or combinations thereof.
   Embodiment 117. The system of any of the Embodiments 2-111, wherein in the fourth subsystem the precipitated transition metals are removed using membrane filtration, belt filtration, cartridge filtration, nanofiltration, pressure filtration, rotary disk filtration, or combinations thereof.
   Embodiment 118. The system of any of the Embodiments 2-111, wherein in the fourth subsystem the precipitated transition metals are removed using magnetic fields.
   Embodiment 119. The system of any of the Embodiments 2-111, wherein in the fourth subsystem the precipitated transition metals are removed using particle traps.
   Embodiment 120. The system of any of the Embodiments 2-111, wherein in the fourth subsystem the precipitated transition metals are removed using surfactants.
   Embodiment 121. The system of any of the Embodiments 2-111, wherein in the fourth subsystem the precipitated transition metals are removed using floatation.
   Embodiment 122. The system of any of the Embodiments 1-121, wherein in second subsystem the dissolved transition metals are removed by precipitating transition metal species, separating the precipitated species by a solid-liquid separator, and removing additional transition metals using ion exchange resins, water softeners, solvent extraction, or combinations thereof.
   Embodiment 123. The system of any of the Embodiments 1-122, wherein the ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.
   Embodiment 124. The system of Embodiment 123, wherein said ion exchange material is a coated ion exchange material with a coating that is selected from an oxide, a polymer, or combinations thereof.
   Embodiment 125. The system of any of the Embodiments 123 to 124, wherein said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof.
   Embodiment 126. The system of any of the Embodiments 1-125, wherein the liquid resource is a natural brine, a pretreated brine, a dissolved salt flat brine, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.
   Embodiment 127. The system of any of the Embodiments 1-126, wherein the acidic solution is an acid comprising hydrochloric acid, sulfuric acid, nitric acid, phosphoric acid, hydrobromic acid, hydroiodic acid, perchloric acid, acetic acid, or a combination thereof.
   Embodiment 128. The system of any of the Embodiments 1-127, wherein the ion exchange material is washed with pure water or an aqueous solution.
   Embodiment 129. The system of any of the Embodiments 1-128, wherein the second subsystem comprises one or more vessels.
   Embodiment 130. The system of any of the Embodiments 1-129, wherein the third subsystem comprises one or more vessels.
   Embodiment 131. The system of any of the Embodiments 1-130, wherein the fourth subsystem comprises one or more solid-liquid separators.
   Embodiment 132. The system of any of the Embodiments 129-131, wherein the content of one or more vessels are agitated.
   Embodiment 133. The system of Embodiment 132, wherein the content of one or more vessels are agitated using a stirrer.
   Embodiment 134. The system of Embodiment 132, wherein the content of one or more vessels are agitated using an eductor.
   Embodiment 135. The system of Embodiment 132, wherein the content of one or more vessels are agitated using an air sparger.
   Embodiment 136. The system of any of the Embodiments 129-135, wherein the pH, ORP, or a combination of pH and ORP of the synthetic lithium solution is adjusted in each tank.
   Embodiment 137. The system of any of the Embodiments 129-136, wherein said system is configured within a single vessel.
   Embodiment 138. The system of any of the Embodiments 129-136, wherein said system is configured with 2 to 3 vessels.
   Embodiment 139. The system of any of the Embodiments 129-136, wherein said system is configured with 3 to 5 vessels.
   Embodiment 140. The system of any of the Embodiments 129-136, wherein said system is configured with 5 to 10 vessels.
   Embodiment 141. The system of any of the Embodiments 129-140, wherein said system is configured with 1 solid-liquid separator.
   Embodiment 142. The system of any of the Embodiments 129-140, wherein said system is configured with 2 to 3 solid-liquid separators.
   Embodiment 143. The system of any of the Embodiments 129-140, wherein said system is configured with 3 to 5 solid-liquid separators.
   Embodiment 144. The system of any of the Embodiments 129-140, wherein said system is configured with 5 to 10 solid-liquid separators.
   Embodiment 145. The system of any of the Embodiments 129-144, wherein a substance that adjusts the pH, ORP, or a combination of pH and ORP is injected using a nozzle.
   Embodiment 146. A process of producing a synthetic lithium solution with any of the systems of Embodiments 1-145.
   Embodiment 147. A process of producing an ion exchange material with any of the systems of Embodiments 16-146.

### Examples

Example 1: Removal of Transition Metal Species from a Lithium Eluate by Precipitation and Filtration, Wherein Said Transition Metals are Recycled to Manufacture an Ion Exchange Material

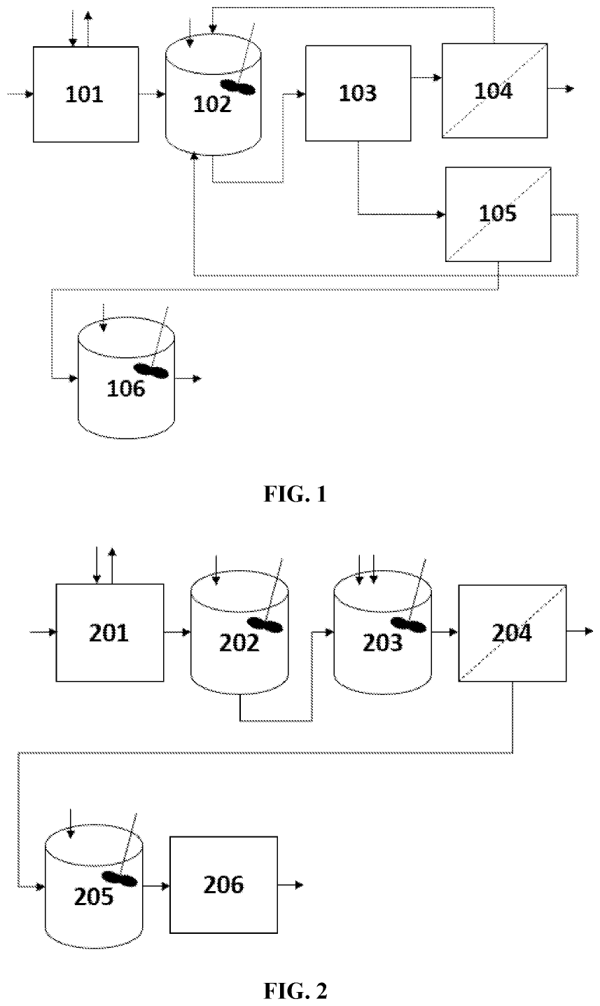

With reference to FIG. 1, lithium is extracted from a liquid resource with ion-exchange system 101. The liquid resource from which lithium is extracted consists of a natural brine containing approximately 500 mg/L Li, 80,000 mg/L Na, 1,000 mg/L Ca, and 2,000 mg/L Mg, 20,000 mg/L K, 250 mg/L B, 1 mg/L Mn, 5 mg/L Fe. The liquid resource is contacted with ion exchange beads comprising Li₄Ti₅O₁₂ to absorb lithium, and lithium is eluted from said ion exchange beads with an acidic chloride solution.

The lithium enriched eluate (e.g., the synthetic lithium solution) comprises 1,500 mg/L lithium and a minority of transition metal species including 50 mg/L of Ti, with a pH value of 1. The lithium chloride eluate (e.g., the synthetic lithium solution) is treated to remove transition metal species.

First, the lithium chloride eluate is fed into agitated vessel 102, where its pH is adjusted to a value of 10 by addition of an aqueous slurry of 2 M NaOH. This results in the formation of a slurry. Said slurry comprises precipitated titanium species (e.g., precipitated transition metal species) and a solution comprising lithium hydroxide and sodium hydroxide. The solution (e.g., the synthetic lithium solution) will contain no detectable Ti and the solution will have a lithium concentration of about 1,500 mg/L.

This slurry is continually fed into thickener 103, where the solids settle towards the bottom to result in a partially clarified supernatant. Concentrated solids are continually fed from the bottom of clarifier to a filter press 105 to separate the solids from the Li eluate. The filtrate from filter press 105 contains small unfiltered crystals, which are recycled back to vessel 102 so that they will go through an additional precipitation cycle and grow into larger crystallites that are trapped by filter press 105.

The top of clarifier 103 is fed into ultrafilter 104. The permeate of 104 comprises the purified lithium eluate, wherein all transition metal species have been removed. The backwash of ultrafilter 104 contains small titanium crystals; therefore, it is recycled back to vessel 102, so that these crystals will go through an additional precipitation cycle and grow into larger crystallites that are trapped by filter press 105.

The process results in a lithium eluate comprising lithium and sodium, wherein all transition metal species have been removed.

The solids from filter press 105 are transferred to a solid-solid mixer 106, where they are mixed with lithium hydroxide monohydrate. This solid mixture is fed into pusher furnace 206, where they are calcined at 500° C. for 16 hours to produce the Li₄Ti₅O₁₂ ion exchange material used for ion exchange to produce lithium.

Example 2: Removal of Transition Metal Species from a Lithium Eluate by Precipitation and Filtration, Wherein Said Transition Metals are Recycled to Manufacture an Ion Exchange Material

With reference to FIG. 2, lithium is extracted from a liquid resource with ion-exchange system 201. The brine (e.g., liquid resource) from which lithium is extracted consists of a geothermal brine containing approximately 250 mg/L Li, 50,000 mg/L Na, 40,000 mg/L Ca, and 200 mg/L Mg, 20,000 mg/L K, 500 mg/L B, 150 mg/L Mn, 50 mg/L Fe. The liquid resource is contacted with ion exchange beads comprising Li₂Mn₂O₅ to absorb lithium, and lithium is eluted from said ion exchange beads with an acidic sulfate solution.

The lithium enriched eluate (e.g., the synthetic lithium solution) comprises 3,000 mg/L lithium and a minority of transition metal species including 100 mg/L of Mn, with a pH value of 2. The lithium sulfate eluate (e.g., the synthetic lithium solution) is treated to remove transition metal species. Said removed transition metals are used to manufacture an ion exchange material.

First, the lithium sulfate eluate is fed into agitated vessel 202, where its pH is adjusted to a value of 9 by addition of an aqueous 8 M NaOH solution. This results in the formation of a slurry. Said slurry comprises a liquid with a Mn concentration of about 25 mg/L and Li concentration of about 3,000 mg/L, and a solid comprising manganese. The solid comprising manganese is at least partially in the form of crystallites, which can act as seed crystals in a second agitation step to increase the amount of manganese separated from the liquid. The slurry from 202 is continually fed to a second agitated vessel 203, where the pH of the slurry is adjusted to a value of 10 by addition of an aqueous 8 M NaOH solution, and the oxidation-reduction potential is adjusted to a value of 400 mV by addition of an aqueous solution of sodium hypochlorite. This results in a slurry comprising a liquid with no detectable Mn and a Li concentration of about 3,000 mg/L, and a solid comprising manganese (e.g., transition metal species, precipitated transition metal species). The slurry is continually fed to a candle filter 204 to separate the solids from the Li eluate (e.g., the synthetic lithium solution) comprising lithium and sodium.

When the solids fill candle filter 204, flow into said filter is stopped. The solids are washed with water and dried with air. The solids are transferred to a solid-solid mixer 205, where they are mixed with lithium hydroxide monohydrate. This solid mixture is fed into push furnace 206, where they are calcined at 600° C. for 10 hours to produce the Li₂Mn₂O₅ ion exchange material (e.g., the impurities-derived ion exchange material) used for ion exchange to produce lithium.

Example 3: Removal of Transition Metal Species from a Lithium Eluate by Precipitation and Filtration, Wherein Said Transition Metals are Recycled to Manufacture an Ion Exchange Material

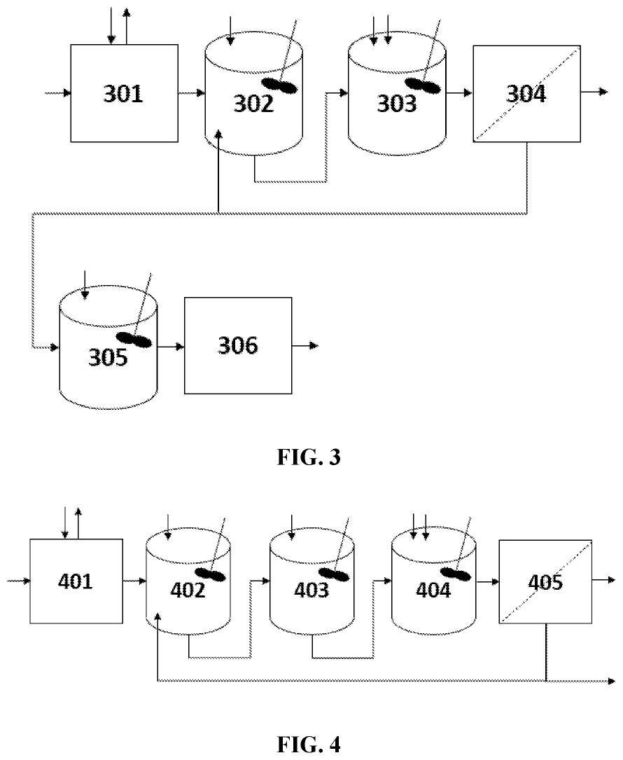

With reference to FIG. 3., lithium is extracted from a liquid resource with ion-exchange system 301. The brine (e.g., liquid resource) from which lithium is extracted consists of a geothermal brine containing approximately 500 mg/L Li, 50,000 mg/L Na, 20,000 mg/L Ca, and 1,000 mg/L Mg, 5,000 mg/L K, 200 mg/L B, 25 mg/L Mn, 25 mg/L Fe. The liquid resource is contacted with ion exchange beads comprising olivine LiFePO₄ coated with a 10 nm layer of SiO₂ to absorb lithium, and lithium is eluted from said ion exchange beads with an acidic chloride solution.

The lithium enriched eluate (e.g., the synthetic lithium solution) comprises 2,000 mg/L lithium and a minority of transition metal species including 5 mg/L of Fe, with a pH value of 3. The lithium chloride eluate (e.g., the synthetic lithium solution) is treated to remove transition metal species. Said removed transition metals are used to manufacture an ion exchange material.

First, the lithium chloride eluate (e.g., the synthetic lithium solution) is fed into agitated vessel 302, where its pH is adjusted to a value of 8 by addition of an aqueous 4 M NaOH solution. This results in the formation of a slurry. Said slurry comprises a liquid with a Fe concentration of about 1 mg/L and Li concentration of about 2,000 mg/L, and a solid comprising iron. This slurry is continually fed to a second agitated vessel 303, where the pH of the slurry is adjusted to a value of 10 by addition of an aqueous 4 M NaOH solution, and the oxidation-reduction potential is adjusted to a value of 500 mV by addition of an aqueous solution of hydrogen peroxide. This results in a slurry comprising a liquid with no detectable Fe and a Li concentration of about 2,000 mg/L, and a solid comprising iron. The slurry is continually fed to a filter press 304 to separate the solids (e.g., transition metal species, precipitated transition metal species) from the Li eluate comprising lithium and sodium (e.g., the synthetic lithium solution).

When the solids fill filter press 304, flow into said filter is stopped. The solids are washed with water and dried with air. A portion of solids are continuously fed into agitated vessel 302 to serve as crystal seeds; the presence of said seeds in 302 results in a higher crystal size for the iron precipitate, leading to a slower clogging rate in filter press 304.

The remainder of the solids are transferred to a solid-solid mixer 305, where they are mixed with lithium phosphate. This solid mixture is fed into push furnace 306, where they are calcined at 550° C. for 12 hours to produce the olivine LiFePO₄ ion exchange material (e.g., the impurities-derived ion exchange material). This material then coated with a 10 nm layer of SiO₂ and used for ion exchange to produce lithium.

Example 4: Removal of Transition Metal Species from a Lithium Eluate by Precipitation and Centrifugation

With reference to FIG. 4., lithium is extracted from a liquid resource with ion-exchange system 401. The brine (e.g., liquid resource) from which lithium is extracted consists of a natural brine containing approximately 2,000 mg/L Li, 75,000 mg/L Na, 500 mg/L Ca, and 15,000 mg/L Mg, 30,000 mg/L K, 2,000 mg/L B, 1 mg/L Mn, 5 mg/L Fe. The liquid resource is contacted with ion exchange beads comprising olivine LiFePO₄ coated with a 10 nm layer of SiO₂ to absorb lithium, and lithium is eluted from said ion exchange beads with an acidic chloride solution.

The lithium enriched eluate (e.g., the synthetic lithium solution) comprises 4,000 mg/L lithium and a minority of transition metal species including 5 mg/L of Fe, with a pH value of 2. The lithium chloride eluate (e.g., the synthetic lithium solution) is treated to remove transition metal species.

First, the lithium chloride eluate (e.g., the synthetic lithium solution) is fed into agitated vessel 402, where its pH is adjusted to a value of 7 by addition of an aqueous 8 M NaOH solution. This results in the formation of a slurry. Said slurry comprises a liquid with a Fe concentration of about 2 mg/L and Li concentration of about 4,000 mg/L, and a solid comprising iron. This slurry is continually fed to a second agitated vessel 403, where the pH of the slurry is adjusted to a value of 9 by addition of an aqueous 8 M NaOH solution. This results in a slurry comprising a liquid with a Fe concentration of about 1 mg/L and a Li concentration of about 4,000 mg/L, and a solid comprising iron. The slurry from 403 is continually fed to a second agitated vessel 404, where the pH of the slurry is adjusted to a value of 9 by addition of an aqueous 8 M NaOH solution, and the oxidation-reduction potential is adjusted to a value of 350 m V by aeration with an air sparger. This results in a slurry comprising a liquid with no detectable Fe and a Li concentration of about 4,000 mg/L, and a solid comprising iron (e.g., transition metal species, precipitated transition metal species). The slurry is continually fed to a disc centrifuge 405 to separate the solids (e.g., transition metal species, precipitated transition metal species) from the Li eluate (e.g., the synthetic lithium solution).

Disc centrifuge 405 intermittently discharges the solids comprising iron (e.g., transition metal species, precipitated transition metal species). A portion of solids are continuously fed into agitated vessel 402 to serve as crystal seeds; the presence of said seeds in 402 results in a larger crystal size for the iron precipitate, leading to a faster rate of centrifugation in disc centrifuge 405.

The process results in a lithium eluate comprising lithium and sodium (e.g., a synthetic lithium solution), wherein all transition metal species have been removed.

Example 5: Removal of Transition Metal Species from a Lithium Eluate by Precipitation and Centrifugation, Wherein Said Transition Metals are Recycled to Manufacture an Ion Exchange Material

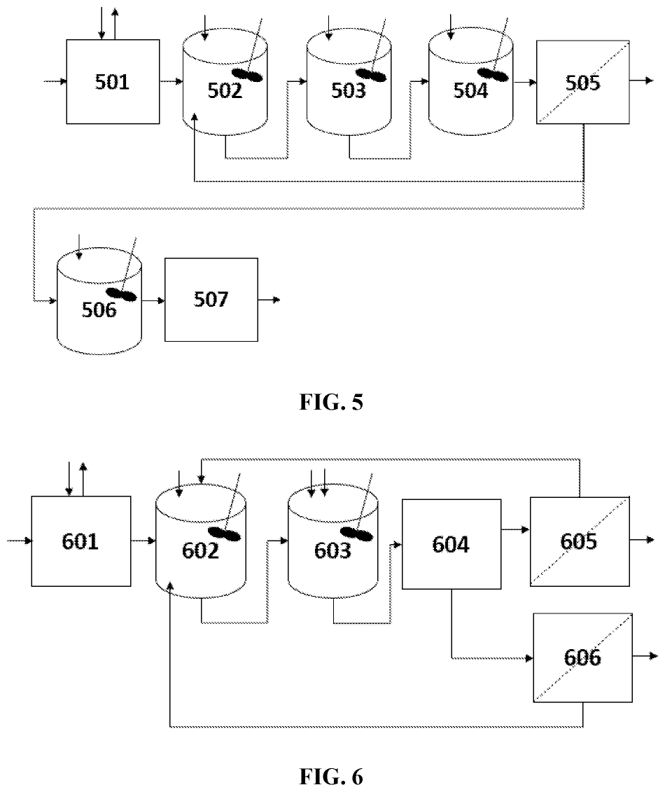

With reference to FIG. 5., lithium is extracted from a liquid resource with ion-exchange system 501. The brine (e.g., liquid resource) from which lithium is extracted consists of a natural brine containing approximately 100 mg/L Li, 100,000 mg/L Na, 500 mg/L Ca, and 1,000 mg/L Mg, 1,000 mg/L K, 300 mg/L B, 1 mg/L Mn, 10 mg/L Fe. The liquid resource is contacted with ion exchange beads comprising Li₄Ti₅O₁₂, and lithium is eluted from said ion exchange beads with an acidic nitrate solution.

The lithium enriched eluate (e.g., the synthetic lithium solution) comprises 1,000 mg/L lithium and a minority of transition metal species including 5 mg/L of Ti, with a pH value of 1.5. The lithium nitrate eluate is treated to remove transition metal species. Said removed transition metals are used to manufacture an ion exchange material.

First, the lithium nitrate eluate (e.g., the synthetic lithium solution) is fed into agitated vessel 502, where its pH is adjusted to a value of 7 by addition of an aqueous 4 M LiOH solution. This results in the formation of a slurry. Said slurry comprises a liquid with a Ti concentration of about 2 mg/L and Li concentration of about 1,000 mg/L, and a solid comprising titanium. This slurry is continually fed to a second agitated vessel 503, where the pH of the slurry is adjusted to a value of 9 by addition of an aqueous 4 M LiOH solution. This results in a slurry comprising a liquid with a Ti concentration of about 1 mg/L and a Li concentration of about 1,000 mg/L, and a solid comprising titanium (e.g., transition metal species, precipitated transition metal species). The slurry from 503 is continually fed to a second agitated vessel 504, where the pH of the slurry is adjusted to a value of 9 by addition of an aqueous 4 M LiOH solution. This results in a slurry comprising a liquid with no detectable Ti and a Li concentration of about 1,000 mg/L, and a solid comprising titanium. The slurry is continually fed to perforated basket centrifuge 505 to separate the solids from the pure Li eluate. The process results in a pure lithium eluate (e.g., a synthetic lithium solution), wherein all transition metal species have been removed.

Solids comprising titanium (e.g., transition metal species, precipitated transition metal species) are collected by perforated basket centrifuge 505. A portion of solids are continuously fed into agitated vessel 502 to serve as crystal seeds; the presence of said seeds in 502 results in a larger crystal size for the titanium precipitate, leading to a faster rate of centrifugation in perforated basket centrifuge 505.

The remainder of the solids are transferred to a solid-solid mixer 506, where they are mixed with lithium nitrate. This solid mixture is fed into furnace 507, where they are calcined at 600° C. for 10 hours to produce the Li₄Ti₅O₁₂ ion exchange material (e.g., the impurities-derived ion exchange material).

Example 6: Removal of Transition Metal Species from a Lithium Eluate by Precipitation and Filtration

With reference to FIG. 6, lithium is extracted from a liquid resource with ion-exchange system 601. The brine (e.g., liquid resource) from which lithium is extracted consists of a geothermal brine containing approximately 500 mg/L Li, 50,000 mg/L Na, 30,000 mg/L Ca, and 5,000 mg/L Mg, 10,000 mg/L K, 250 mg/L B, 100 mg/L Mn, 25 mg/L Fe. The liquid resource is contacted with ion exchange beads comprising Li₂Mn₂O₅ to absorb lithium, and lithium is eluted from said ion exchange beads with an acidic chloride solution.

The lithium enriched eluate (e.g., the synthetic lithium solution) comprises 5,000 mg/L lithium and a minority of transition metal species including 50 mg/L of Mn, with a pH value of 2. The lithium chloride eluate is treated to remove transition metal species.

First, the lithium chloride eluate (e.g., the synthetic lithium solution) is fed into agitated vessel 602, where its pH is adjusted to a value of 8 by addition of an aqueous slurry of 4 M CaOH₂. This results in the formation of a slurry. Said slurry comprises a liquid with a Mn concentration of about 25 mg/L and Li concentration of about 5,000 mg/L, and a solid comprising manganese. This slurry is continually fed to a second agitated vessel 603, where the pH of the slurry is adjusted to a value of 10 by addition of an aqueous slurry of 4 M CaOH₂, and the oxidation-reduction potential is adjusted to a value of 350 mV by addition of an aqueous solution of hydrogen peroxide. This results in a slurry comprising a liquid with no detectable Mn and a Li concentration of about 5,000 mg/L, and a solid comprising manganese (e.g., transition metal species, precipitated transition metal species).

This slurry is continually fed into thickener 604, where the solids (e.g., transition metal species, precipitated transition metal species) settle towards the bottom to result in a partially clarified supernatant.

The bottom of clarifier 604, concentrated in solids, is continually fed to a filter press 606 to separate the solids from the Li eluate (e.g., the synthetic lithium solution). The filtrate from filter press 606 contains small unfiltered crystals, which are recycled back to vessel 602 so that they will go through an additional precipitation cycle and grow into larger crystallites that are trapped by filter press 606.

The top of clarifier 604 is fed into ultrafilter 605. The permeate of 605 comprises the purified lithium eluate, wherein all transition metal species have been removed. The backwash of ultrafilter 605 contains small manganese crystals; therefore, it is recycled back to vessel 602, so that these crystals will go through an additional precipitation cycle and grow into larger crystallites that are trapped by filter press 606.

The process results in a lithium eluate comprising lithium and calcium (e.g., a synthetic lithium solution), wherein all transition metal species have been removed.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents.

What is claimed is:

1. A system for producing a synthetic lithium solution and removing transition metal species from said synthetic lithium solution, comprising:
a. a first subsystem configured to 1) first contact an ion exchange material to a liquid resource, wherein said ion exchange material absorbs lithium ions from said liquid resource while releasing protons, and subsequently 2) contact the ion exchange material to an acidic solution, wherein said ion exchange material releases lithium into said acidic solution while absorbing protons, producing a synthetic lithium solution; and
b. a second subsystem configured to remove transition metal species from said synthetic lithium solution.

2. The system of claim 1, wherein the second subsystem further comprises:
i. a third subsystem configured to precipitate transition metal species dissolved in the synthetic lithium solution, to provide precipitated transition metal species in said synthetic lithium solution; and
ii. a fourth subsystem for separating the synthetic lithium solution from the precipitated transition metal species.

3. The system of claim 2, wherein the third subsystem is configured to perform an adjustment of the pH of the synthetic lithium solution, and wherein said adjustment causes the precipitated transition metal species to form.

4. The system of claim 2, wherein the third subsystem is configured to perform an adjustment of the oxidation-reduction potential of the synthetic lithium solution, and wherein said adjustment causes the precipitated transition metal species to form.

5. The system of claim 2, wherein the third subsystem is configured to perform an adjustment of the pH and the oxidation-reduction potential of the synthetic lithium solution, and wherein said adjustment causes the precipitated transition metal species to form.

6. The system of any one of claims 1-5, wherein the second subsystem is configured to perform a removal of transition metal species directly from the synthetic lithium solution.

7. The system of claim 6, wherein the removal of transition metal species occurs by contacting an immiscible solvent to the synthetic lithium solution, and wherein said immiscible solvent preferentially dissolves the dissolved transition metal species thereby extracting transition metal species directly from the synthetic lithium solution.

8. The system of claim 6, wherein the removal of transition metal species occurs by contacting the synthetic lithium solution to a cation exchange resin, and wherein said cation exchange resin preferentially absorbs the transition metal species thereby extracting transition metal species directly from the synthetic lithium solution.

9. The system of claim 6, wherein the removal of transition metal species occurs by flowing the synthetic lithium solution through a nanofiltration system comprising a filter, and wherein said nanofiltration system preferentially retains the transition metal species while allowing lithium ions to pass through the filter thereby extracting transition metal species directly from the synthetic lithium solution.

10. The system of claim 6, wherein the removal of transition metal species occurs by a combination of the systems of claims 7 to 9.

11. The system of any one of claims 1-6, wherein the removal of transition metal species occurs by a combination of the systems of claims 2-5 and the systems of claims 6-10.

12. The system of claim 1, wherein the second subsystem is configured to pass an electrical current through the synthetic lithium solution.

13. The system of claim 12, wherein said electrical current is passed between two electrodes in contact with the synthetic lithium solution.

14. The system of claim 13, wherein a solid is formed on one of the electrodes, and wherein said solid comprises at least one of the transition metal species removed from the synthetic lithium solution.

15. The system of claim 14, wherein the transition metal species are additionally removed by the system of any of the claims 2-11.

16. The system of any one of claims 1-15, further comprising a fifth subsystem, wherein the fifth subsystem is configured to manufacture an impurities-derived ion exchange material from the transition metal species removed from the synthetic lithium solution.

17. The system of claim 16, wherein the fifth subsystem uses transition metal species removed from the synthetic lithium solution by the system of any of the claims 2-5 to manufacture the impurities-derived ion exchange material.

18. The system of claim 16, wherein the fifth subsystem uses transition metal species removed from the synthetic lithium solution by the system of any of the claims 12-15 to manufacture the impurities-derived ion exchange material.

19. The system of any one of claims 16-18, wherein within the fifth subsystem the transition metal species are washed with pure water or an aqueous solution.

20. The system of any one of claims 16-19, wherein within the fifth subsystem the transition metal species comprise oxides, hydroxides, metals, insoluble salts, chelates, or a combination thereof.

21. The system of any one of claims 16-20, wherein within the fifth subsystem the transition metal species are dissolved with an acid, and wherein said acid comprises hydrochloric acid, sulfuric acid, nitric acid, phosphoric acid, hydrobromic acid, hydroiodic acid, perchloric acid, acetic acid, or a combination thereof.

22. The system of any one of claims 16-21, wherein within the fifth subsystem the transition metal species are purified via hydrometallurgical processes.

23. The system of the claim 22, wherein the hydrometallurgical processes comprise leaching, concentration, precipitation, cementation, solvent extraction, ion exchange, gas reduction, electrowinning, electrolysis, electrorefining, or a combination thereof.

24. The system of any one of claims 16-23, wherein within the fifth subsystem the transition metal species are purified via pyrometallurgical processes.

25. The system of any one of claims 16-24, wherein within the fifth subsystem the transition metal species are purified via vapor metallurgy processes.

26. The system of any one of claims 16-25, wherein within the fifth subsystem the transition metal species are purified via molten salt electrometallurgy processes.

27. The system of any one of claims 16-26, wherein within the fifth subsystem the transition metal species are reduced in size through milling, grinding, or a combination thereof.

28. The system of any one of claims 16-27, wherein within the fifth subsystem the transition metal species are calcined in a furnace or a kiln to provide precursors for the manufacture of the impurities-derived ion exchange material.

29. The system of any one of claims 16-27, wherein within the fifth subsystem the transition metal species are mixed with other metals and calcined in a furnace or a kiln to manufacture the impurities-derived ion exchange material.

30. The system of any one of claims 16-27, wherein within the fifth subsystem the transition metal species are mixed with a lithium salt and calcined in a furnace or kiln to manufacture the impurities-derived ion exchange material.

31. The system of any one of claims 16-27, wherein within the fifth subsystem the transition metal species are mixed with other metals and a lithium salt and calcined in a furnace or kiln to manufacture the impurities-derived ion exchange material.

32. The system of claim 30 or 31, wherein the lithium salt comprises Li₂CO₃, LiOH, LiOH·H₂O, LiNO₃, Li₂SO₄, Li₃PO₄, or a combination thereof.

33. The system of any one of claims 1-32, wherein the synthetic lithium solution produced by the first subsystem comprises chloride, sulfate, phosphate, bromide, chlorate, perchlorate, nitrate, formate, citrate, acetate, or a combination thereof.

34. The system of any one of claims 1-33, wherein the synthetic lithium solution produced by the first subsystem comprises chloride, sulfate, nitrate, or a combination thereof.

35. The system of any one of claims 1-34, wherein the synthetic lithium solution is used to produce a lithium product, and wherein said lithium product comprises lithium carbonate, lithium chloride, lithium hydroxide, lithium nitrate, lithium sulfate, lithium phosphate, metallic lithium, or a combination thereof.

36. The system of any one of claims 1-35, wherein the transition metal species comprise titanium, zirconium, vanadium, iron, copper, manganese, molybdenum, aluminum, niobium, or a combination thereof.

37. The system of any one of claims 1-36, wherein in the synthetic lithium solution produced by the first subsystem, the molar concentration of transition metal species is lower than the molar concentration of lithium in the synthetic lithium solution.

38. The system of any one of claims 1-37, wherein the concentration of lithium in the synthetic lithium solution produced by the first subsystem is greater than about 200 milligrams per liter and less than about 8000 milligrams per liter.

39. The system of any one of claims 1-37, wherein the concentration of lithium in the synthetic lithium solution produced by the first subsystem is greater than about 200 milligrams per liter and less than about 4000 milligrams per liter.

40. The system of any one of claims 1-37, wherein the concentration of lithium in the synthetic lithium solution produced by the first subsystem is greater than about 2000 milligrams per liter and less than about 8000 milligrams per liter.

41. The system of any one of claims 1-37, wherein the concentration of lithium in the synthetic lithium solution produced by the first subsystem is greater than about 200 milligrams per liter and less than about 1000 milligrams per liter.

42. The system of any one of claims 1-37, wherein the concentration of lithium in the synthetic lithium solution produced by the first subsystem is greater than about 200 milligrams per liter and less than about 500 milligrams per liter.

43. The system of any one of claims 1-37, wherein the concentration of lithium in the synthetic lithium solution produced by the first subsystem is greater than about 1000 milligrams per liter and less than about 4000 milligrams per liter.

44. The system of any one of claims 1-37, wherein the concentration of lithium in the synthetic lithium solution produced by the first subsystem is greater than about 1000 milligrams per liter and less than about 2000 milligrams per liter.

45. The system of any one of claims 1-37, wherein the concentration of lithium in the synthetic lithium solution produced by the first subsystem is greater than about 2000 milligrams per liter and less than about 3000 milligrams per liter.

46. The system of any one of claims 1-37, wherein the concentration of lithium in the synthetic lithium solution produced by the first subsystem is greater than about 3000 milligrams per liter and less than about 4000 milligrams per liter.

47. The system of any one of claims 1-37, wherein the concentration of lithium in the synthetic lithium solution produced by the first subsystem is greater than about 4000 milligrams per liter and less than about 5000 milligrams per liter.

48. The system of any one of claims 1-37, wherein the concentration of lithium in the synthetic lithium solution produced by the first subsystem is greater than about 5000 milligrams per liter and less than about 6000 milligrams per liter.

49. The system of any one of claims 1-37, wherein the concentration of lithium in the synthetic lithium solution produced by the first subsystem is greater than about 6000 milligrams per liter and less than about 8000 milligrams per liter.

50. The system of any one of claims 1-49, wherein the synthetic lithium solution produced by the first subsystem is acidic.

51. The system of any one of claims 1-49, wherein the value of pH of the synthetic lithium solution produced by the first subsystem is greater than about 1 and less than about 4.

52. The system of any one of claims 1-49, wherein the value of pH of the synthetic lithium solution produced by the first subsystem is greater than about 0 and less than about 1.

53. The system of any one of claims 1-49, wherein the value of pH of the synthetic lithium solution produced by the first subsystem is greater than about 1 and less than about 2.

54. The system of any one of claims 1-49, wherein the value of pH of the synthetic lithium solution produced by the first subsystem is greater than about 2 and less than about 3.

55. The system of any one of claims 1-49, wherein the value of pH of the synthetic lithium solution produced by the first subsystem is greater than about 3 and less than about 4.

56. The system of any one of claims 1-49, wherein the value of pH of the synthetic lithium solution produced by the first subsystem is greater than about 4 and less than about 5.

57. The system of any one of claims 1-49, wherein the value of pH of the synthetic lithium solution produced by the first subsystem is greater than about 5 and less than about 6.

58. The system of any one of claims 1-49, wherein the value of pH of the synthetic lithium solution produced by the first subsystem is greater than about 6 and less than about 8.

59. The system of any one of claims 1-49, wherein the value of pH of the synthetic lithium solution produced by the first subsystem is greater than about 8 and less than about 10.

60. The system of any one of claims 1-59, wherein within the second subsystem the pH of the synthetic lithium solution is adjusted by adding a base.

61. The system of any one of claims 1-59, wherein within the second subsystem the pH of the synthetic lithium solution is adjusted by adding hydroxide containing species to the synthetic lithium solution to precipitate transition metal species in the form of insoluble transition metal hydroxide salts.

62. The system of any one of claims 1-59, wherein within the second subsystem transition metal species are removed from the synthetic lithium solution by adding hydroxide containing species to the synthetic lithium solution to precipitate transition metal species in the form of insoluble transition metal hydroxide salts.

63. The system of any one of claims 1-62, wherein within the second subsystem the pH of the synthetic lithium solution is adjusted by adding NaOH, KOH, LiOH, RbOH, Ca(OH)₂, Mg(OH)₂, Sr(OH)₂, Ba(OH)₂, NH₄OH, Li₂CO₃, Na₂CO₃, other basic compounds, or a combination thereof to the synthetic lithium solution.

64. The system of any one of claims 1-63, wherein the pH of the synthetic lithium solution is adjusted by distilling acid away from the synthetic lithium solution.

65. The system of any one of claims 1-64, wherein the pH of the synthetic lithium solution is adjusted by distilling acid away from the synthetic lithium solution at temperatures of from about 50 degrees centigrade to about 150 degrees centigrade.

66. The system of any one of claims 1-64, wherein the pH of the synthetic lithium solution is adjusted by distilling acid away from the synthetic lithium solution at temperatures of from about 100 degrees centigrade to about 200 degrees centigrade.

67. The system of any one of claims 1-64, wherein the pH of the synthetic lithium solution is adjusted by distilling acid away from the synthetic lithium solution at temperatures of from about 100 degrees centigrade to about 300 degrees centigrade.

68. The system of any one of claims 1-64, wherein the pH of the synthetic lithium solution is adjusted by distilling acid away from the synthetic lithium solution at temperatures of from about 200 degrees centigrade to about 400 degrees centigrade.

69. The system of any one of claims 1-64, wherein the pH of the synthetic lithium solution is adjusted by distilling acid away from the synthetic lithium solution at temperatures of from about 400 degrees centigrade to about 600 degrees centigrade.

70. The system of any one of claims 1-69, wherein the pH of the synthetic lithium solution is adjusted by distilling acid away from the synthetic lithium solution at a pressure of from about 0.01 atmospheres to about 0.1 atmospheres.

71. The system of any one of claims 1-69, wherein the pH of the synthetic lithium solution is adjusted by distilling acid away from the synthetic lithium solution at a pressure of from about 0.1 atmospheres to about 1 atmosphere.

72. The system of any one of claims 1-69, wherein the pH of the synthetic lithium solution is adjusted by distilling acid away from the synthetic lithium solution at a pressure of from about 1 to about 10 atmospheres.

73. The system of any one of claims 1-72, wherein within the second subsystem, the pH of the synthetic lithium solution is adjusted from a value of less than about 3 to a value greater than about 9.

74. The system of any one of claims 1-72, wherein within the second subsystem, the pH of the synthetic lithium solution is adjusted from a value of less than about 3 to a value of between 7 and 8.

75. The system of any one of claims 1-72, wherein within the second subsystem, the pH of the synthetic lithium solution is adjusted from a value of less than about 3 to a value of between 8 and 9.

76. The system of any one of claims 1-72, wherein within the second subsystem, the pH of the synthetic lithium solution is adjusted from a value of less than about 3 to a value of between 9 and 10.

77. The system of any one of claims 1-72, wherein within the second subsystem, the pH of the synthetic lithium solution is adjusted from a value of less than about 2 to a value of between 7 and 8.

78. The system of any one of claims 1-72, wherein in the second subsystem, the pH of the synthetic lithium solution is adjusted from a value of less than about 2 to a value of between 8 and 9.

79. The system of any one of claims 1-72, wherein in the second subsystem, the pH of the synthetic lithium solution is adjusted from a value of less than about 2 to a value of between 9 and 10.

80. The system of any one of claims 1-79, wherein the value of oxidation reduction potential of the synthetic lithium solution produced by the first subsystem is greater than about 50 mV and less than about 150 mV versus standard hydrogen electrode.

81. The system of any one of claims 1-79, wherein the value of oxidation reduction potential of the synthetic lithium solution produced by the first subsystem is greater than about 150 m V and less than about 300 mV versus standard hydrogen electrode.

82. The system of any one of claims 1-79, wherein the value of oxidation reduction potential of the synthetic lithium solution produced by the first subsystem is greater than about 300 m V and less than about 500 mV versus standard hydrogen electrode.

83. The system of any one of claims 1-79, wherein the value of oxidation reduction potential of the synthetic lithium solution produced by the first subsystem is greater than about 500 m V and less than about 800 mV versus standard hydrogen electrode.

84. The system of any one of claims 1-83, wherein within the second subsystem a redox active species is added to the synthetic lithium solution to adjust its oxidation-reduction potential.

85. The system of any one of claims 1-83, wherein within the second subsystem an electrical current through the synthetic lithium solution to adjust its oxidation-reduction potential.

86. The system of claim 85, wherein said electrical current is passed between two electrodes in contact with the synthetic lithium solution.

87. The system of claim 85 or 86, wherein a solid is formed on one of the electrodes, and wherein said solid comprises at least one transition metal species that is removed from the synthetic lithium solution.

88. The system of any one of claims 1-87, wherein in the second subsystem comprises an electrolysis cell.

89. The system of any one of claims 1-87, wherein in the second subsystem comprises an electrowinning cell.

90. The system of any one of claims 1-89, wherein within the second subsystem an oxidant is added to the synthetic lithium solution to increase its oxidation-reduction potential.

91. The system of claim 90, wherein the oxidant comprises sodium hypochlorite, perchlorate, chlorate, bleach, hydrogen peroxide, nitric acid, potassium permanganate, fluorine, chlorine, air, oxygen, ozone, or a combination thereof.

92. The system of any one of claims 1-91, wherein within the second subsystem a reductant is added to the synthetic lithium solution to decrease its oxidation-reduction potential.

93. The system of claim 92, wherein the reductant comprises sodium bisulfite, sodium metabisulfite, sodium borohydride, formic acid, ascorbic acid, oxalic acid, potassium iodide, or a combination thereof.

94. The system of any one of claims 1-93, wherein within the second subsystem the oxidation-reduction potential of the synthetic lithium solution is adjusted from a value of less than about 200 mV to a value of between 300 and 400 mV versus standard hydrogen electrode.

95. The system of any one of claims 1-93, wherein within the second subsystem the oxidation-reduction potential of the synthetic lithium solution is adjusted from a value of less than about 200 mV to a value of between 400 and 500 mV versus standard hydrogen electrode.

96. The system of any one of claims 1-93, wherein within the second subsystem the oxidation-reduction potential of the synthetic lithium solution is adjusted from a value of less than about 200 mV to a value of between 500 and 600 mV versus standard hydrogen electrode.

97. The system of any one of claims 1-93, wherein within the second subsystem the oxidation-reduction potential of the synthetic lithium solution is adjusted from a value of less than about 200 mV to a value of between 600 and 700 mV versus standard hydrogen electrode.

98. The system of any one of claims 1-93, wherein within the second subsystem the oxidation-reduction potential of the synthetic lithium solution is adjusted from a value of less than about 200 mV to a value of between 700 and 800 mV versus standard hydrogen electrode.

99. The system of any one of claims 1-93, wherein within the second subsystem the oxidation-reduction potential of the synthetic lithium solution is adjusted from a value of less than about 200 mV to a value of between 800 and 1000 mV versus standard hydrogen electrode.

100. The system of any one of claims 1-93, wherein within the second subsystem the oxidation-reduction potential of the synthetic lithium solution is adjusted from a value of more than about 200 mV to a value of between 100 and 200 mV versus standard hydrogen electrode.

101. The system of any one of claims 1-93, wherein within the second subsystem the oxidation-reduction potential of the synthetic lithium solution is adjusted from a value of more than about 200 mV to a value of between 0 and 100 mV versus standard hydrogen electrode.

102. The system of any one of claims 1-93, wherein within the second subsystem the oxidation-reduction potential of the synthetic lithium solution is adjusted from a value of more than about 100 mV to a value of between 0 and 100 mV versus standard hydrogen electrode.

103. The system of any one of claims 2-102, wherein within the second subsystem the transition metal impurities are precipitated from the synthetic lithium solution by adding seed crystals to the synthetic lithium solution to crystallize the transition metal species within the third subsystem thereby providing precipitated transition metal species.

104. The system of claim 103, wherein within the second subsystem the addition of seed crystals increases the size of crystallites of the transition metal species formed within the third subsystem.

105. The system of claim 103, wherein within the second subsystem the addition of seed crystals increases the size of crystallites of the precipitated transition metal species, facilitating the separation of the precipitated transition metal species from the synthetic lithium solution within the fourth subsystem.

106. The system of any one of claims 2-105, wherein within the second subsystem the transition metal species are precipitated by adding a chelating ligand to the synthetic lithium solution within the third subsystem thereby providing precipitated transition metal species.

107. The system claim 106, wherein the chelating ligand comprises EDTA, oxalate, or a combination thereof.

108. The system of any one of claims 2-107, wherein within the second subsystem the transition metal species are precipitated by adding a complimentary anion to the synthetic lithium solution within the third subsystem thereby providing precipitated transition metal species that comprise insoluble transition metal salts.

109. The system claim 108, wherein the complimentary anion comprises sulfide, phosphate, carbonate, other anions, or a combination thereof.

110. The system of any one of claims 2-109, wherein within the second subsystem the transition metals are precipitated by adding a precipitant comprising H₂S, Na₂S, K₂S, CaS, MgS, Na₃PO₄, K₃PO₄, Rb₃PO₄, (NH₄)₃PO₄, MgCO₃, CaCO₃, SrCO₃, CO₂, Na₂CO₃, or a combination thereof to the synthetic lithium solution within the third subsystem.

111. The system of claim 110, wherein the precipitant comprises Na₃PO₄, K₃PO₄, Rb₃PO₄, (NH₄)₃PO₄, MgCO₃, CaCO₃, SrCO₃, Na₂CO₃, or a combination thereof.

112. The system of any one of claims 2-111, wherein within the fourth subsystem the precipitated transition metal species are separated from the synthetic lithium solution using centrifugation.

113. The system of any one of claims 2-111, wherein within the fourth subsystem the precipitated transition metal species are separated from the synthetic lithium solution using pressure filtration.

114. The system of any one of claims 2-111, wherein within the fourth subsystem the precipitated transition metal species are separated from the synthetic lithium solution using gravity sedimentation.

115. The system of any one of claims 2-111, wherein within the fourth subsystem the precipitated transition metal species are separated from the synthetic lithium solution by allowing said precipitated transition metal species to settle into a bed and removing the synthetic lithium solution from above said bed.

116. The system of claim 115, wherein the settling of the precipitated transition metal species is aided by a flocculant, a coagulant, or a combination thereof.

117. The system of any one of claims 2-111, wherein within the fourth subsystem the precipitated transition metal species are separated from the synthetic lithium solution using membrane filtration, belt filtration, cartridge filtration, nanofiltration, pressure filtration, rotary disk filtration, or a combination thereof.

118. The system of any one of claims 2-111, wherein within the fourth subsystem the precipitated transition metal species are separated from the synthetic lithium solution using magnetic fields.

119. The system of any one of claims 2-111, wherein within the fourth subsystem the precipitated transition metal species are separated from the synthetic lithium solution using one or more particle traps.

120. The system of any one of claims 2-111, wherein within the fourth subsystem the precipitated transition metal species are separated from the synthetic lithium solution using one or more surfactants.

121. The system of any one of claims 2-111, wherein within the fourth subsystem the precipitated transition metal species are separated from the synthetic lithium solution using floatation.

122. The system of any one of claims 1-121, wherein within the second subsystem the dissolved transition metal species are removed from the synthetic lithium solution by precipitating said transition metal species, separating the precipitated species using a solid-liquid separator, and removing additional transition metal species from the synthetic lithium solution using ion exchange resins, water softeners, solvent extraction, or a combination thereof.

123. The system of any one of claims 1-122, wherein the ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.

124. The system of claim 123, wherein said ion exchange material is a coated ion exchange material with a coating that is selected from an oxide, a polymer, or combinations thereof.

125. The system of claim 123 or 124, wherein said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof.

126. The system of any one of claims 1-125, wherein the liquid resource is a natural brine, a pretreated brine, a dissolved salt flat brine, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

127. The system of any one of claims 1-126, wherein the acidic solution comprises hydrochloric acid, sulfuric acid, nitric acid, phosphoric acid, hydrobromic acid, hydroiodic acid, perchloric acid, acetic acid, or a combination thereof.

128. The system of any one of claims 1-127, wherein the first subsystem is configured to wash the ion exchange material with pure water or an aqueous solution.

129. The system of any one of claims 1-128, wherein the second subsystem comprises one or more vessels.

130. The system of any one of claims 1-129, wherein the third subsystem comprises one or more vessels.

131. The system of any one of claims 1-130, wherein the fourth subsystem comprises one or more solid-liquid separators.

132. The system of any one of claims 129-131, wherein the contents of the one or more vessels are agitated.

133. The system of claim 132, wherein the contents of the one or more vessels are agitated using a stirrer.

134. The system of claim 132, wherein the contents of the one or more vessels are agitated using an eductor.

135. The system of claim 132, wherein the contents of the one or more vessels are agitated using an air sparger.

136. The system of any one of claims 129-135, wherein the pH, the oxidation-reduction potential, or a combination of the pH and the oxidation-reduction potential of the synthetic lithium solution is adjusted in each vessel.

137. The system of any one of claims 129-136, wherein said subsystem is configured within a single vessel.

138. The system of any one of claims 129-136, wherein said subsystem is configured within 2 to 3 vessels.

139. The system of any one of claims 129-136, wherein said subsystem is configured within 3 to 5 vessels.

140. The system of any one of claims 129-136, wherein said subsystem is configured within 5 to 10 vessels.

141. The system of any one of claims 129-140, wherein said subsystem is configured within 1 solid-liquid separator.

142. The system of any one of claims 129-140, wherein said subsystem is configured within 2 to 3 solid-liquid separators.

143. The system of any one of claims 129-140, wherein said subsystem is configured within 3 to 5 solid-liquid separators.

144. The system of any one of claims 129-140, wherein said subsystem is configured within 5 to 10 solid-liquid separators.

145. The system of any one of claims 129-144, wherein a substance that adjusts the pH, the oxidation-reduction potential, or a combination of the pH and the oxidation-reduction potential of the synthetic lithium solution is injected into at least one vessel using a nozzle.

146. A process of producing a synthetic lithium solution with the system of any one of claims 1-145.

147. A process of producing an impurities-derived ion exchange material with the system of any one of claims 16-146.

148. A process of producing an impurities-derived ion exchange material, the process comprising:
a. contacting an ion exchange material to a liquid resource, wherein said ion exchange material absorbs lithium ions from said liquid resource while releasing protons;
b. contacting the ion exchange material to an acidic solution, wherein said ion exchange material releases lithium into said acidic solution while absorbing protons, producing a synthetic lithium solution, and wherein said synthetic lithium solution comprises at least one transition metal species;
c. removing at least one of said transition metal species from said synthetic lithium solution; and
d. manufacturing the impurities-derived ion exchange material from said transition metal species.

149. The process of claim 148, further comprising adjusting the pH of the synthetic lithium solution.

150. The process of claim 149, wherein adjusting the pH of the synthetic lithium solution leads to the precipitation of the transition metal species thereby removing at least one of said transition metal species from said synthetic lithium solution.

151. The process of any one of claims 148-150, further comprising adjusting the oxidation-reduction potential of the synthetic lithium solution.

152. The process of claim 151, wherein adjusting the oxidation-reduction potential of the synthetic lithium solution leads to the precipitation of the transition metal species thereby removing at least one of said transition metal species from said synthetic lithium solution.

153. The process of any one of claims 148-152, wherein removing at least one of said transition metal species from said synthetic lithium solution comprises removal of the transition metal species directly from the synthetic lithium solution.

154. The process of claim 153, wherein the removal of the transition metal species directly from the synthetic lithium solution comprises contacting an immiscible solvent to the synthetic lithium solution, and wherein said immiscible solvent preferentially dissolves the dissolved transition metal species.

155. The process of claim 153, wherein the removal of the transition metal species directly from the synthetic lithium solution comprises contacting the synthetic lithium solution to a cation exchange resin, and wherein said cation exchange resin preferentially absorbs the transition metal species.

156. The process of claim 153, wherein the removal of the transition metal species directly from the synthetic lithium solution comprises flowing the synthetic lithium solution through a nanofiltration system comprising a filter, and wherein said nanofiltration system preferentially retains the transition metal species while allowing lithium ions to pass through the filter.

157. The process of claim 153, wherein the removal of the transition metal species directly from the synthetic lithium solution comprises a combination of the processes of claims 154 to 156.

158. The process of any one of claims 148-153, wherein removing at least one of said transition metal species from said synthetic lithium solution comprises a combination of the processes of claims 149 to 157.

159. The process of claim 148, wherein removing at least one of said transition metal species from said synthetic lithium solution comprises passing an electrical current through the synthetic lithium solution.

160. The process of claim 159, wherein said electrical current is passed between two electrodes in contact with the synthetic lithium solution.

161. The process of claim 160, wherein a solid is formed on one of the electrodes, wherein said solid comprises at least one of said transition metal species removed from the synthetic lithium solution.

162. The process of claim 161, wherein at least one additional transition metal species is removed by the process of any one of claims 148 to 159.

163. The process of any one of claims 148-162, further comprising washing the transition metals species with pure water or an aqueous solution following their removal from the synthetic lithium solution.

164. The process of any one of claims 148-163, wherein the transition metal species used to manufacture the impurities-derived ion exchange material comprise oxides, hydroxides, metals, insoluble salts, chelates, or a combination thereof.

165. The process of any one of claims 148-164, wherein manufacturing the impurities-derived ion exchange material comprises dissolving the transition metal species with an acid, and wherein said acid comprises hydrochloric acid, sulfuric acid, nitric acid, phosphoric acid, hydrobromic acid, hydroiodic acid, perchloric acid, acetic acid, or a combination thereof.

166. The process of any one of claims 148-165, wherein manufacturing the impurities-derived ion exchange material comprises purifying the transition metal species via hydrometallurgical processes.

167. The process of claim 166, wherein the hydrometallurgical processes comprise leaching, concentration, precipitation, cementation, solvent extraction, ion exchange, gas reduction, electrowinning, electrolysis, electrorefining, or a combination thereof.

168. The process of any one of claims 148-167, wherein manufacturing the impurities-derived ion exchange material comprises purifying the transition metal species via pyrometallurgical processes.

169. The process of any one of claims 148-168, wherein manufacturing the impurities-derived ion exchange material comprises purifying the transition metal species via vapor metallurgy processes.

170. The process of any one of claims 148-169, wherein manufacturing the impurities-derived ion exchange material comprises purifying the transition metal species via molten salt electrometallurgy processes.

171. The process of any one of claims 148-170, wherein the transition metal species used to manufacture the impurities-derived ion exchange material are reduced in size through milling, grinding, or a combination thereof.

172. The process of any one of claims 148-171, wherein the transition metal species used to manufacture the impurities-derived ion exchange material are calcined in a furnace or a kiln to provide precursors for the manufacture of the impurities-derived ion exchange material.

173. The process of any one of claims 148-171, wherein the transition metal species used to manufacture the impurities-derived ion exchange material are mixed with other metals and calcined in a furnace or a kiln to manufacture the impurities-derived ion exchange material.

174. The process of any one of claims 148-171, wherein the transition metal species used to manufacture the impurities-derived ion exchange material are mixed with a lithium salt and calcined in a furnace or kiln to manufacture the impurities-derived ion exchange material.

175. The process of any one of claims 148-171, wherein the transition metal species used to manufacture the impurities-derived ion exchange material are mixed with other metals and a lithium salt and calcined in a furnace or kiln to manufacture the impurities-derived ion exchange material.

176. The process of claim 174 or 175, wherein the lithium salt comprises Li₂CO₃, LiOH, LiOH·H₂O, LiNO₃, Li₂SO₄, Li₃PO₄, or a combination thereof.

177. The process of any one of claims 148-176, wherein the synthetic lithium solution comprises chloride, sulfate, phosphate, bromide, chlorate, perchlorate, nitrate, formate, citrate, acetate, or a combination thereof.

178. The process of any one of claims 148-177, wherein the synthetic lithium solution comprises chloride, sulfate, nitrate, or a combination thereof.

179. The process of any one of claims 148-178, wherein the synthetic lithium solution is used to produce a lithium product, and wherein said lithium product comprises lithium carbonate, lithium chloride, lithium hydroxide, lithium nitrate, lithium sulfate, lithium phosphate, metallic lithium, or a combination thereof.

180. The process of any one of claims 148-179, wherein the transition metal species comprise titanium, zirconium, vanadium, iron, copper, manganese, molybdenum, aluminum, niobium, or a combination thereof.

181. The process of any one of claims 148-180, wherein prior to removing at least one of said transition metal species from said synthetic lithium solution the molar concentration of transition metal species is lower than the molar concentration of lithium in said synthetic lithium solution.

182. The process of any one of claims 148-181, wherein prior to removing at least one of said transition metal species from said synthetic lithium solution said synthetic lithium solution is acidic.

183. The process of any one of claims 148-182, wherein removing at least one of said transition metal species from said synthetic lithium solution comprises adjusting the pH of said synthetic lithium solution by adding a base thereto.

184. The process of any one of claims 148-182, wherein removing at least one of said transition metal species from said synthetic lithium solution comprises adjusting the pH of said synthetic lithium solution by adding hydroxide containing species thereto, and wherein transition metal species precipitate in the form of insoluble transition metal hydroxide salts.

185. The process of any one of claims 148-184, wherein removing at least one of said transition metal species from said synthetic lithium solution comprises adjusting the pH of said synthetic lithium solution by adding NaOH, KOH, LiOH, RbOH, Ca(OH)₂, Mg(OH)₂, Sr(OH)₂, Ba(OH)₂, NH₄OH, Li₂CO₃, Na₂CO₃, other basic compounds, or a combination thereof to the synthetic lithium solution.

186. The process of any one of claims 148-185, further comprising distilling acid away from the synthetic lithium solution to adjust its pH.

187. The process of any one of claims 148-186, further comprising adding a redox active species to the synthetic lithium solution to adjust its oxidation-reduction potential.

188. The process of any one of claims 148-186, further comprising passing an electrical current through the synthetic lithium solution to adjust its oxidation-reduction potential.

189. The process of claim 188, wherein said electrical current is passed between two electrodes in contact with the synthetic lithium solution.

190. The process of claim 188 or 189, wherein a solid is formed on one of the electrodes, wherein said solid comprises at least one of said transition metal species removed from the synthetic lithium solution.

191. The process of any one of claims 148-190, further comprising adding an oxidant to the synthetic lithium solution to increase its oxidation-reduction potential.

192. The process of claim 191, wherein the oxidant comprises sodium hypochlorite, perchlorate, chlorate, bleach, hydrogen peroxide, nitric acid, potassium permanganate, fluorine, chlorine, air, oxygen, ozone, or a combination thereof.

193. The process of any one of claims 148-192, further comprising adding a reductant to the synthetic lithium solution to decrease its oxidation-reduction potential.

194. The process of claim 193, wherein the reductant comprises sodium bisulfite, sodium metabisulfite, sodium borohydride, formic acid, ascorbic acid, oxalic acid, potassium iodide, or a combination thereof.

195. The process of any one of claims 148-194, wherein removing at least one of said transition metal species from said synthetic lithium solution comprises adding seed crystals to the synthetic lithium solution to precipitate the transition metal species.

196. The process of any one of claims 148-195, wherein removing at least one of said transition metal species from said synthetic lithium solution comprises adding a chelating ligand to the synthetic lithium solution to precipitate the transition metal species.

197. The process of claim 196, wherein the chelating ligand comprises EDTA, oxalate, or a combination thereof.

198. The process of any one of claims 148-197, wherein removing at least one of said transition metal species from said synthetic lithium solution comprises adding a complementary anion to the synthetic lithium solution to precipitate the transition metal species.

199. The process of claim 198, wherein the complementary anion comprises sulfide, phosphate, carbonate, other anions, or a combination thereof.

200. The process of any one of claims 148-199, wherein removing at least one of said transition metal species from said synthetic lithium solution comprises adding a precipitant comprising H₂S, Na₂S, K₂S, CaS, MgS, Na₃PO₄, K₃PO₄, Rb₃PO₄, (NH₄)₃PO₄, MgCO₃, CaCO₃, SrCO₃, CO₂, Na₂CO₃, or a combination thereof to the synthetic lithium solution to precipitate the transition metal species.

201. The process of claim 200, wherein the precipitant comprises Na₃PO₄, K₃PO₄, Rb₃PO₄, (NH₄)₃PO₄, MgCO₃, CaCO₃, SrCO₃, Na₂CO₃, or a combination thereof.

202. The process of any one of claims 148-201, wherein the ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.

203. The process of claim 202, wherein said ion exchange material is a coated ion exchange material with a coating that is selected from an oxide, a polymer, or combinations thereof.

204. The process of any one of claims 148-203, wherein the liquid resource is a natural brine, a pretreated brine, a dissolved salt flat brine, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

205. The process of any one of claims 148-204, wherein the acidic solution comprises hydrochloric acid, sulfuric acid, nitric acid, phosphoric acid, hydrobromic acid, hydroiodic acid, perchloric acid, acetic acid, or a combination thereof.

206. The process of any one of claims 148-205, wherein the impurities-derived ion exchange material comprises at least one transition metal derived from the transition metal species removed from the synthetic lithium solution.

207. The process of claim 206, wherein the impurities-derived ion exchange material comprises at least one transition metal derived from the transition metal species removed from the synthetic lithium solution in addition to transition metal ions derived from other sources.

208. The process of any one of claims 148-207, wherein the transition metal species present in the synthetic lithium solution are derived from elution of said transition metal species from the ion exchange material into the acidic solution.

209. The process of any one of claims 148-208, wherein the transition metal species present in the synthetic lithium solution are derived from degradation or dissolution of the ion exchange material into the acidic solution.

210. The process of any one of claims 148-209, wherein the transition metal species present in the synthetic lithium solution are derived from at least one transition metal present in the liquid resource.
